(19) United States
(12) Patent Application Publication
(10) Pub. No.: US 2024/0170667 A1
(43) Pub. Date: May 23, 2024

(54) BATTERY, ELECTRONIC DEVICE, AND VEHICLE

(71) Applicant: SEMICONDUCTOR ENERGY LABORATORY CO., LTD., Atsugi-shi, Kanagawa-ken (JP)

(72) Inventors: Shunpei YAMAZAKI, Setagaya, Tokyo (JP); Tetsuya KAKEHATA, Isehara, Kanagawa (JP); Yohei MOMMA, Isehara, Kanagawa (JP); Yumiko YONEDA, Isehara, Kanagawa (JP); Kazutaka KURIKI, Ebina, Kanagawa (JP); Tatsuyoshi TAKAHASHI, Atsugi, Kanagawa (JP); Kunihiro FUKUSHIMA, Isehara, Kanagawa (JP)

(21) Appl. No.: 18/550,769

(22) PCT Filed: Mar. 14, 2022
(86) PCT No.: PCT/IB2022/052240

§ 371 Date: Sep. 15, 2023

(30) Foreign Application Priority Data
Mar. 22, 2021 (JP) 2021-047831
May 11, 2021 (JP) 2021-080592
May 13, 2021 (JP) 2021-081778
Jun. 17, 2021 (JP) 2021-101158

(51) Int. Cl. H01M 4/525; B60L 50/64; H01M 4/02; H01M 4/131; H01M 50/109

(52) U.S. Cl. CPC H01M 4/525; H01M 4/131; H01M 50/109; B60L 50/64; H01M 2004/028; H01M 2220/20

(57) ABSTRACT

A battery in which a decrease in discharge capacity retention rate in charge and discharge cycle tests is inhibited is provided. The battery includes a positive electrode and a negative electrode. The positive electrode is used as a positive electrode of a test battery in which a negative electrode includes a lithium metal. When a test of 50 repetitions of a cycle of charge and discharge in which, after constant current charge is performed at a charge rate of 1 C (1 C=200 mA/g) until a voltage of 4.6 V is reached, constant voltage charge is performed at a voltage of 4.6 V until the charge rate reaches 0.1 C, and constant current discharge is then performed at a discharge rate of 1 C until a voltage of 2.5 V is reached is performed in a 25° C. environment or a 45° C. environment and discharge capacity is measured in each cycle, a discharge capacity value measured in a 50th cycle accounts for higher than or equal to 90% and lower than 100% of a maximum discharge capacity value in all 50 cycles.

### TECHNICAL FIELD

One embodiment of the present invention relates to a battery, an electronic device, and a vehicle. One embodiment of the present invention relates to an object, a method, or a manufacturing method. One embodiment of the present invention relates to a process, a machine, manufacture, or a composition of matter. One embodiment of the present invention relates to a semiconductor device, a display device, a light-emitting device, a power storage device, a lighting device, an electronic device, or a manufacturing method thereof.

Note that in this specification, a battery includes a secondary battery. Note that in this specification, a power storage device includes a stationary device having a function of a battery, for example, a home power storage battery. Note that electronic devices in this specification generally mean devices including batteries, and for example, electro-optical devices including batteries, information terminal devices including batteries, and the like are all electronic devices.

### BACKGROUND ART

In recent years, a variety of batteries such as lithium-ion secondary batteries, lithium-ion capacitors, air batteries, and all-solid-state batteries have been actively developed. In particular, demand for lithium-ion secondary batteries (also referred to as lithium-ion batteries) with high output and high capacity has rapidly grown with the development of the semiconductor industry. The lithium-ion secondary batteries are essential as rechargeable energy supply sources for today's information society.

In particular, secondary batteries for mobile electronic devices are highly demanded to have high discharge capacity per weight and excellent cycle performance. In order to meet such demands, positive electrode active materials in positive electrodes of secondary batteries have been actively improved (e.g., Patent Document 1 to Patent Document 3). In addition, crystal structures of positive electrode active materials have been studied (Non-Patent Document 1 to Non-Patent Document 3).

In addition, X-ray diffraction (XRD) is one of methods used for analysis of the crystal structure of a positive electrode active material. With the use of ICSD (Inorganic Crystal Structure Database) described in Non-Patent Document 4, XRD data can be analyzed.

### REFERENCES

### Patent Documents

[Patent Document 1] Japanese Published Patent Application No. 2019-179758
[Patent Document 2] International Publication WO 2020/026078 Pamphlet
[Patent Document 3] Japanese Published Patent Application No. 2020-140954

### Non-Patent Documents

[Non-Patent Document 1] Toyoki Okumura et al., “Correlation of lithium ion distribution and X-ray absorption near-edge structure in O3- and O2-lithium cobalt oxides from first-principle calculation”, Journal of Materials Chemistry, 2012, 22, pp. 17340-17348.
[Non-Patent Document 2] Motohashi, T. et al., “Electronic phase diagram of the layered cobalt oxide system LiₓCoO₂ (0.0≤x≤1.0)”, Physical Review B, 80 (16); 165114.
[Non-Patent Document 3] Zhaohui Chen et al., “Staging Phase Transitions in LiₓCoO₂”, Journal of The Electrochemical Society, 2002, 149 (12), A1604-A1609.
[Non-Patent Document 4] Belsky, A. et al., “New developments in the Inorganic Crystal Structure Database (ICSD): accessibility in support of materials research and design”, Acta Cryst., (2002) B58, pp. 364-369.

### SUMMARY OF THE INVENTION

### Problems to be Solved by the Invention

Development of lithium-ion secondary batteries and positive electrode active materials used therein has room for improvement in terms of charge and discharge capacity, cycle performance, reliability, safety, cost, and the like.

An object of the present invention is to provide a positive electrode active material or a composite oxide which inhibits a decrease in charge and discharge capacity due to charge and discharge cycles when used in a lithium-ion secondary battery. Another object is to provide a positive electrode active material or a composite oxide whose crystal structure is not easily broken even when charge and discharge are repeated. Another object is to provide a positive electrode active material or a composite oxide with high charge and discharge capacity. Another object is to provide a highly safe or reliable secondary battery.

Another object of the present invention is to provide a positive electrode active material, a composite oxide, a secondary battery, or a manufacturing method thereof.

Note that the description of these objects does not preclude the existence of other objects. One embodiment of the present invention does not have to achieve all the objects. Other objects can be derived from the description of the specification, the drawings, and the claims.

### Means for Solving the Problems

One embodiment of the present invention is a battery including a positive electrode and a negative electrode. The positive electrode is used as a positive electrode of a test battery in which a negative electrode includes a lithium metal. When a test of 50 repetitions of a cycle of charge and discharge in which, after constant current charge is performed at 200 mA/g until a voltage of 4.6 V is reached, constant voltage charge is performed at a voltage of 4.6 V until the charge current reaches 20 mA/g, and constant current discharge is then performed at 200 mA/g until a voltage of 2.5 V is reached is performed in a 25° C. environment or a 45° C. environment and discharge capacity is measured in each cycle, a discharge capacity value measured in a 50th cycle accounts for higher than or equal to 90% and lower than 100% of a maximum discharge capacity value in all 50 cycles.

Another embodiment of the present invention is a battery including a positive electrode and a negative electrode. The positive electrode is used as a positive electrode of a test battery in which a negative electrode includes a lithium metal. When a test of 50 repetitions of a cycle of charge and discharge in which, after constant current charge is performed at a charge rate of 0.5 C (1 C=200 mA/g) until a voltage of 4.6 V is reached, constant voltage charge is performed at a voltage of 4.6 V until the charge rate reaches 0.05 C, and constant current discharge is then performed at a discharge rate of 0.5 C until a voltage of 2.5 V is reached is performed in a 25° C. environment or a 45° C. environment and discharge capacity is measured in each cycle, a discharge capacity value measured in a 50th cycle accounts for higher than or equal to 90% and lower than 100% of a maximum discharge capacity value in all 50 cycles.

Another embodiment of the present invention is a battery including a positive electrode and a negative electrode. The positive electrode is used as a positive electrode of a test battery in which a negative electrode includes a lithium metal. When a test of 50 repetitions of a cycle of charge and discharge in which, after constant current charge is performed at 100 mA/g until a voltage of 4.6 V is reached, constant voltage charge is performed at a voltage of 4.6 V until the charge current reaches 10 mA/g, and constant current discharge is then performed at 100 mA/g until a voltage of 2.5 V is reached is performed in a 25° C. environment or a 45° C. environment and discharge capacity is measured in each cycle, a discharge capacity value measured in a 50th cycle accounts for higher than or equal to 90% and lower than 100% of a maximum discharge capacity value in all 50 cycles.

Another embodiment of the present invention is a battery including a positive electrode and a negative electrode. The positive electrode is used as a positive electrode of a test battery in which a negative electrode includes a lithium metal. When a test of 50 repetitions of a cycle of charge and discharge in which, after constant current charge is performed at 200 mA/g until a voltage of 4.65 V is reached, constant voltage charge is performed at a voltage of 4.65 V until the charge current reaches 20 mA/g, and constant current discharge is then performed at 200 mA/g until a voltage of 2.5 V is reached is performed in a 25° C. environment and discharge capacity is measured in each cycle, a discharge capacity value measured in a 50th cycle accounts for higher than or equal to 90% and lower than 100% of a maximum discharge capacity value in all 50 cycles.

Another embodiment of the present invention is a battery including a positive electrode and a negative electrode. The positive electrode is used as a positive electrode of a test battery in which a negative electrode includes a lithium metal. When a test of 50 repetitions of a cycle of charge and discharge in which, after constant current charge is performed at a charge rate of 0.5 C (1 C=200 mA/g) until a voltage of 4.65 V is reached, constant voltage charge is performed at a voltage of 4.65 V until the charge rate reaches 0.05 C, and constant current discharge is then performed at a discharge rate of 0.5 C until a voltage of 2.5 V is reached is performed in a 25° C. environment and discharge capacity is measured in each cycle, a discharge capacity value measured in a 50th cycle accounts for higher than or equal to 90% and lower than 100% of a maximum discharge capacity value in all 50 cycles.

Another embodiment of the present invention is a battery including a positive electrode and a negative electrode. The positive electrode is used as a positive electrode of a test battery in which a negative electrode includes a lithium metal. When a test of 50 repetitions of a cycle of charge and discharge in which, after constant current charge is performed at 100 mA/g until a voltage of 4.65 V is reached, constant voltage charge is performed at a voltage of 4.65 V until the charge current reaches 10 mA/g, and constant current discharge is then performed at 100 mA/g until a voltage of 2.5 V is reached is performed in a 25° C. environment and discharge capacity is measured in each cycle, a discharge capacity value measured in a 50th cycle accounts for higher than or equal to 90% and lower than 100% of a maximum discharge capacity value in all 50 cycles.

Another embodiment of the present invention is a battery including a positive electrode and a negative electrode. The positive electrode is used as a positive electrode of a test battery in which a negative electrode includes a lithium metal. When a test of 50 repetitions of a cycle of charge and discharge in which, after constant current charge is performed at 200 mA/g until a voltage of 4.7 V is reached, constant voltage charge is performed at a voltage of 4.7 V until the charge current reaches 20 mA/g, and constant current discharge is then performed at 200 mA/g until a voltage of 2.5 V is reached is performed in a 25° C. environment and discharge capacity is measured in each cycle, a discharge capacity value measured in a 50th cycle accounts for higher than or equal to 90% and lower than 100% of a maximum discharge capacity value in all 50 cycles.

Another embodiment of the present invention is a battery including a positive electrode and a negative electrode. The positive electrode is used as a positive electrode of a test battery in which a negative electrode includes a lithium metal. When a test of 50 repetitions of a cycle of charge and discharge in which, after constant current charge is performed at a charge rate of 0.5 C (1 C=200 mA/g) until a voltage of 4.7 V is reached, constant voltage charge is performed at a voltage of 4.7 V until the charge rate reaches 0.05 C, and constant current discharge is then performed at a discharge rate of 0.5 C until a voltage of 2.5 V is reached is performed in a 25° C. environment and discharge capacity is measured in each cycle, a discharge capacity value measured in a 50th cycle accounts for higher than or equal to 90% and lower than 100% of a maximum discharge capacity value in all 50 cycles.

Another embodiment of the present invention is a battery including a positive electrode and a negative electrode. The positive electrode is used as a positive electrode of a test battery in which a negative electrode includes a lithium metal. When a test of 50 repetitions of a cycle of charge and discharge in which, after constant current charge is performed at 100 mA/g until a voltage of 4.7 V is reached, constant voltage charge is performed at a voltage of 4.7 V until the charge current reaches 10 mA/g, and constant current discharge is then performed at 100 mA/g until a voltage of 2.5 V is reached is performed in a 25° C. environment and discharge capacity is measured in each cycle, a discharge capacity value measured in a 50th cycle accounts for higher than or equal to 90% and lower than 100% of a maximum discharge capacity value in all 50 cycles.

In the present invention, with the test battery in the 25° C. environment and the 45° C. environment, when a test of 50 repetitions of a cycle of charge and discharge is performed and discharge capacity is measured in each cycle, a discharge capacity value measured in a 50th cycle preferably accounts for higher than or equal to 90% and lower than 100% of a maximum discharge capacity value in all 50 cycles.

In the present invention, the discharge capacity value measured in the 50th cycle preferably accounts for higher than or equal to 95% of the maximum discharge capacity value in all the 50 cycles.

Another embodiment of the present invention is a battery including a positive electrode and a negative electrode. The positive electrode is used as a positive electrode of a test battery in which a negative electrode includes a lithium metal. When a test of 50 repetitions of a cycle of charge and discharge in which, after constant current charge is performed at a charge rate of 0.5 C (1 C=200 mA/g) until a voltage of 4.65 V is reached, constant voltage charge is performed at a voltage of 4.65 V until the charge rate reaches 0.05 C, and constant current discharge is then performed at a discharge rate of 0.5 C until a voltage of 2.5 V is reached is performed in a 25° C. environment and discharge capacity is measured in each cycle, a discharge capacity value measured in a 50th cycle accounts for higher than or equal to 85% and lower than 100% of a maximum discharge capacity value in all 50 cycles.

Another embodiment of the present invention is a battery including a positive electrode and a negative electrode. The positive electrode is used as a positive electrode of a test battery in which a negative electrode includes a lithium metal. When a test of 50 repetitions of a cycle of charge and discharge in which, after constant current charge is performed at 100 mA/g until a voltage of 4.65 V is reached, constant voltage charge is performed at a voltage of 4.65 V until the charge current reaches 10 mA/g, and constant current discharge is then performed at 100 mA/g until a voltage of 2.5 V is reached is performed in a 25° C. environment and discharge capacity is measured in each cycle, a discharge capacity value measured in a 50th cycle accounts for higher than or equal to 85% and lower than 100% of a maximum discharge capacity value in all 50 cycles.

Another embodiment of the present invention is a battery including a positive electrode and a negative electrode. The positive electrode is used as a positive electrode of a test battery in which a negative electrode includes a lithium metal. When a test of 50 repetitions of a cycle of charge and discharge in which, after constant current charge is performed at a charge rate of 0.5 C (1 C=200 mA/g) until a voltage of 4.7 V is reached, constant voltage charge is performed at a voltage of 4.7 V until the charge rate reaches 0.05 C, and constant current discharge is then performed at a discharge rate of 0.5 C until a voltage of 2.5 V is reached is performed in a 25° C. environment and discharge capacity is measured in each cycle, a discharge capacity value measured in a 50th cycle accounts for higher than or equal to 80% and lower than 100% of a maximum discharge capacity value in all 50 cycles.

Another embodiment of the present invention is a battery including a positive electrode and a negative electrode. The positive electrode is used as a positive electrode of a test battery in which a negative electrode includes a lithium metal. When a test of 50 repetitions of a cycle of charge and discharge in which, after constant current charge is performed at 100 mA/g until a voltage of 4.7 V is reached, constant voltage charge is performed at a voltage of 4.7 V until the charge current reaches 10 mA/g, and constant current discharge is then performed at 100 mA/g until a voltage of 2.5 V is reached is performed in a 25° C. environment and discharge capacity is measured in each cycle, a discharge capacity value measured in a 50th cycle accounts for higher than or equal to 80% and lower than 100% of a maximum discharge capacity value in all 50 cycles.

In the present invention, the test battery is preferably a coin-type half cell.

In the present invention, the positive electrode preferably includes a layered rock-salt positive electrode active material.

In the present invention, the positive electrode preferably includes lithium cobalt oxide.

In the present invention, an electronic device or a vehicle includes the above battery.

### Effect of the Invention

One embodiment of the present invention can provide a positive electrode active material or a composite oxide which inhibits a decrease in charge and discharge capacity due to charge and discharge cycles when used in a lithium-ion secondary battery. A positive electrode active material or a composite oxide whose crystal structure is not easily broken even when charge and discharge are repeated can be provided. A positive electrode active material or a composite oxide with high charge and discharge capacity can be provided. A highly safe or reliable secondary battery can be provided.

According to the present invention, a positive electrode active material, a composite oxide, a secondary battery, or a manufacturing method thereof can be provided.

Note that the description of these effects does not preclude the existence of other effects. One embodiment of the present invention does not need to have all of these effects. Note that other effects will be apparent from the description of the specification, the drawings, the claims, and the like, and other effects can be derived from the description of the specification, the drawings, the claims, and the like.

### BRIEF DESCRIPTION OF THE DRAWINGS

FIG. 1A to FIG. 1C are diagrams illustrating a formation method of a positive electrode active material.

FIG. 2 is a diagram illustrating a formation method of a positive electrode active material.

FIG. 3A to FIG. 3C are diagrams illustrating a formation method of a positive electrode active material.

FIG. 4A is a cross-sectional view of a positive electrode active material, and FIG. 4B1 to FIG. 4C2 are part of the cross-sectional view of the positive electrode active material.

FIG. 5A and FIG. 5B are cross-sectional views of a positive electrode active material, and FIG. 5C1 and FIG. 5C2 are part of the cross-sectional view of the positive electrode active material.

FIG. 6 is a cross-sectional view of a positive electrode active material.

FIG. 7 is a cross-sectional view of a positive electrode active material.

FIG. 8 is a diagram illustrating the charge depth and crystal structures of a positive electrode active material.

FIG. 9 is a diagram illustrating XRD patterns calculated from crystal structures.

FIG. 10 is a diagram illustrating the charge depth and crystal structures of a positive electrode active material.

FIG. 11 is a diagram illustrating XRD patterns calculated from crystal structures.

FIG. 12A and FIG. 12B are diagrams illustrating XRD patterns calculated from crystal structures.

FIG. 13A to FIG. 13C show lattice constants calculated by XRD.

FIGS. 14A to 14C show lattice constants calculated by XRD.

FIG. 15 is an example of a TEM image showing crystal orientations substantially aligned with each other.

FIG. 16A is an example of a STEM image showing crystal orientations substantially aligned with each other. FIG. 16B shows an FFT of a rock-salt crystal RS region, and FIG. 16C is an FFT in a layered rock-salt crystal LRS region.

FIG. 17A and FIG. 17B are cross-sectional views of an active material layer using a graphene compound as a conductive additive.

FIG. 18A and FIG. 18B are diagrams illustrating an example of a secondary battery.

FIG. 19A to FIG. 19C are diagrams illustrating an example of a secondary battery.

FIG. 20A and FIG. 20B are diagrams an example of a secondary battery.

FIG. 21A to FIG. 21C are diagrams illustrating a coin-type secondary battery.

FIG. 22A to FIG. 22D are diagrams illustrating cylindrical secondary batteries.

FIG. 23A and FIG. 23B are diagrams illustrating examples of a secondary battery.

FIG. 24A to FIG. 24D are diagrams illustrating examples of a secondary battery.

FIG. 25A and FIG. 25B are diagrams illustrating examples of a secondary battery.

FIG. 26 is a diagram illustrating an example of a secondary battery.

FIG. 27A to FIG. 27C are diagrams illustrating a laminated secondary battery.

FIG. 28A and FIG. 28B are diagrams illustrating a laminated secondary battery.

FIG. 29 is a diagram illustrating the appearance of a secondary battery.

FIG. 30 is a diagram illustrating the appearance of a secondary battery.

FIG. 31A to FIG. 31C are diagrams illustrating a formation method of a secondary battery.

FIG. 32A to FIG. 32H are diagrams illustrating examples of electronic devices.

FIG. 33A to FIG. 33C are each a diagram illustrating an example of an electronic device.

FIG. 34 is a diagram illustrating examples of electronic devices.

FIG. 35A to FIG. 35D are diagrams illustrating examples of electronic devices.

FIG. 36A to FIG. 36C are diagrams illustrating examples of electronic devices.

FIG. 37A to FIG. 37C are diagrams illustrating examples of vehicles.

FIG. 38A and FIG. 38B are diagrams showing cycle performance.

FIG. 39A and FIG. 39B are diagrams showing cycle performance.

FIG. 40A and FIG. 40B are diagrams showing cycle performance.

FIG. 41 is a diagram showing cycle performance.

FIG. 42A and FIG. 42B are diagrams showing charge and discharge curves.

FIG. 43A and FIG. 43B are diagrams showing charge and discharge curves.

FIG. 44A and FIG. 44B are diagrams showing charge and discharge curves.

FIG. 45A and FIG. 45B are diagrams showing cycle performance.

FIG. 46A and FIG. 46B are diagrams showing cycle performance.

FIG. 47A and FIG. 47B are diagrams showing cycle performance.

FIG. 48 is a diagram and the like showing discharge capacity retention rate versus maximum discharge capacity.

FIG. 49 is a diagram and the like showing discharge capacity retention rate versus maximum discharge capacity.

FIG. 50A and FIG. 50B are diagrams showing charge and discharge curves.

FIG. 51A and FIG. 51B are diagrams showing charge and discharge curves.

FIG. 52A and FIG. 52B are diagrams showing charge and discharge curves.

FIG. 53A and FIG. 53B are diagrams showing rate performance.

FIG. 54A and FIG. 54B are diagrams showing rate performance.

FIG. 55A and FIG. 55B are diagrams showing rate performance.

FIG. 56A and FIG. 56B are diagrams showing relationship between measurement temperature and charge and discharge voltage.

FIG. 57A and FIG. 57B are diagrams showing relationship between measurement temperature and charge and discharge voltage.

FIG. 58 is a diagram showing relationship between measurement temperature and charge and discharge voltage.

FIG. 59A and FIG. 59B are diagrams showing relationship between measurement temperature and charge and discharge voltage.

FIG. 60A and FIG. 60B are diagrams showing relationship between measurement temperature and charge and discharge voltage.

FIG. 61 is a diagram showing relationship between measurement temperature and charge and discharge voltage.

FIG. 62A and FIG. 62B are diagrams showing relationship between measurement temperature and charge and discharge voltage.

FIG. 63A and FIG. 63B are diagrams showing relationship between measurement temperature and charge and discharge voltage.

FIG. 64 is a diagram showing relationship between measurement temperature and charge and discharge voltage.

FIG. 65A and FIG. 65B are diagrams showing charge curves versus measurement temperature.

FIG. 66A and FIG. 66B are diagrams showing charge curves versus measurement temperature.

FIG. 67 is a diagram showing charge curves versus measurement temperature.

FIG. 68A and FIG. 68B are diagrams showing charge curves versus measurement temperature.

FIG. 69A and FIG. 69B are diagrams showing charge curves versus measurement temperature.

FIG. 70 is a diagram showing charge curves versus measurement temperature.

FIG. 71A and FIG. 71B are diagrams showing charge curves versus measurement temperature.

FIG. 72A and FIG. 72B are diagrams showing charge curves versus measurement temperature.

FIG. 73 is a diagram showing charge curves versus measurement temperature.

FIG. 74 is a diagram showing discharge capacity retention rate versus measurement temperature.

FIG. 75 is a diagram showing charge depth versus measurement temperature.

FIG. 76 is a conceptual diagram showing relationship between charge depth and crystal structure.

FIG. 77 is a conceptual diagram showing a change in crystal phase inside an active material particle due to repetition of a charge and discharge cycle.

FIG. 78 is a diagram and the like showing cycle performance, the maximum discharge capacity, and discharge capacity retention rate of a full cell.

FIG. 79 is a diagram and the like showing cycle performance and the maximum discharge capacity of a full cell.

FIG. 80 is a diagram and the like showing cycle performance, the maximum discharge capacity, and discharge capacity retention rate of a full cell.

FIG. 81 is a diagram and the like showing cycle performance and the maximum discharge capacity of a full cell.

FIG. 82A and FIG. 82B are diagrams showing discharge curves versus measurement temperature.

FIG. 83A and FIG. 83B are diagrams showing discharge curves versus measurement temperature.

FIG. 84 is a diagram showing relationship between discharge capacity and measurement temperature.

FIG. 85A and FIG. 85B are diagrams showing relationship between weight energy density and measurement temperature.

FIG. 86 is a diagram showing relationship between weight energy density and measurement temperature.

FIG. 87 is a diagram showing discharge curves versus measurement temperature.

FIG. 88 is a diagram showing discharge curves versus measurement temperature.

FIG. 89A and FIG. 89B are diagrams showing relationship between discharge capacity and rate.

FIG. 90A and FIG. 90B are diagrams showing discharge curves versus rate.

FIG. 91A and FIG. 91B are diagrams showing relationship between discharge capacity and rate.

FIG. 92A and FIG. 92B are diagrams showing relationship between weight energy density and rate.

FIG. 93A and FIG. 93B are diagrams showing relationship between weight energy density and rate.

FIG. 94A and FIG. 94B are diagrams showing discharge curves versus rate.

FIG. 95 is a diagram showing discharge curves.

### MODE FOR CARRYING OUT THE INVENTION

Examples of embodiments of the present invention will be described in detail below with reference to the drawings and the like. Note that the present invention should not be interpreted as being limited to the examples of embodiments given below. Embodiments of the invention can be changed unless it deviates from the spirit of the present invention.

In this specification and the like, the Miller index is used for the expression of crystal planes and crystal orientations. An individual plane that shows a crystal plane is denoted by “( )”. In the crystallography, a bar is placed over a number in the expression of crystal planes, crystal orientations, and space groups; in this specification and the like, because of format limitations, crystal planes, crystal orientations, and space groups are sometimes expressed by placing a minus sign (−) in front of a number instead of placing a bar over the number.

In this specification and the like, the theoretical capacity of a positive electrode active material refers to the amount of electricity for the case where all the lithium that can be inserted and extracted in the positive electrode active material is extracted. For example, the theoretical capacity of LiCoO₂ is 274 mAh/g, the theoretical capacity of LiNiO₂ is 274 mAh/g, and the theoretical capacity of LiMn₂O₄ is 148 mAh/g.

In this specification and the like, a charge depth is used as an indicator; the charge depth obtained when all the lithium that can be inserted and extracted is inserted is 0, and the charge depth obtained when all the lithium that can be inserted and extracted and is contained in a positive electrode active material is extracted is 1.

In this specification and the like, a charge depth is a value indicating the degree of a capacity that has been charged, i.e., the amount of lithium extracted from a positive electrode, relative to the theoretical capacity of a positive electrode active material as reference. For example, in the case of a positive electrode active material having a layered rock-salt structure such as lithium cobalt oxide (LiCoO₂) or lithium nickel cobalt manganese oxide (LiNiₓCo_{y}Mn_{z}O₂ (x+y+z=1)), a charge depth of 0 indicates a state where no lithium has been extracted from the positive electrode active material; a charge depth of 0.5 indicates a state where lithium corresponding to 137 mAh/g has been extracted from the positive electrode; and a charge depth of 0.8 indicates a state where lithium corresponding to 219.2 mAh/g has been extracted from the positive electrode, relative to the theoretical capacity of 274 mAh/g as reference.

In this specification, the value of x in LiₓCoO₂ can also be used as an indicator of the remaining amount of lithium that can be inserted into and extracted from a positive electrode active material. Note that LiₓMO₂ can also be used when Co is replaced with a transition metal M that is oxidized or reduced due to insertion and extraction of lithium. x can be obtained from (theoretical capacity−charge capacity)/theoretical capacity. Note that in the calculation of x, charge capacity may be read as discharge capacity. For example, in the case where a secondary battery using LiCoO₂ as a positive electrode active material is charged to 219.2 mAh/g, x=0.2. It may be said that the state in which x=0.2 is the same as the state in which the charge depth is 0.8. Small x in LiₓCoO₂ means, for example, 0.1<x≤0.24.

Charge capacity and/or discharge capacity used for calculation of x is preferably measured under the condition where there is no influence or small influence of a short circuit and/or decomposition of an electrolyte solution. For example, data of a secondary battery, containing a sudden change that seems to result from a short circuit, is not used for calculation of x. The same applies to the case in which discharge capacity is used for the calculation of x.

Lithium with a proportion higher than or equal to the stoichiometric proportion hardly enters a positive electrode active material; when the entry of lithium stops, the voltage of the secondary battery rapidly decreases. It can be said that discharge of the secondary battery ends at this time. When the discharge ends, lithium cobalt oxide is in a state in which there is no entry of lithium, and it can be assumed that x=1 in LiₓCoO₂. In a lithium-ion secondary battery using lithium cobalt oxide for a positive electrode, “the end of discharge” is sometimes said to mean a state in which the voltage is lower than or equal to 2.5 V (a lithium counter electrode) at a current of 100 mA/g.

### Embodiment 1

In this embodiment, a formation method of a positive electrode active material of one embodiment of the present invention is described.

### <<Formation Method 1 of Positive Electrode Active Material>>

### <Step S11>

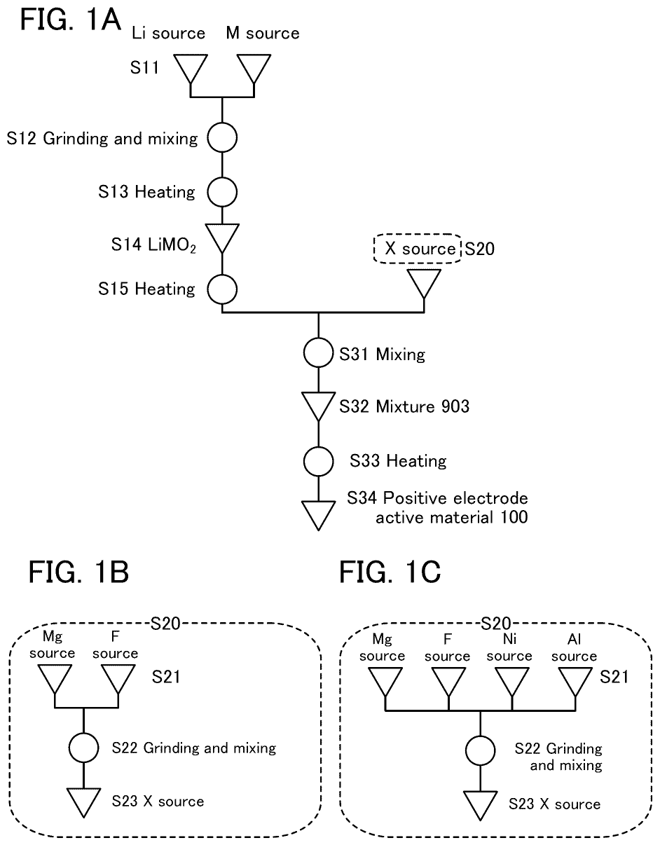

In Step S11 illustrated in FIG. 1A, a lithium source (referred to as a Li source in the drawing) and a transition metal source (referred to as an M source in the drawing) are prepared as a lithium material and a material of transition metal, respectively, which are starting materials (referred to as starting raw materials).

As the lithium source, a lithium-containing compound is preferably used and for example, lithium carbonate, lithium hydroxide, lithium nitrate, lithium fluoride, or the like can be used. The lithium source preferably has a high purity and is preferably a material having a purity of higher than or equal to 99.99%, for example.

The transition metal can be selected from the elements belonging to Groups 3 to 11 of the periodic table and for example, at least one of manganese, cobalt, and nickel is used. As the transition metal, for example, cobalt alone; nickel alone; two metals of cobalt and manganese; two metals of cobalt and nickel; or three metals of cobalt, manganese, and nickel may be used. When cobalt alone is used, the positive electrode active material obtained by this formation method contains lithium cobalt oxide (also referred to as LCO); when three metals of cobalt, manganese, and nickel are used, the positive electrode active material to be obtained contains lithium nickel cobalt manganese oxide (also referred to as NCM).

In the case of using two or more transition metal sources, the two or more transition metal sources are preferably prepared to have proportions (mixing ratio) such that a layered rock-salt crystal structure would be obtained.

As the transition metal source, a compound containing the above transition metal is preferably used and for example, an oxide, a hydroxide, or the like of any of the metals given as examples of the transition metal can be used. As a cobalt source, cobalt oxide, cobalt hydroxide, or the like can be used. As a manganese source, manganese oxide, manganese hydroxide, or the like can be used. As a nickel source, nickel oxide, nickel hydroxide, or the like can be used. As an aluminum source, aluminum oxide, aluminum hydroxide, or the like can be used.

The transition metal source preferably has a high purity and is preferably a material having a purity of higher than or equal to 3N (99.9%), further preferably higher than or equal to 4N (99.99%), still further preferably higher than or equal to 4N5 (99.995%), yet still further preferably higher than or equal to 5N (99.999%), for example. Impurities of the positive electrode active material can be controlled by using such a high-purity material. As a result, a secondary battery with an increased capacity and/or increased reliability can be obtained.

Furthermore, the transition metal source preferably has high crystallinity and for example, the transition metal source preferably includes single crystal particles. Evaluation of the crystallinity of the transition metal source can employ determination based on a TEM (Transmission Electron Microscope) image, a STEM (Scanning Transmission Electron Microscope) image, a HAADF-STEM (High-Angle Annular Dark Field Scanning TEM) image, an ABF-STEM (Annular Bright-Field Scanning Transmission Electron Microscope) image, or the like or employ determination based on X-ray diffraction (XRD), electron diffraction, neutron diffraction, or the like. Note that the above methods for evaluating crystallinity can also be employed to evaluate the crystallinity of the positive electrode active material and the like in addition to the crystallinity of the transition metal source.

### <Step S12>

Next, in Step S12 shown in FIG. 1A, the lithium source and the transition metal source are ground and mixed to form a mixed material (also referred to as a mixture). The grinding and mixing can be performed by a dry method or a wet method. A wet method is preferred because it can crush a material into a smaller size. When a wet method is employed, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent, which is unlikely to react with lithium, is further preferably used. In this embodiment, dehydrated acetone or super-dehydrated acetone with a purity of higher than or equal to 99.5% is used. It is preferable that the lithium source and the transition metal source be mixed into super-dehydrated acetone whose moisture content is less than or equal to 10 ppm and which has a purity of higher than or equal to 99.5% in the grinding and mixing. With the use of dehydrated acetone or super-dehydrated acetone with the above-described purity, impurities that might be mixed can be reduced.

A ball mill, a bead mill, or the like can be used as a means of the mixing and the like. When the ball mill is used, alumina balls or zirconia balls are preferably used as grinding media. Zirconia balls are preferable because they release fewer impurities. When a ball mill, a bead mill, or the like is used, the peripheral speed is preferably higher than or equal to 100 mm/s and lower than or equal to 2000 mm/s in order to inhibit contamination from the media. For example, the mixing is preferably performed at a peripheral speed of 838 mm/s (the rotational frequency is 400 rpm, and the ball mill diameter is 40 mm).

### <Step S13>

Next, in Step S13 shown in FIG. 1A, the above mixed material is heated. The heating is preferably performed at higher than or equal to 800° C. and lower than or equal to 1100° C., further preferably at higher than or equal to 900° C. and lower than or equal to 1000° C., still further preferably at approximately 950° ° C. An excessively low temperature might lead to insufficient decomposition and melting of the lithium source and the transition metal source. An excessively high temperature might lead to a defect due to evaporation or sublimation of lithium from the lithium source and/or excessive reduction of the metal used as the transition metal source, for example. The defect is, for example, an oxygen defect induced by a change of trivalent cobalt into divalent cobalt due to excessive reduction, in the case where cobalt is used as the transition metal.

The heating time is preferably longer than or equal to 1 hour and shorter than or equal to 100 hours, further preferably longer than or equal to 2 hours and shorter than or equal to 20 hours.

A temperature raising rate is preferably higher than or equal to 80° C./h and lower than or equal to 250° C./h, although depending on the end-point temperature of the heating. For example, in the case of heating at 1000° C. for 10 hours, the temperature raising is preferably 200° C./h.

The heating is preferably performed in an atmosphere with little water such as dry air and, for example, the dew point of the atmosphere is preferably lower than or equal to −50° C., further preferably lower than or equal to −80° C. In this embodiment, the heating is performed in an atmosphere with a dew point of −93° C. To reduce impurities that might enter the mixed material, the concentrations of impurities such as CH₄, CO, CO₂, and H₂ in the heating atmosphere are each preferably lower than or equal to 5 ppb (parts per billion).

The heating atmosphere is preferably an oxygen-containing atmosphere. In a method, a dry air is continuously introduced into a reaction chamber (also referred to as a heating chamber), for example. The flow rate of a dry air in this case is preferably 10 L/min. Continuously supplying oxygen such as a dry air into a reaction chamber to make the oxygen flow therein is referred to as “flowing”.

In the case where the heating atmosphere is an oxygen-containing atmosphere, supplying oxygen to the reaction chamber is not necessarily performed. For example, the following method may be employed: the pressure in with the reaction chamber is reduced, then the reaction chamber is filled with oxygen, and the oxygen is prevented from entering or exiting from the reaction chamber. Such a method is referred to as “purging”. For example, the pressure in the reaction chamber may be reduced to −970 hPa as measured by a differential pressure gauge, and then, the reaction chamber may be filled with oxygen until the pressure becomes 50 hPa.

Cooling after the heating can be performed by letting the mixed material stand to cool, and the time it takes for the temperature to decrease to room temperature from a predetermined temperature is preferably longer than or equal to 10 hours and shorter than or equal to 50 hours. Note that the temperature does not necessarily need to decrease to room temperature as long as it decreases to a temperature acceptable to the next step.

A crucible used at the time of the heating is preferably an aluminum oxide (referred to as alumina) crucible or saggar. An alumina crucible has a material property that hardly releases impurities. In this embodiment, a crucible made of alumina with a purity of 99.9% is used. The heating is preferably performed with the crucible covered with a lid, in which case volatilization or sublimation of a material can be prevented.

The heating in this step may be performed with a rotary kiln or a roller hearth kiln. Heating with a rotary kiln may be performed by either a sequential method or a batch-type method; in either method, the material can be heated while being stirred.

The heated material is ground as needed and may be made to pass through a sieve. Before collection of the heated material, the material may be moved from the crucible to a mortar. As the mortar, an alumina mortar can be suitably used. An alumina mortar has a material property that hardly releases impurities. Specifically, a mortar made of alumina with a purity of higher than or equal to 90%, preferably higher than or equal to 99% is used. Note that heating conditions equivalent to those in Step S13 can be employed in a later-described heating step other than Step S13.

### <Step S14>

Through the above steps, LiMO₂ (a composite oxide or a composite oxide containing the transition metal) can be obtained in Step S14 shown in FIG. 1A. The composite oxide needs to have a crystal structure of a lithium composite oxide represented by LiMO₂, but the composition is not strictly limited to Li:M:O=1:1:2. When the transition metal is cobalt, the composite oxide is referred to as a composite oxide containing cobalt and is represented by LiCoO₂. Note that the composition is not strictly limited to Li:Co:O=1:1:2.

Although the example is described in which the composite oxide is formed by a solid phase method as in Step S11 to Step S14, the composite oxide may be formed by a coprecipitation method. Alternatively, the composite oxide may be formed by a hydrothermal method.

### <Step S15>

Next, in Step S15 shown in FIG. 1A, the above composite oxide is heated. The heating in Step S15 is the first heating performed on the composite oxide and thus, this heating is sometimes referred to as the initial heating. Through the initial heating, the surface of the composite oxide becomes smooth. Having a smooth surface refers to a state where the composite oxide has little unevenness and is rounded as a whole and its corner portion is rounded. A smooth surface also refers to a surface to which few foreign matters are attached. Foreign matters are deemed to cause unevenness and are preferably not attached to the surface of the composite oxide.

The initial heating, which is performed after completion as the composite oxide, makes the surface smooth and can inhibit degradation after charge and discharge.

For the initial heating, there is no need to prepare a lithium compound source. For the initial heating, there is no need to prepare an additive element source. For the initial heating, there is no need to prepare a flux agent.

The initial heating is performed before Step S31 described below and is sometimes referred to as preheating or pretreatment.

The lithium source and/or transition metal source prepared in Step S11 and the like might contain impurities. The composite oxide completed in Step 14 might contain impurities. The impurities can be reduced by the initial heating.

The heating conditions of the initial heating can be freely set as long as the surface of the composite oxide is made smooth. For example, the heating can be performed under any of the heating conditions selected from those described for Step S13. As a supplementary explanation of the heating conditions, the heating temperature in the initial heating is preferably lower than that in Step S13 so that the crystal structure of the composite oxide in Step S14 is maintained. The heating time of the initial heating is preferably shorter than that in Step S13 so that the crystal structure of the composite oxide in Step S14 is maintained. For example, the heating in the initial heating is preferably performed at a temperature higher than or equal to 700° C. and lower than or equal to 1000° ° C. for longer than or equal to 2 hours.

The heating in Step S13 might cause a temperature difference between the surface and an inner portion of the composite oxide in Step S14. The temperature difference sometimes induces differential shrinkage. It can also be deemed that the temperature difference leads to a fluidity difference between the surface and the inner portion, thereby causing differential shrinkage. The energy involved in differential shrinkage causes a difference in internal stress in the composite 20) oxide. The difference in internal stress is also called distortion, and the above energy is sometimes referred to as distortion energy. The internal stress is eliminated by the initial heating in Step S15 and in other words, the distortion energy is probably equalized by the initial heating in Step S15. When the distortion energy is equalized, the distortion in the composite oxide is relieved. This is probably why the surface of the composite oxide becomes smooth, or “surface improvement is achieved”, through Step S15. In other words, it is deemed that Step S15 reduces 25 the differential shrinkage caused in the composite oxide to make the surface of the composite oxide smooth.

Such differential shrinkage might cause a micro shift in the composite oxide in Step S14 such as a shift in a crystal. To reduce the shift, the initial heating is preferably performed. Performing the initial heating can distribute a shift uniformly in the composite oxide. When the shift is distributed uniformly, the surface of the composite oxide might become smooth. This is also referred to as alignment of crystal grains. In other words, it is deemed that Step S15 reduces the shift in a crystal or the like which is caused in the composite oxide to make the surface of the composite oxide smooth.

In a secondary battery using a composite oxide with a smooth surface as a positive electrode active material, degradation by charge and discharge is suppressed and a crack in the positive electrode active material can be inhibited.

It can be said that when surface unevenness information in one cross section of a composite oxide is quantified with measurement data, a smooth surface of the composite oxide has a surface roughness of less than or equal to 10 nm. The one cross section is, for example, a cross section obtained in STEM observation.

Note that a pre-synthesized composite oxide may be used in Step S14. In this case, Step S11 to Step S13 can be omitted. When Step S15 is performed on the pre-synthesized composite oxide, a composite oxide with a smooth surface can be obtained.

The initial heating might reduce the amount of lithium in the composite oxide. An additive element described for Step S20 or the like below might easily enter the composite oxide owing to the reduction in the amount of lithium.

### <Step S20>

The additive element X may be added to the composite oxide having a smooth surface as long as a layered rock-salt crystal structure can be obtained. When the additive element X is added to the composite oxide having a smooth surface, the additive element can be uniformly added. It is thus preferable that the initial heating precede the addition of the additive element. The step of adding the additive element X is described with reference to FIG. 1B and FIG. 1C.

### <Step S21>

In Step S21 shown in FIG. 1B, an additive element source (X source) to be added to the composite oxide is prepared. A lithium source may be prepared together with the additive element source (X source).

As the additive element X, one or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic can be used. As the additive element X, one or more selected from bromine and beryllium can be used. Note that the aforementioned additive element X are more suitable because bromine and beryllium are elements having toxicity to living things.

When magnesium is selected as the additive element X, the additive element source (X source) can be referred to as a magnesium source. As the magnesium source, magnesium fluoride, magnesium oxide, magnesium hydroxide, magnesium carbonate, or the like can be used. Two or more of these magnesium sources may be used.

When fluorine is selected as the additive element X, the additive element source can (X source) be referred to as a fluorine source. As the fluorine source, for example, lithium fluoride, magnesium fluoride, aluminum fluoride, titanium fluoride, cobalt fluoride, nickel fluoride, zirconium fluoride, vanadium fluoride, manganese fluoride, iron fluoride, chromium fluoride, niobium fluoride, zinc fluoride, calcium fluoride, sodium fluoride, potassium fluoride, barium fluoride, cerium fluoride, lanthanum fluoride, sodium aluminum hexafluoride, or the like can be used. Among them, lithium fluoride, which has a relatively low melting point of 848° C., is preferable because it is easily melted in a heating step described later.

Magnesium fluoride can be used as both the fluorine source and the magnesium source. Lithium fluoride can be used as the lithium source. Another example of the lithium source that can be used in Step S21 is lithium carbonate.

The fluorine source may be a gas; for example, fluorine, carbon fluoride, sulfur fluoride, oxygen fluoride (including a fluorine source represented by OF₂, O₂F₂, O₃F₂, O₄F₂, O₅F₂, O₆F₂, or O₂F), or the like may be used and mixed in the atmosphere in a heating step described later. Two or more of these fluorine sources may be used.

In this embodiment, lithium fluoride (LiF) is prepared as the fluorine source, and magnesium fluoride (MgF₂) is prepared as the fluorine source and the magnesium source. When lithium fluoride and magnesium fluoride are mixed at a molar ratio of approximately LiF:MgF₂=65:35, the effect of lowering the melting point is maximized. Meanwhile, when the proportion of lithium fluoride increases, the cycle performance might deteriorate because of an excessive amount of lithium. Therefore, the molar ratio of lithium fluoride to magnesium fluoride is preferably LiF:MgF₂=x:1 (0≤x≤1.9), further preferably LiF:MgF₂=x:1 (0.1≤x≤0.5), still further preferably LiF:MgF₂=x:1 (an approximate value of x=0.33). Note that in this specification and the like, the expression “an approximate value of a given value” means greater than 0.9 times and smaller than 1.1 times the given value.

### <Step S22>

Next, in Step S22 shown in FIG. 1B, the magnesium source and the fluorine source are ground and mixed. Any of the conditions for the grinding and mixing that are described for Step S12 can be selected to perform this step.

A heating step may be performed after Step S22 as needed. For the heating step, any of the heating conditions described for Step S13 can be selected. The heating time is preferably longer than or equal to 2 hours and the heating temperature is preferably higher than or equal to 800° C. and lower than or equal to 1100° C.

### <Step S23>

Next, in Step S23 shown in FIG. 1B, the materials ground and mixed in the above step are collected to give the additive element source (X source). Note that the additive element source (X source) in Step S23 contains a plurality of starting materials and can be referred to as a mixture.

As for the particle diameter of the mixture, the median diameter (D50) is preferably greater than or equal to 600 nm and less than or equal to 20 μm, further preferably greater than or equal to 1 μm and less than or equal to 10 μm. Also when one kind of material is used as the additive element source (X source), the median diameter (D50) is preferably greater than or equal to 600 nm and less than or equal to 20 μm, further preferably greater than or equal to 1 μm and less than or equal to 10 μm.

Such a pulverized mixture (which may contain only one kind of the additive element X) is easily attached to the surface of a composite oxide particle uniformly in a later step of mixing with the composite oxide. The mixture is preferably attached uniformly to the surface of the composite oxide, in which case the additive element X (typically, fluorine and magnesium) is easily distributed or dispersed uniformly in a surface portion of the composite oxide by heating. The region where fluorine and magnesium are distributed can also be referred to as a surface portion of the composite oxide. When there is a region containing neither fluorine nor magnesium in the surface portion, the positive electrode active material might be less likely to have an O3′ type crystal structure, which is described later, in the charged state. Note that although fluorine is used in the above description, chlorine may be used instead of fluorine, and a general term “halogen” for these elements can replace “fluorine”.

### <Step S21>

A process different from that in FIG. 1B is described with reference to FIG. 1C. In Step S21 shown in FIG. 1C, four kinds of additive element sources (X sources) to be added to the composite oxide are prepared. In other words, FIG. 1C is different from FIG. 1B in the kinds of the additive element sources. A lithium source may be prepared together with the additive element sources (X sources).

As the four kinds of additive element sources (X sources), a magnesium source (Mg source), a fluorine source (F source), a nickel source (Ni source), and an aluminum source (Al source)) are prepared. Note that the magnesium source and the fluorine source can be selected from the compounds and the like described with reference to FIG. 1B. As the nickel source, nickel oxide, nickel hydroxide, or the like can be used. As the aluminum source, aluminum oxide, aluminum hydroxide, or the like can be used.

### <Step S22> and <Step S23>

Next, Step S22 and Step S23 shown in FIG. 1C are similar to the steps described with reference to FIG. 1B.

### <Step S31>

Next, in Step S31 shown in FIG. 1A, the composite oxide and the additive element source (X source) are mixed. The ratio of the number A_{M} of the transition metal atoms in the composite oxide containing lithium, the transition metal, and oxygen to the number A_{Mg} of magnesium atoms in the additive element X is preferably A_{M}:A_{Mg}=100:y (0.1≤y≤6), further preferably A_{M}:A_{Mg}=100:y (0.3≤y≤3).

The conditions of the mixing in Step S31 are preferably milder than those of the mixing in Step S12 in order not to damage the particle of the composite oxide Step S14. For example, conditions with a lower rotation frequency or shorter time than the mixing in Step S12 are preferable. In addition, it can be said that the dry process has a milder condition than the wet process. For example, a ball mill, a bead mill, or the like can be used for the mixing. When a ball mill is used, zirconia balls are preferably used as grinding media, for example.

In this embodiment, the mixing is performed with a ball mill using zirconia balls with a diameter of 1 mm by a dry process at 150 rpm for 1 hour. The mixing is performed in a dry room the dew point of which is higher than or equal to −100° C. and lower than or equal to −10° C.

### <Step S32>

Next, in Step S32 in FIG. 1A, the materials mixed in the above step are collected, whereby a mixture 903 is obtained. At the time of the collection, the materials may be crushed as needed and made to pass through a sieve.

Note that in this embodiment, the method is described in which lithium fluoride as the fluorine source and magnesium fluoride as the magnesium source are added afterward to the composite oxide that has been subjected to the initial heating. However, the present invention is not limited to the above method. The magnesium source, the fluorine source, and the like can be added to the lithium source and the transition metal source (M source) in Step S11, i.e., at the stage of the starting materials of the composite oxide. Then, the heating in Step S13 is performed, so that LiMO₂ to which magnesium and fluorine are added can be obtained. In that case, there is no need to separately perform Step S11 to Step S14 and Step S21 to Step S23. This method can be regarded as being simple and highly productive.

Alternatively, lithium cobalt oxide to which magnesium and fluorine are added in advance may be used. When lithium cobalt oxide to which magnesium and fluorine are added is used, Step S11 to Step S32 and Step S20 can be skipped. This method can be regarded as being simple and highly productive.

Alternatively, to lithium cobalt oxide to which magnesium and fluorine are added in advance, a magnesium source and a fluorine source may be further added as in Step S20 of FIG. 1B, or a magnesium source, a fluorine source, a nickel source, and an aluminum source may be further added as in Step S20 of FIG. 1C.

### <Step S33>

Then, in Step S33 shown in FIG. 1A, the mixture 903 is heated. Any of the heating conditions described for Step S13 can be selected. The heating time is preferably longer than or equal to 2 hours.

Here, a supplementary explanation of the heating temperature is provided. The lower limit of the heating temperature in Step S33 needs to be higher than or equal to the temperature at which a reaction between the composite oxide (LiMO₂) and the additive element source proceeds. The temperature at which the reaction proceeds is the temperature at which interdiffusion of the elements included in LiMO₂ and the additive element source occurs, and may be lower than the melting temperatures of these materials. It is known that in the case of an oxide as an example, solid phase diffusion occurs at a temperature that is 0.757 times (the Tamman low) the melting temperature Tₘ. Accordingly, it is only required that the heating temperature in Step S33 be higher than or equal to 500° C.

Needless to say, the reaction more easily proceeds at a temperature higher than or equal to the temperature at which at least part of the mixture 903 is melted. For example, in the case where LiF and MgF₂ are included in the additive element source (X source), the eutectic point of LiF and MgF₂ is around 742° C. Therefore, the lower limit of the heating temperature in Step S33 is preferably higher than or equal to 742° C.

The mixture 903 obtained by mixing such that LiCoO₂:LiF:MgF₂=100:0.33:1 (molar ratio) exhibits an endothermic peak at around 830° C. in differential scanning calorimetry (DSC) measurement. Therefore, the lower limit of the heating temperature is further preferably higher than or equal to 830° C.

A higher heating temperature is preferable because it facilitates the reaction, shortens the heating time, and enables high productivity.

The upper limit of the heating temperature is lower than the decomposition temperature of LiMO₂ (the decomposition temperature of LiCoO₂ is 1130°) C. At around the decomposition temperature, a slight amount of LiMO₂ might be decomposed. Thus, the upper limit of the heating temperature is preferably lower than or equal to 1000° C., further preferably lower than or equal to 950° C., still further preferably lower than or equal to 900° C.

In view of the above, the heating temperature in Step S33 is preferably higher than or equal to 500° C. and lower than or equal to 1130° C., further preferably higher than or equal to 500° C. and lower than or equal to 1000° C., still further preferably higher than or equal to 500° ° C. and lower than or equal to 950° C., yet still further preferably higher than or equal to 500° C. and lower than or equal to 900° C. Furthermore, the heating temperature is preferably higher than or equal to 742° C. and lower than or equal to 1130° C., further preferably higher than or equal to 742° C. and lower than or equal to 1000° C., still further preferably higher than or equal to 742° C. and lower than or equal to 950° ° C., yet still further preferably higher than or equal to 742° C. and lower than or equal to 900° C. Furthermore, the heating temperature is preferably higher than or equal to 800° C. and lower than or equal to 1100° C., further preferably higher than or equal to 830° C. and lower than or equal to 1130° C., still further preferably higher than or equal to 830° C. and lower than or equal to 1000° C., yet still further preferably higher than or equal to 830° C. and lower than or equal to 950° C., yet still further preferably higher than or equal to 830° C. and lower than or equal to 900° C. Note that the heating temperature in Step S33 is preferably lower than that in Step 13.

In addition, at the time of heating the mixture 903, the partial pressure of fluorine or a fluoride originating from the fluorine source or the like is preferably controlled to be within an appropriate range.

In the formation method described in this embodiment, some of the materials, e.g., LiF as the fluorine source, function as a fusing agent in some cases. Owing to this function, the heating temperature for Step S33 can be lower than the decomposition temperature of the composite oxide (LiMO₂), e.g., a temperature higher than or equal to 742° C. and lower than or equal to 950° C., which allows distribution of the additive element such as magnesium in the surface portion and formation of the positive electrode active material having excellent performance.

However, since LiF in a gas phase has a specific gravity less than that of oxygen, heating might volatilize or sublimate LiF and in that case, LiF in the mixture 903 decreases. As a result, the function of flux deteriorates. Thus, heating needs to be performed while volatilization or sublimation of LiF is inhibited. Note that even when LiF is not used as the fluorine source or the like, Li at the surface of LiMO₂ and F of the fluorine source might react to produce LiF, which might volatilize or sublimate. Therefore, the volatilization or sublimation needs to be inhibited also when a fluoride having a higher melting point than LiF is used.

In view of this, the mixture 903 is preferably heated in an atmosphere containing LiF, i.e., the mixture 903 is preferably heated in a state where the partial pressure of LiF in a heating furnace is high. Such heating can inhibit volatilization or sublimation of LiF in the mixture 903.

The heating in this step is preferably performed such that the particles of the mixture 903 are not adhered to each other. Adhesion of the particles of the mixtures 903 during the heating might decrease the area of contact with oxygen in the atmosphere and inhibit a path of diffusion of the additive element X (e.g., fluorine), thereby hindering distribution of the additive element X (e.g., magnesium and fluorine) in the surface portion.

It is considered that uniform distribution of the additive element X (e.g., fluorine) in the surface portion leads to a smooth positive electrode active material with little unevenness. Thus, it is preferable that the particles of the mixture 903 not be adhered to each other in order to allow the smooth surface obtained through the heating in Step S15 to be maintained or to be smoother in this step.

In the case where heating with a rotary kiln is employed in Step S33, the flow rate of an oxygen-containing atmosphere in the kiln (also referred to as furnace) is preferably controlled during the heating. For example, the flow rate of an oxygen-containing atmosphere is preferably set low, or no oxygen supply is preferably performed after an atmosphere is purged first and an oxygen atmosphere is introduced into the kiln. Oxygen flow in the above atmosphere by oxygen supply is not preferable because it might cause evaporation of the fluorine source, which prevents maintaining the smoothness of the surface.

In the case where heating using a roller hearth kiln is employed for Step S33, the mixture 903 can be heated in an atmosphere containing LiF with the container containing the mixture 903 covered with a lid, for example.

A supplementary explanation of the heating time is provided. The heating time depends on conditions such as the heating temperature and the particle size and composition of LiMO₂ in Step S14. The heating may be preferably performed at a lower temperature or for a shorter time in the case where the particle size is small than in the case where the particle size is large.

In the case where the composite oxide (LiMO₂) in Step S14 in FIG. 1A has a median diameter (D50) of approximately 12 μm, the heating temperature is preferably higher than or equal to 600° C. and lower than or equal to 950° C., for example. The heating time is preferably longer than or equal to 3 hours, further preferably longer than or equal to 10 hours, still further preferably longer than or equal to 60 hours, for example. Note that the time for lowering the temperature after the heating is preferably longer than or equal to 10 hours and shorter than or equal to 50 hours, for example.

In the case where the composite oxide (LiMO₂) in Step S14 has a median diameter (D50) of approximately 5 μm, the heating temperature is preferably higher than or equal to 600° C. and lower than or equal to 950° C., for example. The heating time is preferably longer than or equal to 1 hour and shorter than or equal to 10 hours, further preferably approximately 2 hours, for example. Note that the time for lowering the temperature after the heating is preferably longer than or equal to 10 hours and shorter than or equal to 50 hours, for example.

### <Step S34>

Next, the heated material is collected in Step S34 shown in FIG. 1A, in which crushing is performed as needed; thus, the positive electrode active material 100 is obtained. Here, the collected particles are preferably made to pass through a sieve. Through the above process, the positive electrode active material 100 of one embodiment of the present invention can be formed. The positive electrode active material of one embodiment of the present invention has a smooth surface.

### <<Formation Method 2 of Positive Electrode Active Material>>

Next, as one embodiment of the present invention, a method different from Formation method 1 of a positive electrode active material will be described.

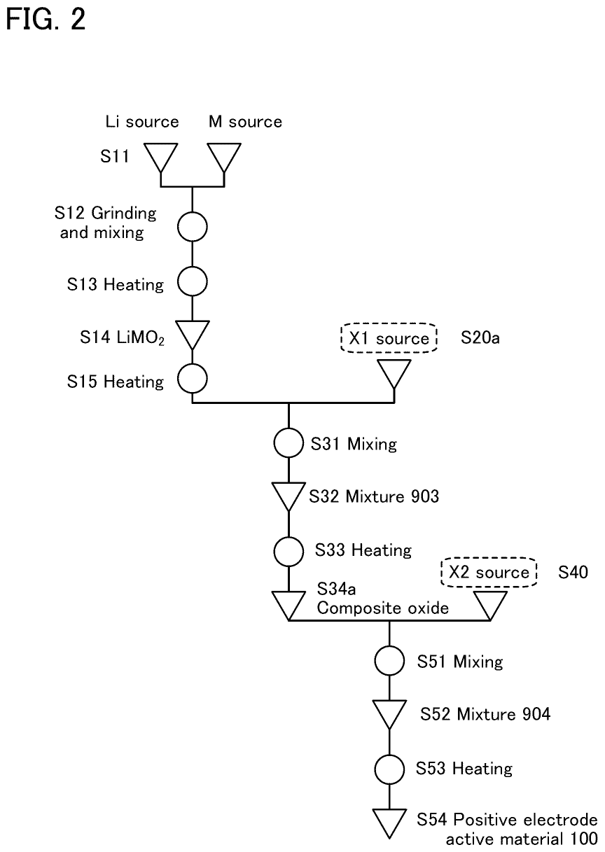

Steps S11 to S15 in FIG. 2 are performed as in FIG. 1A to prepare a composite oxide (LiMO₂) having a smooth surface.

### <Step S20a>

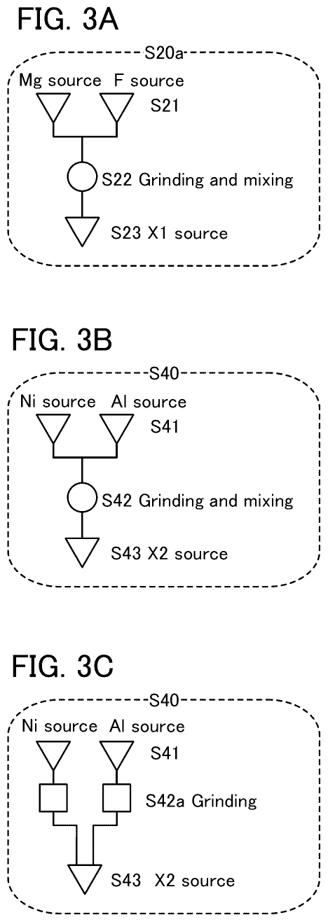

As already described above, the additive element X may be added to the composite oxide as long as a layered rock-salt crystal structure can be obtained. Formation method 2 of has two or more steps of adding additive elements X1 and X2 as the additive element X, as described below with reference to FIG. 3A.

### <Step S21>

In Step S21 shown in FIG. 3A, a first additive element source is prepared. The first additive element source can be selected from the additive elements X described for Step S21 with reference to FIG. 1B to be used. For example, one or more selected from magnesium, fluorine, and calcium can be suitably used as the additive element X1. FIG. 3A shows an example of using a magnesium source (Mg source) and a fluorine source (F source) as the additive element X1. Step S21 to Step S23 shown in FIG. 3A can be performed under the conditions similar to those in Step S21 to Step S23 shown in FIG. 1B. As a result, the additive element source (X1 source) can be obtained in Step S23.

Steps S31 to S33 shown in FIG. 2 can be performed in a manner similar to that of Steps S31 to S33 shown in FIG. 1A.

### <Step S34a>

Next, the material heated in Step S33 is collected to form a composite oxide containing the additive element X1. With the use of an ordinal number, the composite oxide in this step is sometimes called a second composite oxide to be distinguished from the composite oxide in Step S14.

### <Step S40>

In Step S40 shown in FIG. 2, a second additive element source (X2 source) is added. FIG. 3B and FIG. 3C are referred to in the following description.

### <Step S41>

In Step S41 shown in FIG. 3B, the second additive element source is prepared. The second additive element source can be selected from the additive elements X described for Step S21 with reference to FIG. 1B to be used and is preferably different from the additive element X1. For example, one or more selected from nickel, titanium, boron, zirconium, and aluminum can be suitably used as the additive element X2. FIG. 3B shows an example of using nickel and aluminum as the additive elements X2.

Step S41 to Step S43 shown in FIG. 3B can be performed under the conditions similar to those in Step S21 to Step S23 shown in FIG. 1B. As a result, the additive element source (X2 source) can be obtained in Step S43.

FIG. 3C shows a modification example of the steps described with reference to FIG. 3B. A nickel source (Ni source) and an aluminum source (Al source) are prepared in Step S41 shown in FIG. 3C and are separately ground in Step S42a. Accordingly, a plurality of the second additive element sources (X2 sources) are prepared in Step S43. FIG. 3C is different from FIG. 3B in separately grinding the additive element X2 in Step S42a.

### <Step S51 to Step S54>

Next, Step S51 to Step S54 shown in FIG. 2 can be performed under the conditions similar to those in Step S31 to Step S34 shown in FIG. 1A. The heating in Step S53 can be performed at a lower temperature and for a shorter time than the heating in Step S33. Through the above steps, the positive electrode active material 100 of one embodiment of the present invention can be formed in Step S54.

As shown in FIG. 2 and FIG. 3, in the formation method 2, introduction of the additive element X to the composite oxide is separated into introduction of the first additive element X1 and that of the second additive element X2. When the elements are separately introduced, the additive elements X can have different profiles in the depth direction. For example, the first additive element X1 can have a profile such that the concentration is higher in the surface portion than in the inner portion, and the second additive element X2 can have a profile such that the concentration is higher in the inner portion than in the surface portion.

The initial heating enables the positive electrode active material to have a smooth surface also in Formation method 2.

The initial heating in Formation methods 1 and 2 described in this embodiment is performed on a composite oxide. Thus, the initial heating is preferably performed at a temperature lower than the heating temperature for forming the composite oxide and for a time shorter than the heating time for forming the composite oxide. In the case of adding the additive element X to the composite oxide, the adding step is preferably performed after the initial heating. The adding step may be separated into two or more steps. Such an order of steps is preferred in order to maintain the smoothness of the surface achieved by the initial heating.

In this embodiment, when a composite oxide contains cobalt as a transition metal, the composite oxide can be rephrased as a composite oxide containing cobalt.

In this embodiment, the composite oxide before containing the additive element is referred to as a first composite oxide and the composite oxide containing the additive element is referred to as a second composite oxide in some cases so that they are distinguished from each other.

In this embodiment, the obtained positive electrode active material is referred to as a composite oxide in some cases. In the case where a distinction is established as described above, the positive electrode active material can be referred to as a second composite oxide.

This embodiment can be used in combination with the other embodiments.

### Embodiment 2

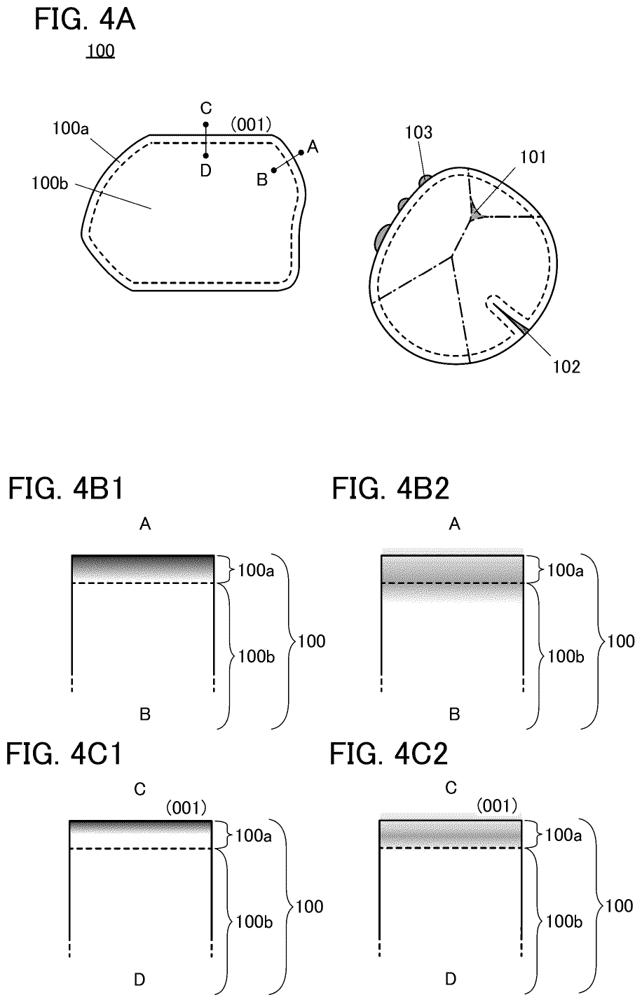

In this embodiment, a positive electrode active material of one embodiment of the present invention is described with reference to FIG. 4 to FIG. 14.

FIG. 4A is a cross-sectional view of the positive electrode active material 100 of one embodiment of the present invention. FIG. 4B1 and FIG. 4B2 show enlarged views of a portion near the line A-B in FIG. 4A. FIG. 4C1 and FIG. 4C2 show enlarged views of a portion near the line C-D in FIG. 4A.

As illustrated in FIG. 4A to FIG. 4C2, the positive electrode active material 100 includes a surface portion 100a and an inner portion 100b. In each drawing, the dashed line denotes a boundary between the surface portion 100a and the inner portion 100b. In FIG. 4A, the dashed-dotted line denotes part of a crystal grain boundary.

In this specification and the like, the surface portion 100a of the positive electrode active material 100 refers to a region that is within 50 nm, preferably within 35 nm, further preferably within 20 nm in depth from the surface toward the inner portion, and most preferably a region positioned within 10 nm in depth from the surface toward the inner portion. A plane generated by a crack may also be referred to as a surface. The surface portion 100a may also be referred to as the vicinity of a surface, a region in the vicinity of a surface, a shell, or the like. A region in a deeper position than the surface portion 100a of the positive electrode active material is referred to as the inner portion 100b. The inner portion 100b may also be referred to as an inner region or a core.

The surface portion 100a preferably has a higher concentration of the additive element X than the inner portion 100b. The additive element X preferably has a concentration gradient. In the case where a plurality of kinds of additive elements X are included, the peak tops exhibiting the highest concentrations of the additive elements X are preferably different from each other.

For example, the case where an additive element Xa and additive element Xb are included is described. The additive element Xa preferably has a concentration gradient as illustrated by gradation in FIG. 4B1, in which the concentration increases from the inner portion 100b toward the surface. Examples of the additive element Xa that preferably has such a concentration gradient include magnesium, fluorine, titanium, silicon, phosphorus, boron, and calcium.

Preferably, the additive element Xb different from the additive element Xa preferably has a concentration gradient as illustrated by gradation in FIG. 4B2, and a peak top exhibiting the concentration maximum is located at a deeper region than that in FIG. 4B1. The peak top of the additive element Xb may be located in the surface portion 100a or located deeper than the surface portion 100a. That is, the peak top of the additive element Xb is preferably in a region other than the outermost surface. For example, the peak top of the additive element Xb is preferably located in a region of 5 nm to 30 nm inclusive in depth from the surface toward the inner portion. Examples of the additive element Xb that preferably has such a concentration gradient include aluminum and manganese.

It is preferable that the crystal structure continuously change from the inner portion 100b toward the surface owing to the above-described concentration gradient of the additive element.

The positive electrode active material 100 contains lithium, the transition metal M, oxygen, and the additive element X. The positive electrode active material 100 can be regarded as a composite oxide represented by LiMO₂ to which the additive element X is added. Note that the positive electrode active material of one embodiment of the present invention only needs to have a crystal structure of a lithium composite oxide represented by LiMO₂, and the composition is not strictly limited to Li:M:O=1:1:2. In some cases, a positive electrode active material to which the additive element X is added is referred to as a composite oxide or a lithium composite oxide.

As the transition metal M contained in the positive electrode active material 100, a metal that can form, together with lithium, a composite oxide having a layered rock-salt structure belonging to the space group R-3m is preferably used. For example, at least one of manganese, cobalt, and nickel can be used. That is, as the transition metal M contained in the positive electrode active material 100, cobalt may be used alone, nickel may be used alone, cobalt and manganese may be used, cobalt and nickel may be used, or cobalt, manganese, and nickel may be used. In other words, the positive electrode active material 100 can contain a composite oxide containing lithium and the transition metal M, such as lithium cobalt oxide, lithium nickel oxide, lithium cobalt oxide in which manganese is substituted for part of cobalt, lithium cobalt oxide in which nickel is substituted for part of cobalt, or lithium nickel-manganese-cobalt oxide.

Specifically, using cobalt at greater than or equal to 75 at %, preferably greater than or equal to 90 at %, further preferably greater than or equal to 95 at % as the transition metal M contained in the positive electrode active material 100 brings many advantages such as relatively easy synthesis, easy handling, and excellent cycle performance. Moreover, when nickel is contained as the transition metal M in addition to cobalt in the above range, a shift in a layered structure formed of octahedrons of cobalt and oxygen is sometimes inhibited. This is preferable because the crystal structure becomes more stable particularly in a charged state at a high temperature in some cases.

Note that manganese is not necessarily contained as the transition metal M. When the positive electrode active material 100 is substantially free from manganese, the above advantages such as relatively easy synthesis, easy handling, and excellent cycle performance are sometimes enhanced. The weight of manganese contained in the positive electrode active material 100 is preferably less than or equal to 600 ppm, further preferably less than or equal to 100 ppm, for example. The weight of manganese can be analyzed by GD-MS (glow discharge mass spectrometry), for example.

Using nickel at greater than or equal to 33 at %, preferably greater than or equal to 60 at %, further preferably greater than or equal to 80 at % as the transition metal M contained in the positive electrode active material 100 is preferable because in that case, the cost of the raw materials might be lower than that in the case of using a large amount of cobalt and charge and discharge capacity per weight might be increased.

Note that nickel is not necessarily contained as the transition metal M.

As the additive element X contained in the positive electrode active material 100, at least one of magnesium, fluorine, aluminum, titanium, zirconium, vanadium, iron, chromium, niobium, cobalt, arsenic, zinc, silicon, sulfur, phosphorus, and boron is preferably used. These additive elements X further stabilize the crystal structure of the positive electrode active material 100 in some cases as described later. The positive electrode active material 100 can contain lithium cobalt oxide to which magnesium and fluorine are added, lithium cobalt oxide to which magnesium, fluorine, and titanium are added, lithium nickel-cobalt oxide to which magnesium and fluorine are added, lithium cobalt-aluminum oxide to which magnesium and fluorine are added, lithium nickel-cobalt-aluminum oxide, lithium nickel-cobalt-aluminum oxide to which magnesium and fluorine are added, lithium nickel-manganese-cobalt oxide to which magnesium and fluorine are added, or the like. Note that in this specification and the like, the additive element X may be rephrased as a mixture, a constituent of a material, an impurity element, or the like.

Note that as the additive element X, magnesium, fluorine, aluminum, titanium, zirconium, vanadium, iron, chromium, niobium, cobalt, arsenic, zinc, silicon, sulfur, phosphorus, or boron is not necessarily contained.

In the positive electrode active material 100 of one embodiment of the present invention, in order to prevent breakage of a layered structure formed of octahedrons of the transition metal M and oxygen even when lithium is extracted from the positive electrode active material 100, the surface portion 100a having a high additive element X concentration, i.e., the outer portion of the particle, reinforces the positive electrode active material 100.

The concentration gradient of the added-element X is preferably similar throughout the surface portion 100a. In other words, it is preferable that the reinforcement derived from the high added-element concentration uniformly occurs in the surface portion 100a. When the surface portion 100a partly has reinforcement, stress might be concentrated on parts that do not have reinforcement. The concentration of stress on part of a particle might cause defects such as cracks from that part, leading to cracking of the positive electrode active material and a decrease in charge and discharge capacity.

Note that in this specification and the like, uniformity refers to a phenomenon in which, in a solid made of a plurality of elements (e.g., A, B, and C), a certain element (e.g., A) is distributed with similar features in specific regions. Note that it is acceptable for the specific regions to have substantially the same concentration of the element. For example, a difference in the concentration of the element between the specific regions can be 10% or less. Examples of the specific regions include a surface portion, a surface, a projected portion, a depressed portion, and an inner portion.

Note that the additive elements do not necessarily have similar concentration gradients throughout the surface portion 100a of the positive electrode active material 100. For example, FIG. 4C1 shows an example of distribution of the additive element Xa in the portion near the line C-D in FIG. 4A and FIG. 4C2 shows an example of distribution of the additive element Xb in the portion near the line C-D.

Here, the portion near the line C-D has a layered rock-salt crystal structure belonging to R-3m and the surface of the portion has a (001) orientation. The distribution of the additive element at the surface having the (001) orientation (referred to as (001) plane in some cases) illustrated in FIG. 4C1 and FIG. 4C2 may be different from that at other planes illustrated in FIG. 4B1 and FIG. 4B2. For example, the additive element Xa may be distributed shallower from the surface of the (001) plane and the surface portion 100a including the surface illustrated in FIG. 4C1 than from the surface of the other plane illustrated in FIG. 4B1. Alternatively, the (001) plane and the surface portion 100a including the surface illustrated in FIG. 4C1 may have a lower concentration of the additive element Xa than the other surface illustrated in FIG. 4B1.

Alternatively, at the (001) plane and the surface portion 100a including the surface illustrated in FIG. 4C1, the concentration of the additive element Xa may be below the lower detection limit. For example, the additive element Xb may be distributed shallower from the surface of the (001) plane and the surface portion 100a including the surface illustrated in FIG. 4C2 than from the surface of the other plane illustrated in FIG. 4B2. Alternatively, the (001) plane and the surface portion 100a including the surface illustrated in FIG. 4C2 may have a lower concentration of the additive element Xb than the other surface illustrated in FIG. 4B2. Alternatively, at the (001) plane and the surface portion 100a including the surface illustrated in FIG. 4C2, the concentration of the additive element Xb may be below the lower detection limit.

In a layered rock-salt crystal structure belonging to R-3m, cations are arranged parallel to a (001) plane. This is because the layered rock-salt crystal structure belonging to R-3m has a structure in which an MO₂ layer formed of octahedrons of the transition metal M and oxygen and a lithium layer are alternately stacked parallel to a (001) plane. Accordingly, a diffusion path of lithium ions also exists parallel to a (001) plane.

The MO₂ layer formed of the (001) plane of the transition metal M and oxygen is relatively stable, and a diffusion path of lithium ions is not exposed at the (001) plane.

By contrast, a diffusion path of lithium ions is exposed at each of the surfaces in FIG. 4B1 and FIG. 4B2, which are not the (001) plane. Thus, the surface other than the (001) plane and the surface portion 100a including the surface easily lose stability because they are regions where extraction of lithium ions starts as well as important regions for maintaining a diffusion path of lithium ions. It is thus extremely important to reinforce the surface other than the (001) plane and the surface portion 100a including the surface so that the crystal structure of the whole positive electrode active material 100 is maintained.

Accordingly, in the positive electrode active material 100 of another embodiment of the present invention, it is important to distribute the additive element X at the surface other than the (001) plane and the surface portion 100a including the surface, as illustrated in FIG. 4B1 or FIG. 4B2. By contrast, in the (001) plane and the surface portion 100a including the surface illustrated in FIG. 4C1 and FIG. 4C2, the additive element may have a low concentration as described above or the additive element may be absent.

In the formation methods as described in the above embodiment, in which high-purity LiMO₂ is formed, the additive element X is mixed afterwards, and heating is performed, the additive element X spreads mainly through a diffusion path of lithium ions and thus, distribution of the additive element X at the surface other than the (001) plane and the surface portion 100a including the surface can easily fall within a preferred range.

Moreover, in the formation method involving the initial heating, lithium atoms in the surface portion are expected to be extracted from LiMO₂ owing to the initial heating and thus, the additive element X such as magnesium atoms can be probably distributed easily in the surface portion at a high concentration.

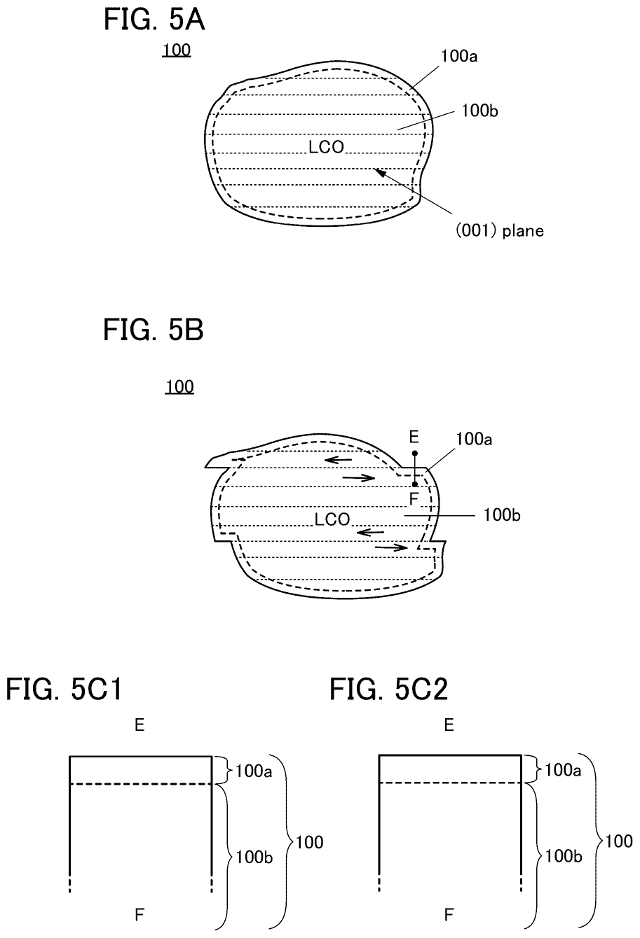

The positive electrode active material 100 preferably has a smooth surface with little unevenness; however, it is not necessary that the whole surface of the positive electrode active material 100 be in such a state. In a composite oxide with a layered rock-salt crystal structure belonging to R-3m, slipping easily occurs at a plane parallel to a (001) plane, e.g., a plane where lithium atoms are arranged. In the case where a (001) plane is horizontal as shown in FIG. 5A, steps such as a pressing step sometimes cause slipping in a horizontal direction as denoted by arrows in FIG. 5B, resulting in deformation. Pressing may be performed a plurality of times. The pressure in the pressing is higher than or equal to 100 kN/m and lower than or equal to 300 kN/m, preferably higher than or equal to 150 kN/m and lower than or equal to 250 kN/m, further preferably higher than or equal to 190 kN/m and lower than or equal to 230 kN/m. In the case where pressing is performed a plurality of times, the pressure in the second pressing is greater than or equal to 5 times and less than or equal to 8 times, preferably greater than or equal to 6 times and less than or equal to 7 times the pressure in the first pressing.

In this case, at a surface newly formed as a result of slipping and the surface portion 100a thereof, the additive element does not exist or the concentration of the additive element is below the lower detection limit in some cases. The line E-F in FIG. 5B denotes examples of the surface newly formed as a result of slipping and its surface portion 100a. FIG. 5C1 and FIG. 5C2 show enlarged views of the vicinity of the line E-F. Unlike in FIG. 4B1 to FIG. 4C2, there exists neither concentration gradation of the additive element X nor that of the additive element Xb in FIG. 5C1 and FIG. 5C2.

However, since slipping easily occurs parallel to a (001) plane, the newly formed surface becomes the (001) plane and the plane is included in the surface portion 100a. Since a diffusion path of lithium ions is not exposed at a (001) plane and the (001) plane is relatively stable, substantially no problem is caused even when the additive element X does not exist or the concentration of the additive element X is below the lower detection limit.

Note that as described above, in a composite oxide whose composition is LiMO₂ and which has a layered rock-salt crystal structure belonging to R-3m, cations are arranged parallel to a (001) plane. In a HAADF-STEM image, the luminance of the transition metal M, which has the largest atom number in LiMO₂, is the highest. Thus, in a HAADF-STEM image, arrangement of atoms with a high luminance may be regarded as arrangement of atoms of the transition metal M. Repetition of such arrangement with a high luminance may be referred to as crystal fringes or lattice fringes. Such crystal fringes or lattice fringes may be deemed to be parallel to a (001) plane in the case of a layered rock-salt crystal structure belonging to R-3m.

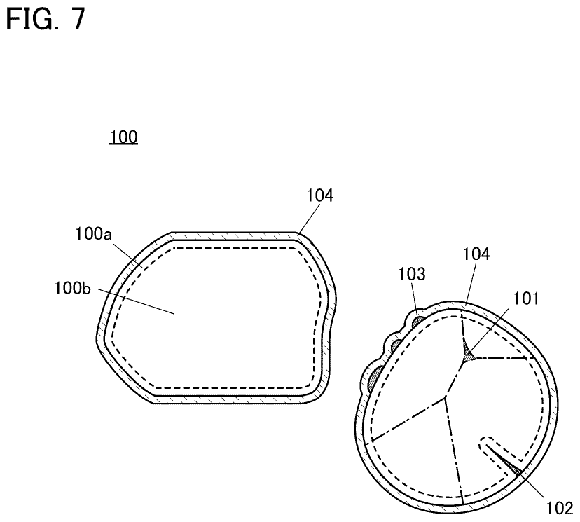

The positive electrode active material 100 has a depression, a crack, a depressed portion, a V-shaped cross section, or the like in some cases. These are examples of defects, and when charge and discharge are repeated, elution of the transition metal M, breakage of a crystal structure, cracking of the positive electrode active material 100, extraction of oxygen, or the like might be derived from the defects or the like. However, when there is a filling portion 102 (FIG. 7) as illustrated in FIG. 4A, which fills such defects, elution of the transition metal M or the like can be inhibited. The filling portion 102 preferably contains the additive element X. Owing to the filling portion 102, the positive electrode active material 100 can have high reliability and excellent cycle performance.

The positive electrode active material 100 may include a projection 103 (FIG. 7), which is a region where the additive element X is unevenly distributed.

As described above, an excessive amount of the additive element X in the positive electrode active material 100 might adversely affect insertion and extraction of lithium. The use of such a positive electrode active material 100 for a secondary battery might cause an internal resistance increase, a charge and discharge capacity decrease, and the like. Meanwhile, when the amount of the additive element X is insufficient, the additive element is not distributed throughout the surface portion 100a, which might diminish the effect of inhibiting degradation of a crystal structure. The additive element X is thus required to be contained in the positive electrode active material 100 at an appropriate concentration; however, the adjustment of the concentration is not easy.

Thus, in the positive electrode active material 100, when the surface portion 100a includes a region where the additive element X is unevenly distributed, for example, the additive element concentration can be appropriate in the inner portion 100b. This can inhibit an internal resistance increase, a charge and discharge capacity decrease, and the like when a secondary battery is fabricated. A feature of inhibiting an internal resistance increase in a secondary battery is extremely preferable especially in charge and discharge at a high rate such as charge and discharge at 2 C or more (note that 1 C is 200 mA/g).

In the positive electrode active material 100 including a region where the additive element X is unevenly distributed, since the additive element concentration can be appropriate in the inner portion 100b, addition of excess additive elements to some extent in the formation process is acceptable. This is preferable because the margin of production can be increased.

In this specification and the like, uneven distribution refers to a state where a concentration of a certain element in a certain region is different from that in other regions, and may be rephrased as segregation, precipitation, unevenness, deviation, a mixture of a high-concentration portion and a low-concentration portion, or the like.

Magnesium, which is one of the additive element X, is divalent and is more stable in lithium sites than in transition metal sites in a layered rock-salt crystal structure; thus, magnesium is likely to enter the lithium sites. An appropriate concentration of magnesium in the lithium sites of the surface portion 100a facilitates maintenance of the layered rock-salt crystal structure. Magnesium can inhibit extraction of oxygen around magnesium when the charge depth is large. Magnesium is also expected to increase the density of the positive electrode active material. An appropriate concentration of magnesium does not have an adverse effect on insertion or extraction of lithium in charge and discharge, and is thus preferable. However, excess magnesium might adversely affect insertion and extraction of lithium. Thus, as will be described later, the concentration of the transition metal M is preferably higher than that of magnesium in the surface portion 100a, for example.

Aluminum, which is an example of the additive element X, is trivalent and can exist at a transition metal site in a layered rock-salt crystal structure. Aluminum can inhibit elution of surrounding cobalt. The bonding strength of aluminum with oxygen is high, thereby inhibiting extraction of oxygen around aluminum. Hence, aluminum contained as the additive element X enables the positive electrode active material 100 to have the crystal structure that is unlikely to be broken by repeated charge and discharge.

When fluorine, which is a monovalent anion, is substituted for part of oxygen in the surface portion 100a, the lithium extraction energy is lowered. This is because the change in valence of cobalt ions associated with lithium extraction is trivalent to tetravalent in the case of not containing fluorine and divalent to trivalent in the case of containing fluorine, and the oxidation-reduction potential differs therebetween. It can thus be said that when fluorine is substituted for part of oxygen in the surface portion 100a of the positive electrode active material 100, lithium ions near fluorine are likely to be extracted and inserted smoothly. Thus, using such a positive electrode active material 100 in a secondary battery is preferable because the charge and discharge characteristics, rate performance, and the like are improved.

A titanium oxide is known to have superhydrophilicity. Accordingly, the positive electrode active material 100 including titanium oxide at the surface portion 100a presumably has good wettability with respect to a high-polarity solvent. Such a positive electrode active material 100 and a high-polarity electrolyte solution can have favorable contact at the interface therebetween and presumably inhibit an internal resistance increase when a secondary battery is formed using such a positive electrode active material 100.

The voltage of a positive electrode generally increases with increasing charge voltage of a secondary battery. The positive electrode active material of one embodiment of the present invention has a stable crystal structure even at a high voltage. The stable crystal structure of the positive electrode active material in a charged state can suppress a charge and discharge capacity decrease due to repeated charge and discharge.

A short circuit of a secondary battery might cause not only malfunction in charging operation and/or discharging operation of the secondary battery but also heat generation and firing. In order to obtain a safe secondary battery, a short-circuit current is preferably inhibited even at a high charge voltage. In the positive electrode active material 100 of one embodiment of the present invention, a short-circuit current is inhibited even at a high charge voltage. Thus, a secondary battery having high charge and discharge capacity and a high level of safety can be obtained.

The concentration gradient of the additive element X can be evaluated using energy dispersive X-ray spectroscopy (EDX), EPMA (electron probe microanalysis), or the like. In the EDX measurement, the measurement in which a region is measured while scanning the region and evaluated two-dimensionally is referred to as EDX area analysis. The measurement by line scan, which is performed to evaluate the atomic concentration distribution in a positive electrode active material particle, is referred to as linear analysis. Furthermore, extracting data of a linear region from EDX area analysis is referred to as linear analysis in some cases. The measurement of a region without scanning is referred to as point analysis.

By EDX area analysis (e.g., element mapping), the concentrations of the additive element X in the surface portion 100a, the inner portion 100b, a crystal grain boundary 101, the vicinity thereof, and the like of the positive electrode active material 100 can be quantitatively analyzed. By EDX linear analysis, the concentration distribution and the highest concentration of the additive element X can be analyzed.

When the positive electrode active material 100 containing magnesium as the additive element X is subjected to the EDX linear analysis, the maximum peak of the magnesium concentration in the surface portion 100a is preferably exhibited by a region that is 3 nm in depth, further preferably 1 nm in depth, still further preferably 0.5 nm in depth from the surface toward the center of the positive electrode active material 100.

When the positive electrode active material 100 contains magnesium and fluorine as the additive elements X, the distribution of fluorine preferably overlaps with the distribution of magnesium. Thus, in the EDX linear analysis, the maximum peak of the fluorine concentration in the surface portion 100a is preferably exhibited by a region that is 3 nm in depth, further preferably 1 nm in depth, still further preferably 0.5 nm in depth from the surface toward the center of the positive electrode active material 100.

Note that the concentration distribution may differ between the additive elements X. For example, in the case where the positive electrode active material 100 contains aluminum as the additive element X, the distribution of aluminum is preferably slightly different from that of magnesium and that of fluorine as described above. For example, in the EDX linear analysis, the maximum peak of the magnesium concentration is preferably closer to the surface than the maximum peak of the aluminum concentration is in the surface portion 100a. For example, the maximum peak of the aluminum concentration is preferably exhibited by a region that is greater than or equal to 0.5 nm and less than or equal to 50 nm in depth, further preferably greater than or equal to 5 nm and less than or equal to 30 nm in depth from the surface of the positive electrode active material 100. Alternatively, it is preferably present in a region that is greater than or equal to 0.5 nm and less than or equal to 30 nm. Further alternatively, it is preferably present in a region that is greater than or equal to 5 nm and less than or equal to 50 nm.

When the positive electrode active material 100 is subjected to linear analysis or area analysis, the atomic ratio of an additive element X to the transition metal M (X/M) in the surface portion 100a is preferably greater than or equal to 0.05 and less than or equal to 1.00. When the additive element is titanium, the atomic ratio of titanium to the transition metal M (Ti/M) is preferably greater than or equal to 0.05 and less than or equal to 0.4, further preferably greater than or equal to 0.1 and less than or equal to 0.3. When the additive element is magnesium, the atomic ratio of magnesium to the transition metal M (Mg/M) is preferably greater than or equal to 0.4 and less than or equal to 1.5, further preferably greater than or equal to 0.45 and less than or equal to 1.00. When the additive element is fluorine, the atomic ratio of fluorine to the transition metal M (F/M) is preferably greater than or equal to 0.05 and less than or equal to 1.5, further preferably greater than or equal to 0.3 and less than or equal to 1.00.

According to results of the EDX linear analysis, where a surface of the positive electrode active material 100 is can be estimated as follows. A point where the detected amount of an element which uniformly exists in the inner portion 100b of the positive electrode active material 100, e.g., oxygen or the transition metal M such as cobalt, is ½ of the detected amount thereof in the inner portion 100b is assumed as the surface.

Since the positive electrode active material 100 is a composite oxide, the detected amount of oxygen is preferably used to estimate where the surface is. Specifically, an average value Oₐᵥₑ of the oxygen concentration of a region of the inner portion 100b where the detected amount of oxygen is stable is calculated first. At this time, in the case where oxygen O_{background} which is probably led from chemical adsorption or the background is detected in a region that is obviously outside the surface, O_{background} is subtracted from the measurement value to obtain the average value Oₐᵥₑ of the oxygen concentration. The measurement point where the measurement value which is closest to ½ of the average value Oₐᵥₑ, or ½Oₐᵥₑ, is obtained can be estimated to be the surface of the positive electrode active material.

Where the surface is can also be estimated with the use of the transition metal M contained in the positive electrode active material 100. For example, in the case where 95% or more of the transition metals M is cobalt, the detected amount of cobalt can be used to estimate where the surface is as in the above description. Alternatively, the sum of the detected amounts of the transition metals M can be used for the estimation in a similar manner. The detected amount of the transition metal M is unlikely to be affected by chemical adsorption and is thus suitable for the estimation of where the surface is.

When the positive electrode active material 100 is subjected to linear analysis or area analysis, the atomic ratio of the additive element X to the transition metal M (X/M) in the vicinity of the crystal grain boundary 101 is preferably greater than or equal to 0.020 and less than or equal to 0.50, further preferably greater than or equal to 0.025 and less than or equal to 0.30, still further preferably greater than or equal to 0.030 and less than or equal to 0.20. Alternatively, it is preferably greater than or equal to 0.020 and less than or equal to 0.30. Alternatively, it is preferably greater than or equal to 0.020 and less than or equal to 0.20. Alternatively, it is preferably greater than or equal to 0.025 and less than or equal to 0.50. Alternatively, it is preferably greater than or equal to 0.025 and less than or equal to 0.20. Alternatively, it is preferably greater than or equal to 0.030 and less than or equal to 0.50. Alternatively, it is preferably greater than or equal to 0.030 and less than or equal to 0.30.

For example, when the additive element X is magnesium and the transition metal M is cobalt, the atomic ratio of magnesium to cobalt (Mg/Co) is preferably greater than or equal to 0.020 and less than or equal to 0.50, further preferably greater than or equal to 0.025 and less than or equal to 0.30, still further preferably greater than or equal to 0.030 and less than or equal to 0.20. Alternatively, it is preferably greater than or equal to 0.020 and less than or equal to 0.30. Alternatively, it is preferably greater than or equal to 0.020 and less than or equal to 0.20. Alternatively, it is preferably greater than or equal to 0.025 and less than or equal to 0.50. Alternatively, it is preferably greater than or equal to 0.025 and less than or equal to 0.20. Alternatively, it is preferably greater than or equal to 0.030 and less than or equal to 0.50. Alternatively, it is preferably greater than or equal to 0.030 and less than or equal to 0.30.

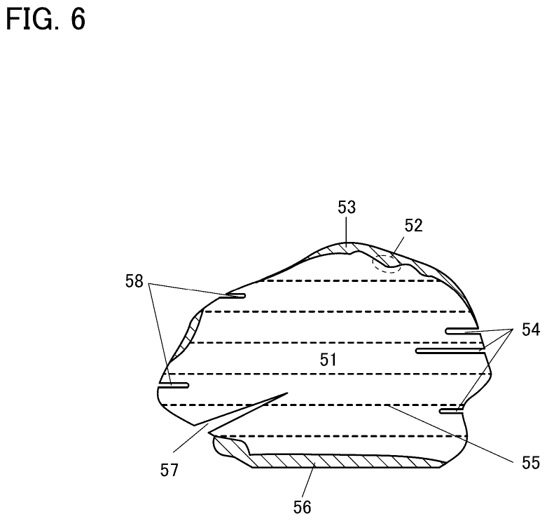

Note that when the positive electrode active material 100 undergoes charge and discharge under conditions with a large charge depth, including charge at 4.5 V or more, or at a high temperature (45° C. or higher), a progressive defect (also referred to as a pit) might be generated in the positive electrode active material. In addition, a defect such as a crevice (also referred to as a crack) might be generated by expansion and contraction of the positive electrode active material due to charge and discharge. FIG. 6 shows a schematic cross-sectional view of a positive electrode active material 51. Although pits of the positive electrode active material 51 are illustrated as holes denoted by reference numerals 54 and 58, their opening shape is not circular but a wide groove-like shape. A source of a pit can be a point defect. Presumably, the crystal structure of LCO in the vicinity of a portion where a pit is formed is broken and differs from a layered rock-salt crystal structure. The breakage of the crystal structure might inhibit diffusion and release of lithium ions that are carrier ions; thus, a pit is probably a cause of degradation of cycle performance. In the positive electrode active material 51, a crack 57 is also illustrated. A crystal plane 55 is a crystal plane parallel to arrangement of cations, and the positive electrode active material 51 includes a depressed portion 52 in some cases. Regions 53 and 56 denote the regions where the additive element exists, and the region 53 is positioned at least to fill the depressed portion 52.

Typical positive electrode active materials of lithium-ion secondary batteries are LCO and nickel-manganese-lithium cobalt oxide (NMC), which can also be regarded as a composite oxide containing a plurality of metal elements (cobalt, nickel, and the like). At least one of a plurality of positive electrode active materials has a defect and the defect might change before and after charge and discharge. When used in a secondary battery, a positive electrode active material might undergo a phenomenon such as chemical or electrochemical erosion or degradation due to environmental substances (e.g., electrolyte solution) surrounding the positive electrode active material. This degradation does not occur uniformly in the surface of the positive electrode active material but occurs locally in a concentrated manner, and a defect is formed deeply from the surface toward the inner portion, for example, by repeated charge and discharge of the secondary battery.

Progress of a defect in a positive electrode active material to form a hole can be referred to as pitting corrosion, and the hole generated by the pitting corrosion is shown as pits 54 and 58 in FIG. 6.

In this specification, a crack and a pit are different from each other. Immediately after formation of a positive electrode active material, a crack can exist but a pit does not exist. A pit can also be regarded as a hole formed by extraction of some layers of cobalt and oxygen due to charge and discharge under conditions with a large charge depth, such as high-voltage conditions at 4.5 V or more, or at a high temperature (45° ° C. or higher), i.e., a portion from which cobalt has been eluted. A crack refers to a surface newly generated by application of physical pressure or a crevice generated owing to the crystal grain boundary 101 in FIG. 4A. A crack might be caused by expansion and contraction of a positive electrode active material due to charge and discharge. A pit might be generated from a void inside a positive electrode active material and/or a crack.

The positive electrode active material 100 may include a coating film (also referred to as a coating portion) in at least part of its surface. FIG. 7 shows an example of the positive electrode active material 100 including a coating film 104.

The coating film 104 is preferably formed by deposition of a decomposition product of an electrolyte solution due to charge and discharge, for example. A coating film originating from an electrolyte solution, which is formed on the surface of the positive electrode active material 100, is expected to improve charge and discharge cycle performance particularly when charge with a large charge depth is repeated. This is because an increase in impedance of the surface of the positive electrode active material is inhibited or elution of the transition metal M is inhibited, for example. The coating film 104 preferably contains carbon, oxygen, and fluorine, for example. The coating film can have high quality easily when the electrolyte solution includes lithium bis(oxalate)borate (LiBOB) and/or suberonitrile (SUN), for example. Accordingly, the coating film 104 preferably contains at least one of boron, nitrogen, sulfur, and fluorine to possibly have high quality. The coating film 104 does not necessarily cover the positive electrode active material 100 entirely.

### <Crystal Structure>

A material with a layered rock-salt crystal structure, such as lithium cobalt oxide (LiCoO₂), is known to have a high discharge capacity and excel as a positive electrode active material of a secondary battery. Examples of a material with a layered rock-salt crystal structure include a composite oxide represented by LiMO₂.

It is known that the Jahn-Teller effect in a transition metal compound varies in degree according to the number of electrons in the d orbital of the transition metal.

In a compound containing nickel, distortion is likely to be caused because of the Jahn-Teller effect in some cases. Accordingly, when charge and discharge with a large charge depth are performed on LiNiO₂, the crystal structure might be broken because of the distortion. The influence of the Jahn-Teller effect is suggested to be small in LiCoO₂; hence, cobalt is preferably used as the transition metal because its tolerance at the time of charge with a large charge depth is higher in some cases.

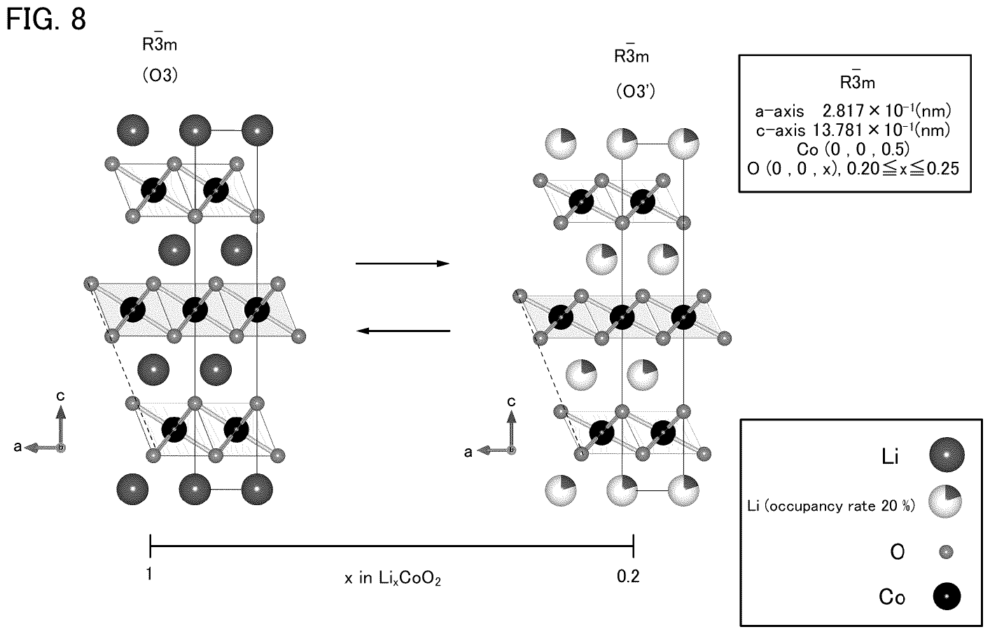

Crystal structures of positive electrode active materials are described with reference to FIG. 8 to FIG. 12. In FIG. 8 to FIG. 12, the case where cobalt is used as the transition metal M contained in the positive electrode active material is described.

### <Conventional Positive Electrode Active Material>

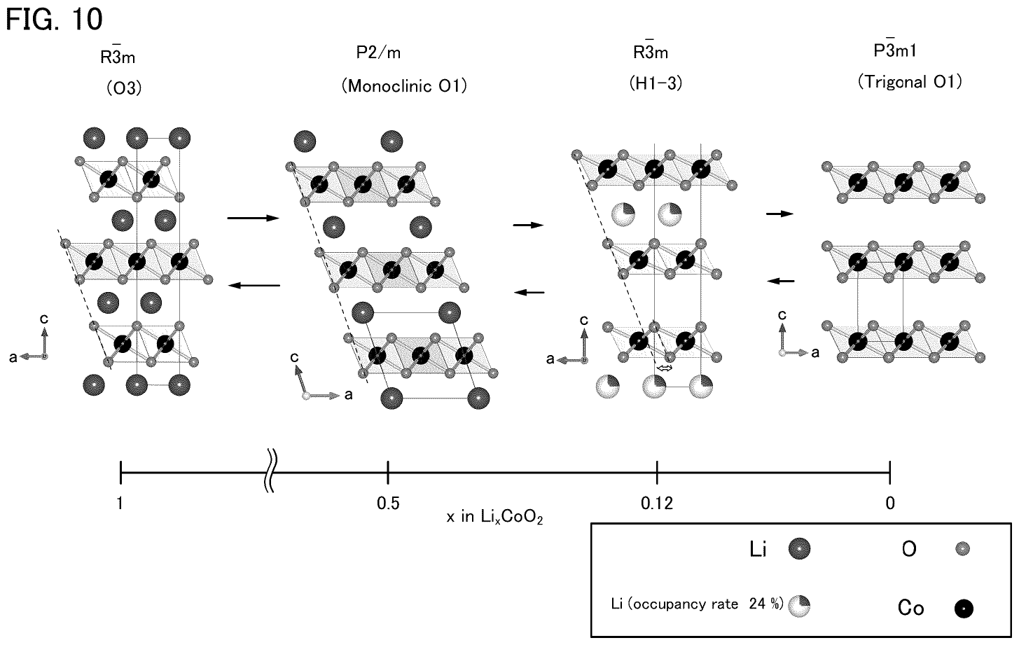

A positive electrode active material shown in FIG. 10 is lithium cobalt oxide (LiCoO₂) to which fluorine and magnesium are not added in a formation method described later. As described in Non-Patent Document 1, Non-Patent Document 2, and the like, the crystal structure of the lithium cobalt oxide changes. FIG. 10 shows a state where the crystal structure of the lithium cobalt oxide changes in accordance with x in LiₓCoO₂.

FIG. 10 shows the crystal structure of lithium cobalt oxide with x=1 in LiₓCoO₂, which is denoted by R-3m (O3). The lithium cobalt oxide with x=1 in LiₓCoO₂ corresponds to the structure with a charge depth of 0 (discharged state). In a unit cell of this crystal structure, three CoO₂ layers exist and lithium is positioned between the CoO₂ layers. Furthermore, lithium occupies octahedral sites with six coordinated oxygen. Thus, this crystal structure is referred to as an O3 type crystal structure in some cases. Note that the CoO₂ layer has a structure in which an octahedral structure with cobalt coordinated to six oxygen atoms continues on a plane in an edge-shared state. Such a layer is sometimes referred to as a layer formed of octahedrons of cobalt and oxygen.

Conventional lithium cobalt oxide with x being approximately 0.5 is known to have an improved symmetry of lithium and have a monoclinic crystal structure belonging to the space group P2/m. This structure includes one CoO₂ layer in a unit cell. Thus, this crystal structure is referred to as an O1 type structure or a monoclinic O1 type structure in some cases. FIG. 10 shows the crystal structure of lithium cobalt oxide with x in LiₓCoO₂ of 0.5 is denoted with P2/m (monoclinic O1).

When x=0, the positive electrode active material has a trigonal crystal structure belonging to the space group P-3m1, and one CoO₂ layer exists in a unit cell. Thus, this crystal structure is referred to as an O1 type structure or a trigonal O1 type structure in some cases. Moreover, in some cases, this crystal structure is referred to as a hexagonal O1 type structure when a trigonal crystal is converted into a composite hexagonal lattice. FIG. 10 shows the crystal structure of lithium cobalt oxide with x in LiₓCoO₂ of 0 is denoted with P-3m1 (trigonal O1).

Conventional lithium cobalt oxide with x being approximately 0.12 has the crystal structure belonging to the space group R-3m. The lithium cobalt oxide when x=approximately 0.12 in LiₓCoO₂ corresponds to the structure with a charge depth of approximately 0.8, where the percentage of the charge depth is approximately 80%. This structure can also be regarded as a structure in which CoO₂ structures such as trigonal O₁ type structures and LiCoO₂ structures such as R-3m (O3) are alternately stacked. Thus, this crystal structure is referred to as an H1-3 type crystal structure in some cases. FIG. 10 shows the crystal structure of lithium cobalt oxide with x in LiₓCoO₂ of 0.12 is denoted with R-3m (H1-3). Note that since insertion and extraction of lithium do not necessarily uniformly occur in reality, the H1-3 type crystal structure is started to be observed when x is approximately 0.25 in practice. The number of cobalt atoms per unit cell in the actual H1-3 type crystal structure is twice that in other structures. However, in this specification including FIG. 10, the c-axis of the H1-3 type crystal structure is half that of the unit cell for easy comparison with the other crystal structures.

For the H1-3 type crystal structure, as disclosed in Non-Patent Document 3, the coordinates of cobalt and oxygen in the unit cell can be expressed as follows, for example: Co (0, 0, 0.42150±0.00016), O₁ (0, 0, 0.27671±0.00045), and O₂ (0, 0, 0.11535±0.00045). O₁ and O₂ are each an oxygen atom. In this manner, the H1-3 type crystal structure is represented by a unit cell including one cobalt atom and two oxygen atoms. Meanwhile, the O3′ type crystal structure of one embodiment of the present invention is preferably represented by a unit cell including one cobalt atom and one oxygen atom, as described later. This means that the symmetry of cobalt and oxygen differs between the O3′ structure and the H1-3 type structure, and the amount of change from the O3 structure is smaller in the O3′ structure than in the H1-3 type structure. A preferred unit cell for representing a crystal structure in a positive electrode active material is selected such that the value of GOF (goodness of fit) is smaller in Rietveld analysis of XRD patterns, for example.

When charge at a high voltage of 4.6 V (vs Li/Li⁺) or more with reference to the redox potential of a lithium metal or charge that makes x in LiₓCoO₂ be 0.24 or less (corresponding to deep-depth charge with a charge depth of 0.8 or more) and discharge are repeated, the crystal structure of conventional lithium cobalt oxide changes (i.e., an unbalanced phase change occurs) repeatedly between the H1-3 type crystal structure and the R-3m (O3) structure in a discharged state.

However, there is a large shift in the CoO₂ layers between these two crystal structures. As denoted by the dotted lines and the arrow in FIG. 10, the CoO₂ layer in the H1-3 type crystal structure largely shifts from that in the R-3m (O3) structure. Such a dynamic structural change can adversely affect the stability of the crystal structure.

A difference in volume between these two crystal structures is also large. The difference in volume per the same number of cobalt atoms between the R-3m O3 type crystal structure in a discharged state and the H1-3 type crystal structure is greater than or equal to 3.0%, and typically greater than or equal to 3.9%.

In addition, although the H1-3 type crystal structure is a structure in which CoO₂ layers are arranged continuously, the structure of continuous CoO₂ layers is the structure also including P-3m1 (trigonal O1) and highly likely to be unstable.

Accordingly, the crystal structure of lithium cobalt oxide is broken by the repetition of charge with a large charge depth and discharge or charge that makes x be 0.24 or less and discharge. The broken crystal structure triggers deterioration of the cycle performance. The broken crystal structure reduces sites where lithium can exist stably and makes it difficult to insert and extract lithium.

### <Positive Electrode Active Material of One Embodiment of the Present Invention>

### <<Crystal Structure>>

In the positive electrode active material 100 of one embodiment of the present invention, the shift in CoO₂ layers can be small in repeated charge and discharge with a large charge depth. Specifically, a change in the crystal structure between a state with x in LiₓCoO₂ being 1 and a state with x being 0.24 or less is smaller than that in a conventional positive electrode active material. More specifically, a shift in the CoO₂ layers between the discharge state with x being 1 and the charge state with x being 0.24 or less can be small. Furthermore, a change in the volume can be small in the case where the positive electrode active materials have the same number of cobalt atoms. Thus, the positive electrode active material 100 of one embodiment of the present invention can have a crystal structure that is difficult to break even when charge that makes x be 0.24 or less and discharge are repeated, and obtain excellent cycle performance. In addition, the positive electrode active material 100 of one embodiment of the present invention with x in LiₓCoO₂ being 0.24 or less can have a more stable crystal structure than a conventional positive electrode active material. Thus, in the positive electrode active material of one embodiment of the present invention, a short circuit in a secondary battery is unlikely to occur while the state with x in LiₓCoO₂ of 0.24 or less is maintained, in some cases. This is preferable because the safety of the secondary battery is further improved.

FIG. 8 shows crystal structures of the inner portion 100b of the positive electrode active material 100 in a state where x in LiₓCoO₂ is 1 and in a state where x in LiₓCoO₂ is approximately 0.2. The inner portion 100b, accounting for the majority of the volume of the positive electrode active material 100, largely contributes to charge and discharge and is accordingly a portion where a shift in CoO₂ layers and a volume change matter most.

The positive electrode active material 100 is a composite oxide containing lithium, cobalt as the transition metal M, and oxygen. In addition to the above elements, the inner portion 100b preferably contains magnesium as the additive element and further preferably contains nickel as the transition metal M as well as cobalt. The surface portion 100a preferably contains fluorine as the additive element and further preferably contains aluminum and/or nickel as the additive element. The surface portion 100a is described later in detail.

In FIG. 8, the positive electrode active material 100 has the R-3m (O3) crystal structure when x=1, like conventional lithium cobalt oxide. By contrast, the inner portion 100b of the positive electrode active material 100 includes a crystal having a structure different from H1-3 type crystal structure when charge is sufficiently performed, for example, typically when x is less than or equal to 0.24, e.g., approximately 0.2 or approximately 0.12. The positive electrode active material 100 of one embodiment of the present invention when x=approximately 0.2 has a trigonal crystal structure which belongs to the space group R-3m and in which an ion of cobalt, magnesium, or the like occupies a site coordinated to six oxygen atoms. The symmetry of the CoO₂ layers of this structure is the same as that of O3. This structure is thus referred to as the O3′ type crystal structure in this specification and the like, and denoted by R-3m (O3′) as shown in FIG. 8. In both the O3 type crystal structure and the O3′ type crystal structure, a slight amount of magnesium preferably exists between the CoO₂ layers, i.e., in lithium sites. In addition, a slight amount of fluorine preferably exists at random in oxygen sites.

Note that in the O3′ type crystal structure, a light element such as lithium sometimes occupies a site coordinated to four oxygen atoms.

Although a chance of the existence of lithium in all lithium sites is one in five in the O3′ type structure in FIG. 8, the positive electrode active material 100 of one embodiment of the present invention is not limited thereto. Lithium may exist unevenly in only some of the lithium sites. For example, lithium may exist in some lithium sites that are aligned, as in Li_{0.5}CoO₂ belonging to the space group P2/m. Distribution of lithium can be analyzed by neutron diffraction, for example.

The O3′ type crystal structure can be regarded as a crystal structure that contains lithium between layers randomly but is similar to a CdCl₂ type crystal structure. The crystal structure similar to the CdCl₂ type crystal structure is close to a crystal structure of lithium nickel oxide (Li_{0.06}NiO₂) that is charged until the charge depth reaches 0.94; however, pure lithium cobalt oxide or a layered rock-salt positive electrode active material containing a large amount of cobalt is known not to have such a crystal structure generally.

In the positive electrode active material 100 of one embodiment of the present invention, a change in the crystal structure caused when a large amount of lithium is extracted is smaller than that in a conventional positive electrode active material. As indicated by dotted lines in FIG. 8, for example, CoO₂ layers hardly shift between the crystal structures.

Specifically, the crystal structure of the positive electrode active material 100 of one embodiment of the present invention is highly stable even when a large amount of lithium is extracted. For example, at a charge voltage that makes a conventional positive electrode active material have the H1-3 type crystal structure, for example, at a voltage of approximately 4.6 V with reference to the potential of a lithium metal, the crystal structure belonging to R-3m (O3) can be maintained. Moreover, in a higher charge voltage range, for example, at voltages of greater than or equal to 4.65 V and less than or equal to 4.7 V with reference to the potential of a lithium metal, the O3′ type crystal structure can be obtained. At a much higher charge voltage, the H1-3 crystal is eventually observed in some cases. In addition, the positive electrode active material 100 of one embodiment of the present invention might have the O3′ type crystal structure even at a lower charge voltage (e.g., a charge voltage of greater than or equal to 4.5 V and less than 4.6 V with reference to the potential of a lithium metal).

Thus, in the positive electrode active material 100 of one embodiment of the present invention, the crystal structure is unlikely to be broken even when charge and discharge extracting a large amount of lithium are repeated.

The space group of a crystal structure is identified by XRD, electron diffraction, neutron diffraction, or the like. Thus, in this specification and the like, belonging to a space group or being a space group can be rephrased as being identified as a space group.

Note that in the case where graphite is used as a negative electrode active material in a secondary battery, for example, the voltage of the secondary battery is lower than the above-mentioned voltages by the potential of graphite. The potential of graphite is approximately 0.05 V to 0.2 V with reference to the potential of a lithium metal. Thus, even in a secondary battery which includes graphite as a negative electrode active material and which has a voltage of greater than or equal to 4.3 V and less than or equal to 4.5 V, for example, the positive electrode active material 100 of one embodiment of the present invention can maintain the crystal structure belonging to R-3m (O3) and moreover, can have the O3′ type structure at higher voltages, e.g., a voltage of the secondary battery of greater than 4.5 V and less than or equal to 4.6 V. In addition, the positive electrode active material 100 of one embodiment of the present invention can have the O3′ type structure at lower charge voltages, e.g., at a voltage of the secondary battery of greater than or equal to 4.2 V and less than 4.3 V, in some cases.

Note that in the unit cell of the O3′ type structure, the coordinates of cobalt and oxygen can be represented by Co (0, 0, 0.5) and O (0, 0, x) within the range of 0.20≤x≤0.25. In the unit cell, the lattice constant of the a-axis is preferably 2.797×10⁻¹≤a≤2.837×10⁻¹ (nm), further preferably 2.807×10⁻¹≤a≤2.827×10⁻¹ (nm), typically a=2.817×10⁻¹ (nm). The lattice constant of the c-axis is preferably 13.681×10⁻¹≤c≤13.881×10⁻¹ (nm), further preferably 13.751×10⁻¹≤c≤13.811×10⁻¹ (nm), typically, c=13.781×10⁻¹ (nm).

A slight amount of the additive element such as magnesium randomly existing between the CoO₂ layers, i.e., in lithium sites, can suppress a shift in the CoO₂ layers when the charge depth is large. Thus, magnesium between the CoO₂ layers makes it easier to obtain the O3′ type crystal structure. Therefore, magnesium is preferably distributed throughout the positive electrode active material 100 of one embodiment of the present invention. To distribute magnesium throughout the whole positive electrode active material 100, heat treatment is preferably performed in the formation process of the positive electrode active material 100 of one embodiment of the present invention.

However, heat treatment at an excessively high temperature may cause cation mixing, which increases the possibility of entry of the additive element such as magnesium into the cobalt sites. Magnesium in the cobalt sites does not have the effect of maintaining the structure belonging to R-3m when a large amount of lithium is extracted. Furthermore, heat treatment at an excessively high temperature might have an adverse effect; for example, cobalt might be reduced to have a valence of two or lithium might be evaporated.

In view of the above, a fluorine compound is preferably added to lithium cobalt oxide before the heat treatment for distributing magnesium throughout the particle. The addition of the fluorine compound decreases the melting point of lithium cobalt oxide. The decreased melting point makes it easier to distribute magnesium throughout the positive electrode active material 100 at a temperature at which the cation mixing is unlikely to occur. Furthermore, the fluorine compound probably increases corrosion resistance to hydrofluoric acid generated by decomposition of an electrolyte solution.

Furthermore, the above-described initial heating can improve distribution of the additive element such as magnesium or aluminum. Thus, in some cases, the H1-3 type structure is not formed but a crystal structure in which a shift in the CoO₂ layers is suppressed can be maintained even at higher charge voltages, e.g., a charge voltage of greater than or equal to 4.6 V and less than or equal to 4.8 V, and even when a large amount of lithium is extracted. This crystal structure has the same symmetry as the O3′ type structure but is different from the O3′ type structure in the lattice constant. Therefore, this structure is referred to as the O3″ type structure in this specification and the like. The O3″ type structure can also be regarded as being similar to the CdCl₂ crystal structure.

When the magnesium concentration is higher than a desired value, the effect of stabilizing a crystal structure becomes small in some cases. This is probably because magnesium enters the cobalt sites in addition to the lithium sites. The number of magnesium atoms in the positive electrode active material 100 of one embodiment of the present invention is preferably greater than or equal to 0.001 times and less than or equal to 0.1 times, further preferably greater than 0.01 times and less than 0.04 times, still further preferably approximately 0.02 times the number of atoms of the transition metal M. Alternatively, the number of magnesium atoms is preferably greater than or equal to 0.001 times and less than 0.04 times the number of atoms of the transition metal M. Alternatively, the number of magnesium atoms is preferably greater than or equal to 0.01 times and less than or equal to 0.1 times the number of atoms of the transition metal M. The magnesium concentration described here may be a value obtained by element analysis on the whole of the positive electrode active material 100 by ICP-MS (inductively coupled plasma mass spectrometry) or the like, or may be a value based on the ratio of the raw materials mixed in the process of forming the positive electrode active material, for example.

Aluminum and the transition metal M typified by nickel preferably exist in cobalt sites, but part of them may exist in lithium sites. Magnesium preferably exists in lithium sites. Fluorine may be substituted for part of oxygen.

As the magnesium concentration in the positive electrode active material of one embodiment of the present invention increases, the charge and discharge capacity of the positive electrode active material decreases in some cases. As an example, one reason is that the amount of lithium that contributes to charge and discharge decreases when magnesium enters the lithium sites. Another possible reason is that excess magnesium generates a magnesium compound that does not contribute to charge and discharge. When the positive electrode active material of one embodiment of the present invention contains nickel in addition to magnesium, the charge and discharge capacity per weight and per volume can be increased in some cases. When the positive electrode active material of one embodiment of the present invention contains aluminum in addition to magnesium, the charge and discharge capacity per weight and per volume can be increased in some cases. When the positive electrode active material of one embodiment of the present invention contains nickel and aluminum in addition to magnesium, the charge and discharge capacity per weight and per volume can be increased in some cases.

The concentrations of the elements contained in the positive electrode active material of one embodiment of the present invention, such as magnesium and the metal Z, are described below using the number of atoms.

The number of nickel atoms in the positive electrode active material 100 of one embodiment of the present invention is preferably greater than 0% and less than or equal to 7.5%, further preferably greater than or equal to 0.05% and less than or equal to 4%, still further preferably greater than or equal to 0.1% and less than or equal to 2%, yet still further preferably greater than or equal to 0.2% and less than or equal to 1% of the number of cobalt atoms. Alternatively, it is preferably greater than 0% and less than or equal to 4%. Alternatively, it is preferably greater than 0% and less than or equal to 2%. Alternatively, it is preferably greater than or equal to 0.05% and less than or equal to 7.5%. Alternatively, it is preferably greater than or equal to 0.05% and less than or equal to 2%. Alternatively, it is preferably greater than or equal to 0.1% and less than or equal to 7.5%. Alternatively, it is preferably greater than or equal to 0.1% and less than or equal to 4%. The nickel concentration described here may be a value obtained by element analysis on the whole positive electrode active material 100 by GD-MS, ICP-MS, or the like, or may be a value based on the ratio of the raw materials mixed in the process of forming the positive electrode active material 100, for example.

Nickel contained at any of the above concentrations easily forms a solid solution uniformly throughout the positive electrode active material 100 and thus particularly contributes to stabilization of the crystal structure of the inner portion 100b. When divalent nickel exists in the inner portion 100b, a slight amount of the additive element having a valence of two and randomly existing in lithium sites, such as magnesium, might be able to exist more stably in the vicinity of the divalent nickel. Thus, even after charge and discharge involving extraction of a large amount of lithium, elution of magnesium might be inhibited. Accordingly, charge and discharge cycle performance might be improved. Such a combination of the effect of nickel in the inner portion 100b and the effect of magnesium, aluminum, titanium, fluorine, or the like in the surface portion 100a extremely effectively stabilizes the crystal structure at the time when a large amount of lithium is extracted.

The number of aluminum atoms in the positive electrode active material of one embodiment of the present invention is preferably greater than or equal to 0.05% and less than or equal to 4%, further preferably greater than or equal to 0.1% and less than or equal to 2%, still further preferably greater than or equal to 0.3% and less than or equal to 1.5% of the number of cobalt atoms. Alternatively, it is preferably greater than or equal to 0.05% and less than or equal to 2%. Alternatively, it is preferably greater than or equal to 0.1% and less than or equal to 4%. The aluminum concentration described here may be a value obtained by element analysis on the whole of the positive electrode active material 100 by GD-MS, ICP-MS, or the like, or may be a value based on the ratio of the raw materials mixed in the process of forming the positive electrode active material 100, for example.

Preferably, the positive electrode active material 100 of one embodiment of the present invention further contains phosphorus as the additive element. Further preferably, the positive electrode active material 100 of one embodiment of the present invention contains a compound containing phosphorus and oxygen.

When the positive electrode active material 100 of one embodiment of the present invention includes a compound containing phosphorus, a short circuit in a secondary battery can be inhibited while a state in which a large amount of lithium is extracted is maintained, in some cases.

When the positive electrode active material 100 of one embodiment of the present invention contains phosphorus, phosphorus may react with hydrogen fluoride generated by the decomposition of the electrolyte solution, which might decrease the hydrogen fluoride concentration in the electrolyte solution.

In the case where the electrolyte solution contains LiPF₆, hydrogen fluoride may be generated by hydrolysis. In some cases, hydrogen fluoride is generated by the reaction of polyvinylidene fluoride (PVDF) used as a component of the positive electrode and alkali. The decrease in hydrogen fluoride concentration in the electrolyte solution may inhibit corrosion of a current collector and/or separation of the coating film 104 or may inhibit a reduction in adhesion properties due to gelling and/or insolubilization of PVDF.

When phosphorus is contained in addition to magnesium, the positive electrode active material of one embodiment of the present invention is extremely stable in a state in which a large amount of lithium is extracted. When phosphorus is contained, the number of phosphorus atoms is preferably greater than or equal to 1% and less than or equal to 20%, further preferably greater than or equal to 2% and less than or equal to 10%, still further preferably greater than or equal to 3% and less than or equal to 8% of the number of cobalt atoms. Alternatively, it is preferably greater than or equal to 1% and less than or equal to 10%. Alternatively, it is preferably greater than or equal to 1% and less than or equal to 8%. Alternatively, it is preferably greater than or equal to 2% and less than or equal to 20%. Alternatively, it is preferably greater than or equal to 2% and less than or equal to 8%. Alternatively, it is preferably greater than or equal to 3% and less than or equal to 20%. Alternatively, it is preferably greater than or equal to 3% and less than or equal to 10%. In addition, the number of magnesium atoms is preferably greater than or equal to 0.1% and less than or equal to 10%, further preferably greater than or equal to 0.5% and less than or equal to 5%, still further preferably greater than or equal to 0.7% and less than or equal to 4% of the number of cobalt atoms. Alternatively, it is preferably greater than or equal to 0.1% and less than or equal to 5%. Alternatively, it is preferably greater than or equal to 0.1% and less than or equal to 4%. Alternatively, it is preferably greater than or equal to 0.5% and less than or equal to 10%. Alternatively, it is preferably greater than or equal to 0.5% and less than or equal to 4%. Alternatively, it is preferably greater than or equal to 0.7% and less than or equal to 10%. Alternatively, it is preferably greater than or equal to 0.7% and less than or equal to 5%. The phosphorus concentration and the magnesium concentration described here may each be a value obtained by element analysis on the whole particles of the positive electrode active material 100 by ICP-MS or the like, or may be a value based on the ratio of the raw materials mixed in the process of forming the positive electrode active material 100, for example.

The positive electrode active material 100 has a crack in some cases. When the inner portion or the depressed portion, such as the filling portion 102, of the positive electrode active material 100 with the crack on the surface contains phosphorus, more specifically, a compound containing phosphorus and oxygen, may inhibit crack development, for example.

### <<Surface Portion>>

It is preferable that magnesium be distributed throughout a particle of the positive electrode active material 100 of one embodiment of the present invention, and it is further preferable that the magnesium concentration in the surface portion 100a be higher than the average magnesium concentration in the whole positive electrode active material 100. Alternatively, it is preferable that the magnesium concentration in the surface portion 100a be higher than the magnesium concentration in the inner portion 100b. For example, the magnesium concentration in the surface portion 100a measured by XPS (X-ray photoelectron spectroscopy) or the like is preferably higher than the average magnesium concentration in the whole positive electrode active material 100 measured by ICP-MS or the like. Alternatively, the magnesium concentration in the surface portion 100a measured by EDX (energy dispersive X-ray spectroscopy) area analysis or the like is preferably higher than the magnesium concentration in the inner portion 100b.

In the case where the positive electrode active material 100 of one embodiment of the present invention contains the additive element X, the concentration of the additive element X in the surface portion 100a is preferably higher than the average concentration in the entire positive electrode active material 100. Alternatively, the concentration of the additive element X in the surface portion 100a is preferably higher than that in the inner portion 100b. For example, the concentration of the element other than cobalt in the surface portion 100a measured by XPS or the like is preferably higher than the average concentration of the element in the entire positive electrode active material 100 measured by ICP-MS or the like. Alternatively, the concentration of the element other than cobalt in the surface portion 100a measured by EDX area analysis or the like is preferably higher than the concentration of the element other than cobalt in the inner portion 100b.

The surface portion 100a is in a state where bonds are cut unlike the inner portion 100b whose crystal structure is maintained, and lithium is extracted from the surface during charge; thus, the lithium concentration in the surface portion 100a tends to be lower than that in the inner portion 100b. Therefore, the surface portion 100a tends to be unstable and its crystal structure is likely to be broken. The higher the magnesium concentration in the surface portion 100a is, the more effectively the change in the crystal structure can be reduced. In addition, a high magnesium concentration in the surface portion 100a probably increases the corrosion resistance to hydrofluoric acid generated by the decomposition of the electrolyte solution.

The fluorine concentration in the surface portion 100a of the positive electrode active material 100 of one embodiment of the present invention is preferably higher than the average concentration in the whole positive electrode active material 100. Alternatively, the fluorine concentration in the surface portion 100a is preferably higher than that in the inner portion 100b. When fluorine exists in the surface portion 100a, which is in contact with the electrolyte solution, the corrosion resistance to hydrofluoric acid can be effectively increased.

As described above, the surface portion 100a of the positive electrode active material 100 of one embodiment of the present invention preferably has a composition different from that in the inner portion 100b, i.e., the concentrations of the additive elements such as magnesium and fluorine are preferably higher than those in the inner portion. The composition preferably has a crystal structure stable at room temperature (25°) C. Accordingly, the surface portion 100a may have a crystal structure different from that of the inner portion 100b. For example, at least part of the surface portion 100a of the positive electrode active material 100 of one embodiment of the present invention may have the rock-salt crystal structure. When the surface portion 100a and the inner portion 100b have different crystal structures, the orientations of crystals in the surface portion 100a and the inner portion 100b are preferably substantially aligned with each other.

Anions of a layered rock-salt crystal and anions of a rock-salt crystal form a cubic close-packed structure (face-centered cubic lattice structure). Anions of an O3′ type crystal are presumed to form a cubic close-packed structure.

Note that in this specification and the like, a structure is referred to as a cubic close-packed structure when three layers of anions are shifted and stacked like “ABCABC” in the structure. Accordingly, anions do not necessarily form a cubic lattice structure. At the same time, actual crystals always have a defect and thus, analysis results are not consistent with the theory in some cases. For example, in an electron diffraction pattern or an FFT (fast Fourier transform) pattern of a TEM image or the like, a spot may appear in a position slightly different from a theoretical position. For example, anions may be regarded as forming a cubic close-packed structure when a difference in orientation from a theoretical position is 5° or less or 2.5° or less.

When a layered rock-salt crystal and a rock-salt crystal are in contact with each other, there is a crystal plane at which orientations of cubic close-packed structures formed of anions are aligned with each other.

The description can also be made as follows. An anion on the (111) plane of a cubic crystal structure has a triangular arrangement. A layered rock-salt structure, which belongs to the space group R-3m and is a rhombohedral structure, is generally represented by a composite hexagonal lattice for easy understanding of the structure, and the (0001) plane of the layered rock-salt structure has a hexagonal lattice. The triangle lattice on the (111) plane of the cubic crystal has atomic arrangement similar to that of the hexagonal lattice on the (0001) plane of the layered rock-salt structure. These lattices being consistent with each other can be expressed as “orientations of the cubic close-packed structures are aligned with each other”.

Note that a space group of the layered rock-salt crystal and the O3′ type crystal is R-3m, which is different from the space group of rock-salt crystals; thus, the Miller index of the crystal plane satisfying the above conditions in the layered rock-salt crystal and the O3′ type crystal is different from that in the rock-salt crystal. In this specification, in the layered rock-salt crystal, the O3′ type crystal, and the rock-salt crystal, a state where the orientations of the cubic close-packed structures formed of anions are aligned with each other may be referred to as a state where crystal orientations are substantially aligned with each other.

The orientations of crystals in two regions being substantially aligned with each other can be judged, for example, from a TEM image, a STEM image, a HAADF-STEM image, an ABF-STEM image, an electron diffraction pattern, or an FFT pattern of a TEM image or the like. XRD, electron diffraction, neutron diffraction, or the like can also be used for judging.

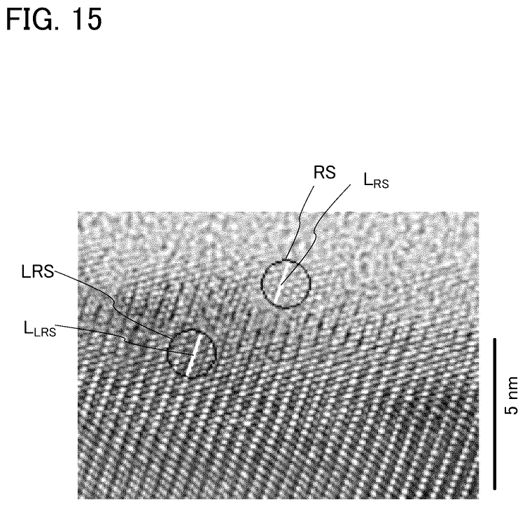

FIG. 15 shows an example of a TEM image in which orientations of a layered rock-salt crystal LRS and a rock-salt crystal RS are substantially aligned with each other. In a TEM image, a STEM image, a HAADF-STEM image, an ABF-STEM image, and the like, an image reflecting a crystal structure is obtained.

For example, in a high-resolution TEM image, a contrast derived from a crystal plane is obtained. When an electron beam is incident perpendicularly to the c-axis of a layered rock-salt type composite hexagonal lattice, for example, a contrast derived from the (0003) plane is obtained as repetition of bright bands (bright strips) and dark bands (dark strips) because of diffraction and interference of the electron beam. Thus, when repetition of bright lines and dark lines is observed and the angle between the bright lines (e.g., L_{RS} and L_{LRS} in FIG. 15) is 5° or less or 2.5° or less in the TEM image, it can be judged that the crystal planes are substantially aligned with each other, that is, orientations of the crystals are substantially aligned with each other. Similarly, when the angle between the dark lines is 5° or less or 2.5° or less, it can be judged that orientations of the crystals are substantially aligned with each other.

In a HAADF-STEM image, a contrast corresponding to the atomic number is obtained, and an element having a larger atomic number is observed to be brighter. For example, in the case of lithium cobalt oxide that has a layered rock-salt structure belonging to the space group R-3m, cobalt (atomic number: 27) has the largest atomic number; hence, an electron beam is strongly scattered at the position of a cobalt atom, and arrangement of the cobalt atoms is observed as bright lines or arrangement of high-luminance dots. Thus, when the lithium cobalt oxide having a layered rock-salt crystal structure is observed perpendicularly to the c-axis, arrangement of the cobalt atoms is observed as bright lines or arrangement of high-luminance dots, and arrangement of lithium atoms and oxygen atoms is observed as dark lines or a low-luminance region in the direction perpendicular to the c-axis. The same applies to the case where fluorine (atomic number: 9) and magnesium (atomic number: 12) are included as the additive elements of the lithium cobalt oxide.

Consequently, in the case where repetition of bright lines and dark lines is observed in two regions having different crystal structures and the angle between the bright lines is 5° or less or 2.5° or less in a HAADF-STEM image, it can be judged that arrangements of the atoms are substantially aligned with each other, that is, orientations of the crystals are substantially aligned with each other. Similarly, when the angle between the dark lines is 5° or less or 2.5° or less, it can be judged that orientations of the crystals are substantially aligned with each other.

With an ABF-STEM, an element having a smaller atomic number is observed to be brighter, but a contrast corresponding to the atomic number is obtained as with a HAADF-STEM; hence, in an ABF-STEM image, crystal orientations can be judged as in a HAADF-STEM image.

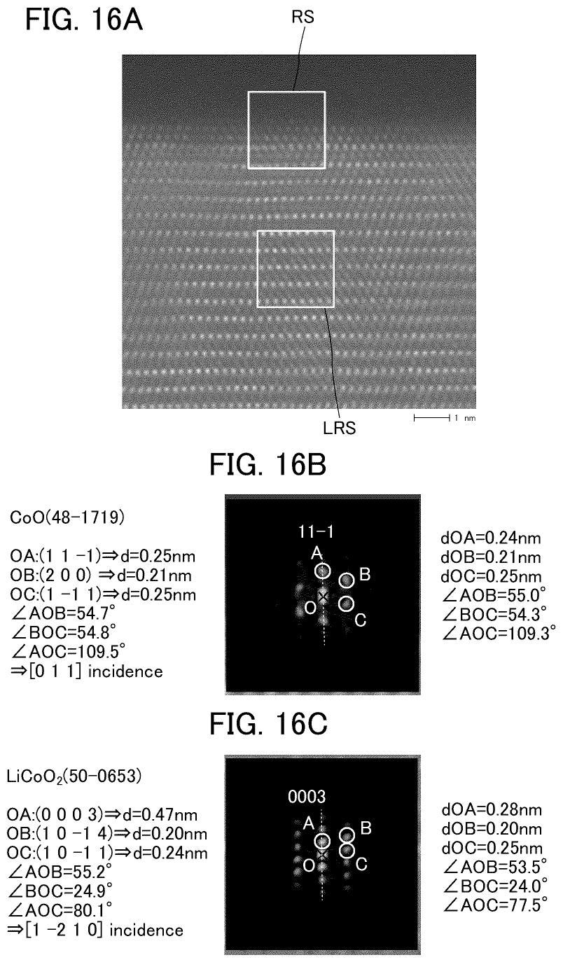

FIG. 16A shows an example of a STEM image in which orientations of the layered rock-salt crystal LRS and the rock-salt crystal RS are substantially aligned with each other. FIG. 16B shows an FFT of a region of the rock-salt crystal RS, and FIG. 16C shows an FFT of a region of the layered rock-salt crystal LRS. In FIG. 16B and FIG. 16C, the composition, the JCPDS card number, and d values and angles to be calculated are shown on the left. The measured values are shown on the right. A spot denoted by O is zero-order diffraction.

A spot denoted by A in FIG. 16B is derived from 11-1 reflection of a cubic structure. A spot denoted by A in FIG. 16C is derived from 0003 reflection of a layered rock-salt structure. It is found from FIG. 16B and FIG. 16C that the direction of the 11-1 reflection of the cubic structure and the direction of the 0003 reflection of the layered rock-salt structure are substantially aligned with each other. That is, a straight line that passes through AO in FIG. 16B is substantially parallel to a straight line that passes through AO in FIG. 16C. Here, the terms “substantially aligned” and “substantially parallel” mean that the angle between the two is 5° or less or 2.5° or less.

When the orientations of the layered rock-salt crystal and the rock-salt crystal are substantially aligned with each other in the above manner in an FFT and electron diffraction, the <0003> orientation of the layered rock-salt crystal and the <11-1> orientation of the rock-salt crystal may be substantially aligned with each other. In that case, it is preferable that these reciprocal lattice points be spot-shaped, that is, they be not connected to other reciprocal lattice points. The state where reciprocal lattice points are spot-shaped and not connected to other reciprocal lattice points means high crystallinity.

When the direction of the 11-1 reflection of the cubic structure and the direction of the 0003 reflection of the layered rock-salt structure are substantially aligned with each other as described above, a spot that is not derived from the 0003 reflection of the layered rock-salt structure may be observed, depending on the incident direction of the electron beam, on a reciprocal lattice space different from the direction of the 0003 reflection of the layered rock-salt structure. For example, a spot denoted by B in FIG. 16C is derived from 1014 reflection of the layered rock-salt structure. This is sometimes observed at a position where the difference in orientation from the reciprocal lattice point derived from the 0003 reflection of the layered rock-salt structure (A in FIG. 16C) is greater than or equal to 52° and less than or equal to 56° (i.e., ∠AOB is 52° to 56°) and d is greater than or equal to 0.19 nm and less than or equal to 0.21 nm. Note that these indices are just an example, and the spot does not necessarily correspond with them. For example, the spot may be a reciprocal lattice point equivalent to 0003 and 1014.

Similarly, a spot that is not derived from the 11-1 reflection of the cubic structure may be observed on a reciprocal lattice space different from the direction where the 11-1 reflection of the cubic structure is observed. For example, a spot denoted by B in FIG. 16B is derived from 200 reflection of the cubic structure. A diffraction spot is sometimes observed at a position where the difference in orientation from the spot derived from the 11-1 reflection of the cubic structure (A in FIG. 16B) is greater than or equal to 54° and less than or equal to 56° (i.e., ∠AOB is 54° to) 56°. Note that these indices are just examples, and the spot does not necessarily correspond with them. For example, the spot may be a reciprocal lattice point equivalent to 11-1 and 200.

It is known that in a layered rock-salt positive electrode active material, such as lithium cobalt oxide, the (0003) plane and a plane equivalent thereto and the (10⁻¹⁴) plane and a plane equivalent thereto are likely to be crystal planes. Thus, a sample to be observed can be processed to be thin by FIB or the like such that an electron beam of a TEM, for example, enters in [12-10], in order to easily observe the (0003) plane in careful observation of the shape of the positive electrode active material with a SEM or the like. To judge alignment of crystal orientations, a sample is preferably processed to be thin so that the (0003) plane of the layered rock-salt structure is easily observed.

However, in the surface portion 100a where only MgO is contained or MgO and CoO(II) form a solid solution, it is difficult to insert and extract lithium. Thus, the surface portion 100a should contain at least cobalt, and also contain lithium in a discharged state to have the path through which lithium is inserted and extracted. The cobalt concentration is preferably higher than the magnesium concentration.

The additive element X is preferably positioned in the surface portion 100a of the positive electrode active material 100 of one embodiment of the present invention. For example, the positive electrode active material 100 of one embodiment of the present invention may be covered with the coating film 104 containing the additive element X.

### <<Grain Boundary>>

It is further preferable that the additive element contained in the positive electrode active material 100 of one embodiment of the present invention have the above-described distribution and be partly segregated in the crystal grain boundary 101 and the vicinity thereof as shown in FIG. 4A.

Specifically, the magnesium concentration at the crystal grain boundary 101 and the vicinity thereof in the positive electrode active material 100 is preferably higher than that in the other regions in the inner portion 100b. In addition, the fluorine concentration at the crystal grain boundary 101 and the vicinity thereof is preferably higher than that in the other regions in the inner portion 100b.

The crystal grain boundary 101 is a plane defect, and thus tends to be unstable and suffer a change in the crystal structure like the surface of the particle. Thus, the higher the magnesium concentration at the crystal grain boundary 101 and the vicinity thereof is, the more effectively the change in the crystal structure can be reduced.

When the magnesium concentration and the fluorine concentration are high at the crystal grain boundary 101 and the vicinity thereof, the magnesium concentration and the fluorine concentration in the vicinity of a surface generated by a crack are also high even when the crack is generated along the crystal grain boundary 101 of the positive electrode active material 100 of one embodiment of the present invention. Thus, the positive electrode active material including a crack can also have an increased corrosion resistance to hydrofluoric acid.

Note that in this specification and the like, the vicinity of the crystal grain boundary 101 refers to a region of approximately 10 nm from the grain boundary. The crystal grain boundary refers to a plane where atomic arrangement is changed and which can be observed with an electron microscope. Specifically, the crystal grain boundary 101 refers to a portion where the angle formed by repetition of bright lines and dark lines in an electron microscope image exceeds 5° or a portion where a crystal structure cannot be observed in an electron microscope.

### <<Particle Diameter>>

When the particle diameter of the positive electrode active material 100 of one embodiment of the present invention is too large, there are problems such as difficulty in lithium diffusion and large surface roughness of an active material layer at the time when the material is applied to a current collector. By contrast, too small a particle diameter causes problems such as difficulty in loading of the active material layer at the time when the material is applied to the current collector and overreaction with the electrolyte solution. Therefore, the median diameter (D50) is preferably greater than or equal to 1 μm and less than or equal to 100 μm, further preferably greater than or equal to 2 μm and less than or equal to 40 μm, still further preferably greater than or equal to 5 μm and less than or equal to 30 μm. Alternatively, it is preferably greater than or equal to 1 μm and less than or equal to 40 μm. Alternatively, it is preferably greater than or equal to 1 μm and less than or equal to 30 μm. Alternatively, it is preferably greater than or equal to 2 μm and less than or equal to 100 μm. Alternatively, it is preferably greater than or equal to 2 μm and less than or equal to 30 μm. Alternatively, it is preferably greater than or equal to 5 μm and less than or equal to 100 μm. Alternatively, it is preferably greater than or equal to 5 μm and less than or equal to 40 μm.

### <Analysis Method>

Whether or not a given positive electrode active material is the positive electrode active material 100 of one embodiment of the present invention, which has the O3′ type crystal structure when a large amount of lithium is extracted, can be judged by analysis of a positive electrode including the positive electrode active material in which a large amount of lithium is extracted by XRD, electron diffraction, neutron diffraction, electron spin resonance (ESR), nuclear magnetic resonance (NMR), or the like. In particular, XRD is preferable because the symmetry of a transition metal such as cobalt in the positive electrode active material can be analyzed with high resolution, comparison of the degree of crystallinity and comparison of the crystal orientation can be performed, distortion of lattice periodicity and the crystallite size can be analyzed, and a positive electrode obtained only by disassembling a secondary battery can be measured with sufficient accuracy, for example.

As described above, the positive electrode active material 100 of one embodiment of the present invention features in a small change in the crystal structure between a state where a large amount of lithium is extracted and a discharged state. A material, in which 50 wt % or more of the crystal structure in the state where a large amount of lithium is extracted causes a change from that in a discharged state, is not preferable because the material cannot withstand the charge and discharge that involves extraction of a large amount of lithium. It should be noted that the intended crystal structure is not obtained in some cases only by addition of the additive element X. For example, although the positive electrode active material that is lithium cobalt oxide containing magnesium and fluorine is a commonality, the positive electrode active material has the O3′ type crystal structure at 60 wt % or more in some cases, and has the H1-3 type crystal structure at 50 wt % or more in other cases, when a state where a large amount of lithium is extracted. Furthermore, the positive electrode active material has the O3′ type crystal structure at almost 100 wt % at a predetermined voltage, and increasing the voltage to be higher than the predetermined voltage may cause the H1-3 type crystal structure. Thus, to determine whether or not a positive electrode active material is the positive electrode active material 100 of one embodiment of the present invention, the crystal structure should be analyzed by XRD and other methods.

Note that a positive electrode active material in the state where a large amount of lithium is extracted or the discharged state sometimes causes a change in the crystal structure when exposed to air. For example, the O3′ type crystal structure changes into the H1-3 type structure in some cases. For that reason, all samples are preferably handled in an inert atmosphere such as an argon atmosphere.

### <<Charging Method>>

High voltage charge for determining whether or not a composite oxide is the positive electrode active material 100 of one embodiment of the present invention can be performed on a coin cell (CR2032 type with a diameter of 20 mm and a height of 3.2 mm) with a lithium counter electrode, for example

More specifically, a positive electrode can be formed by application of a slurry in which the positive electrode active material, a conductive agent, and a binder are mixed to a positive electrode current collector made of aluminum foil.

A lithium metal can be used for the counter electrode (negative electrode). Note that when the counter electrode is formed using a material other than the lithium metal, the potential of a secondary battery differs from the potential of the positive electrode. Unless otherwise specified, the voltage and the potential in this specification and the like refer to the potential (V vs. Li/Li⁺) of a positive electrode in the case of using a lithium metal for a counter electrode. As an electrolyte contained in an electrolyte solution, 1 mol/L lithium hexafluorophosphate (LiPF₆) can be used. As the electrolyte solution, an electrolyte solution in which ethylene carbonate (EC) and diethyl carbonate (DEC) at EC:DEC=3:7 (volume ratio) and vinylene carbonate (VC) at 2 wt % are mixed can be used.

As a separator, a 25-μm-thick polypropylene porous film can be used.

Stainless steel (SUS) can be used for a positive electrode can and a negative electrode can.

The coin cell fabricated with the above conditions is subjected to constant current charge at 0.5 C to a freely selected voltage (e.g., 4.6 V, 4.65 V, 4.7 V, 4.75 V, or 4.8 V) and then constant voltage charge until the current value reaches 0.01 C. Note that 1 C is the value of current flowing when a battery in a charged state is discharged in one hour, and a small value of current is preferably used for observation of a phase change of the positive electrode active material. For example, it is possible that 1 C=137 mA/g or 1 C=200 mA/g. In the case where the coin cell assembled as a test battery and the amount of the active material of the positive electrode in the coin cell is 10 mg, charge at a charge rate of 0.5 C corresponds to charge with 0.685 mA when 1 C=137 mA/g or to charge with 1 mA when 1 C=200 mA/g. The temperature is set to 25° C. or 45° C. After the charge is performed in this manner, the coin cell is disassembled in a glove box with an argon atmosphere to take out the positive electrode, whereby the positive electrode active material from which a large amount of lithium is extracted can be obtained. In order to inhibit a reaction with components in the external environment, the positive electrode is preferably enclosed in an argon atmosphere in performing various analyses later. For example, XRD can be performed on the positive electrode enclosed in an airtight container with an argon atmosphere.

### <<XRD>>

The apparatus and conditions for the XRD measurement are not particularly limited. The measurement can be performed with the apparatus and conditions as described below, for example.
XRD apparatus: D8 ADVANCE produced by Bruker AXS
X-ray source: CuKα radiation
Output: 40 kV, 40 mA
Slit system: Div. Slit, 0.5°
Detector: LynxEye
Scanning method: 2θ/θ continuous scanning
Measurement range (2θ): from 15° to 90°
Step width (2θ): 0.01°
Counting time: 1 second/step
Rotation of sample stage: 15 rpm

In the case where the measurement sample is a powder, the sample can be set by, for example, being put in a glass sample holder or being sprinkled on a reflection-free silicon plate to which grease is applied. In the case where the measurement sample is a positive electrode, the sample can be set in such a manner that the positive electrode is attached to a substrate with a double-sided adhesive tape so that the position of the positive electrode active material layer can be adjusted to the measurement plane required by the apparatus.

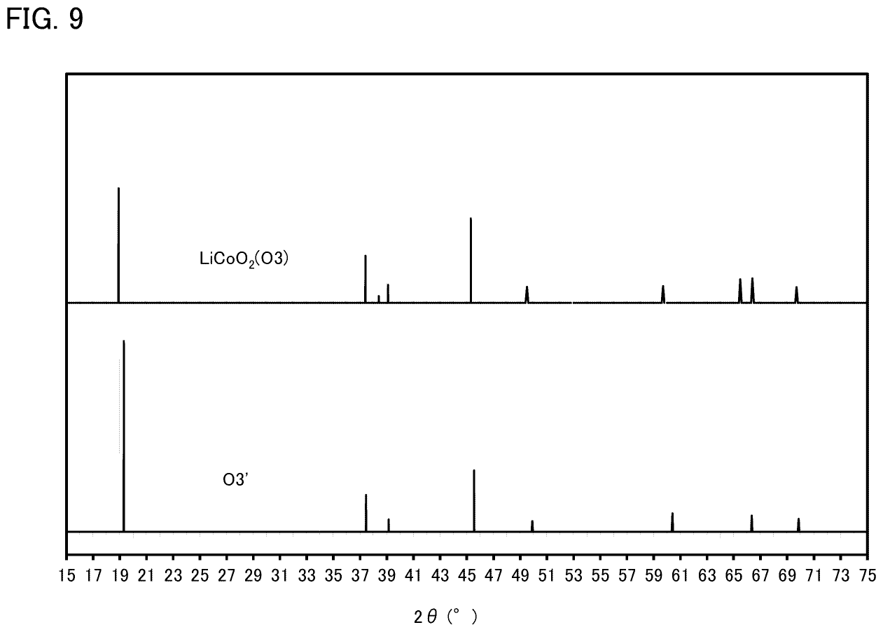

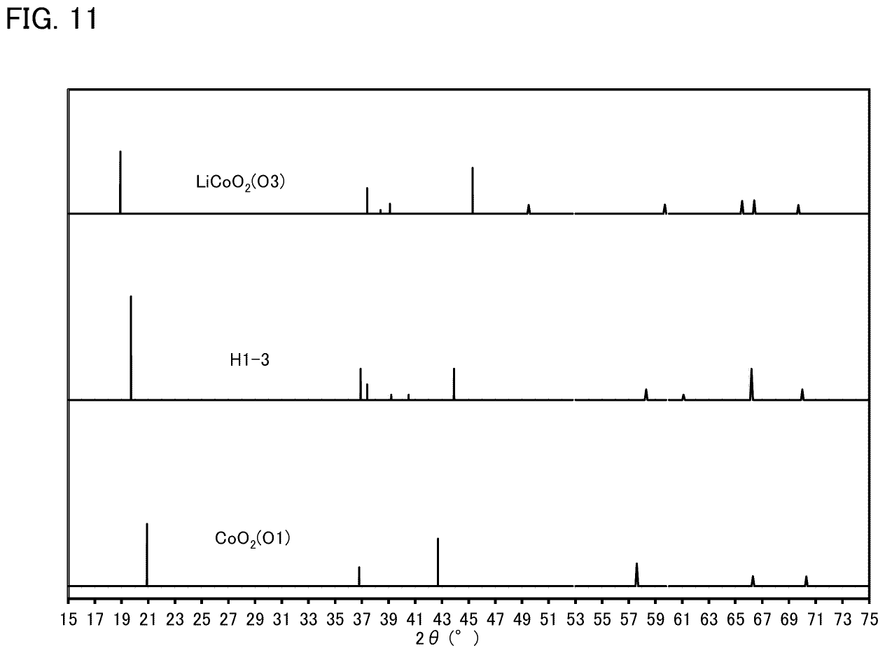

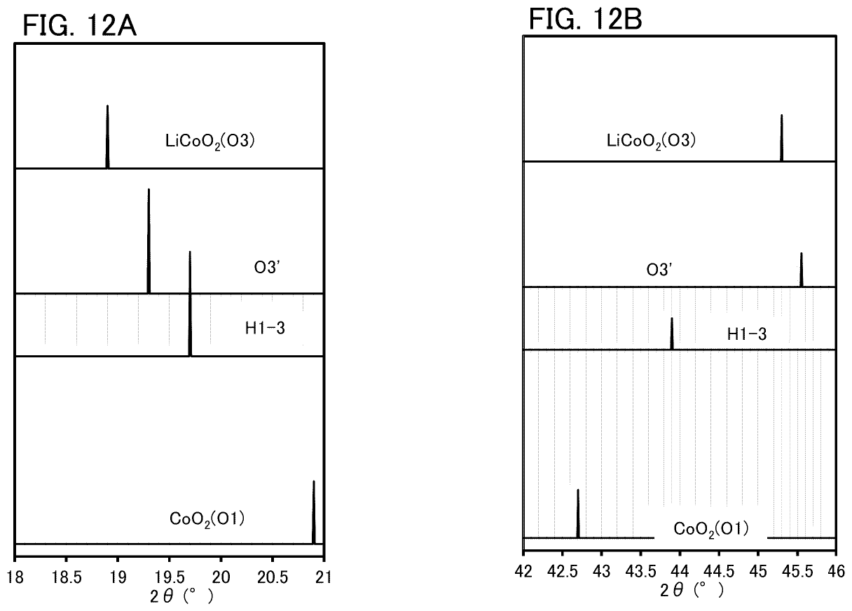

FIG. 9, FIG. 11, FIG. 12A, and FIG. 12B show ideal powder XRD patterns with CuKα₁ radiation that are calculated from models of the O3′ type crystal structure and the H1-3 type crystal structure. For comparison, ideal XRD patterns calculated from the crystal structure of LiCoO₂ (O3) with x being 1 and the crystal structure of CoO₂ (O1) with x being 0 are also shown. FIG. 12A and FIG. 12B each show both the XRD patterns of the O3′ type structure and the H1-3 type structure, and FIG. 12A and FIG. 12B are enlarged diagrams showing, respectively, a range of 2θ greater than or equal to 18° and less than or equal to 21° and a range of 2θ greater than or equal to 42° and less than or equal to 46°. Note that the patterns of LiCoO₂ (O3) and CoO₂ (O1) are made from crystal structure data obtained from the ICSD (Inorganic Crystal Structure Database) (see Non-Patent Document 4) with Reflex Powder Diffraction, which is a module of Materials Studio (BIOVIA). The range of 2θ is from 15° to 75°, the step size is 0.01, the wavelength λ1 is 1.540562×10⁻¹⁰ m, the wavelength λ2 is not set, and a single monochromator is used. The pattern of the H1-3 type crystal structure is similarly made from the crystal structure data disclosed in Non-Patent Document 3. The O3′ type crystal structure is estimated from the XRD pattern of the positive electrode active material of one embodiment of the present invention, the crystal structure is fitted with TOPAS Ver. 3 (crystal structure analysis software produced by Bruker Corporation), and the XRD pattern of the O3′ type crystal structure is made in a manner similar to that for other structures.

As shown in FIG. 9 and FIG. 12, the O3′ type crystal structure exhibits diffraction peaks at 2θ of 19.30±0.20° (greater than or equal to 19.10° and less than or equal to 19.50°) and 2θ of 45.55±0.10° (greater than or equal to 45.45° and less than or equal to 45.65°). More specifically, the O3′ type crystal structure exhibits sharp diffraction peaks at 2θ of 19.30±0.10° (greater than or equal to 19.20° and less than or equal to 19.40°) and 2θ of 45.55±0.05° (greater than or equal to 45.50° and less than or equal to 45.60°). By contrast, as shown in FIG. 11 and FIG. 12, the H1-3 type crystal structure and CoO₂ (P-3m1, O1) do not exhibit peaks at these positions. Thus, the peaks at 2θ of 19.30±0.20° and 2θ of 45.55±0.10° in a state with a large charge depth can be the features of the positive electrode active material 100 of one embodiment of the present invention.

It can be said that the positions of the XRD diffraction peaks exhibited by the crystal structure with x being 1 and the crystal structure with x being 0.24 or less are close to each other. More specifically, it can be said that a difference in the positions of two or more, preferably three or more of the main diffraction peaks between the crystal structures is 2θ=0.7° or less, preferably 2θ=0.5° or less.

Although not illustrated, the O3′ type crystal structure exhibits diffraction peaks at 2θ=19.47±0.10° (greater than or equal to 19.37° and less than or equal to 19.57°) and 2θ=45.62±0.05° (greater than or equal to 45.57° and less than or equal to 45.67°). The H1-3 type crystal structure and CoO₂ (P-3m1, O1) do not exhibit peaks at these positions. Thus, the appearance of the peaks at 2θ=19.47±0.10° and 2θ=45.62±0.05° in a state in which x in LiₓCoO₂ is small at a charge voltage higher than or equal to 4.8 V can be said to be a feature of the positive electrode active material 100 of one embodiment of the present invention, the formation of which involves the initial heating.

Although the positive electrode active material 100 of one embodiment of the present invention has the O3′ type crystal structure when x in LiₓCoO₂ is small, not all the particles necessarily have the O3′ type crystal structure. Some of the particles may have another crystal structure or be amorphous. Note that when the XRD patterns are subjected to the Rietveld analysis, the O3′ type crystal structure preferably accounts for greater than or equal to 50 wt %, further preferably greater than or equal to 60 wt %, still further preferably greater than or equal to 66 wt %. The positive electrode active material in which the O3′ type crystal structure accounts for greater than or equal to 50 wt %, preferably greater than or equal to 60 wt %, further preferably greater than or equal to 66 wt % can have sufficiently good cycle performance.

Furthermore, even after 100 or more cycles of charge and discharge after the measurement starts, the O3′ type crystal structure preferably accounts for greater than or equal to 35 wt %, further preferably greater than or equal to 40 wt %, still further preferably greater than or equal to 43 wt %, in the Rietveld analysis.

Sharpness of a diffraction peak in an XRD pattern indicates the degree of crystallinity. It is thus preferable that the diffraction peaks after charge be sharp or in other words, have a small half width, e.g., a small full width at half maximum. Even peaks that are derived from the same crystal phase have different half widths depending on the XRD measurement conditions and/or the 2θ value. In the case of the above-described measurement conditions, the peak observed at 2θ of greater than or equal to 43° and less than or equal to 46° preferably has a small half width of less than or equal to 0.2°, further preferably less than or equal to 0.15°, still further preferably less than or equal to 0.12°. Note that not all peaks need to fulfill the requirement. A crystal phase can be regarded as having high crystallinity when one or more peaks derived from the crystal phase fulfill the requirement. Such high crystallinity contributes to stability of the crystal structure after sufficient charge.

The crystallite size of the O3′ type crystal structure of the positive electrode active material particle is only decreased to approximately one-tenth that of LiCoO₂ (O3) in a discharged state. Thus, a clear peak of the O3′ type crystal structure can be observed when x in LiₓCoO₂ is small, even under the same XRD measurement conditions as those of a positive electrode before the charge and discharge. By contrast, simple LiCoO₂ has a small crystallite size and exhibits a broad and small peak although it can partly have a structure similar to the O3′ type crystal structure. The crystallite size can be calculated from the half width of the XRD peak.

As described above, the influence of the Jahn-Teller effect is preferably small in the positive electrode active material of one embodiment of the present invention. It is preferable that the positive electrode active material of one embodiment of the present invention have a layered rock-salt crystal structure and mainly contain cobalt as a transition metal. The positive electrode active material of one embodiment of the present invention may contain the above-described metal Z in addition to cobalt as long as the influence of the Jahn-Teller effect is small.

The range of the lattice constants where the influence of the Jahn-Teller effect is presumed to be small in the positive electrode active material is examined by XRD analysis.

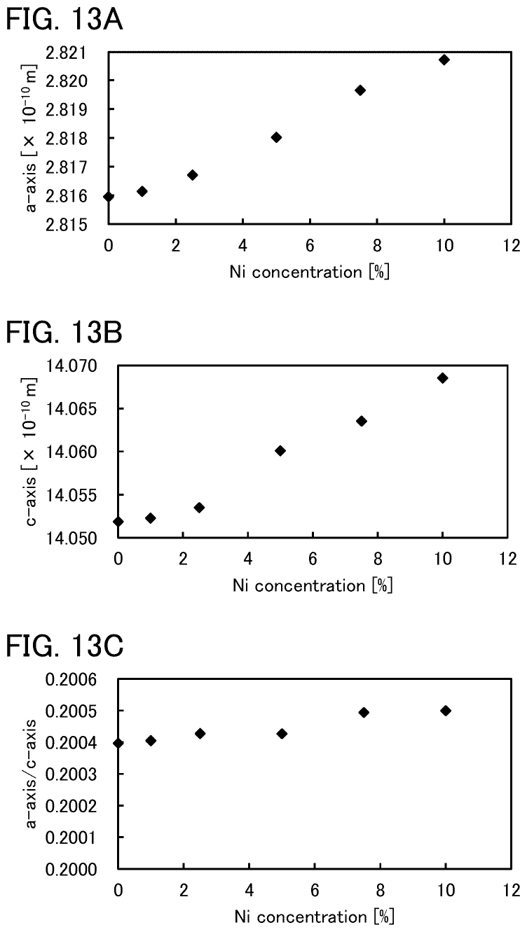

FIG. 13 shows the calculation results of the lattice constants of the a-axis and the c-axis by XRD in the case where the positive electrode active material of one embodiment of the present invention has a layered rock-salt crystal structure and contains cobalt and nickel. FIG. 13A shows the results of the a-axis, and FIG. 13B shows the results of the c-axis. Note that the XRD patterns of a powder after the synthesis of the positive electrode active material before incorporation into a positive electrode are used for the calculation. The nickel concentration on the horizontal axis represents a nickel concentration with the sum of cobalt atoms and nickel atoms assumed as 100%. The positive electrode active material was formed in accordance with the formation method in FIG. 2 except that the aluminum source was not used. The nickel concentration represents a nickel concentration with the sum of cobalt atoms and nickel atoms in a positive electrode active material assumed as 100%.

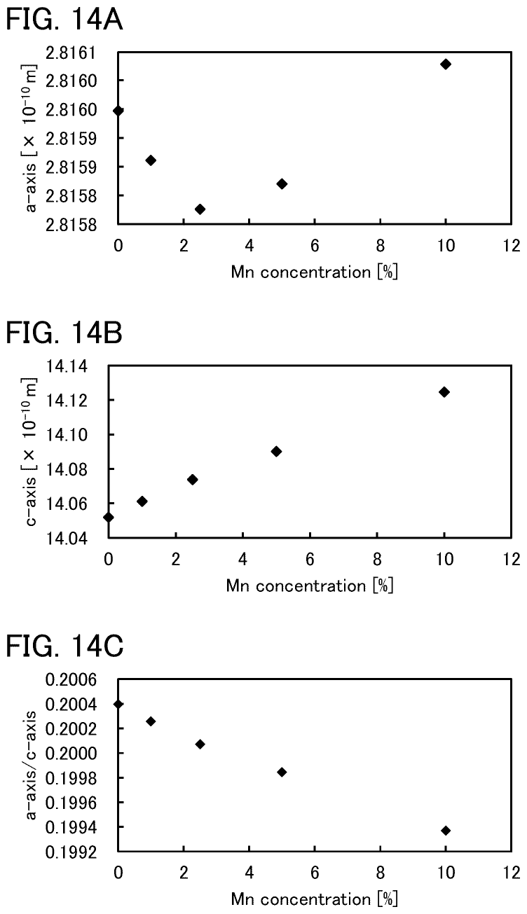

FIG. 14 shows the estimation results of the lattice constants of the a-axis and the c-axis by XRD in the case where the positive electrode active material of one embodiment of the present invention has a layered rock-salt crystal structure and contains cobalt and manganese. FIG. 14A shows the results of the a-axis, and FIG. 14B shows the results of the c-axis. Note that the lattice constants shown in FIG. 14 are obtained by XRD measurement of a powder after the synthesis of the positive electrode active material before incorporation into a positive electrode. The manganese concentration on the horizontal axis represents a manganese concentration with the sum of cobalt atoms and manganese atoms assumed as 100%. The positive electrode active material was formed in accordance with the formation method of FIG. 2 except that a manganese source was used instead of the nickel source and the aluminum source was not used. The manganese concentration represents a manganese concentration with the sum of cobalt atoms and manganese atoms regarded as 100% in Step S21.

FIG. 13C shows values obtained by dividing the lattice constants of the a-axis by the lattice constants of the c-axis (a-axis/c-axis) in the positive electrode active material, whose results of the lattice constants are shown in FIG. 13A and FIG. 13B. FIG. 14C shows values obtained by dividing the lattice constants of the a-axis by the lattice constants of the c-axis (a-axis/c-axis) in the positive electrode active material, whose results of the lattice constants are shown in FIG. 14A and FIG. 14B.

As shown in FIG. 13C, the value of a-axis/c-axis tends to significantly change between nickel concentrations of 5% and 7.5%, and the distortion of the a-axis becomes large at a nickel concentration of 7.5%. This distortion may be the Jahn-Teller distortion. It is suggested that an excellent positive electrode active material with small Jahn-Teller distortion can be obtained at a nickel concentration of lower than 7.5%.

FIG. 14A indicates that the lattice constant changes differently at a manganese concentration of 5% or higher and does not follow the Vegard's law. This suggests that the crystal structure changes at a manganese concentration of 5% or higher. Thus, the manganese concentration is preferably 4% or lower, for example.

Note that the nickel concentration and the manganese concentration in the surface portion 100a are not limited to the above ranges. In other words, the nickel concentration and the manganese concentration in the surface portion 100a may be higher than the above concentrations in some cases.

Preferable ranges of the lattice constants of the positive electrode active material of one embodiment of the present invention are examined above. In the layered rock-salt crystal structure of the particle of the positive electrode active material in a discharged state or a state where charge and discharge are not performed, which can be estimated from the XRD patterns, the a-axis lattice constant is preferably greater than 2.814×10⁻¹⁰ m and less than 2.817×10⁻¹⁰ m, and the c-axis lattice constant is preferably greater than 14.05×10⁻¹⁰ m and less than 14.07×10⁻¹⁰ m. The state where charge and discharge are not performed may be the state of a powder before the formation of a positive electrode of a secondary battery.

Alternatively, in the layered rock-salt crystal structure of particle of the positive electrode active material in the discharged state or the state where charge and discharge are not performed, the value obtained by dividing the a-axis lattice constant by the c-axis lattice constant (a-axis/c-axis) is preferably greater than 0.20000 and less than 0.20049.

Alternatively, when the layered rock-salt crystal structure of the particle of the positive electrode active material in the discharged state or the state where charge and discharge are not performed is subjected to XRD analysis, a first peak is observed at 2θ of greater than or equal to 18.50° and less than or equal to 19.30°, and a second peak is observed at 2θ of greater than or equal to 38.00° and less than or equal to 38.80°, in some cases.

Note that the peaks appearing in the powder XRD patterns reflect the crystal structure of the inner portion 100b of the positive electrode active material 100, which accounts for the majority of the volume of the positive electrode active material 100. The crystal structure of the surface portion 100a, the crystal grain boundary 101, or the like can be analyzed by electron diffraction of a cross section of the positive electrode active material 100, for example.

<<Charge Curve and dQ/dV Curve>>

The positive electrode active material 100 of one embodiment of the present invention sometimes shows a characteristic voltage change along with charge. A voltage change can be read from a dQ/dVvsV curve, which can be obtained by differentiating capacitance (Q) in a charge curve with voltage (V) (dQ/dV). There should be an unbalanced phase change and a significant change in the crystal structure between before and after a peak in the dQ/dVvsV curve. Note that in this specification and the like, an unbalanced phase change refers to a phenomenon that causes a nonlinear change in physical quantity.

The positive electrode active material 100 of one embodiment of the present invention sometimes shows a broad peak at around 4.55 V in a dQ/dV curve. The peak at around 4.55 V reflects a change in voltage at the time of the phase change from the O3 type structure to the O3′ type structure. This means that a change in crystal structure occurs more gradually when this peak is broad than when the peak is sharp. Preferably, the change toward the O3′ type structure occurs gradually, in which case the shift in CoO₂ layers and a volume change have a low impact.

Specifically, when the maximum value appearing at greater than or equal to 4.5 V and less than or equal to 4.6 V in a dQ/dV curve of a charge curve is a first peak, the first peak preferably has a full width at half maximum of greater than or equal to 0.10 V to be sufficiently broad. In this specification and the like, the half width of the first peak refers to the sum of HWHM₁ and HWHM₂, where HWHM₁ is an average value of the first peak and a first minimum value appearing at greater than or equal to 4.3 V and less than or equal to 4.5 V and HWHM₂ is an average value of the first peak and a second minimum value appearing at greater than or equal to 4.6 V and less than or equal to 4.8 V.

<<Discharge Curve and dQ/dV Curve>>

Moreover, when the positive electrode active material 100 of one embodiment of the present invention is discharged at a low rate of, for example, 0.2 C or less after high-voltage charge, a characteristic change in voltage appears just before the end of discharge, in some cases. This change can be clearly observed by the fact that at least one peak appears within the range to 3.5 V at a voltage lower than that of a peak which appears around 3.9 V in dQ/dV calculated from a discharge curve.

### <<XPS>>

A region that is approximately 2 nm to 8 nm (normally, less than or equal to 5 nm) in depth from a surface can be analyzed by XPS. The concentrations of elements in a region to the above depth of the surface portion 100a can be quantitatively analyzed. The bonding states of the elements can be analyzed by narrow scanning. Note that the quantitative accuracy of XPS is approximately +1 atomic % in many cases. The lower detection limit is approximately 1 atomic % but depends on the element.

When the positive electrode active material 100 of one embodiment of the present invention is subjected to XPS analysis, the number of atoms of a given additive element X is preferably greater than or equal to 1.6 times and less than or equal to 6.0 times, further preferably greater than or equal to 1.8 times and less than 4.0 times the number of atoms of the transition metal M. When the positive electrode active material 100 contains magnesium as the additive element X and the transition metal M is cobalt, for example, the number of magnesium atoms is preferably greater than or equal to 1.6 times and less than or equal to 6.0 times, further preferably greater than or equal to 1.8 times and less than 4.0 times the number of cobalt atoms. The number of atoms of a halogen such as fluorine is preferably greater than or equal to 0.2 times and less than or equal to 6.0 times, further preferably greater than or equal to 1.2 times and less than or equal to 4.0 times the number of atoms of the transition metal M.

In the XPS analysis, monochromatic aluminum can be used as an X-ray source, for example. An extraction angle is, for example, 45°. For example, the measurement can be performed using the following apparatus and conditions.
Measurement device: Quantera II produced by PHI, Inc.
X-ray source: monochromatic Al (1486.6 eV)
Detection area: 100 μm ϕ
Detection depth: approximately 4 to 5 nm (extraction angle 45°)
Measurement spectrum: wide scanning, narrow scanning of each detected element

In addition, when the positive electrode active material 100 of one embodiment of the present invention is analyzed by XPS, a peak indicating the bonding energy of fluorine with another element is preferably at greater than or equal to 682 eV and less than 685 eV, further preferably approximately 684.3 eV. This bonding energy is different from that of lithium fluoride (685 eV) and that of magnesium fluoride (686 eV). That is, the positive electrode active material 100 of one embodiment of the present invention containing fluorine is preferably in the bonding state other than lithium fluoride and magnesium fluoride.

Furthermore, when the positive electrode active material 100 of one embodiment of the present invention is analyzed by XPS, a peak indicating the bonding energy of magnesium with another element is preferably at greater than or equal to 1302 eV and less than 1304 eV, further preferably approximately 1303 eV. This bonding energy is different from that of magnesium fluoride (1305 eV) and is close to that of magnesium oxide. That is, the positive electrode active material 100 of one embodiment of the present invention containing magnesium is preferably in the bonding state other than magnesium fluoride.

The concentrations of the additive elements X that preferably exist in the surface portion 100a in a large amount, such as magnesium and aluminum, measured by XPS or the like are preferably higher than the concentrations measured by ICP-MS, GD-MS, or the like.

When a cross section is exposed by processing and analyzed by TEM-EDX, the concentrations of magnesium and aluminum in the surface portion 100a are preferably higher than those in the inner portion 100b. For example, in the TEM-EDX analysis, the magnesium concentration preferably attenuates, at a depth of 1 nm from a point where the concentration reaches a peak, to less than or equal to 60% of the peak concentration. In addition, the magnesium concentration preferably attenuates, at a depth of 2 nm from the point where the concentration reaches the peak, to less than or equal to 30% of the peak concentration. An FIB (Focused Ion Beam) can be used for the processing, for example.

In the XPS (X-ray photoelectron spectroscopy) analysis, the number of magnesium atoms is preferably greater than or equal to 0.4 times and less than or equal to 1.5 times the number of cobalt atoms. In the ICP-MS analysis, ratio Mg/Co of the number of magnesium atoms to the number of cobalt atoms is preferably greater than or equal to 0.001 and less than or equal to 0.06. By contrast, it is preferable that nickel, which is one of the transition metals M, not be unevenly distributed in the surface portion 100a but be distributed in the entire positive electrode active material 100. Note that one embodiment of the present invention is not limited thereto in the case where the above-described region where the additive element X is unevenly distributed exists.

### <<ESR>>

As described above, the positive electrode active material of one embodiment of the present invention preferably contains cobalt and nickel as the transition metal M and magnesium as the additive element. It is preferable that Ni²⁺ be substituted for part of Co³⁺ and Mg²⁺ be substituted for part of Li⁺ accordingly. Accompanying the substitution of Mg²⁺ for Li⁺, the Ni²⁺ might be reduced to be Ni³⁺. Accompanying the substitution of Mg²⁺ for part of Li⁺, Co³⁺ in the vicinity of Mg²⁺ might be reduced to be Co²⁺. Accompanying the substitution of Mg²⁺ for part of Co³⁺, Co³⁺ in the vicinity of Mg²⁺ might be oxidized to be Co⁴⁺.

Thus, the positive electrode active material of one embodiment of the present invention preferably contains one or more of Ni²⁺, Ni³⁺, Co²⁺, and Co⁴⁺. Moreover, the spin density attributed to one or more of Ni²⁺, Ni³⁺, Co²⁺, and Co⁴⁺ per weight of the positive electrode active material is preferably higher than or equal to 2.0×10¹⁷ spins/g and less than or equal to 1.0×10²¹ spins/g. The positive electrode active material preferably has the above spin density, in which case the crystal structure can be stable particularly in a charged state. Note that too high a magnesium concentration might reduce the spin density attributed to one or more of Ni²⁺, Ni³⁺, Co²⁺, and Co⁴⁺.

The spin density of a positive electrode active material can be analyzed by electron spin resonance (ESR), for example.

### <<EPMA>>

Quantitative analysis of elements can be conducted by EPMA (electron probe microanalysis). In area analysis, distribution of each element can be analyzed.

In EPMA, a region from a surface to a depth of approximately 1 μm is analyzed. Thus, the concentration of each element is sometimes different from measurement results obtained by other analysis methods. For example, when area analysis is performed on the positive electrode active material 100, the concentration of the additive element X existing in the surface portion might be lower than the concentration obtained in XPS. The concentration of the additive element X existing in the surface portion might be higher than the concentration obtained in ICP-MS or a value based on the ratio of the raw materials mixed in the process of forming the positive electrode active material.

EPMA area analysis of a cross section of the positive electrode active material 100 of one embodiment of the present invention preferably reveals a concentration gradient in which the concentration of the additive element X increases from the inner portion toward the surface portion. Specifically, each of magnesium, fluorine, titanium, and silicon preferably has a concentration gradient in which the concentration increases from the inner portion toward the surface of the positive electrode active material 100 as shown in FIG. 4C1. The concentration of aluminum preferably has a peak in a region deeper than the region where the concentration of any of the above elements has a peak, as shown in FIG. 4C2. The aluminum concentration peak may be located in the surface portion or located deeper than the surface portion.

Note that the surface and the surface portion of the positive electrode active material of one embodiment of the present invention do not contain a carbonate, a hydroxy group, or the like which is chemisorbed after formation of the positive electrode active material. Furthermore, an electrolyte solution, a binder, a conductive additive, and a compound originating from any of these that are attached to the surface of the positive electrode active material are not contained either. Thus, in quantitative analysis of the elements contained in the positive electrode active material, correction may be performed to exclude carbon, hydrogen, excess oxygen, excess fluorine, and the like that might be detected in area analysis such as XPS and EPMA. For example, in XPS, the kinds of bonds can be identified by analysis, and a C—F bond originating from a binder may be excluded by correction.

Furthermore, before any of various kinds of analyses is performed, a sample such as a positive electrode active material and a positive electrode active material layer may be washed, for example, to eliminate an electrolyte solution, a binder, a conductive additive, and a compound originating from any of these that are attached to the surface of the positive electrode active material. Although lithium might be dissolved into a solvent or the like used in the washing at this time, the additive element X is not easily dissolved even in that case; thus, the atomic ratio of the additive element X is not affected

### <<Surface Roughness and Specific Surface Area>>

The positive electrode active material 100 of one embodiment of the present invention preferably has a smooth surface with little unevenness. A smooth surface with little unevenness indicates favorable distribution of the additive element in the surface portion 100a.

A smooth surface with little unevenness can be recognized from, for example, a cross-sectional SEM image or a cross-sectional TEM image of the positive electrode active material 100 or the specific surface area of the positive electrode active material 100.

The level of the surface smoothness of the positive electrode active material 100 can be quantified from its cross-sectional SEM image, as described below, for example.

First, the positive electrode active material 100 is processed with an FIB or the like such that its cross section is exposed. At this time, the positive electrode active material 100 is preferably covered with a protective film, a protective material, or the like. Next, a SEM image of the interface between the positive electrode active material 100 and the protective film or the like is taken. The SEM image is subjected to noise processing using image processing software. For example, the Gaussian Blur (=2) is performed, followed by binarization. In addition, interface extraction is performed using image processing software. Moreover, an interface line between the positive electrode active material 100 and the protective film or the like is selected with an automatic selection tool or the like, and data is extracted to spreadsheet software or the like. With the use of the function of the spreadsheet software or the like, correction is performed using regression curves (quadratic regression), parameters for calculating roughness are obtained from data subjected to slope correction, and root-mean-square (RMS) surface roughness is obtained by calculating standard deviation. This surface roughness refers to the surface roughness of part of the particle periphery (at least 400 nm) of the positive electrode active material.

On the surface of the particle of the positive electrode active material 100 of this embodiment, root-mean-square (RMS) surface roughness, which is an index of roughness, is preferably less than 3 nm, further preferably less than 1 nm, still further preferably less than 0.5 nm.

Note that the image processing software used for the noise processing, the interface extraction, or the like is not particularly limited, and for example, “ImageJ” can be used. In addition, the spreadsheet software or the like is not particularly limited, and Microsoft Office Excel can be used, for example.

For example, the level of surface smoothness of the positive electrode active material 100 can also be quantified from the ratio of an actual specific surface area A_{R} measured by a constant-volume gas adsorption method to an ideal specific surface area Aᵢ.

The ideal specific surface area Aᵢ is calculated on the assumption that all the particles have the same diameter as the median diameter (D50), have the same weight, and have ideal spherical shapes.

The median diameter (D50) can be measured with a particle size analyzer or the like using a laser diffraction and scattering method. The specific surface area can be measured with a specific surface area analyzer or the like by a constant-volume gas adsorption method, for example.

In the positive electrode active material 100 of one embodiment of the present invention, the ratio of the actual specific surface area A_{R} to the ideal specific surface area Aᵢ obtained from the median diameter (D50) (A_{R}/Aᵢ) is preferably less than or equal to 2.1.

The level of the surface smoothness of the positive electrode active material 100 can be quantified from its cross-sectional SEM image by the following method, for example.

First, a surface SEM image of the positive electrode active material 100 is taken. At this time, conductive coating may be performed as pretreatment for observation. The surface to be observed is preferably vertical to an electron beam. In the case of comparing a plurality of samples, the same measurement conditions and the same observation area are adopted.

Then, the above SEM image is converted into an 8-bit image (which is referred to as a grayscale image) with the use of image processing software (e.g., ImageJ). The grayscale image includes luminance (brightness information). For example, in an 8-bit grayscale image, luminance can be represented by 2⁸=256 gradation levels. A dark portion has a low gradation level and a bright portion has a high gradation level. A variation in luminance can be quantified in relation to the number of gradation levels. The value obtained by the quantification is referred to as a grayscale value. By obtaining such a grayscale value, the unevenness of the positive electrode active material can be evaluated quantitatively.

In addition, a variation in luminance in a target region can also be represented with a histogram. A histogram three-dimensionally shows distribution of gradation levels in a target region and is also referred to as a luminance histogram. A luminance histogram enables visually easy-to-understand evaluation of unevenness of the positive electrode active material.

In the positive electrode active material 100 of one embodiment of the present invention, the difference between the maximum grayscale value and the minimum grayscale value is preferably less than or equal to 120, further preferably less than or equal to 115, still further preferably greater than or equal to 70 and less than or equal to 115. The standard deviation of the grayscale value is preferably less than or equal to 11, further preferably less than or equal to 8, still further preferably greater than or equal to 4 and less than or equal to 8.

This embodiment can be used in combination with any of the other embodiments.

### Embodiment 3

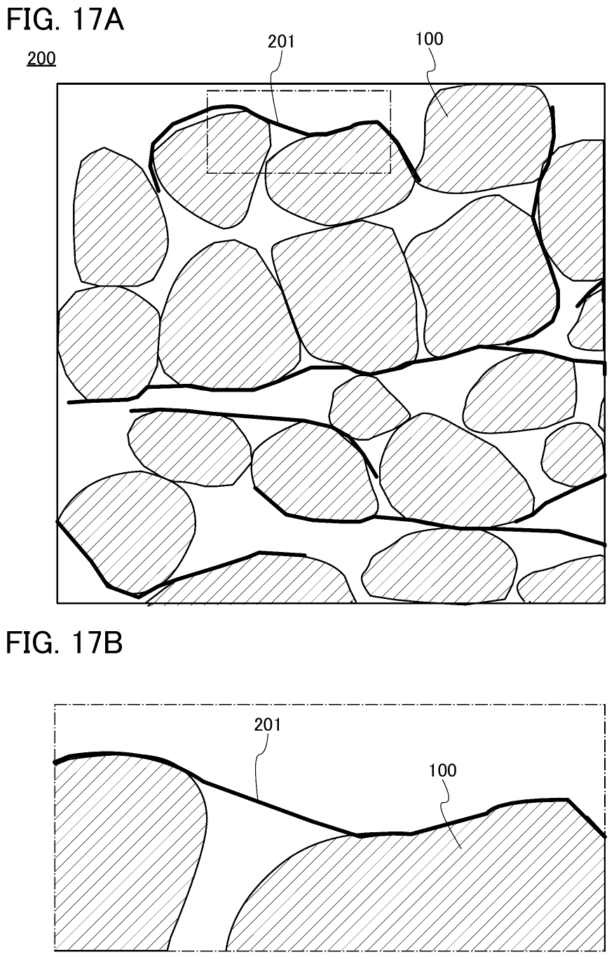

In this embodiment, examples of a secondary battery of one embodiment of the present invention are described with reference to FIG. 17 to FIG. 20.

### Structure Example 1 of Secondary Battery

Hereinafter, a secondary battery in which a positive electrode, a negative electrode, and an electrolyte solution are wrapped in an exterior body is described as an example.

### [Positive Electrode]

The positive electrode includes a positive electrode active material layer and a positive electrode current collector. The positive electrode active material layer includes a positive electrode active material, and may include a conductive additive and a binder. As the positive electrode active material, the positive electrode active material formed by the formation method described in the above embodiments is used.

The positive electrode active material described in the above embodiments and another positive electrode active material may be mixed to be used.

Example of the another positive electrode active material include a composite oxide with an olivine crystal structure, a composite oxide with a layered rock-salt crystal structure, and a composite oxide with a spinel crystal structure. For example, a compound such as LiFePO₄, LiFeO₂, LiNiO₂, LiMn₂O₄, V₂O₅, Cr₂O₅, or MnO₂ can be used.

As the another positive electrode active material, it is preferable to mix lithium nickel oxide (LiNiO₂, LiNi₁₋ₓMₓO₂ (0<x<1) (M=Co, Al, or the like), or the like) with a lithium-containing material that has a spinel crystal structure and contains manganese, such as LiMn₂O₄. This composition can improve the characteristics of the secondary battery.

The applicable another example of the positive electrode active material is a lithium-manganese composite oxide that can be represented by a composition formula LiₐMn_{b}M_{c}O_{d}. Here, the element M is preferably silicon, phosphorus, or a metal element other than lithium and manganese, further preferably nickel. In the case where the whole lithium-manganese composite oxide is measured, it is preferable to satisfy the following at the time of discharging: 0<a/(b+c)<2; c>0); and 0.26≤(b+c)/d<0.5. Note that the proportions of metals, silicon, phosphorus, and the like in the whole lithium-manganese composite oxide can be measured with, for example, an ICP-MS (inductively coupled plasma mass spectrometer). The proportion of oxygen in the whole lithium-manganese composite oxide can be measured by, for example, EDX. Alternatively, the proportion of oxygen can be measured by ICP-MS analysis combined with fusion gas analysis and valence evaluation of XAFS (X-ray absorption fine structure) analysis. Note that the lithium-manganese composite oxide is an oxide containing at least lithium and manganese, and may contain at least one selected from chromium, cobalt, aluminum, nickel, iron, magnesium, molybdenum, zinc, indium, gallium, copper, titanium, niobium, silicon, phosphorus, and the like.

A cross-sectional structure example of an active material layer 200 containing graphene or a graphene compound as a conductive additive is described below.

FIG. 17A is a longitudinal cross-sectional view of the active material layer 200. The active material layer 200 includes particles of the positive electrode active material 100, graphene or a graphene compound 201 serving as the conductive additive, and a binder (not illustrated).

The graphene compound 201 in this specification and the like refers to multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound may include a functional group. The graphene compound is preferably bent. The graphene compound may be rounded like a carbon nanofiber.

In this specification and the like, graphene oxide contains carbon and oxygen, has a sheet-like shape, and includes a functional group, in particular, an epoxy group, a carboxy group, or a hydroxy group.

In this specification and the like, reduced graphene oxide contains carbon and oxygen, has a sheet-like shape, and has a two-dimensional structure formed of a six-membered ring composed of carbon atoms. The reduced graphene oxide may also be referred to as a carbon sheet. The reduced graphene oxide functions by itself and may have a stacked-layer structure. The reduced graphene oxide preferably includes a portion where the carbon concentration is higher than 80 atomic % and the oxygen concentration is higher than or equal to 2 atomic % and lower than or equal to 15 atomic %. With such a carbon concentration and such an oxygen concentration, the reduced graphene oxide can function as a conductive additive with high conductivity even with a small amount. In addition, the intensity ratio G/D of a G band to a D band of the Raman spectrum of the reduced graphene oxide is preferably 1 or more. The reduced graphene oxide with such an intensity ratio can function as a conductive additive with high conductivity even with a small amount.

A graphene compound sometimes has excellent electrical characteristics of high conductivity and excellent physical properties of high flexibility and high mechanical strength. A graphene compound has a sheet-like shape. A graphene compound has a curved surface in some cases, thereby enabling low-resistant surface contact. Furthermore, a graphene compound sometimes has extremely high conductivity even with a small thickness, and thus a small amount of a graphene compound efficiently allows a conductive path to be formed in an active material layer. Hence, a graphene compound is preferably used as the conductive additive, in which case the area where the active material and the conductive additive are in contact with each other can be increased. The graphene compound preferably covers 80% or more of the active material. Note that the graphene compound preferably clings to at least part of an active material particle. The graphene compound preferably overlays at least part of the active material particle. The shape of the graphene compound preferably conforms to at least part of the shape of the active material particle. The shape of an active material particle means, for example, unevenness of a single active material particle or unevenness formed by a plurality of active material particles. The graphene compound preferably surrounds at least part of an active material particle. The graphene compound may have a hole.

In the case where active material particles with a small diameter (e.g., 1 μm or less) are used, the specific surface area of the active material particles is large and thus more conductive paths for the active material particles are needed. In such a case, it is particularly preferable to use a graphene compound that can efficiently form a conductive path even with a small amount.

It is particularly effective to use a graphene compound, which has the above-described properties, as a conductive additive of a secondary battery that needs to be rapidly charged and discharged. For example, a secondary battery for a two- or four-wheeled vehicle, a secondary battery for a drone, or the like is required to have fast charge and fast discharge characteristics in some cases. In addition, a mobile electronic device or the like is required to have fast charge characteristics in some cases. Fast charge and fast discharge may also be referred to as charge at a high rate and discharge at a high rate, for example, at 1 C, 2 C, or 5 C or more.

The longitudinal cross section of the active material layer 200 in FIG. 17B shows substantially uniform dispersion of the sheet-like graphene or the graphene compound 201 in the active material layer 200. The graphene or the graphene compound 201 is schematically shown by the thick line in FIG. 17B but is actually a thin film having a thickness corresponding to the thickness of a single layer or a multi-layer of carbon molecules. A plurality of sheets of graphene or the plurality of graphene compounds 201 are formed to partly cover or adhere to the surfaces of the plurality of particles of the positive electrode active material 100, so that the plurality of sheets of graphene or the plurality of graphene compounds 201 make surface contact with the particles of the positive electrode active material 100.

Here, the plurality of sheets of graphene or the plurality of graphene compounds can be bonded to each other to form a net-like graphene compound sheet (hereinafter, referred to as a graphene compound net or a graphene net). A graphene net that covers the active material can function as a binder for bonding the active material particles. Accordingly, the amount of the binder can be reduced, or the binder does not have to be used. This can increase the proportion of the active material in the electrode volume and the electrode weight. That is to say, the charge and discharge capacity of the secondary battery can be increased.

Here, it is preferable to perform reduction after a layer to be the active material layer 200 is formed in such a manner that graphene oxide is used as the graphene or the graphene compound 201 and mixed with an active material. That is, the formed active material layer preferably contains reduced graphene oxide. When graphene oxide with extremely high dispersibility in a polar solvent is used for the formation of the graphene or the graphene compound 201, the graphene or the graphene compound 201 can be substantially uniformly dispersed in the active material layer 200. The solvent is removed by volatilization from a dispersion medium in which graphene oxide is uniformly dispersed, and the graphene oxide is reduced; hence, the sheets of graphene or the graphene compounds 201 remaining in the active material layer 200 partly overlap with each other and are dispersed such that surface contact is made, thereby forming a three-dimensional conduction path. Note that graphene oxide can be reduced by heat treatment or with the use of a reducing agent, for example.

Unlike a conductive material in the form of particles, such as acetylene black, which makes point contact with an active material, the graphene or the graphene compound 201 is capable of making low-resistance surface contact; accordingly, the electrical conduction between the particles of the positive electrode active material 100 and the graphene or the graphene compound 201 can be improved with a small amount of the graphene and the graphene compound 201 compared with a normal conductive material. Thus, the proportion of the positive electrode active material 100 in the active material layer 200 can be increased, resulting in increased discharge capacity of the secondary battery.

It is possible to form, with a spray dry apparatus, a graphene compound serving as a conductive material as a coating film to cover the entire active material in advance and to form a conductive path between the active materials using the graphene compound.

A material used in formation of the graphene compound may be mixed with the graphene compound to be used for the active material layer 200. For example, particles used as a catalyst in formation of the graphene compound may be mixed with the graphene compound. As an example of the catalyst in formation of the graphene compound, particles containing any of silicon oxide (SiO₂ or SiOₓ (x<2)), aluminum oxide, iron, nickel, ruthenium, iridium, platinum, copper, germanium, and the like can be given. The median diameter (D50) of the particles is preferably less than or equal to 1 μm, further preferably less than or equal to 100 nm.

### [Binder]

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Fluororubber can also be used as the binder.

As the binder, for example, water-soluble polymers are preferably used. As the water-soluble polymers, a polysaccharide can be used, for example. As the polysaccharide, one or more of starch, cellulose derivatives such as carboxymethyl cellulose (CMC), methyl cellulose, ethyl cellulose, hydroxypropyl cellulose, diacetyl cellulose, and regenerated cellulose, and the like can be used. It is further preferable that such water-soluble polymers be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

Two or more of the above materials may be used in combination for the binder.

For example, a material having a significant viscosity modifying effect and another material may be used in combination. For example, a material having elasticity, typically a rubber material or the like, has high adhesion and/or high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. As a water-soluble polymer having a significant viscosity modifying effect, the above-mentioned polysaccharide, for instance, a cellulose derivative such as carboxymethyl cellulose (CMC), methyl cellulose, ethyl cellulose, hydroxypropyl cellulose, diacetyl cellulose, or regenerated cellulose or starch can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material and other components in the formation of a slurry for an electrode. In this specification, cellulose and a cellulose derivative used as a binder of an electrode include salts thereof.

A water-soluble polymer stabilizes the viscosity by being dissolved in water and allows stable dispersion of the active material and another material combined as a binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers or is in contact with the active material surface forms a film, the film is expected to serve also as a passivation film to suppress the decomposition of the electrolyte solution. Here, a passivation film refers to a film without electric conductivity or a film with extremely low electric conductivity, and can inhibit the decomposition of an electrolyte solution at a potential at which a battery reaction occurs when the passivation film is formed on the active material surface, for example. It is preferable that the passivation film can conduct lithium ions while suppressing electrical conduction.

### [Positive Electrode Current Collector]

The positive electrode current collector can be formed using a material that has high conductivity, such as a metal like stainless steel, gold, platinum, aluminum, or titanium, or an alloy thereof. It is preferable that a material used for the positive electrode current collector not be eluted at the potential of the positive electrode. It is also possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The positive electrode current collector can have a foil-like shape, a plate-like shape, a sheet-like shape, a net-like shape, a punching-metal shape, an expanded-metal shape, or the like as appropriate. The positive electrode current collector preferably has a thickness greater than or equal to 5 μm and less than or equal to 30 μm.

Slurry containing the above positive electrode active material, the above binder, a solvent, a conductive additive, and the like is applied to the positive electrode current collector, and then press working is performed, whereby the positive electrode can be obtained. As the solvent. NMP can be used. Preferably, a press machine is used in press working, and the slurry is heated while the temperature of each of first and second rolls included in the press machine is set to higher than or equal to 80° C. and lower than or equal to 150° C. preferably higher than or equal to 100° C. and lower than or equal to 130° C. When the temperature of the rolls is high, the electrode density can be increased. Note that the temperature is preferably lower than or equal to the melting point of the binder, for example. The melting point of PVDF used as the binder, for example, is higher than or equal to 158° C. and lower than or equal to 160° C. The pressure in the pressing is higher than or equal to 100 kN/m and lower than or equal to 300 kN/m, preferably higher than or equal to 150 kN/m and lower than or equal to 250 kN/m, further preferably higher than or equal to 190 kN/m and lower than or equal to 230 kN/m. In the case where pressing is performed a plurality of times, the pressure in the second pressing is greater than or equal to 5 times and less than or equal to 8 times, preferably greater than or equal to 6 times and less than or equal to 7 times the pressure in the first pressing.

### [Negative Electrode]

The negative electrode includes a negative electrode active material layer and a negative electrode current collector. The negative electrode active material layer may contain a conductive additive and a binder.

### [Negative Electrode Active Material]

As a negative electrode active material, for example, an alloy-based material or a carbon-based material can be used.

For the negative electrode active material, an element that enables charge and discharge reactions by an alloying reaction and a dealloying reaction with lithium can be used. For example, a material containing at least one of silicon, tin, gallium, aluminum, germanium, lead, antimony, bismuth, silver, zinc, cadmium, indium, and the like can be used. Such elements have higher charge and discharge capacity than carbon; in particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, NisSn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by an alloying reaction and a dealloying reaction with lithium, a compound containing the element, and the like may be referred to as an alloy-based material.

In this specification and the like, SiO refers, for example, to silicon monoxide. Note that SiO can alternatively be expressed as SiOₓ. Here, x preferably has an approximate value of 1. For example, x is preferably greater than or equal to 0.2 and less than or equal to 1.5, further preferably greater than or equal to 0.3 and less than or equal to 1.2. Alternatively, x is preferably greater than or equal to 0.2 and less than or equal to 1.2. Still alternatively, x is preferably greater than or equal to 0.3 and less than or equal to 1.5.

As the carbon-based material, graphite, graphitizing carbon (soft carbon), non-graphitizing carbon (hard carbon), carbon nanotube, graphene, carbon black, or the like can be used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (greater than or equal to 0.05 V and less than or equal to 0.3 V vs. Li/Li⁺) when lithium ions are inserted into graphite (while a lithium-graphite intercalation compound is formed). For this reason, a lithium-ion secondary battery can have a high operating voltage. In addition, graphite is preferred because of its advantages such as a relatively high charge and discharge capacity per unit volume, relatively small volume expansion, low cost, and a higher level of safety than that of a lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M=Co, Ni, or Cu) with a Li₃N structure, which is a composite nitride of lithium and a transition metal, can be used. For example, Li_{2.6}Co_{0.4}N₃ is preferable because of high charge and discharge capacity (900 mAh/g and 1890 mAh/cm³).

A composite nitride containing lithium and a transition metal is preferably used, in which case lithium ions are contained in the negative electrode active material and thus the negative electrode active material can be used in combination with a material for a positive electrode active material that does not contain lithium ions, such as V₂O₅ or Cr₃O₈. Note that in the case of using a material containing lithium ions as a positive electrode active material, the composite nitride containing lithium and a transition metal can be used as the negative electrode active material by extracting the lithium ions contained in the positive electrode active material in advance.

Alternatively, a material that causes a conversion reaction can be used for the negative electrode active material. For example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive additive and the binder that can be included in the negative electrode active material layer, materials similar to those for the conductive additive and the binder that can be included in the positive electrode active material layer can be used.

### [Negative Electrode Current Collector]

For the negative electrode current collector, a material similar to that of the positive electrode current collector can be used. Note that a material that is not alloyed with carrier ions of lithium or the like is preferably used for the negative electrode current collector.

Slurry containing the above negative electrode active material, the above binder, a solvent, a conductive additive, and the like is applied to the negative electrode current collector, and then press working is performed, whereby the positive electrode can be obtained. As the solvent, NMP can be used. Preferably, a press machine is used in press working, and the slurry is heated while the temperature of each of first and second rolls included in the press machine is set to higher than or equal to 80° C. and lower than or equal to 150° C., preferably higher than or equal to 100° C. and lower than or equal to 130° C. When the temperature of the rolls is high, the electrode density can be increased. Note that the temperature is preferably lower than or equal to the melting point of the binder, for example. The melting point of PVDF used as the binder, for example, is higher than or equal to 158° C. and lower than or equal to 160° C. The pressure in the pressing is higher than or equal to 100 kN/m and lower than or equal to 300 kN/m, preferably higher than or equal to 150 kN/m and lower than or equal to 250 kN/m, further preferably higher than or equal to 190 kN/m and lower than or equal to 230 kN/m. In the case where pressing is performed a plurality of times, the pressure in the second pressing is greater than or equal to 5 times and less than or equal to 8 times, preferably greater than or equal to 6 times and less than or equal to 7 times the pressure in the first pressing.

### [Electrolyte Solution]

The electrolyte solution contains a solvent and an electrolyte. As the solvent of the electrolyte solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more kinds of these can be used in an appropriate combination at an appropriate ratio.

The use of one or more kinds of ionic liquids (room temperature molten salts) which have features of non-flammability and non-volatility as the solvent of the electrolyte solution can prevent a secondary battery from exploding and/or catching fire, for example, even when the secondary battery internally shorts out or the internal temperature increases owing to overcharge or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As an electrolyte dissolved in the above-described solvent, one of lithium salts such as LiPF₆, LiClO₄, LiASF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(FSO₂)₂, LiN(CF₃SO₂)₂, LiN(C₄F₉SO₂) (CF₃SO₂), and LiN(C₂F₅SO₂)₂ can be used, or two or more kinds of these can be used in an appropriate combination in an appropriate ratio.

The electrolyte solution used for a secondary battery is preferably highly purified and contains small contents of dust particles or elements other than the constituent elements of the electrolyte solution (hereinafter, also simply referred to as “impurities”). Specifically, the weight ratio of impurities to the electrolyte solution is preferably less than or equal to 1%, further preferably less than or equal to 0.1%, still further preferably less than or equal to 0.01%.

Furthermore, an additive agent such as vinylene carbonate (VC), propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of the material to be added in the whole solvent is, for example, higher than or equal to 0.1 wt % and lower than or equal to 5 wt %. VC or LiBOB is particularly preferable because it facilitates formation of a favorable coating film.

A polymer gel electrolyte obtained in such a manner that a polymer is swelled with an electrolyte solution may be used.

When a polymer gel electrolyte is used, safety against liquid leakage and the like is improved. Moreover, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP), can be used. The formed polymer may be porous.

Instead of the electrolyte solution, a solid electrolyte including an inorganic material such as a sulfide-based or oxide-based inorganic material, a solid electrolyte including a polymer material such as a PEO (polyethylene oxide)-based high-molecular material, or the like can be used. When the solid electrolyte is used, a separator and/or a spacer is not necessary. Furthermore, the battery can be entirely solidified; therefore, there is no possibility of liquid leakage and thus the safety of the battery is dramatically improved.

### [Exterior Body]

For an exterior body included in the secondary battery, a metal material such as aluminum or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

### Structure Example 2 of Secondary Battery

A structure of a secondary battery including a solid electrolyte layer is described below as another structure example of a secondary battery.

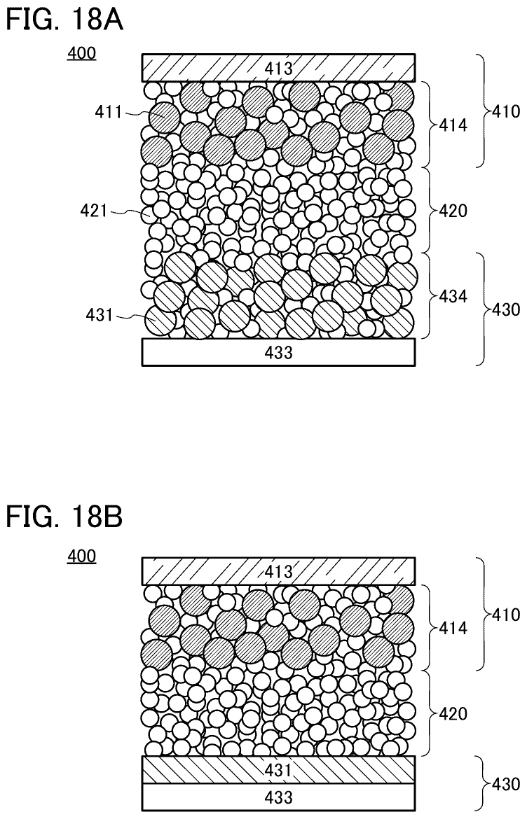

As illustrated in FIG. 18A, a secondary battery 400 of one embodiment of the present invention includes a positive electrode 410, a solid electrolyte layer 420, and a negative electrode 430.

The positive electrode 410 includes a positive electrode current collector 413 and a positive electrode active material layer 414. The positive electrode active material layer 414 includes a positive electrode active material 411 and a solid electrolyte 421. As the positive electrode active material 411, the positive electrode active material fabricated by the fabrication method described in the above embodiments is used. The positive electrode active material layer 414 may also include a conductive additive and a binder.

The solid electrolyte layer 420 includes the solid electrolyte 421. The solid electrolyte layer 420 is positioned between the positive electrode 410 and the negative electrode 430 and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may include a conductive additive and a binder. Note that when metal lithium is used for the negative electrode 430, it is possible that the negative electrode 430 does not include the solid electrolyte 421 as illustrated in FIG. 18B. The use of metal lithium for the negative electrode 430 is preferable because the energy density of the secondary battery 400 can be increased.

As the solid electrolyte 421 included in the solid electrolyte layer 420, a sulfide-based solid electrolyte, an oxide-based solid electrolyte, or a halide-based solid electrolyte can be used, for example.

The sulfide-based solid electrolyte includes a thio-LISICON-based material (e.g., Li₁₀GeP₂S₁₂ or Li_{3.25}Ge_{0.25}P_{0.75}S₄), sulfide glass (e.g., 70Li₂S·30P₂S₅, 30Li₂S·26B₂S₃·44LiI, 63Li₂S·36SiS₂·1Li₃PO₄, 57Li₂S·38SiS₂·5Li₄SiO₄, or 50Li₂S·50GeS₂), or sulfide-based crystallized glass (e.g., Li₇P₃S₁₁ or Li_{3.25}P_{0.95}S₄). The sulfide-based solid electrolyte has advantages such as high conductivity of some materials, low-temperature synthesis, and ease of maintaining a path for electrical conduction after charge and discharge because of its relative softness.

Examples of the oxide-based solid electrolyte include a material with a perovskite crystal structure (e.g., La_{2/3-x}Li₃ₓTiO₃), a material with a NASICON crystal structure (e.g., Li₁₊ₓAlₓTi₂₋ₓ(PO₄)₃), a material with a garnet crystal structure (e.g., Li₇La₃Zr₂O₁₂), a material with a LISICON crystal structure (e.g., Li₁₄ZnGe₄O₁₆), oxide glass (e.g., Li₃PO₄—Li₄SiO₄ and 50Li₄SiO₄·50Li₃BO₃), and oxide-based crystallized glass (e.g., Li_{1.07}Al_{0.69} Ti_{1.46}(PO₄)₃ and Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and LiI. Moreover, a composite material in which pores of porous aluminum oxide and/or porous silica are filled with such a halide-based solid electrolyte can be used as the solid electrolyte.

Different solid electrolytes may be mixed and used.

In particular, Li₁₊ₓAlₓTi₂₋ₓ(PO₄)₃ (0<x<1) having a NASICON crystal structure (hereinafter, LATP) is preferable because it contains aluminum and titanium, each of which is the element the positive electrode active material used in the secondary battery 400 of one embodiment of the present invention is allowed to contain, and thus synergy of improving the cycle performance is expected. Moreover, higher productivity due to the reduction in the number of steps is expected. Note that in this specification and the like, a NASICON crystal structure refers to a compound that is represented by M₂(XO₄)₃ (M: transition metal; X: S, P, As, Mo, W, or the like) and has a structure in which MO₆ octahedrons and XO₄ tetrahedrons that share common corners are arranged three-dimensionally.

### [Exterior Body and Shape of Secondary Battery]

An exterior body of the secondary battery 400 of one embodiment of the present invention can be formed using a variety of materials and have a variety of shapes, and preferably has a function of applying pressure to the positive electrode, the solid electrolyte layer, and the negative electrode.

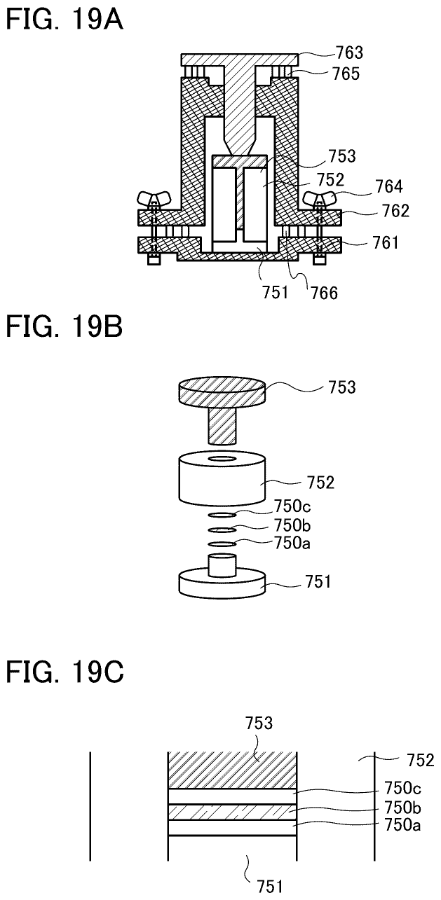

For example, FIG. 19 illustrates an example of a cell for evaluation of materials of an all-solid-state battery.

FIG. 19A is a schematic cross-sectional view of an evaluation cell, the evaluation cell includes a lower component 761, an upper component 762, and a fixation screw and a butterfly nut 764 for fixing them, and by rotating a pressure screw 763, an electrode plate 753 is pressed to fix an evaluation material. An insulator 766 is provided between the lower component 761 and the upper component 762 that are made of a stainless steel material. An O ring 765 for hermetic sealing is provided between the upper component 762 and the pressure screw 763.

The evaluation material is placed on an electrode plate 751, surrounded by an insulating tube 752, and pressed from above by the electrode plate 753. FIG. 19B is an enlarged perspective view of the evaluation material and its vicinity.

A stack of a positive electrode 750a, a solid electrolyte layer 750b, and a negative electrode 750c is shown here as an example of the evaluation material, and its cross section is shown in FIG. 19C. Note that the same portions in FIG. 19A, FIG. 19B, and FIG. 19C are denoted by the same reference numerals.

The electrode plate 751 and the lower component 761 that are electrically connected to the positive electrode 750a correspond to a positive electrode terminal. The electrode plate 753 and the upper component 762 that are electrically connected to the negative electrode 750c correspond to a negative electrode terminal. The electric resistance or the like can be measured while pressure is applied to the evaluation material through the electrode plate 751 and the electrode plate 753.

A package having excellent airtightness is preferably used as the exterior body of the secondary battery of one embodiment of the present invention. For example, a ceramic package and/or a resin package can be used. The exterior body is sealed preferably in a closed atmosphere where the outside air is blocked, for example, in a glove box.

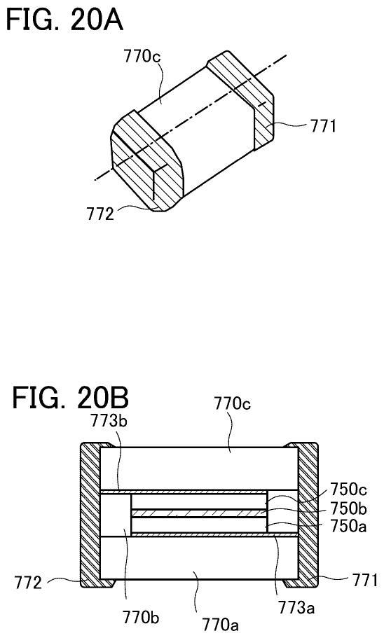

FIG. 20A is a perspective view of a secondary battery of one embodiment of the present invention that has an exterior body and a shape different from those in FIG. 19. The secondary battery in FIG. 20A includes external electrodes 771 and 772 and is sealed with an exterior body including a plurality of package components.

FIG. 20B illustrates an example of a cross section along the dashed-dotted line in FIG. 20A. A stack including the positive electrode 750a, the solid electrolyte layer 750b, and the negative electrode 750c has a structure of being surrounded and sealed by a package component 770a including an electrode layer 773a on a flat plate, a frame-like package component 770b, and a package component 770c including an electrode layer 773b on a flat plate. For the package components 770a, 770b, and 770c, an insulating material such as a resin material and/or a ceramic-based material can be used.

The external electrode 771 is electrically connected to the positive electrode 750a through the electrode layer 773a and functions as a positive electrode terminal. The external electrode 772 is electrically connected to the negative electrode 750c through the electrode layer 773b and functions as a negative electrode terminal.

This embodiment can be used in appropriate combination with the other embodiments.

### Embodiment 4

In this embodiment, examples of a shape of a secondary battery including the positive electrode described in the above embodiment are described. For the materials used for the secondary battery described in this embodiment, the description of the above embodiment can be referred to.

### <Coin-Type Secondary Battery>

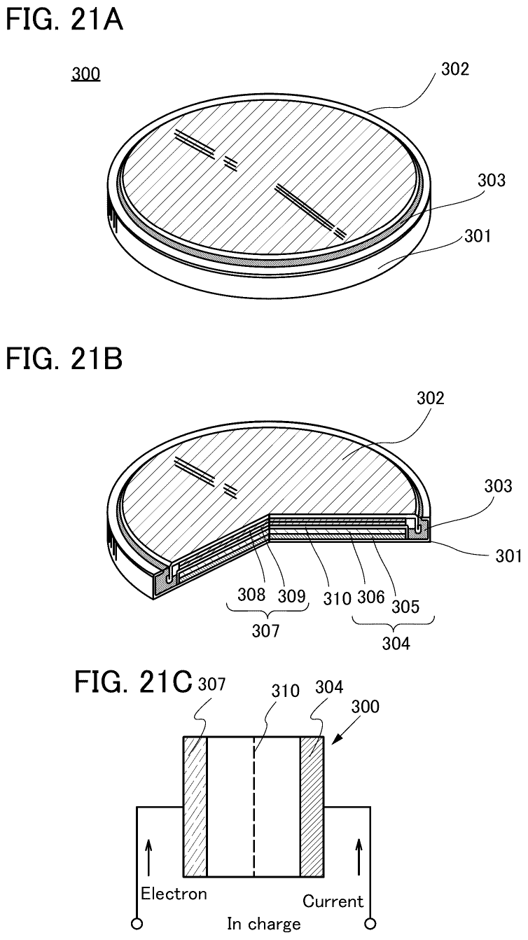

First, an example of a coin-type secondary battery is described. FIG. 21A is an external view of a coin-type (single-layer flat type) secondary battery, and FIG. 21B is a cross-sectional view thereof.

In a coin-type secondary battery 300, a positive electrode can 301 doubling as a positive electrode terminal and a negative electrode can 302 doubling as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. A negative electrode 307 includes a negative electrode current collector 308 and a negative electrode active material layer 309 provided in contact with the negative electrode current collector 308.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. Alternatively, the positive electrode can 301 and the negative electrode can 302 are preferably covered with nickel, aluminum, and/or the like in order to prevent corrosion due to the electrolyte solution. The positive electrode can 301 and the negative electrode can 302 are electrically connected to the positive electrode 304 and the negative electrode 307, respectively.

The negative electrode 307, the positive electrode 304, and a separator 310 are soaked in the electrolyte solution. Then, as illustrated in FIG. 21B, the positive electrode 304, the separator 310, the negative electrode 307, and the negative electrode can 302 are stacked in this order with the positive electrode can 301 positioned at the bottom, and the positive electrode can 301 and the negative electrode can 302 are subjected to pressure bonding with the gasket 303 located therebetween. In such a manner, the coin-type secondary battery 300 is manufactured.

When the positive electrode active material described in the above embodiment is used in the positive electrode 304, the coin-type secondary battery 300 with high charge and discharge capacity and excellent cycle performance can be obtained.

Here, a current flow in charging a secondary battery is described with reference to FIG. 21C. When a secondary battery using lithium is regarded as a closed circuit, movement of lithium ions and the current flow are in the same direction. Note that in the secondary battery using lithium, the anode and the cathode interchange in charge and discharge, and the oxidation reaction and the reduction reaction interchange; hence, an electrode with a high reaction potential is called a positive electrode and an electrode with a low reaction potential is called a negative electrode. For this reason, in this specification, the positive electrode is referred to as a “positive electrode” or a “plus electrode” and the negative electrode is referred to as a “negative electrode” or a “minus electrode” in all the cases where charge is performed, discharge is performed, a reverse pulse current is supplied, and a charge current is supplied. The use of the terms “anode” and “cathode” related to an oxidation reaction and a reduction reaction might cause confusion because the anode and the cathode interchange in charge and discharge. Thus, the terms “anode” and “cathode” are not used in this specification. If the term “anode” or “cathode” is used, it should be mentioned that the anode or the cathode is which of the one at the time of charge or the one at the time of discharge and corresponds to which of a positive (plus) electrode or a negative (minus) electrode.

Two terminals illustrated in FIG. 21C are connected to a charger, and the secondary battery 300 is charged. As the charge of the secondary battery 300 proceeds, a potential difference between electrodes increases.

### <Cylindrical Secondary Battery>

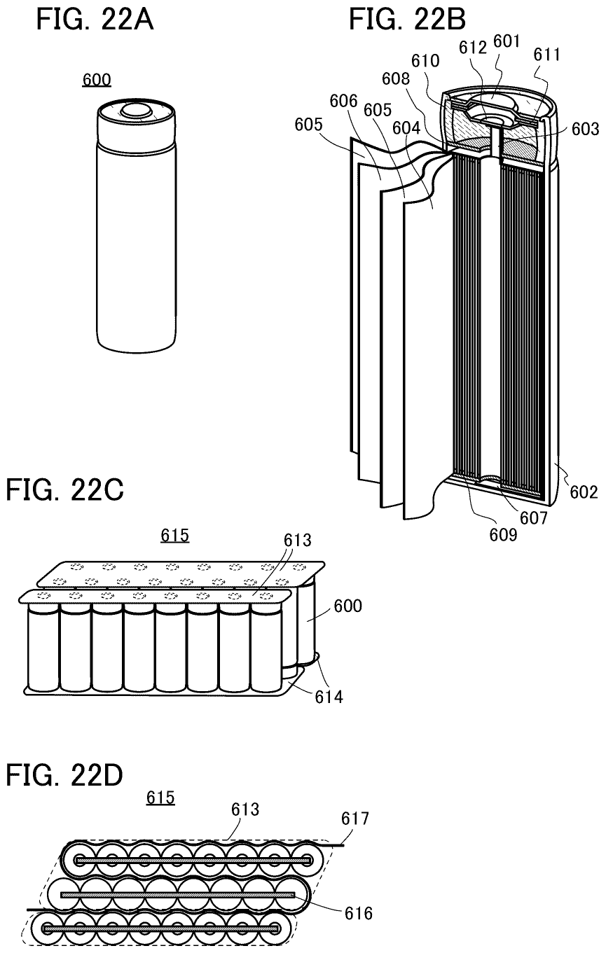

Next, an example of a cylindrical secondary battery is described with reference to FIG. 22. FIG. 22A shows an external view of a cylindrical secondary battery 600. FIG. 22B is a schematic cross-sectional view of the cylindrical secondary battery 600. The cylindrical secondary battery 600 includes, as illustrated in FIG. 22B, a positive electrode cap (battery lid) 601 on the top surface and a battery can (outer can) 602 on a side surface and a bottom surface. The positive electrode cap 601 and the battery can (outer can) 602 are insulated from each other by a gasket (insulating gasket) 610.

Inside the battery can 602 having a hollow cylindrical shape, a battery element in which a strip-like positive electrode 604 and a strip-like negative electrode 606 are wound with a separator 605 located therebetween is provided. Although not illustrated, the battery element is wound around a center pin. One end of the battery can 602 is close and the other end thereof is open. For the battery can 602, a metal having corrosion resistance to an electrolyte solution, such as nickel, aluminum, or titanium, an alloy of such a metal, or an alloy of such a metal and another metal (e.g., stainless steel) can be used. The battery can 602 is preferably covered with nickel, aluminum, and/or the like in order to prevent corrosion due to the electrolyte solution. Inside the battery can 602, the battery element in which the positive electrode, the negative electrode, and the separator are wound is provided between a pair of insulating plates 608 and 609 that face each other. Furthermore, a nonaqueous electrolyte solution (not illustrated) is injected inside the battery can 602 provided with the battery element. As the nonaqueous electrolyte solution, a nonaqueous electrolyte that is similar to that of the coin-type secondary battery can be used.

Since a positive electrode and a negative electrode that are used for a cylindrical storage battery are wound, active materials are preferably formed on both surfaces of a current collector. A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 612 and the bottom of the battery can 602, respectively. The safety valve mechanism 612 is electrically connected to the positive electrode cap 601 through a PTC element (Positive Temperature Coefficient) 611. The safety valve mechanism 612 cuts off electrical connection between the positive electrode cap 601 and the positive electrode 604 when the internal pressure of the battery exceeds a predetermined threshold value. The PTC element 611, which serves as a thermally sensitive resistor whose resistance increases as temperature rises, limits the amount of current by increasing the resistance, in order to prevent abnormal heat generation. Barium titanate (BaTiO₃)-based semiconductor ceramics or the like can be used for the PTC element.

Furthermore, as illustrated in FIG. 22C, a plurality of secondary batteries 600 may be provided between a conductive plate 613 and a conductive plate 614 to form a module 615. The plurality of secondary batteries 600 may be connected in parallel, connected in series, or connected in series after being connected in parallel. With the module 615 including the plurality of secondary batteries 600, large electric power can be extracted.

FIG. 22D is a top view of the module 615. The conductive plate 613 is shown by a dotted line for clarity of the diagram. As illustrated in FIG. 22D, the module 615 may include a wiring 616 electrically connecting the plurality of secondary batteries 600 with each other. It is possible to provide the conductive plate over the wiring 616 to overlap with each other. In addition, a temperature control device 617 may be provided between the plurality of secondary batteries 600. The secondary batteries 600 can be cooled with the temperature control device 617 when overheated, whereas the secondary batteries 600 can be heated with the temperature control device 617 when cooled too much. Thus, the performance of the module 615 is unlikely to be affected by the outside temperature. A heating medium included in the temperature control device 617 preferably has an insulating property and incombustibility.

When the positive electrode active material described in the above embodiment is used in the positive electrode 604, the cylindrical secondary battery 600 with high charge and discharge capacity and excellent cycle performance can be obtained.

### [Separator]

The secondary battery preferably includes a separator. The separator can be formed using, for example, paper, nonwoven fabric, glass fiber, ceramics, or synthetic fiber containing nylon (polyamide), vinylon (polyvinyl alcohol-based fiber), polyester, acrylic, polyolefin, or polyurethane. The separator is preferably formed to have an envelope-like shape to wrap one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, deterioration of the separator in high voltage charge and discharge can be suppressed and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the charge and discharge capacity per volume of the secondary battery can be increased because the safety of the secondary battery can be maintained even when the total thickness of the separator is small.

### <Structure Examples of Secondary Battery>

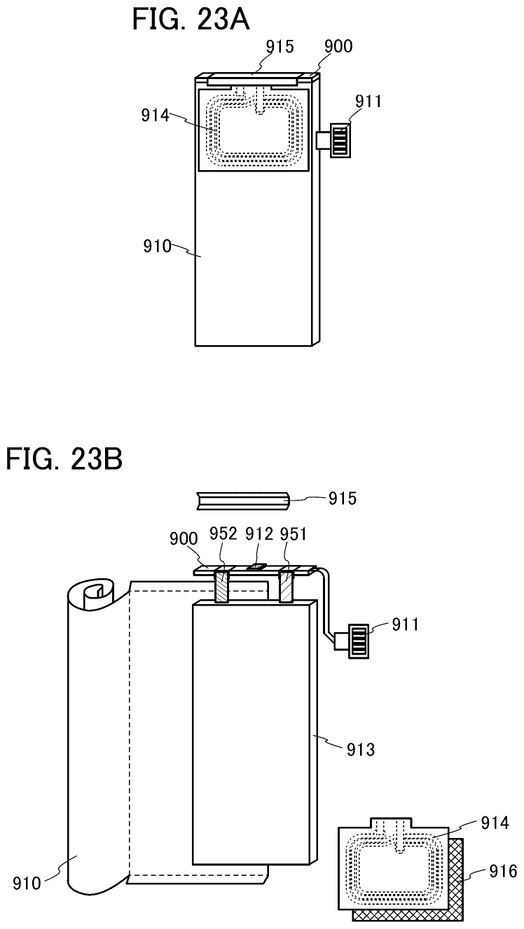

Other structure examples of secondary batteries are described with reference to FIG. 23 to FIG. 27.

FIG. 23A and FIG. 23B are external views of a battery pack. The battery pack includes a secondary battery 913 and a circuit board 900. A secondary battery 913 is connected to an antenna 914 through a circuit board 900. A label 910 is attached to the secondary battery 913. In addition, as illustrated in FIG. 23B, the secondary battery 913 is connected to a terminal 951 and a terminal 952. The circuit board 900 is fixed with a seal 915.

The circuit board 900 includes a terminal 911 and a circuit 912. The terminal 911 is connected to the terminal 951, the terminal 952, the antenna 914, and the circuit 912. Note that a plurality of terminals 911 may be provided to serve as a control signal input terminal, a power supply terminal, and the like.

The circuit 912 may be provided on the rear surface of the circuit board 900. Note that the shape of the antenna 914 is not limited to coil shapes, and may be a linear shape or a plate shape, for example. An antenna such as a planar antenna, an aperture antenna, a traveling-wave antenna, an EH antenna, a magnetic-field antenna, or a dielectric antenna may be used. Alternatively, the antenna 914 may be a flat-plate conductor. The flat-plate conductor can serve as one of conductors for electric field coupling. That is, the antenna 914 may serve as one of two conductors of a capacitor. Thus, electric power can be transmitted and received not only by an electromagnetic field or a magnetic field but also by an electric field.

The battery pack includes a layer 916 between the antenna 914 and the secondary battery 913. The layer 916 has a function of blocking an electromagnetic field by the secondary battery 913, for example. As the layer 916, for example, a magnetic body can be used.

Note that the structure of the battery pack is not limited to that in FIG. 23.

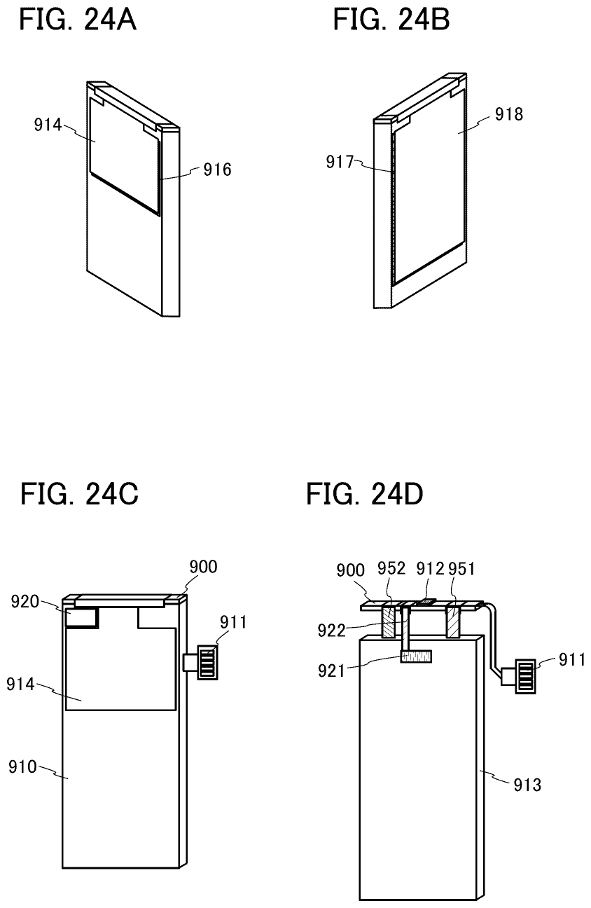

For example, as illustrated in FIG. 24A and FIG. 24B, two opposite surfaces of the secondary battery 913 illustrated in FIG. 23A and FIG. 23B may be provided with respective antennas. FIG. 24A is an external view seen from one side of the opposite surfaces, and FIG. 24B is an external view seen from the other side of the opposite surfaces. Note that in the secondary battery illustrated in FIG. 24A and FIG. 24B, for the description of portions identical to portions similar to those of the secondary battery illustrated in FIG. 23A and FIG. 23B, the description thereof can be appropriately referred to and the description is omitted here.

As illustrated in FIG. 24A, the antenna 914 is provided on one of the opposite surfaces of the secondary battery 913 with the layer 916 located therebetween, and as illustrated in FIG. 24B, an antenna 918 is provided on the other of the opposite surfaces of the secondary battery 913 with a layer 917 located therebetween. The layer 917 has a function of blocking an electromagnetic field by the secondary battery 913, for example. As the layer 917, for example, a magnetic body can be used.

With the above structure, both of the antenna 914 and the antenna 918 can be increased in size. The antenna 918 has a function of communicating data with an external device, for example. An antenna with a shape that can be used for the antenna 914, for example, can be used as the antenna 918. As a system for communication using the antenna 918 between the secondary battery and another device, a response method that can be used between the secondary battery and another device, such as NFC (near field communication), can be employed.

Alternatively, as illustrated in FIG. 24C, the secondary battery 913 illustrated in FIG. 23A and FIG. 23B may be provided with a display device 920. The display device 920 is electrically connected to the terminal 911. Note that the label 910 is not necessarily provided in a portion where the display device 920 is provided. Note that in the secondary battery illustrated in FIG. 24C, for the description of portions identical to portions similar to those of the secondary battery illustrated in FIG. 23A and FIG. 23B, the description thereof can be appropriately referred to and the description is omitted here.

The display device 920 may display, for example, an image showing whether charge is being carried out, an image showing the amount of stored power, or the like. As the display device 920, electronic paper, a liquid crystal display device, an electroluminescent (EL) display device, or the like can be used. For example, the use of electronic paper can reduce power consumption of the display device 920.

Alternatively, as illustrated in FIG. 24D, the secondary battery 913 illustrated in FIG. 23A and FIG. 23B may be provided with a sensor 921. The sensor 921 is electrically connected to the terminal 911 via a terminal 922. Note that in the secondary battery illustrated in FIG. 24D, for the description of portions identical to portions similar to those of the secondary battery illustrated in FIG. 23A and FIG. 23B, the description thereof can be appropriately referred to and the description is omitted here.

The sensor 921 has a function of measuring, for example, displacement, position, speed, acceleration, angular velocity, rotational frequency, distance, light, liquid, magnetism, temperature, chemical substance, sound, time, hardness, electric field, current, voltage, electric power, radiation, flow rate, humidity, gradient, oscillation, odor, or infrared rays. With the sensor 921, for example, data on an environment (e.g., temperature) where the secondary battery is placed can be detected and stored in a memory inside the circuit 912.

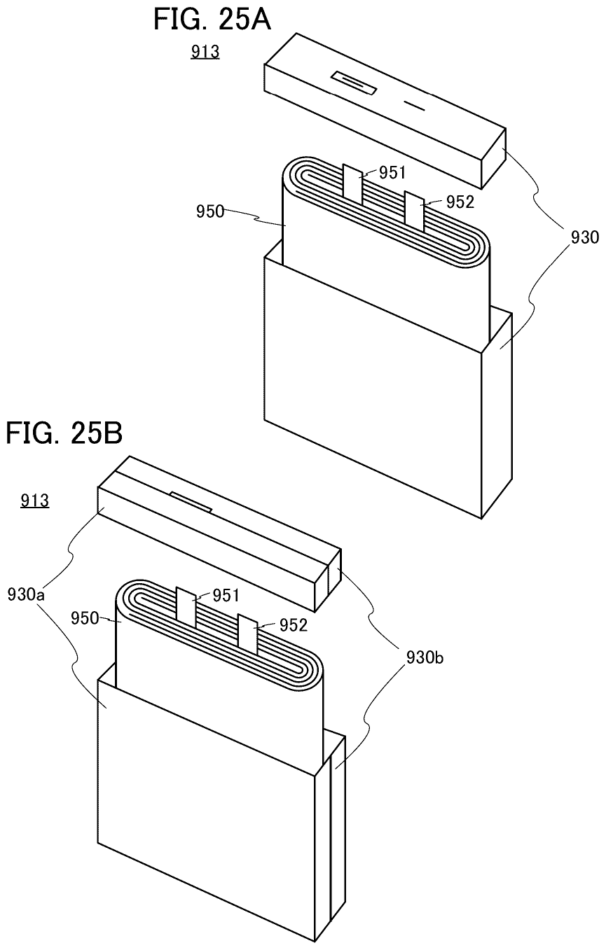

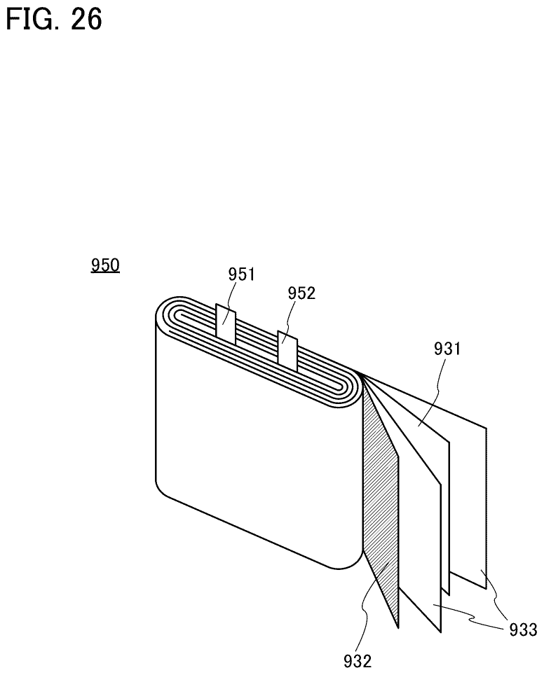

Furthermore, structure examples of the secondary battery 913 are described with reference to FIG. 25 and FIG. 26.

A secondary battery 913 illustrated in FIG. 25A includes a wound body 950 provided with a terminal 951 and a terminal 952 inside a housing 930. The wound body 950 is immersed in an electrolyte solution inside the housing 930. The terminal 952 is in contact with the housing 930, and the terminal 951 is not in contact with the housing 930 with use of an insulator or the like. Note that in FIG. 25A, the housing 930 divided into pieces is illustrated for convenience; however, in the actual structure, the wound body 950 is covered with the housing 930 and the terminal 951 and the terminal 952 extend to the outside of the housing 930. For the housing 930, a metal material (e.g., aluminum) or a resin material can be used.

Note that as illustrated in FIG. 25B, the housing 930 illustrated in FIG. 25A may be formed using a plurality of materials. For example, in the secondary battery 913 illustrated in FIG. 25B, a housing 930a and a housing 930b are bonded to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field from the secondary battery 913 can be inhibited. When an electric field is not significantly blocked by the housing 930a, an antenna such as the antenna 914 may be provided inside the housing 930a. For the housing 930b, a metal material can be used, for example.

FIG. 26 illustrates the structure of the wound body 950. The wound body 950 includes a negative electrode 931, a positive electrode 932, and separators 933. The wound body 950 is obtained by winding a sheet of a stack in which the negative electrode 931 overlaps with the positive electrode 932 with the separator 933 provided therebetween. Note that a plurality of stacks each including the negative electrode 931, the positive electrode 932, and the separator 933 may be further stacked.

The negative electrode 931 is connected to the terminal 911 illustrated in FIG. 23 via one of the terminal 951 and the terminal 952. The positive electrode 932 is connected to the terminal 911 illustrated in FIG. 23 via the other of the terminal 951 and the terminal 952. When the positive electrode active material described in the above embodiment is used in the positive electrode 932, the secondary battery 913 with high charge and discharge capacity and excellent cycle performance can be obtained.

### <Laminated Secondary Battery>

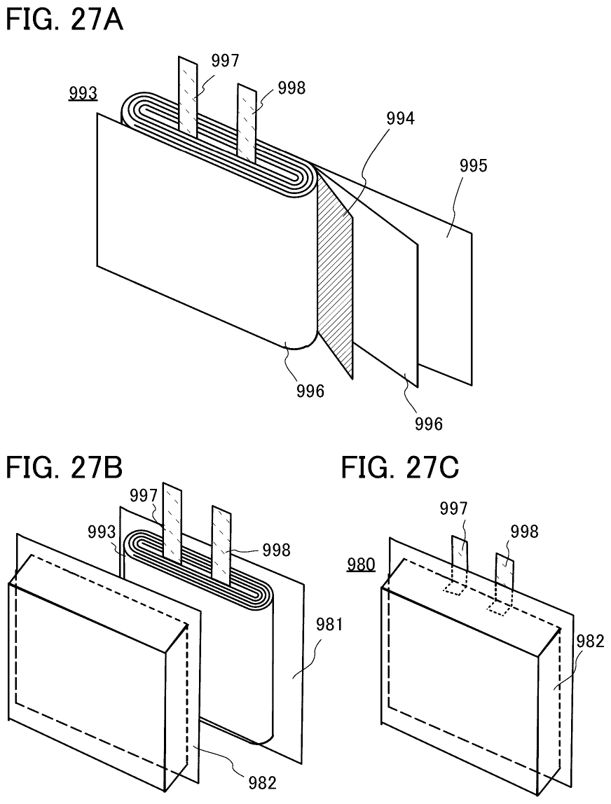

Next, an example of a laminated secondary battery is described with reference to FIG. 27 to FIG. 31. When the laminated secondary battery has flexibility and is used in an electronic device at least part of which is flexible, the secondary battery can be bent as the electronic device is bent.

A laminated secondary battery 980 is described with reference to FIG. 27. The laminated secondary battery 980 includes a wound body 993 illustrated in FIG. 27A. The wound body 993 includes a negative electrode 994, a positive electrode 995, and separators 996. The wound body 993 is, like the wound body 950 illustrated in FIG. 26, obtained by winding a sheet of a stack in which the negative electrode 994 overlaps with the positive electrode 995 with the separator 996 provided therebetween.

Note that the number of stacks each including the negative electrode 994, the positive electrode 995, and the separator 996 may be designed as appropriate depending on required charge and discharge capacity and element volume. The negative electrode 994 is connected to a negative electrode current collector (not illustrated) via one of a lead electrode 997 and a lead electrode 998. The positive electrode 995 is connected to a positive electrode current collector (not illustrated) via the other of the lead electrode 997 and the lead electrode 998.

As illustrated in FIG. 27B, the above-described wound body 993 is packed in a space formed by bonding a film 981 and a film 982 having a depressed portion that serve as exterior bodies by thermocompression bonding or the like, whereby the secondary battery 980 as illustrated in FIG. 27C can be formed. The wound body 993 includes the lead electrode 997 and the lead electrode 998, and is soaked in an electrolyte solution inside the film 981 and the film 982 having a depressed portion.

For the film 981 and the film 982 having a depressed portion, a metal material such as aluminum or a resin material can be used, for example. With the use of a resin material for the film 981 and the film 982 having a depressed portion, the film 981 and the film 982 having a depressed portion can be changed in their forms when external force is applied; thus, a flexible storage battery can be manufactured.

Although FIG. 27B and FIG. 27C show an example of using two films, the wound body 993 may be placed in a space formed by bending one film.

When the positive electrode active material described in the above embodiment is used in the positive electrode 995, the secondary battery 980 with high charge and discharge capacity and excellent cycle performance can be obtained.

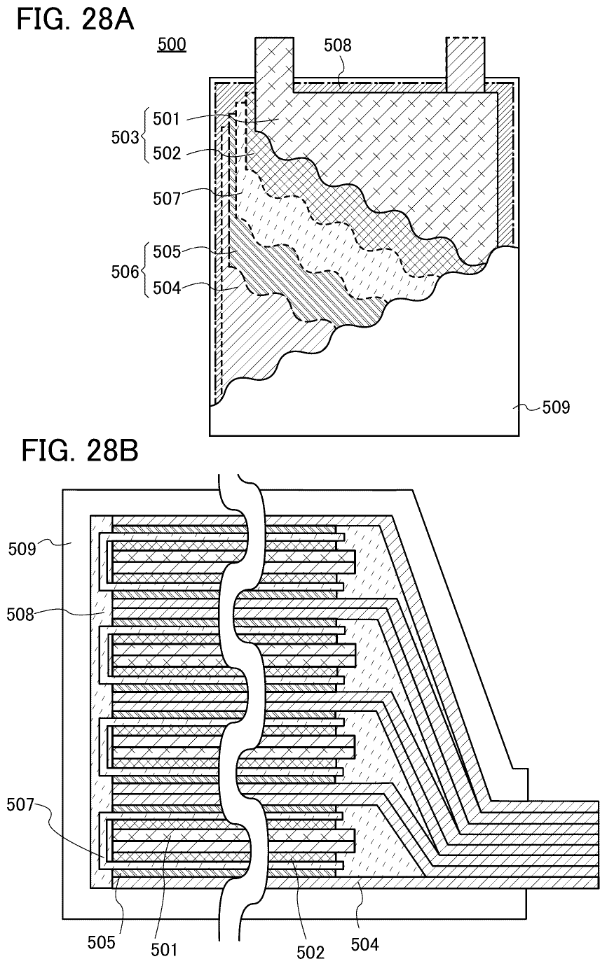

In FIG. 27, an example in which the secondary battery 980 includes a wound body in a space formed by films serving as exterior bodies is described; however, as illustrated in FIG. 28, a secondary battery may include a plurality of strip-shaped positive electrodes, a plurality of strip-shaped separators, and a plurality of strip-shaped negative electrodes in a space formed by films serving as exterior bodies, for example.

A laminated secondary battery 500 illustrated in FIG. 28A includes a positive electrode 503 including a positive electrode current collector 501 and a positive electrode active material layer 502, a negative electrode 506 including a negative electrode current collector 504 and a negative electrode active material layer 505, a separator 507, an electrolyte solution 508, and an exterior body 509. The separator 507 is provided between the positive electrode 503 and the negative electrode 506 in the exterior body 509. The exterior body 509 is filled with the electrolyte solution 508. The electrolyte solution described in Embodiment 3 can be used as the electrolyte solution 508.

In the laminated secondary battery 500 illustrated in FIG. 28A, the positive electrode current collector 501 and the negative electrode current collector 504 also serve as terminals for electrical contact with the outside. For this reason, the positive electrode current collector 501 and the negative electrode current collector 504 may be arranged so that part of the positive electrode current collector 501 and part of the negative electrode current collector 504 are exposed to the outside of the exterior body 509. Alternatively, without exposing the positive electrode current collector 501 and the negative electrode current collector 504 from the exterior body 509 to the outside, a lead electrode may be used, and the lead electrode and the positive electrode current collector 501 or the negative electrode current collector 504 may be bonded by ultrasonic welding so that the lead electrode is exposed to the outside.

As the exterior body 509 of the laminated secondary battery 500, for example, a laminate film having a three-layer structure can be employed in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided as the outer surface of the exterior body over the metal thin film.

FIG. 28B shows an example of a cross-sectional structure of the laminated secondary battery 500. FIG. 28A shows an example in which only two current collectors are included for simplicity, but actually, a plurality of electrode layers are included as illustrated in FIG. 28B.

In FIG. 28B, the number of electrode layers is 16, for example. Note that the secondary battery 500 has flexibility even though the number of electrode layers is set to 16. FIG. 28B illustrates a structure including 8 layers of negative electrode current collectors 504 and 8 layers of positive electrode current collectors 501, i.e., 16 layers in total. Note that FIG. 28B illustrates a cross section of the lead portion of the negative electrode, and the 8 layers of the negative electrode current collectors 504 are bonded to each other by ultrasonic welding. It is needless to say that the number of electrode layers is not limited to 16, and may be more than 16 or less than 16. With a large number of electrode layers, the secondary battery can have high charge and discharge capacity. By contrast, with a small number of electrode layers, the secondary battery can have small thickness and high flexibility.

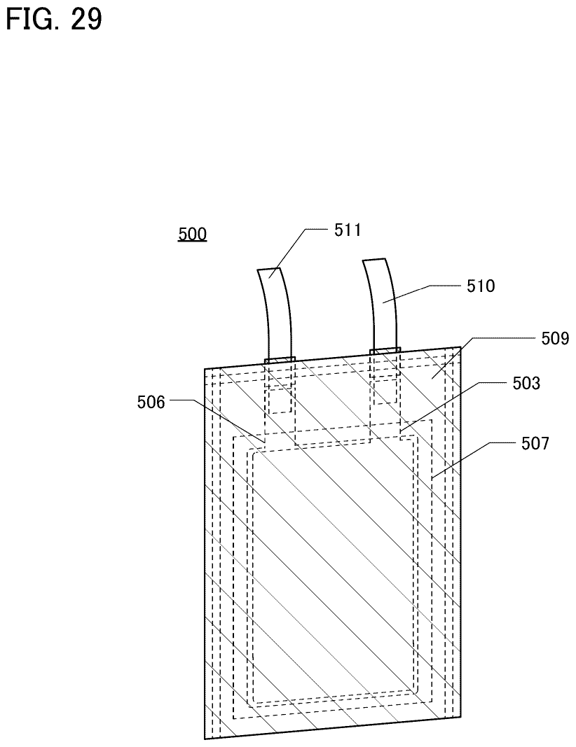

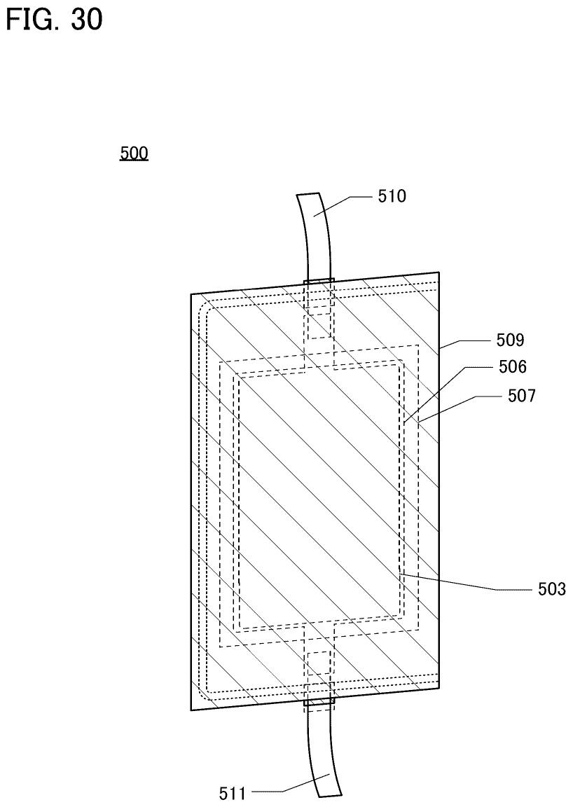

FIG. 29 and FIG. 30 each show an example of the external view of the laminated secondary battery 500. In FIG. 29 and FIG. 30, the positive electrode 503, the negative electrode 506, the separator 507, the exterior body 509, the positive electrode lead electrode 510, and the negative electrode lead electrode 511 are included.

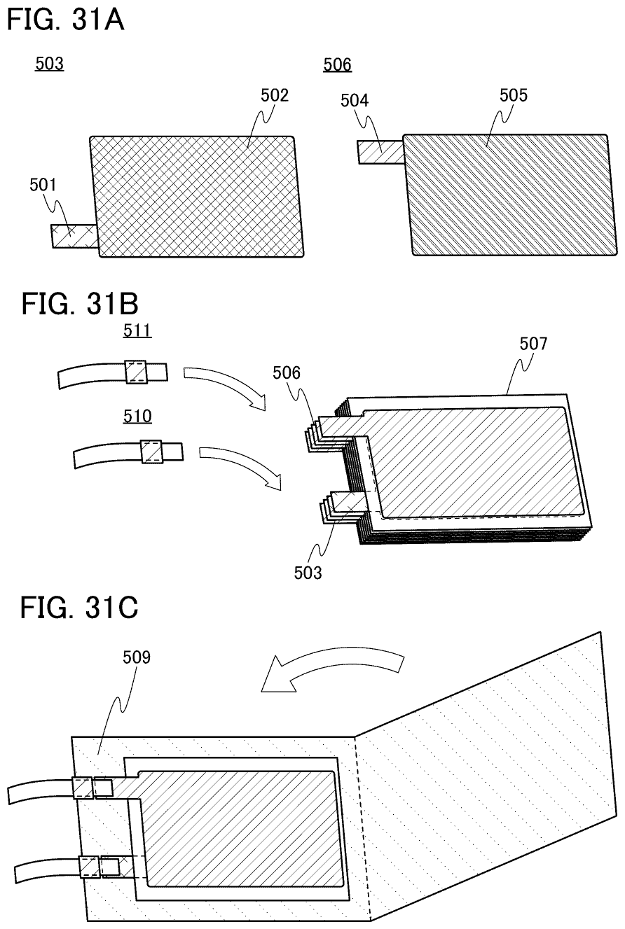

FIG. 31A illustrates external views of the positive electrode 503 and the negative electrode 506. The positive electrode 503 includes the positive electrode current collector 501, and the positive electrode active material layer 502 is formed on a surface of the positive electrode current collector 501. The positive electrode 503 also includes a region where the positive electrode current collector 501 is partly exposed (hereinafter, referred to as a tab region). The negative electrode 506 includes the negative electrode current collector 504, and the negative electrode active material layer 505 is formed on a surface of the negative electrode current collector 504. The negative electrode 506 also includes a region where the negative electrode current collector 504 is partly exposed, that is, a tab region. The areas and the shapes of the tab regions included in the positive electrode and the negative electrode are not limited to those illustrated in FIG. 31A.

### <Method for Manufacturing Laminated Secondary Battery>

Here, an example of a method for manufacturing the laminated secondary battery whose external view is illustrated in FIG. 29 is described with reference to FIG. 31B and FIG. 31C.

First, the negative electrode 506, the separator 507, and the positive electrode 503 are stacked. FIG. 31B illustrates a stack including the negative electrode 506, the separator 507, and the positive electrode 503. Here, an example in which 5 negative electrodes and 4 positive electrodes are used is shown. Next, the tab regions of the positive electrodes 503 are bonded to each other, and the tab region of the positive electrode on the outermost surface and the positive electrode lead electrode 510 are bonded to each other. The bonding can be performed by ultrasonic welding, for example. In a similar manner, the tab regions of the negative electrodes 506 are bonded to each other, and the tab region of the negative electrode on the outermost surface and the negative electrode lead electrode 511 are bonded to each other.

After that, the negative electrode 506, the separator 507, and the positive electrode 503 are placed over the exterior body 509.

Subsequently, the exterior body 509 is folded along a portion shown by a dashed line as illustrated in FIG. 31C. Then, the outer edges of the exterior body 509 are bonded to each other. The bonding can be performed by thermocompression bonding, for example. At this time, an unbonded region (hereinafter referred to as an inlet) is provided for part (or one side) of the exterior body 509 so that the electrolyte solution 508 can be put later.

Next, the electrolyte solution 508 (not illustrated) is introduced into the exterior body 509 from the inlet of the exterior body 509. The electrolyte solution 508 is preferably introduced in a reduced pressure atmosphere or in an inert gas atmosphere. Lastly, the inlet is sealed by bonding. In this manner, a laminated secondary battery 500 can be fabricated.

When the positive electrode active material described in the above embodiment is used in the positive electrode 503, the secondary battery 500 with high charge and discharge capacity and excellent cycle performance can be obtained.

In an all-solid-state battery, the contact state of the inside interfaces can be kept favorable by applying a predetermined pressure in the direction of stacking positive electrodes and negative electrodes. By applying a predetermined pressure in the direction of stacking positive electrodes and negative electrodes, expansion in the stacking direction due to charge and discharge of the all-solid-state battery can be suppressed, and the reliability of the all-solid-state battery can be improved.

This embodiment can be used in appropriate combination with the other embodiments.

### Embodiment 5

In this embodiment, examples of electronic devices each including the secondary battery of one embodiment of the present invention are described.

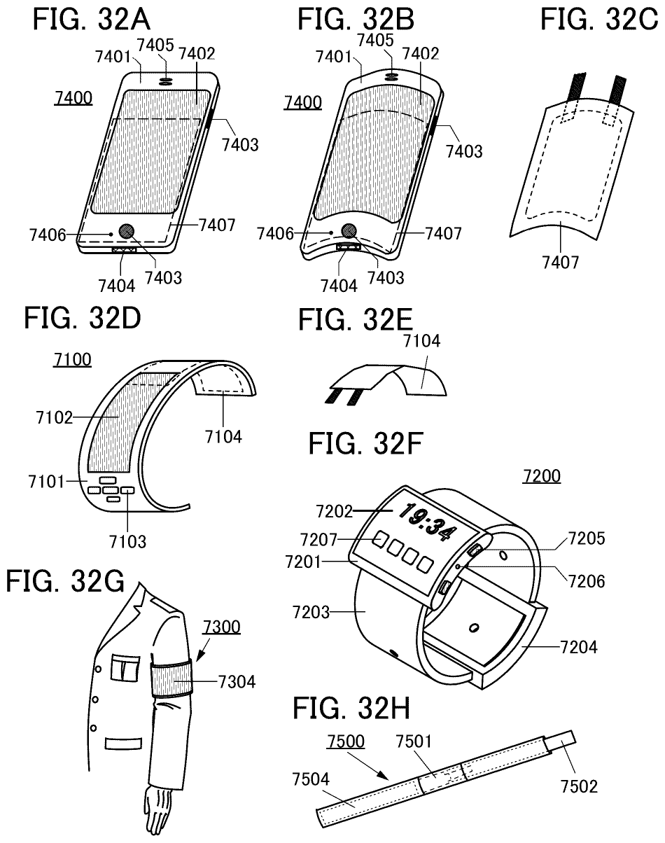

First, FIG. 32A to FIG. 32G show examples of electronic devices including the bendable secondary battery described in the above embodiment. Examples of electronic devices each including a bendable secondary battery include television sets (also referred to as televisions or television receivers), monitors of computers or the like, digital cameras, digital video cameras, digital photo frames, mobile phones (also referred to as cellular phones or mobile phone devices), portable game machines, portable information terminals, audio reproducing devices, and large game machines such as pachinko machines.

Furthermore, a flexible secondary battery can be incorporated along a curved inside or outside wall surface of a house, a building, or the like or a curved interior or exterior surface of an automobile, for example.

FIG. 32A shows an example of a mobile phone. A mobile phone 7400 is provided with a display portion 7402 incorporated in a housing 7401, operation buttons 7403, an external connection port 7404, a speaker 7405, a microphone 7406, and the like. Note that the mobile phone 7400 includes a secondary battery 7407. When the secondary battery of one embodiment of the present invention is used as the secondary battery 7407, a lightweight mobile phone with a long lifetime can be provided.

FIG. 32B illustrates the mobile phone 7400 that is curved. When the whole mobile phone 7400 is curved by external force, the secondary battery 7407 provided therein is also curved. FIG. 32C illustrates the bent secondary battery 7407. The secondary battery 7407 is a thin storage battery. The secondary battery 7407 is fixed in a state of being bent. Note that the secondary battery 7407 includes a lead electrode electrically connected to a current collector. The current collector is, for example, copper foil, and partly alloyed with gallium; thus, adhesion between the current collector and an active material layer in contact with the current collector is improved and the secondary battery 7407 can have high reliability even in a state of being bent.

FIG. 32D shows an example of a bangle display device. A portable display device 7100 includes a housing 7101, a display portion 7102, operation buttons 7103, and a secondary battery 7104. FIG. 32E illustrates the bent secondary battery 7104. When the display device is worn on a user's arm while the secondary battery 7104 is bent, the housing changes its shape and the curvature of part or the whole of the secondary battery 7104 is changed. Note that the bending condition of a curve at a given point that is represented by a value of the radius of a corresponding circle is referred to as the radius of curvature, and the reciprocal of the radius of curvature is referred to as curvature. Specifically, part or the whole of the housing or the main surface of the secondary battery 7104 is changed in the range of radius of curvature from 40 mm or more to 150 mm or less. When the radius of curvature at the main surface of the secondary battery 7104 is in the range from 40 mm or more to 150 mm or less, the reliability can be kept high. When the secondary battery of one embodiment of the present invention is used as the secondary battery 7104, a lightweight portable display device with a long lifetime can be provided.

FIG. 32F shows an example of a watch-type portable information terminal. A portable information terminal 7200 includes a housing 7201, a display portion 7202, a band 7203, a buckle 7204, an operation button 7205, an input/output terminal 7206, and the like.

The portable information terminal 7200 is capable of executing a variety of applications such as mobile phone calls, e-mailing, viewing and editing texts, music reproduction, Internet communication, and a computer game.

The display surface of the display portion 7202 is curved, and images can be displayed on the curved display surface. In addition, the display portion 7202 includes a touch sensor, and operation can be performed by touching the screen with a finger, a stylus, or the like. For example, by touching an icon 7207 displayed on the display portion 7202, application can be started.

With the operation button 7205, a variety of functions such as time setting, power on/off, on/off of wireless communication, setting and cancellation of a silent mode, and setting and cancellation of a power saving mode can be performed. For example, the functions of the operation button 7205 can be set freely by setting the operating system incorporated in the portable information terminal 7200.

The portable information terminal 7200 can perform near field communication that is standardized communication. For example, mutual communication between the portable information terminal 7200 and a headset capable of wireless communication enables hands-free calling.

The portable information terminal 7200 includes the input/output terminal 7206, and data can be directly transmitted to and received from another information terminal via a connector. In addition, charge via the input/output terminal 7206 is possible. Note that the charging operation may be performed by wireless power feeding without using the input/output terminal 7206.

The display portion 7202 of the portable information terminal 7200 includes the secondary battery of one embodiment of the present invention. When the secondary battery of one embodiment of the present invention is used, a lightweight portable information terminal with a long lifetime can be provided. For example, the secondary battery 7104 illustrated in FIG. 32E can be provided in the housing 7201 while being curved, or the secondary battery 7104 illustrated in FIG. 32E can be provided in the band 7203 such that it can be curved.

The portable information terminal 7200 preferably includes a sensor. As the sensor, for example, a human body sensor such as a fingerprint sensor, a pulse sensor, or a temperature sensor, a touch sensor, a pressure sensitive sensor, or an acceleration sensor is preferably mounted.

FIG. 32G shows an example of an armband display device. A display device 7300 includes a display portion 7304 and the secondary battery of one embodiment of the present invention. The display device 7300 can include a touch sensor in the display portion 7304 and can serve as a portable information terminal.

The display surface of the display portion 7304 is curved, and images can be displayed on the curved display surface. A display state of the display device 7300 can be changed by, for example, near field communication that is standardized communication.

The display device 7300 includes an input/output terminal, and data can be directly transmitted to and received from another information terminal via a connector. In addition, charge via the input/output terminal is possible. Note that the charging operation may be performed by wireless power feeding without using the input/output terminal.

When the secondary battery of one embodiment of the present invention is used as the secondary battery included in the display device 7300, a lightweight display device with a long lifetime can be provided.

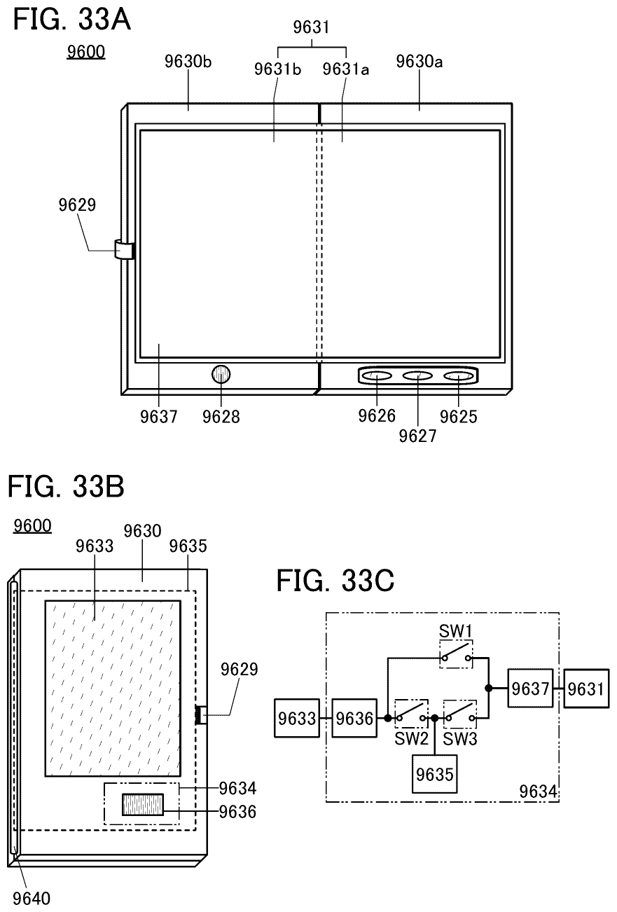

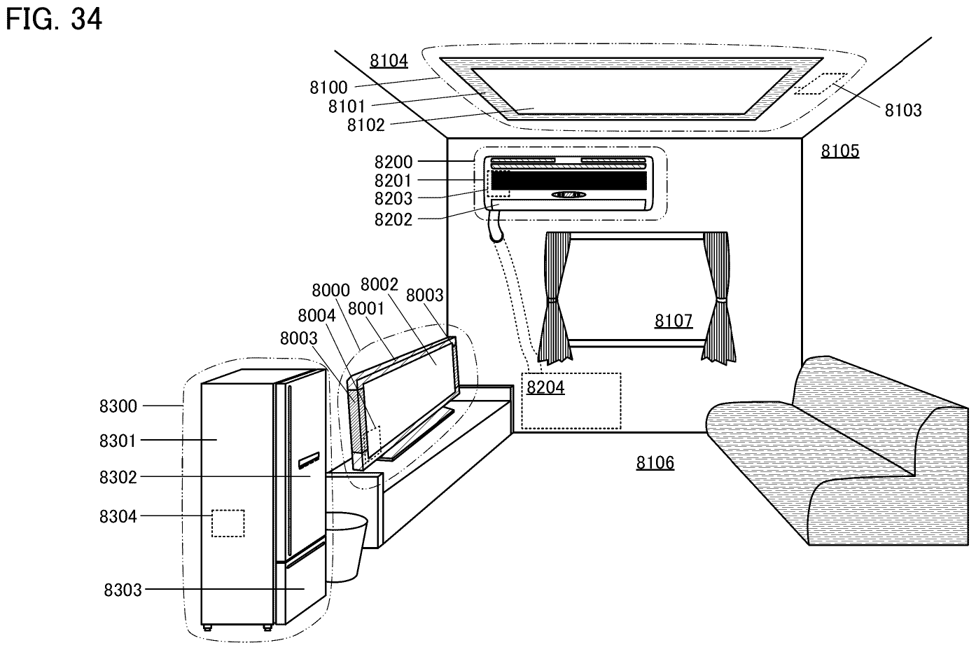

Examples of electronic devices each including the secondary battery with excellent cycle performance described in the above embodiment are described with reference to FIG. 32H, FIG. 33, and FIG. 34.

When the secondary battery of one embodiment of the present invention is used as a secondary battery of a daily electronic device, a lightweight product with a long lifetime can be provided. Examples of the daily electronic device include an electric toothbrush, an electric shaver, and electric beauty equipment. As secondary batteries of these products, small and lightweight stick type secondary batteries with high charge and discharge capacity are desired in consideration of handling ease for users.

FIG. 32H is a perspective view of a device called a cigarette smoking device (electronic cigarette). In FIG. 32H, an electronic cigarette 7500 includes an atomizer 7501 including a heating element, a secondary battery 7504 that supplies power to the atomizer, and a cartridge 7502 including a liquid supply bottle, a sensor, and the like. To improve safety, a protection circuit that prevents overcharge and overdischarge of the secondary battery 7504 may be electrically connected to the secondary battery 7504. The secondary battery 7504 illustrated in FIG. 32H includes an external terminal for connection to a charger. When the electronic cigarette 7500 is held, the secondary battery 7504 is a tip portion; thus, it is preferable that the secondary battery 7504 have a short total length and be lightweight. With the secondary battery of one embodiment of the present invention, which has high charge and discharge capacity and excellent cycle performance, the small and lightweight electronic cigarette 7500 that can be used for a long time over a long period can be provided.

Next, FIG. 33A and FIG. 33B show an example of a tablet terminal that can be folded in half. A tablet terminal 9600 illustrated in FIG. 33A and FIG. 33B includes a housing 9630a, a housing 9630b, a movable portion 9640 connecting the housing 9630a and the housing 9630b to each other, a display portion 9631 including a display portion 9631a and a display portion 9631b, a switch 9625 to a switch 9627, a fastener 9629, and an operation switch 9628. A flexible panel is used for the display portion 9631, whereby a tablet terminal with a larger display portion can be provided. FIG. 33A illustrates the tablet terminal 9600 that is opened, and FIG. 33B illustrates the tablet terminal 9600 that is closed.

The tablet terminal 9600 includes a power storage unit 9635 inside the housing 9630a and the housing 9630b. The power storage unit 9635 is provided across the housing 9630a and the housing 9630b, passing through the movable portion 9640.

The entire region or part of the region of the display portion 9631 can be a touch panel region, and data can be input by touching text, an input form, an image including an icon, and the like displayed on the region. For example, it is possible that keyboard buttons are displayed on the entire display portion 9631a on the housing 9630a side, and data such as text or an image is displayed on the display portion 9631b on the housing 9630b side.

It is possible that a keyboard is displayed on the display portion 9631b on the housing 9630b side, and data such as text or an image is displayed on the display portion 9631a on the housing 9630a side. Furthermore, it is possible that a switching button for showing/hiding a key board on a touch panel is displayed on the display portion 9631 and the button is touched with a finger, a stylus, and the like to display a key board on the display portion 9631.

Touch input can be performed concurrently in a touch panel region in the display portion 9631a on the housing 9630a side and a touch panel region in the display portion 9631b on the housing 9630b side.

The switch 9625 to the switch 9627 may function not only as an interface for operating the tablet terminal 9600 but also as an interface that can switch various functions. For example, at least one of the switch 9625 to the switch 9627 may function as a switch for switching power on/off of the tablet terminal 9600. For another example, at least one of the switch 9625 to the switch 9627 may have a function of switching the display orientation between a portrait mode and a landscape mode and a function of switching display between monochrome display and color display. For another example, at least one of the switch 9625 to the switch 9627 may have a function of adjusting the luminance of the display portion 9631. The luminance of the display portion 9631 can be optimized in accordance with the amount of external light in use of the tablet terminal 9600 detected by an optical sensor incorporated in the tablet terminal 9600. Note that another sensing device including a sensor for measuring inclination, such as a gyroscope sensor or an acceleration sensor, may be incorporated in the tablet terminal, in addition to the optical sensor.

FIG. 33A shows an example in which the display portion 9631a on the housing 9630a side and the display portion 9631b on the housing 9630b side have substantially the same display area; however, there is no particular limitation on the display areas of the display portion 9631a and the display portion 9631b, and the display portions may have different sizes or different display quality. For example, one may be a display panel that can display higher-definition images than the other.

The tablet terminal 9600 is folded in half in FIG. 33B. The tablet terminal 9600 includes a housing 9630, a solar cell 9633, and a charge and discharge control circuit 9634 including a DCDC converter 9636. The secondary battery of one embodiment of the present invention is used as the power storage unit 9635.

Note that as described above, the tablet terminal 9600 can be folded in half, and thus can be folded when not in use such that the housing 9630a and the housing 9630b overlap with each other. By the folding, the display portion 9631 can be protected, which increases the durability of the tablet terminal 9600. With the power storage unit 9635 including the secondary battery of one embodiment of the present invention, which has high charge and discharge capacity and excellent cycle performance, the tablet terminal 9600 that can be used for a long time over a long period can be provided.

The tablet terminal 9600 illustrated in FIG. 33A and FIG. 33B can also have a function of displaying various kinds of data (e.g., a still image, a moving image, and a text image), a function of displaying a calendar, a date, or the time on the display portion, a touch-input function of operating or editing data displayed on the display portion by touch input, a function of controlling processing by various kinds of software (programs), and the like.

The solar cell 9633, which is attached on the surface of the tablet terminal 9600, can supply electric power to a touch panel, a display portion, a video signal processing portion, and the like. Note that the solar cell 9633 can be provided on one surface or both surfaces of the housing 9630 and the power storage unit 9635 can be charged efficiently. The use of a lithium-ion battery as the power storage unit 9635 brings an advantage such as a reduction in size.

The structure and operation of the charge and discharge control circuit 9634 illustrated in FIG. 33B are described with reference to a block diagram in FIG. 33C. The solar cell 9633, the power storage unit 9635, the DCDC converter 9636, a converter 9637, switches SW1 to SW3, and the display portion 9631 are illustrated in FIG. 33C, and the power storage unit 9635, the DCDC converter 9636, the converter 9637, and the switches SW1 to SW3 correspond to the charge and discharge control circuit 9634 illustrated in FIG. 33B.

First, an operation example in which electric power is generated by the solar cell 9633 using external light is described. The voltage of electric power generated by the solar cell is raised or lowered by the DCDC converter 9636 to a voltage for charging the power storage unit 9635. When the display portion 9631 is operated with the electric power from the solar cell 9633, the switch SW1 is turned on and the voltage is raised or lowered by the converter 9637 to a voltage needed for the display portion 9631. When display on the display portion 9631 is not performed, the switch SW1 is turned off and the switch SW2 is turned on, so that the power storage unit 9635 is charged.

Note that the solar cell 9633 is described as an example of a power generation unit; however, one embodiment of the present invention is not limited to this example. The power storage unit 9635 may be charged using another power generation unit such as a piezoelectric element or a thermoelectric conversion element (Peltier element). For example, the charge may be performed with a non-contact power transmission module that performs charge by transmitting and receiving power wirelessly (without contact), or with a combination of other charge units.

FIG. 34 illustrates other examples of electronic devices. In FIG. 34, a display device 8000 is an example of an electronic device including a secondary battery 8004 of one embodiment of the present invention. Specifically, the display device 8000 corresponds to a display device for TV broadcast reception and includes a housing 8001, a display portion 8002, speaker portions 8003, the secondary battery 8004, and the like. The secondary battery 8004 of one embodiment of the present invention is provided in the housing 8001. The display device 8000 can be supplied with electric power from a commercial power supply and can use electric power stored in the secondary battery 8004. Thus, the display device 8000 can be operated with the use of the secondary battery 8004 of one embodiment of the present invention as an uninterruptible power supply even when electric power cannot be supplied from a commercial power supply due to power failure or the like.

A semiconductor display device such as a liquid crystal display device, a light-emitting device in which a light-emitting element such as an organic EL element is provided in each pixel, an electrophoresis display device, a DMD (Digital Micromirror Device), a PDP (Plasma Display Panel), or an FED (Field Emission Display) can be used for the display portion 8002. Note that the display device includes, in its category, all of information display devices for personal computers, advertisement displays, and the like besides information display devices for TV broadcast reception.

In FIG. 34, an installation lighting device 8100 is an example of an electronic device including a secondary battery 8103 of one embodiment of the present invention. Specifically, the lighting device 8100 includes a housing 8101, a light source 8102, the secondary battery 8103, and the like. Although FIG. 34 illustrates the case where the secondary battery 8103 is provided in a ceiling 8104 on which the housing 8101 and the light source 8102 are installed, the secondary battery 8103 may be provided in the housing 8101. The lighting device 8100 can be supplied with electric power from a commercial power supply and can use electric power stored in the secondary battery 8103. Thus, the lighting device 8100 can be operated with the use of the secondary battery 8103 of one embodiment of the present invention as an uninterruptible power supply even when electric power cannot be supplied from a commercial power supply due to power failure or the like.

Note that although the installation lighting device 8100 provided in the ceiling 8104 is illustrated in FIG. 34 as an example, the secondary battery of one embodiment of the present invention can be used in an installation lighting device provided in, for example, a side wall 8105, a floor 8106, or a window 8107 other than the ceiling 8104, and can be used in a tabletop lighting device or the like.

As the light source 8102, an artificial light source that emits light artificially by using electric power can be used. Specifically, an incandescent lamp, a discharge lamp such as a fluorescent lamp, and light-emitting elements such as an LED and an organic EL element are given as examples of the artificial light source.

In FIG. 34, an air conditioner including an indoor unit 8200 and an outdoor unit 8204 is an example of an electronic device including a secondary battery 8203 of one embodiment of the present invention. Specifically, the indoor unit 8200 includes a housing 8201, an air outlet 8202, the secondary battery 8203, and the like. Although FIG. 34 illustrates the case where the secondary battery 8203 is provided in the indoor unit 8200, the secondary battery 8203 may be provided in the outdoor unit 8204. Alternatively, the secondary batteries 8203 may be provided in both the indoor unit 8200 and the outdoor unit 8204. The air conditioner can be supplied with electric power from a commercial power supply and can use electric power stored in the secondary battery 8203. Particularly in the case where the secondary batteries 8203 are provided in both the indoor unit 8200 and the outdoor unit 8204, the air conditioner can be operated with the use of the secondary battery 8203 of one embodiment of the present invention as an uninterruptible power supply even when electric power cannot be supplied from a commercial power supply due to power failure or the like.

Note that although the split-type air conditioner including the indoor unit and the outdoor unit is illustrated in FIG. 34 as an example, the secondary battery of one embodiment of the present invention can be used in an air conditioner in which the function of an indoor unit and the function of an outdoor unit are integrated in one housing.

In FIG. 34, an electric refrigerator-freezer 8300 is an example of an electronic device including a secondary battery 8304 of one embodiment of the present invention. Specifically, the electric refrigerator-freezer 8300 includes a housing 8301, a refrigerator door 8302, a freezer door 8303, the secondary battery 8304, and the like. The secondary battery 8304 is provided in the housing 8301 in FIG. 34. The electric refrigerator-freezer 8300 can be supplied with electric power from a commercial power supply and can use electric power stored in the secondary battery 8304. Thus, the electric refrigerator-freezer 8300 can be operated with the use of the secondary battery 8304 of one embodiment of the present invention as an uninterruptible power supply even when electric power cannot be supplied from a commercial power supply due to power failure or the like.

Note that among the electronic devices described above, a high-frequency heating apparatus such as a microwave oven and an electronic device such as an electric rice cooker require high power in a short time. Therefore, the tripping of a breaker of a commercial power supply in use of the electronic device can be prevented by using the secondary battery of one embodiment of the present invention as an auxiliary power supply for supplying electric power which cannot be supplied enough by a commercial power supply.

In a time period when electronic devices are not used, particularly when the proportion of the amount of electric power which is actually used to the total amount of electric power which can be supplied from a commercial power supply source (such a proportion is referred to as a usage rate of electric power) is low, electric power is stored in the secondary battery, whereby an increase in the usage rate of electric power can be inhibited in a time period other than the above time period. For example, in the case of the electric refrigerator-freezer 8300, electric power is stored in the secondary battery 8304 in night time when the temperature is low and the refrigerator door 8302 and the freezer door 8303 are not opened or closed. Moreover, in daytime when the temperature is high and the refrigerator door 8302 and the freezer door 8303 are opened and closed, the usage rate of electric power in daytime can be kept low by using the secondary battery 8304 as an auxiliary power supply.

According to one embodiment of the present invention, the secondary battery can have excellent cycle performance and improved reliability. Furthermore, according to one embodiment of the present invention, a secondary battery with high charge and discharge capacity can be obtained; thus, the secondary battery itself can be made more compact and lightweight as a result of improved characteristics of the secondary battery. Thus, the secondary battery of one embodiment of the present invention is used in the electronic device described in this embodiment, whereby a more lightweight electronic device with a longer lifetime can be obtained.

This embodiment can be implemented in appropriate combination with the other embodiments.

### Embodiment 6

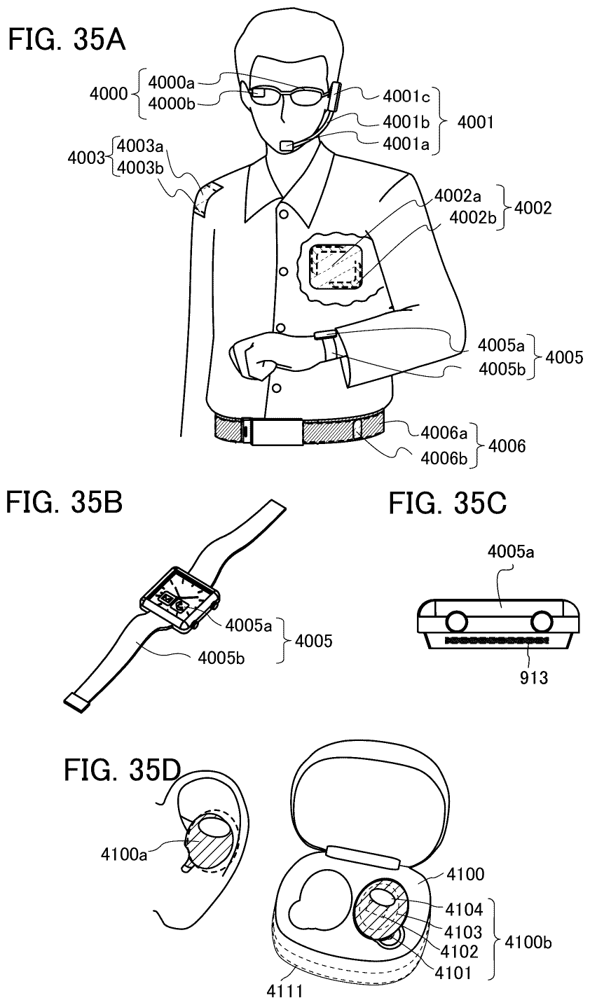

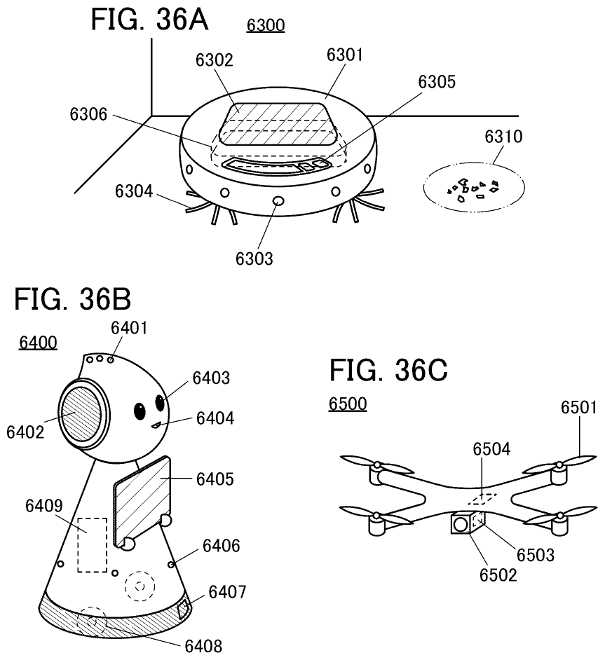

In this embodiment, examples of electronic devices each including the secondary battery described in the above embodiment are described with reference to FIG. 35A to FIG. 36C.

FIG. 35A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 35A. The glasses-type device 4000 includes a frame 4000a and a display part 4000b. The secondary battery is provided in a temple of the frame 4000a having a curved shape, whereby the glasses-type device 4000 can be lightweight, can have a well-balanced weight, and can be used continuously for a long time. With the use of the secondary battery of one embodiment of the present invention, space saving required with downsizing of a housing can be achieved.

The secondary battery of one embodiment of the present invention can be provided in a headset-type device 4001. The headset-type device 4001 includes at least a microphone part 4001a, a flexible pipe 4001b, and an earphone portion 4001c. The secondary battery can be provided in the flexible pipe 4001b or the earphone portion 4001c. With the use of the secondary battery of one embodiment of the present invention, space saving required with downsizing of a housing can be achieved.

The secondary battery of one embodiment of the present invention can be provided in a device 4002 that can be attached directly to a body. A secondary battery 4002b can be provided in a thin housing 4002a of the device 4002. With the use of the secondary battery of one embodiment of the present invention, space saving required with downsizing of a housing can be achieved.

The secondary battery of one embodiment of the present invention can be provided in a device 4003 that can be attached to clothes. A secondary battery 4003b can be provided in a thin housing 4003a of the device 4003. With the use of the secondary battery of one embodiment of the present invention, space saving required with downsizing of a housing can be achieved.

The secondary battery of one embodiment of the present invention can be provided in a belt-type device 4006. The belt-type device 4006 includes a belt portion 4006a and a wireless power feeding and receiving portion 4006b, and the secondary battery can be provided inside the belt portion 4006a. With the use of the secondary battery of one embodiment of the present invention, space saving required with downsizing of a housing can be achieved.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. With the use of the secondary battery of one embodiment of the present invention, space saving required with downsizing of a housing can be achieved.

The display portion 4005a can display various kinds of information such as time and reception information of an e-mail or an incoming call.

In addition, the watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 35B is a perspective view of the watch-type device 4005 that is detached from an arm.

FIG. 35C is a side view. FIG. 35C illustrates a state where the secondary battery 913 is incorporated in the watch-type device 4005. The secondary battery 913 is the secondary battery described in Embodiment 4. The secondary battery 913, which is small and lightweight, overlaps with the display portion 4005a.

FIG. 35D illustrates an example of wireless earphones. The wireless earphones shown here consist of, but are not limited to, a pair of main bodies 4100a and 4100b.

Each of the main bodies 4100a and 4100b includes a driver unit 4101, an antenna 4102, and a secondary battery 4103. Each of the main bodies 4100a and 4100b may also include a display portion 4104. Moreover, each of the main bodies 4100a and 4100b preferably includes a substrate where a circuit such as a wireless IC is provided, a terminal for charge, and the like. Each of the main bodies 4100a and 4100b may also include a microphone.

A case 4110 includes a secondary battery 4111. Moreover, the case 4110 preferably includes a substrate where a circuit such as a wireless IC or a charge control IC is provided, and a terminal for charge. The case 4110 may also include a display portion, a button, and the like.

The main bodies 4100a and 4100b can communicate wirelessly with another electronic device such as a smartphone. Thus, sound data and the like transmitted from another electronic device can be played through the main bodies 4100a and 4100b. When the main bodies 4100a and 4100b include a microphone, sound captured by the microphone is transmitted to another electronic device, and sound data obtained by processing with the electronic device can be transmitted to and played through the main bodies 4100a and 4100b. Hence, the wireless earphones can be used as a translator, for example.

The secondary battery 4103 included in the main body 4100b can be charged by the secondary battery 4111 included in the case 4100. As the secondary battery 4111 and the secondary battery 4103, the coin-type secondary battery or the cylindrical secondary battery of the foregoing embodiment, for example, can be used. A secondary battery whose positive electrode includes the positive electrode active material 100 obtained in Embodiment 1 has a high energy density; thus, with the use of the secondary battery as the secondary battery 4103 and the secondary battery 4111, space saving required with downsizing of the wireless earphones can be achieved.

FIG. 36A illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught in the brush 6304 by image analysis, the rotation of the brush 6304 can be stopped. The cleaning robot 6300 further includes a secondary battery 6306 of one embodiment of the present invention and a semiconductor device or an electronic component. The cleaning robot 6300 including the secondary battery 6306 of one embodiment of the present invention can be a highly reliable electronic device that can operate for a long time.

FIG. 36B illustrates an example of a robot. A robot 6400 illustrated in FIG. 36B includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with a user using the microphone 6402 and the speaker 6404.

The display portion 6405 has a function of displaying various kinds of information. The robot 6400 can display information desired by a user on the display portion 6405. The display portion 6405 may be provided with a touch panel. Moreover, the display portion 6405 may be a detachable information terminal, in which case charge and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes the secondary battery 6409 of one embodiment of the present invention and a semiconductor device or an electronic component. The robot 6400 including the secondary battery of one embodiment of the present invention can be a highly reliable electronic device that can operate for a long time.

FIG. 36C illustrates an example of a flying object. A flying object 6500 illustrated in FIG. 36C includes propellers 6501, a camera 6502, a secondary battery 6503, and the like and has a function of flying autonomously.

For example, image data taken by the camera 6502 is stored in an electronic component 6504. The electronic component 6504 can analyze the image data to detect whether there is an obstacle in the way of the movement. Moreover, the electronic component 6504 can estimate the remaining battery level from a change in the power storage capacity of the secondary battery 6503. The flying object 6500 further includes the secondary battery 6503 of one embodiment of the present invention. The flying object 6500 including the secondary battery of one embodiment of the present invention can be a highly reliable electronic device that can operate for a long time.

This embodiment can be implemented in appropriate combination with the other embodiments.

### Embodiment 7

In this embodiment, examples of vehicles each including the secondary battery of one embodiment of the present invention will be described.

The use of secondary batteries in vehicles enables production of next-generation clean energy vehicles such as hybrid electric vehicles (HVs), electric vehicles (EVs), and plug-in hybrid electric vehicles (PHVs).

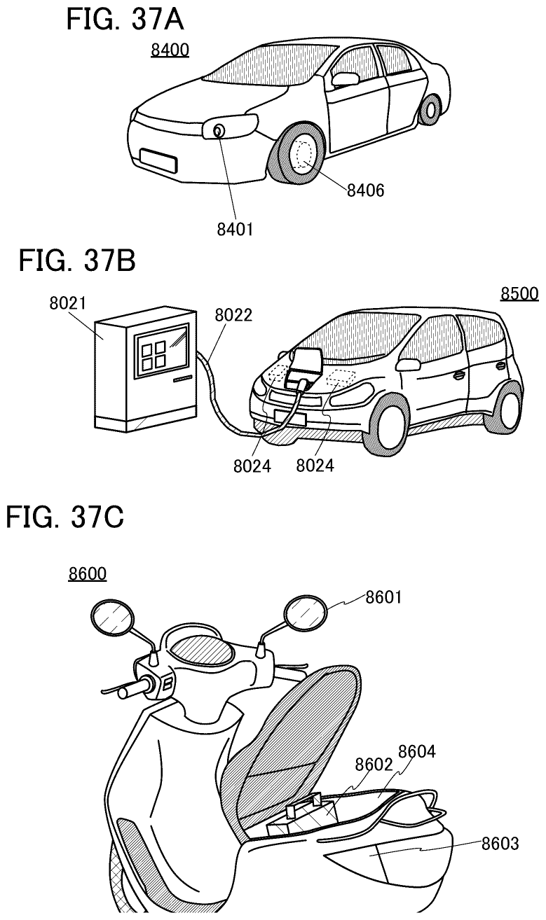

FIG. 37 illustrates examples of a vehicle including the secondary battery of one embodiment of the present invention. An automobile 8400 illustrated in FIG. 37A is an electric vehicle that runs on the power of an electric motor. Alternatively, the automobile 8400 is a hybrid electric vehicle capable of driving using either an electric motor or an engine as appropriate. The use of one embodiment of the present invention achieves a high-mileage vehicle. The automobile 8400 includes the secondary battery. As the secondary battery, the modules of the secondary batteries illustrated in FIG. 22C and FIG. 22D may be arranged to be used in a floor portion in the automobile. Alternatively, a battery pack in which a plurality of secondary batteries illustrated in FIG. 25 are combined may be placed in the floor portion in the automobile. The secondary battery can be used not only for driving an electric motor 8406, but also for supplying electric power to a light-emitting device such as a headlight 8401 or a room light (not shown).

The secondary battery can also supply electric power to a display device included in the automobile 8400, such as a speedometer or a tachometer. Furthermore, the secondary battery can supply electric power to a semiconductor device included in the automobile 8400, such as a navigation system.

An automobile 8500 illustrated in FIG. 37B can be charged when the secondary battery included in the automobile 8500 is supplied with electric power through external charge equipment by a plug-in system, a contactless power feeding system, and/or the like. FIG. 37B illustrates a state where a secondary battery 8024 included in the automobile 8500 is charged with the use of a ground-based charging apparatus 8021 through a cable 8022. Charge can be performed as appropriate by a given method such as CHAdeMO (registered trademark) or Combined Charging System as a charging method, the standard of a connector, or the like. The charging apparatus 8021 may be a charge station provided in a commerce facility or a power supply in a house. For example, with the use of a plug-in technique, the secondary battery 8024 included in the automobile 8500 can be charged by being supplied with electric power from outside. The charge can be performed by converting AC electric power into DC electric power through a converter such as an ACDC converter.

Although not shown, the vehicle may include a power receiving device so that it can be charged by being supplied with electric power from an above-ground power transmitting device in a contactless manner. In the case of the contactless power feeding system, by fitting a power transmitting device in a road or an exterior wall, charge can be performed not only when the vehicle is stopped but also when driven. In addition, the contactless power feeding system may be utilized to perform transmission and reception of electric power between vehicles. Furthermore, a solar cell may be provided in the exterior of the vehicle to charge the secondary battery when the vehicle stops or moves. To supply electric power in such a contactless manner, an electromagnetic induction method or a magnetic resonance method can be used.

FIG. 37C illustrates an example of a motorcycle including the secondary battery of one embodiment of the present invention. A motor scooter 8600 illustrated in FIG. 37C includes a secondary battery 8602, side mirrors 8601, and direction indicators 8603. The secondary battery 8602 can supply electric power to the direction indicators 8603.

In the motor scooter 8600 illustrated in FIG. 37C, the secondary battery 8602 can be held in an under-seat storage 8604. The secondary battery 8602 can be held in the under-seat storage 8604 even when the under-seat storage 8604 is small. The secondary battery 8602 is detachable; thus, the secondary battery 8602 is carried indoors when charged, and is stored before the motor scooter is driven.

According to one embodiment of the present invention, the secondary battery can have improved cycle performance and the charge and discharge capacity of the secondary battery can be increased. Thus, the secondary battery itself can be made more compact and lightweight. The compact and lightweight secondary battery contributes to a reduction in the weight of a vehicle, and thus increases the mileage. Furthermore, the secondary battery included in the vehicle can be used as a power source for supplying electric power to products other than the vehicle. In such a case, the use of a commercial power supply can be avoided at peak time of electric power demand, for example. Avoiding the use of a commercial power supply at peak time of electric power demand can contribute to energy saving and a reduction in carbon dioxide emissions. Moreover, the secondary battery with excellent cycle performance can be used over a long period; thus, the use amount of rare metals typified by cobalt can be reduced.

This embodiment can be implemented in appropriate combination with the other embodiments.

### Example 1

In this example, the positive electrode active material 100 of one embodiment of the present invention was formed and the battery characteristics were obtained.

### <Formation of Positive Electrode Active Material>

Samples formed in this example are described with reference to the formation methods shown in FIG. 2 and FIG. 3.

As LiMO₂ in Step S14 in FIG. 2, with the use of cobalt as the transition metal M, commercially available lithium cobalt oxide (Cellseed C-10N produced by NIPPON CHEMICAL INDUSTRIAL CO., LTD.), to which any additive element was not added, was prepared. The initial heating in Step S15 was performed on the lithium cobalt oxide, which was put in a crucible covered with a lid, in a muffle furnace at 850° C. for two hours. This heating corresponds to the initial heating. After the muffle furnace contained an oxygen atmosphere, supply with no oxygen (referred to as O₂ purging) was performed. The initial heating was presumed to eliminate impurities from LCO.

In accordance with Step S21 and Step S41 shown in FIG. 3A and FIG. 3B, Mg, F, Ni, and Al as the additive elements were prepared, and addition of Mg and F and addition of Ni and Aladditive element were separately performed. In accordance with Step S21 shown in FIG. 3A, LiF and MgF₂ were prepared as the F source and the Mg source, respectively. LiF and MgF₂ were weighed so that LiF:MgF₂ was 1:3 (molar ratio). Then, LiF and MgF₂ were mixed into super-dehydrated acetone and the mixture was stirred at a rotating speed of 400 rpm for 12 hours, whereby an additive element source XA was produced. Then, the mixture was made to pass through a sieve with an aperture of 300 μm, whereby the additive element source XA having a uniform median diameter (D50) was obtained.

Next, the additive element source XA was weighed to be 1 at % of the transition metal M, i.e., cobalt, and mixed with the LCO subjected to the initial heating by a dry process. Stirring was performed at a rotating speed of 150 rpm for one hour. These conditions are milder than those of the stirring in the production of the additive element source XA, and the condition that causes no breakage of LCO is preferably employed. Finally, the mixture was made to pass through a sieve with an aperture of 300 μm, whereby a mixture A having a uniform median diameter (D50) was obtained.

Then, the mixture A was heated. The heating conditions were 900° C. and 20 hours. The heating was performed in a muffle furnace with a lid placed on the crucible containing the mixture A. After the muffle furnace contained an oxygen atmosphere, O₂ purging was performed. By the heating, LCO containing Mg and F (referred to as a composite oxide A) was obtained.

Then, an additive element source XB was added to the composite oxide A. In accordance with Step S41 shown in FIG. 3B, nickel hydroxide and aluminum hydroxide were prepared as the Ni source and the Al source, respectively. The nickel hydroxide and the aluminum hydroxide were each weighed to be 0.5 at % of the transition metal M, i.e., 0.5 at % of cobalt, and were mixed with the composite oxide A by a dry process. Stirring was performed at a rotating speed of 150 rpm for one hour. These conditions were milder than those of the stirring in the production of the additive element source XA. As the conditions for the stirring, the conditions that cause no breakage of the obtained composite oxide A is preferably employed. Finally, the mixture was made to pass through a sieve with an aperture of 300 μm, whereby a mixture B having a uniform particle diameter was obtained.

Then, the mixture B was heated. The heating conditions were 850° C. and 10 hours. The heating was performed in a muffle furnace with a lid placed on the crucible containing the mixture B. After the muffle furnace contained an oxygen atmosphere, O₂ purging was performed. By the heating, LCO containing Mg, F, Ni, and Al (referred to as a composite oxide B) was obtained. The positive electrode active material obtained in this manner was prepared.

Next, the slurry was formed by mixing, at 1500 rpm, the obtained positive electrode active material (LCO), acetylene black (AB) as the conductive additive, and polyvinylidene fluoride (PVDF) as a binder at a ratio LCO:AB:PVDF=95:3:2 (wt %). The solvent of the slurry was NMP, which was volatilized after the slurry was applied to an aluminum current collector. The slurry on the current collector was pressed after the volatilization of the solvent.

In the pressing, Sample 1-1 was the slurry from which the solvent was volatilized and to which pressure was applied at 210 kN/m, and Sample 1-2 was the slurry from which the solvent was volatilized and to which pressure was applied at 1467 kN/m after pressure was applied at 210 kN/m. For both Sample 1-1 and Sample 1-2, the temperature of the roll of the press machine was set to 120° C. The loading levels of the positive electrode active material per unit area of the positive electrodes including Sample 1-1 and Sample 1-2 were each approximately 7 mg/cm². In this manner, the positive electrodes were completed. Table 1 shows the formation conditions of Sample 1-1 and Sample 1-2.

TABLE 1

| | Formation conditions | | | | | | |
|---|---|---|---|---|---|---|---|
| | | Initial | Additive element | | Additive element | | Pressing |
| | LiMO₂ | heating | source | Heating | source | Heating | (kN/m) |
| Sample 1-1 | LiCoO₂ | 850° C. | LiF | 900° C. | Ni(OH)₂ | 850° C. | 210 |
| Sample 1-2 | | 2 hours | MgF₂ | 20 hours | Al(OH)₃ | 10 hours | 210→1467 |

Table 2 shows the electrode density, filling rate, and porosity of each of Sample 1-1 and Sample 1-2.

TABLE 2

| | Electrode density | Filling rate | Porosity |
|---|---|---|---|
| | [g/cc] | [%] | [%] |
| Sample 1-1 | 3.32 | 71 | 29 |
| Sample 1-2 | 4.12 | 88 | 12 |

The electrode density was calculated from the weight of the active material layer (corresponding to the positive electrode active material, the conductive additive, and the binder) obtained by subtracting the current collector from the positive electrode/the volume of the active material layer×100. The filling rate was calculated from (the electrode density/the real density of the mixture)×100. The real density of LiCoO₂, AB used as the conductive additive, and PVDF used as the binder were set to 5.05 g/cc, 1.95 g/cc, and 1.78 g/cc, respectively. Moreover, the porosity was calculated from (1−filling rate)×100.

As shown in Table 2, Sample 1-1 has higher porosity than Sample 1-2 by comparison between Sample 1-1 and Sample 1-2.

Half cells were assembled as test batteries using the two positive electrodes including Sample 1-1 and Sample 1-2. A lithium metal was prepared as a negative electrode, i.e., a counter electrode. A separator was interposed between the positive electrodes including, respectively, Sample 1-1 and Sample 1-2 and the negative electrode, and contained together with an electrolyte solution in an exterior material. As a separator, polypropylene was used. As the electrolyte solution, a mixture of ethylene carbonate (EC) and diethyl carbonate (DEC) at EC:DEC=3:7 (volume ratio) to which vinylene carbonate (VC) was added as an additive agent at 2 wt % was used. As an electrolyte contained in an electrolyte solution, 1 mol/L lithium hexafluorophosphate (LiPF₆) was used. This battery is referred to as a coin-type half cell in some cases because the state of being contained in the exterior material is like a coin.

The coin-type half cells were formed in the above manner, and subjected to charge and discharge cycle tests in which measurement was performed with a charge-discharge measuring system (TOSCAT-3100) produced by TOYO SYSTEM Co., LTD. as a charge-discharge measuring instrument. The performance of the positive electrode itself can be clarified by the charge and discharge cycle tests, i.e., the evaluation of the cycle performance of the half cells.

Rates of the charge and discharge cycle test conditions are described. The rate at discharge is referred to as discharge rate and the discharge rate refers to the relative ratio of a current in discharge to the battery capacity and is expressed in a unit C. A current corresponding to 1 C in a battery with a rated capacity X (Ah) is X (A). The case where discharge is performed at a current of 2X (A) is rephrased as follows: discharge is performed at 2 C. The case where discharge is performed at a current of X/2 A is rephrased as follows: discharge is performed at 0.5 C. The rate at charge is referred to as charge rate and similarly, for the charge rate, the case where charge is performed at a current of 2X (A) is rephrased as follows: charge is performed at 2 C, and the case where charge is performed at a current of X/2 (A) is rephrased as follows: charge is performed at 0.5 C. The charge rate and the discharge rate are collectively referred to as a and discharge rate.

### <Charge and Discharge Cycle Test Condition: Charge and Discharge Rate of 1 C>

Charge and discharge cycle tests were performed at a charge and discharge rate of 1 C. Specifically, in a thermostat kept at 25° C. or 45° C. (referred to as a 25° C. or 45° C. environment), constant current charge was performed at a charge rate of 1 C (1 C=200 mA/g) until a voltage of 4.60 V (referred to as 4.6 V) was reached, constant voltage charge was further performed at a voltage of 4.6 V until the charge rate reached 0.1 C, and constant current discharge was then performed at a discharge rate of 1 C until a voltage of 2.5 V was reached. Between charge and discharge, a break period longer than or equal to 5 minutes and shorter than or equal to 15 minutes may be provided and a break period of 10 minutes was provided in this example.

Another test was performed under conditions with a different upper limit voltage of charge. Specifically, in a 25° C. or 45° C. environment, constant current charge was performed at a charge rate of 1 C (1 C=200 mA/g) until a voltage of 4.65 V was reached, constant voltage charge was further performed at a voltage of 4.65 V until the charge rate reached 0.1 C, and constant current discharge was then performed at a discharge rate of 1 C until a voltage of 2.5 V was reached. A break period of 10 minutes was provided between charge and discharge.

Still another test was performed under conditions with a different upper limit voltage of charge. Specifically, in a 25° C. or 45° C. environment, constant current charge was performed at a charge rate of 1 C (1 C=200 mA/g) until a voltage of 4.70 V (referred to as 4.7 V) was reached, constant voltage charge was further performed at a voltage of 4.7 V until the charge rate reached 0.1 C, and constant current discharge was then performed at a discharge rate of 1 C until a voltage of 2.5 V was reached. A break period of 10 minutes was provided between charge and discharge.

A cycle of the above-described charge and discharge was repeated 50 times, and the value calculated by (the discharge capacity in the 50th cycle/the maximum value of the discharge capacity in the 50 cycles)×100 was referred to as discharge capacity retention rate (%) in the 50th cycle. In other words, in the case where a test of 50 repetitions of a cycle of charge and discharge was conducted and the discharge capacity in each cycle was measured, the proportion of the value of the discharge capacity measured in the 50th cycle with respect to the maximum value of the discharge capacity in all the 50 cycles (the maximum discharge capacity) was calculated. A higher discharge capacity retention rate is desirable as a battery characteristic because a reduction in battery capacity after repeated charge and discharge is inhibited.

In the charge and discharge cycle test, current is measured. Specifically, a battery voltage and a current flowing in a battery are preferably measured by a four-terminal method. In charge, electrons flow from a positive electrode terminal to a negative electrode terminal through a charge-discharge measuring instrument and thus, a charge current flows from the negative electrode terminal to the positive electrode terminal through the charge-discharge measuring instrument. In discharge, electrons flow from the negative electrode terminal to the positive electrode terminal through the charge-discharge measuring instrument and thus, a discharge current flows from the positive electrode terminal to the negative electrode terminal through the charge-discharge measuring instrument. The charge current and discharge current are measured with an ammeter of the charge-discharge measuring instrument, the total amount of the current flowing during one charge and the total amount of the current flowing during one discharge respectively correspond to charge capacity and discharge capacity. For example, the total amount of the discharge current flowing during the discharge in the 1st cycle can be regarded as the discharge capacity in the 1st cycle, and the total amount of the discharge current flowing during the discharge in the 50th cycle can be regarded as the discharge capacity in the 50th cycle.

Table 3 is a list of the maximum discharge capacity (mAh/g), showing the maximum values of the discharge capacity of Sample 1-1 and Sample 1-2 in the 50 cycles, necessary for the calculation of the discharge capacity retention rates.

TABLE 3
Maximum discharge capacity (mAh/g)

| Temperature | 25° C. | | | 45° C. | | |
|---|---|---|---|---|---|---|
| Charge voltage | 4.6 V | 4.65 V | 4.7 V | 4.6 V | 4.65 V | 4.7 V |
| Sample 1-1 | 204.5 | 209.7 | 211.3 | 215.3 | 220.1 | 217.2 |
| Sample 1-2 | 198.7 | 202.1 | 198.1 | 212.2 | 217.7 | 216.1 |

In consideration of the theoretical capacity of LCO, which is 274 mAh/g, for example, the maximum discharge capacity of each of Sample 1-1 and Sample 1-2 shown in Table 3 is high. This indicates that LCO subjected to the initial heating is suitable for obtaining maximum discharge capacity.

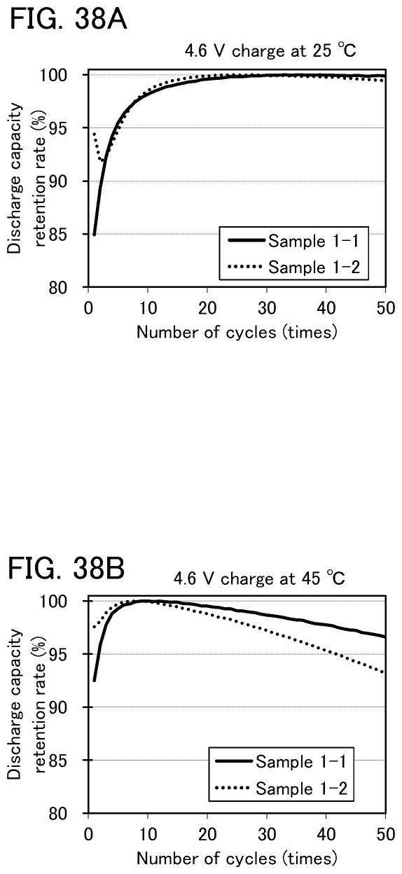

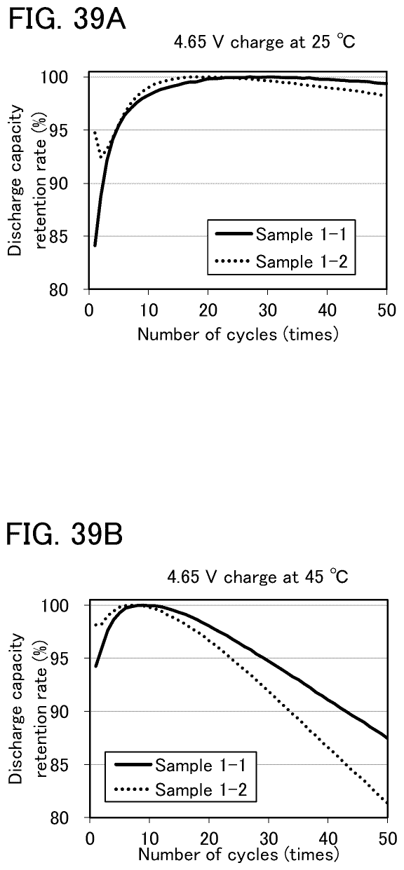

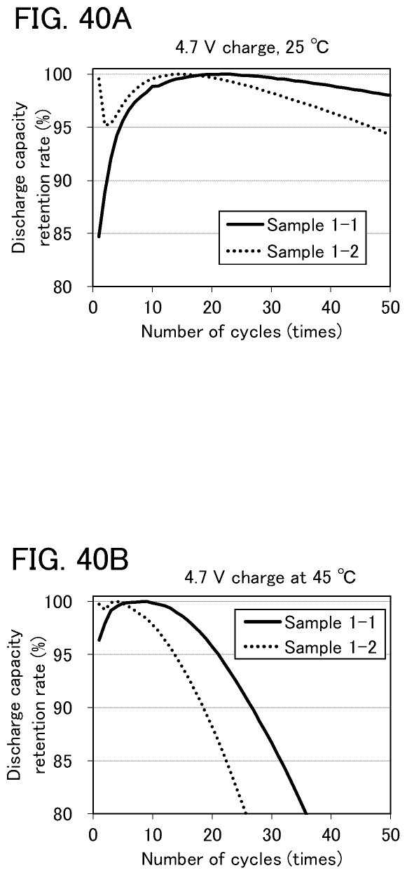

FIG. 38A, FIG. 38B, FIG. 39A, FIG. 39B, FIG. 40A, and FIG. 40B show the results of the charge and discharge cycle test in which measurements were performed under the above conditions. In FIG. 38A, FIG. 38B, FIG. 39A, FIG. 39B, FIG. 40A, and FIG. 40B, the horizontal axis represents the number of cycles (times) and the vertical axis represents the discharge capacity retention rate (%); the solid line denotes the results of Sample 1-1 and the dashed line denotes the results of Sample 1-2.

As shown in FIG. 38A, FIG. 38B, FIG. 39A, FIG. 39B, FIG. 40A, and FIG. 40B, LCO subjected to the initial heating exhibits high discharge capacity retention rate in the 25° C. environment, which is found suitable for battery characteristics. Specifically, in the 4.6 V charge, 4.65 V charge, and 4.7 V charge in the 25° C. environment, Sample 1-1 exhibits the discharge capacity retention rate after the number of cycles reaches 50 (referred to as after 50 cycles) which is higher than or equal to 95%. Furthermore, in the 4.6 V and 4.65 V charges in the 25° C. environment, Sample 1-2 exhibits the discharge capacity retention rate after 50 cycles which is higher than or equal to 95%. This indicates that LCO subjected to the initial heating is suitable for obtaining discharge capacity. Note that the discharge capacity retention rate in the cycle test refers to the proportion of the discharge capacity in the 500th cycle in the maximum discharge capacity.

As shown in FIG. 38A, FIG. 38B, FIG. 39A, FIG. 39B, FIG. 40A, and FIG. 40B, high discharge capacity retention rate is exhibited also in the 45° C. environment, which is found suitable for battery characteristics. Specifically, in the 4.6 V charge in the 45° C. environment, Sample 1-1 exhibits the discharge capacity retention rate after 50 cycles which is higher than or equal to 95%.

In this manner, the values and ranges of the discharge capacity retention rate can be read from FIG. 38A, FIG. 38B, FIG. 39A, FIG. 39B, FIG. 40A, and FIG. 40B.

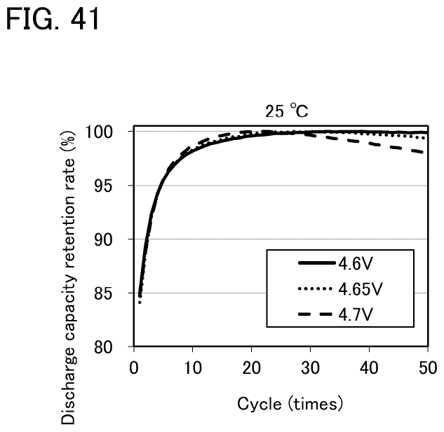

The results of the discharge capacity retention rate in the 25° C. environment, which are shown in FIG. 38A, FIG. 38B, FIG. 39A, FIG. 39B, FIG. 40A, and FIG. 40B, are superimposed and shown in FIG. 41. The solid line denotes the results of the 4.6 V charge, the short-dashed line denotes the results of the 4.65 V charge, and the dashed line denotes the results of the 4.7 V charge.

As shown in FIG. 41, the discharge capacity retention rate in the 50th cycle is higher than or equal to 95% in any temperature environment, indicating good battery characteristics. In other words, LCO subjected to the initial heating is preferred because it exhibits the discharge capacity retention rate in the 50th cycle which is higher than or equal to 95% in cycle test in the 25° C. environment.

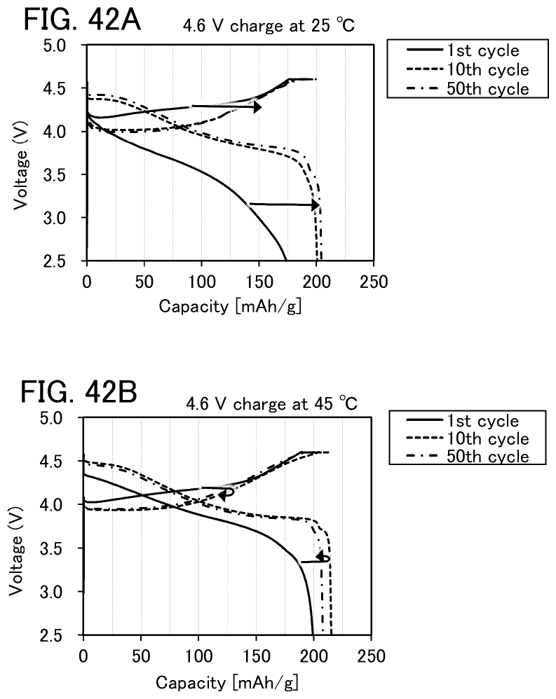

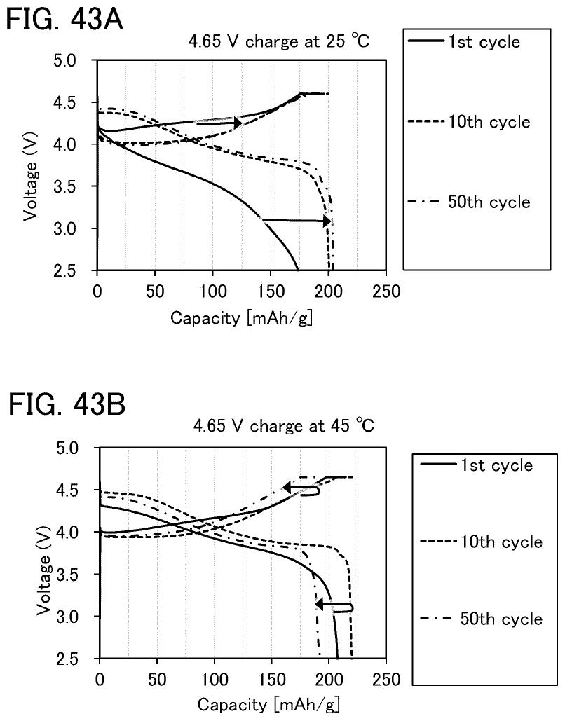

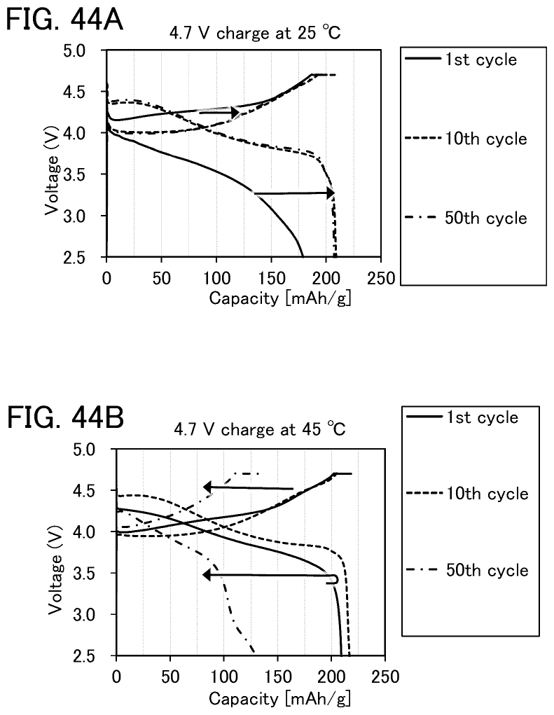

The charge and discharge curves of Sample 1-1 are shown in FIG. 42A, FIG. 42B, FIG. 43A, FIG. 43B, FIG. 44A, and FIG. 44B. The charge and discharge curve means the charge curve and the discharge curve (collectively referred to as charge and discharge curve), which are obtained by charge and discharge cycle tests and superimposed in a range from the 1st cycle to the n-th cycle (n is an integer greater than or equal to 2) in a graph where the horizontal axis represents capacity (mAh/g) and the vertical axis represents voltage (V). FIG. 42A, FIG. 42B, FIG. 43A, FIG. 43B, FIG. 44A, and FIG. 44B are graphs showing superimposed charge and discharge curves in the 1st cycle, the 10th cycle, and the 50th cycle which are based on the obtained charge and discharge curves in a range from the 1st cycle to the 50th cycle inclusive. In each of FIG. 42A, FIG. 42B, FIG. 43A, FIG. 43B, FIG. 44A, and FIG. 44B, arrows are added to clearly show the changes of the charge and discharge curves in the range from the 1st cycle to the 50th cycle.

In the charge curves of Sample 1-1 in FIG. 42A, FIG. 42B, FIG. 43A, FIG. 43B, FIG. 44A, and FIG. 44B, the voltage is low and the capacity is low during several cycles from the 1st cycle. In the 25° C. environment, Sample 1-1 is found to exhibit high capacity, for example, in the 10th cycle and the subsequent cycles, excluding the several cycles during which the capacity is low. In the 45° C. environment, Sample 1-1 causes a capacity decrease through the 4.7 V charge and exhibits a change in the shape of the charge and discharge curve, indicating degradation.

### <Charge and Discharge Cycle Test Condition: Charge and Discharge Rate of 0.5 C>

The discharge capacity retention rates of Sample 1-1 and Sample 1-2 were measured through the charge and discharge cycle tests at a charge and discharge rate of 0.5 C. The conditions other than the charge and discharge rate were similar to those at a rate of 1 C.

First, Table 4 is a list of the maximum discharge capacity (mAh/g) of Sample 1-1 and Sample 1-2 under the above conditions.

TABLE 4
Maximum discharge capacity (mAh/g)

| Temperature | 25° C. | | | 45° C. | | |
|---|---|---|---|---|---|---|
| Charge voltage | 4.6 V | 4.65 V | 4.7 V | 4.6 V | 4.65 V | 4.7 V |
| Sample 1-1 | 208.8 | 215.2 | 216.4 | 217.2 | 224.5 | 224.9 |
| Sample 1-2 | 207.6 | 211.7 | 210.3 | 217.1 | 222.7 | 223.1 |

In consideration of the theoretical capacity of LCO, which is 274 mAh/g, for example, the maximum discharge capacity of each of Sample 1-1 and Sample 1-2 shown in Table 4 is high. This indicates that LCO subjected to the initial heating is suitable for obtaining maximum discharge capacity.

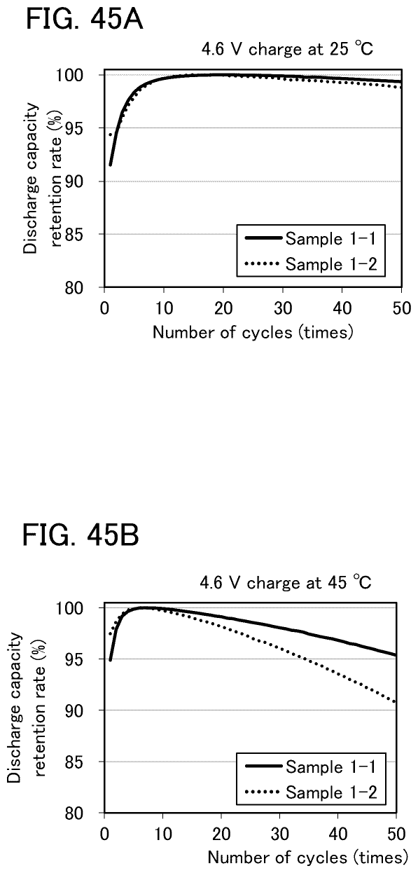

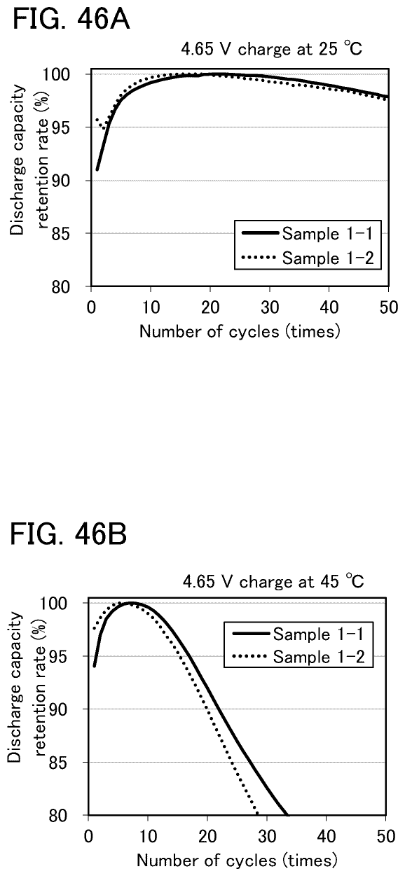

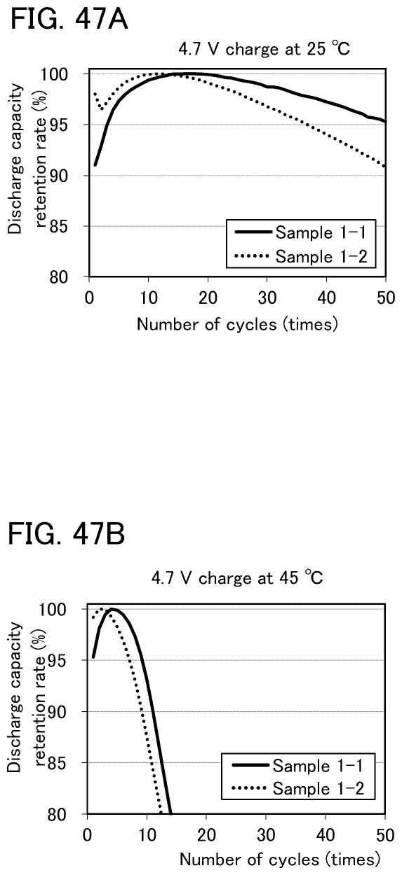

FIG. 45A, FIG. 45B, FIG. 46A, FIG. 46B, FIG. 47A, and FIG. 47B show the results of the charge and discharge cycle test in which measurements were performed under the above conditions. In FIG. 45A, FIG. 45B, FIG. 46A, FIG. 46B, FIG. 47A, and FIG. 47B, the horizontal axis represents the number of cycles (times) and the vertical axis represents the discharge capacity retention rate (%); the solid line denotes the results of Sample 1-1 and the dashed line denotes the results of Sample 1-2.

As shown in FIG. 45A, FIG. 45B, FIG. 46A, FIG. 46B, FIG. 47A, and FIG. 47B, LCO subjected to the initial heating exhibits high discharge capacity retention rate in the 25° C. environment, which is found suitable for battery characteristics. Specifically, in the 4.6 V charge, 4.65 V charge, and 4.7 V charge in the 25° C. environment, Sample 1-1 exhibits the discharge capacity retention rate after 50 cycles which is higher than or equal to 95%. Furthermore, in the 4.6 V and 4.65 V charges in the 25° C. environment, Sample 1-2 exhibits the discharge capacity retention rate after 50 cycles which is higher than or equal to 95%. This indicates that LCO subjected to the initial heating is suitable for obtaining discharge capacity.

As shown in FIG. 45A, FIG. 45B, FIG. 46A, FIG. 46B, FIG. 47A, and FIG. 47B, high discharge capacity retention rate is exhibited also in the 45° C. environment, which is found suitable for battery characteristics. Specifically, in the 4.6 V charge in the 45° C. environment, Sample 1-1 exhibits the discharge capacity retention rate after 50 cycles which is higher than or equal to 95%.

In this manner, the values and ranges of the discharge capacity retention rate can be read from FIG. 45A, FIG. 45B, FIG. 46A, FIG. 46B, FIG. 47A, and FIG. 47B.

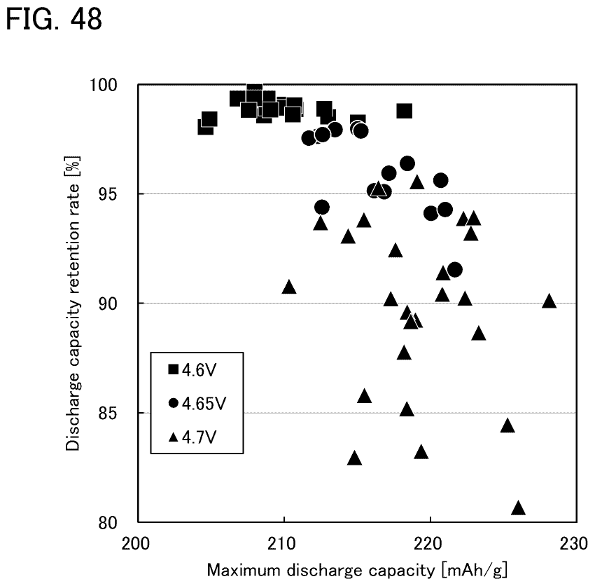

Under the same conditions, n samples were measured for verification of the discharge capacity retention rates shown in FIG. 45A, FIG. 45B, FIG. 46A, FIG. 46B, FIG. 47A, and FIG. 47B with an increased number n. Specifically, with the use of Sample 1-1 as a positive electrode active material for a positive electrode of a test battery including a negative electrode formed of lithium, 50 repetitions of a cycle were performed in which, in a 25° C. environment, constant current charge was performed at a charge rate of 0.5 C until the charge voltage reached 4.6 V, 4.65 V, or 4.7 V, constant voltage charge was performed at a voltage of 4.6 V, 4.65 V, or 4.7 V until the charge rate reached 0.05 C, and constant current discharge was then performed at a discharge rate of 0.5 C until a voltage of 2.5 V was reached. FIG. 48 shows the values of the discharge capacity retention rate in the 50th cycle (the discharge capacity in the 50th cycle/the maximum discharge capacity×100) with respect to maximum discharge capacity, which are listed in Table 5. In FIG. 48, squares represent the results of the 4.6 V charge, circles represent the results of the 4.65 V charge, and triangles represent the results of the 4.7 V charge.

TABLE 5

| | | | |
|---|---|---|---|
| | Maximum | Discharge | Discharge capacity |
| Charge | discharge | capacity in | retention rate |
| Voltage | capacity | 50th cycle | in 50th cycle |
| [V] | [mAh/g] | [mAh/g] | [%] |

| | | | | |
|---|---|---|---|---|
| 4.6 | V | 210.0 | 208.1 | 99.1 |
| 4.6 | V | 208.6 | 205.6 | 98.6 |
| 4.6 | V | 208.8 | 206.5 | 98.9 |
| 4.6 | V | 208.8 | 207.5 | 99.3 |
| 4.6 | V | 210.8 | 208.3 | 98.8 |
| 4.6 | V | 210.0 | 207.8 | 98.9 |
| 4.6 | V | 209.0 | 206.6 | 98.8 |
| 4.6 | V | 206.8 | 205.4 | 99.4 |
| 4.6 | V | 208.0 | 207.2 | 99.7 |
| 4.6 | V | 210.7 | 208.7 | 99.0 |
| 4.6 | V | 207.9 | 206.6 | 99.4 |
| 4.65 | V | 220.0 | 207.1 | 94.1 |
| 4.65 | V | 213.5 | 209.0 | 97.9 |
| 4.65 | V | 216.2 | 205.6 | 95.1 |
| 4.65 | V | 221.0 | 208.4 | 94.3 |
| 4.65 | V | 216.8 | 206.2 | 95.1 |
| 4.65 | V | 221.7 | 202.9 | 91.5 |
| 4.65 | V | 217.2 | 208.3 | 95.9 |
| 4.65 | V | 212.3 | 207.2 | 97.6 |
| 4.65 | V | 215.0 | 210.6 | 97.9 |
| 4.65 | V | 220.7 | 211.0 | 95.6 |
| 4.65 | V | 215.2 | 210.6 | 97.9 |
| 4.7 | V | 225.3 | 190.2 | 84.4 |
| 4.7 | V | 217.3 | 196.0 | 90.2 |
| 4.7 | V | 219.0 | 195.4 | 89.2 |
| 4.7 | V | 223.3 | 198.0 | 88.7 |
| 4.7 | V | 226.0 | 182.4 | 80.7 |
| 4.7 | V | 218.4 | 186.1 | 85.2 |
| 4.7 | V | 217.6 | 201.2 | 92.5 |
| 4.7 | V | 214.4 | 199.5 | 93.1 |
| 4.7 | V | 219.1 | 209.4 | 95.6 |
| 4.7 | V | 215.4 | 202.1 | 93.8 |
| 4.7 | V | 222.4 | 200.7 | 90.2 |
| 4.7 | V | 216.4 | 206.2 | 95.3 |

It is found that, in the case of the 4.6 V charge, the discharge capacity retention rate in the 50th cycle exhibits higher than or equal to 90%, preferably higher than or equal to 95%, further preferably higher than or equal to 97%, although there is some variation. It is found that, in the case of the 4.65V charge, the discharge capacity retention rate in the 50th cycle exhibits higher than or equal to 85%, preferably higher than or equal to 90%, further preferably higher than or equal to 92%. It is also found that, in the case of the 4.7 V charge, the discharge capacity retention rate in the 50th cycle exhibits higher than or equal to 80%, preferably higher than or equal to 85%, further preferably higher than or equal to 87%. In any case, the upper limit can be presumed to be lower than 100%.

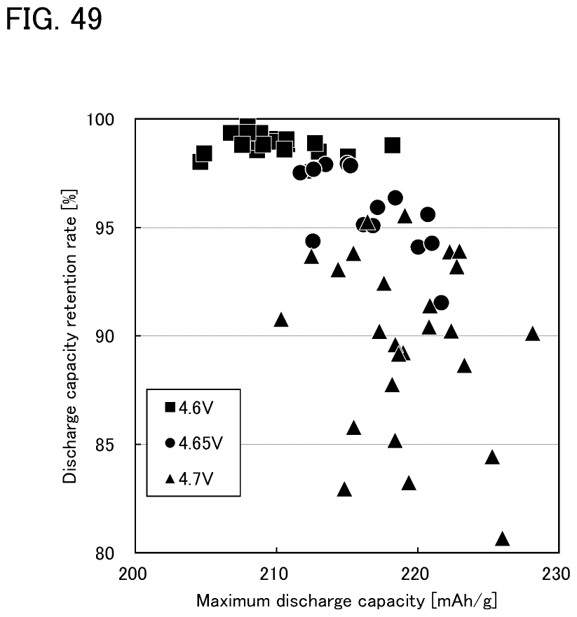

Under the same conditions as those of Sample 1-1, n samples were measured for verification of the discharge capacity retention rate of Sample 1-2 with an increased number n. Specifically, with the use of Sample 1-1 as a positive electrode active material for a positive electrode of a test battery including a negative electrode formed of a lithium metal, 50 repetitions of a cycle were performed in which, in a 25° C. environment, constant current charge was performed at a charge rate of 0.5 C until the charge voltage reached 4.6 V, 4.65 V, or 4.7 V, constant voltage charge was performed at a voltage of 4.6 V, 4.65 V, or 4.7 V until the charge rate reached 0.05 C, and constant current discharge was then performed at a discharge rate of 0.5 C until a voltage of 2.5 V was reached. FIG. 49 shows the values of the discharge capacity retention rate in the 50th cycle (the discharge capacity in the 50th cycle/the maximum discharge capacity×100) with respect to maximum discharge capacity, which are listed in Table 6. In FIG. 49, squares represent the results of the 4.6 V charge, circles represent the results of the 4.65 V charge, and triangles represent the results of the 4.7 V charge.

TABLE 6

| | | | |
|---|---|---|---|
| | Maximum | Discharge | Discharge capacity |
| Charge | discharge | capacity in | retention rate |
| Voltage | capacity | 50th cycle | in 50th cycle |
| [V] | [mAh/g] | [mAh/g] | [%] |

| | | | | |
|---|---|---|---|---|
| 4.6 | V | 215.0 | 211.3 | 98.3 |
| 4.6 | V | 218.2 | 215.5 | 98.8 |
| 4.6 | V | 213.0 | 209.8 | 98.5 |
| 4.6 | V | 212.7 | 210.4 | 98.9 |
| 4.6 | V | 204.6 | 200.5 | 98.0 |
| 4.6 | V | 210.6 | 207.6 | 98.6 |
| 4.6 | V | 207.6 | 205.1 | 98.8 |
| 4.6 | V | 204.9 | 201.6 | 98.4 |
| 4.65 | V | 218.4 | 210.5 | 96.4 |
| 4.65 | V | 212.6 | 200.6 | 94.4 |
| 4.65 | V | 211.7 | 206.4 | 97.5 |
| 4.65 | V | 212.6 | 207.7 | 97.7 |
| 4.7 | V | 222.3 | 208.7 | 93.9 |
| 4.7 | V | 222.8 | 207.6 | 93.2 |
| 4.7 | V | 223.0 | 209.4 | 93.9 |
| 4.7 | V | 228.1 | 205.6 | 90.1 |
| 4.7 | V | 220.9 | 201.9 | 91.4 |
| 4.7 | V | 220.8 | 199.7 | 90.4 |
| 4.7 | V | 218.4 | 195.7 | 89.6 |
| 4.7 | V | 219.4 | 182.6 | 83.2 |
| 4.7 | V | 214.8 | 178.2 | 83.0 |
| 4.7 | V | 215.5 | 184.9 | 85.8 |
| 4.7 | V | 210.3 | 190.9 | 90.8 |
| 4.7 | V | 212.5 | 199.1 | 93.7 |
| 4.7 | V | 218.7 | 195.0 | 89.2 |
| 4.7 | V | 218.2 | 191.5 | 87.8 |

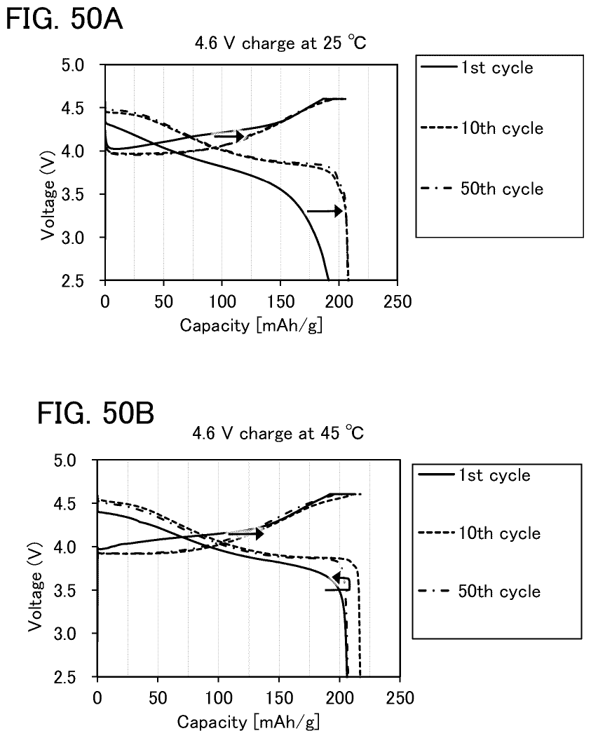

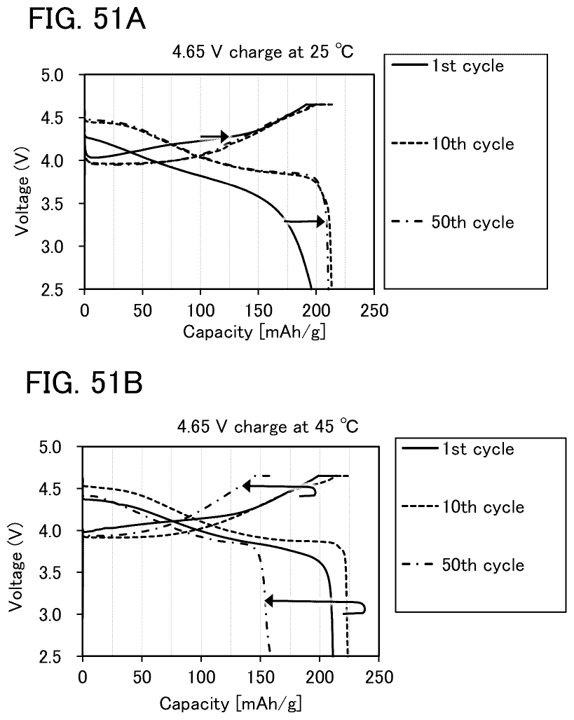

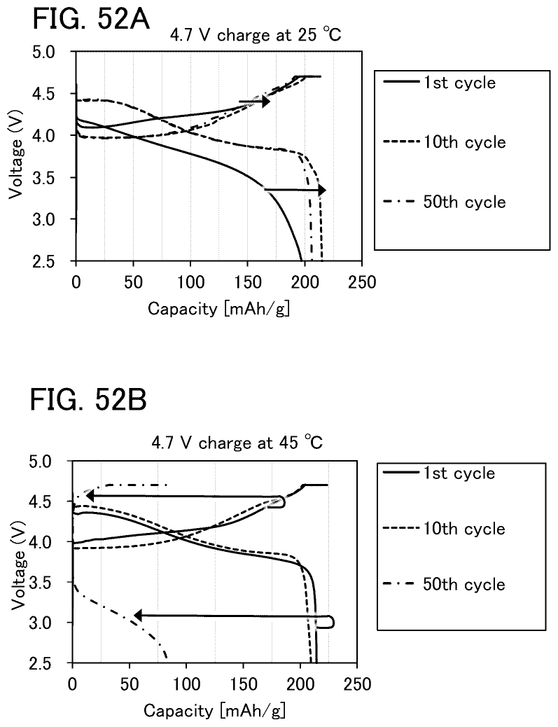

The charge and discharge curves of Sample 1-1 are shown in FIG. 50A to FIG. 52B. In each of FIG. 50A to FIG. 52B, which are the graphs similar to those in FIG. 42A to FIG. 44B, arrows are added to clearly show the changes of charge and discharge curves in a range from the 1st cycle to the 50th cycle.

In the charge curves of Sample 1-1 in FIG. 50A to FIG. 52B, the voltage is low and the capacity is low during several cycles from the 1st cycle. In the 25° C. environment, Sample 1-1 is found to exhibit high capacity, for example, in the 10th cycle and the subsequent cycles, excluding the several cycles during which the capacity is low. In the 45° C. environment, Sample 1-1 causes a capacity decrease through the 4.7 V charge and exhibits a change in the shape of the charge and discharge curve, indicating degradation.

### <Rate Performance>

Next, in a 25° C. environment, the discharge capacity of Sample 1-1 were measured while the rate at the time of charge was fixed to 0.5 C until the voltage reached 4.6 V, 4.65 V, and 4.7 V and the rate at the time of discharge was varied to 0.2 C, 0.5 C, 1 C, 2 C, 3 C, 4 C, 5 C, and 0.2 C in this order. The measurement is referred to as rate performance in some cases. Note that the discharge capacity at each rate was measured twice.

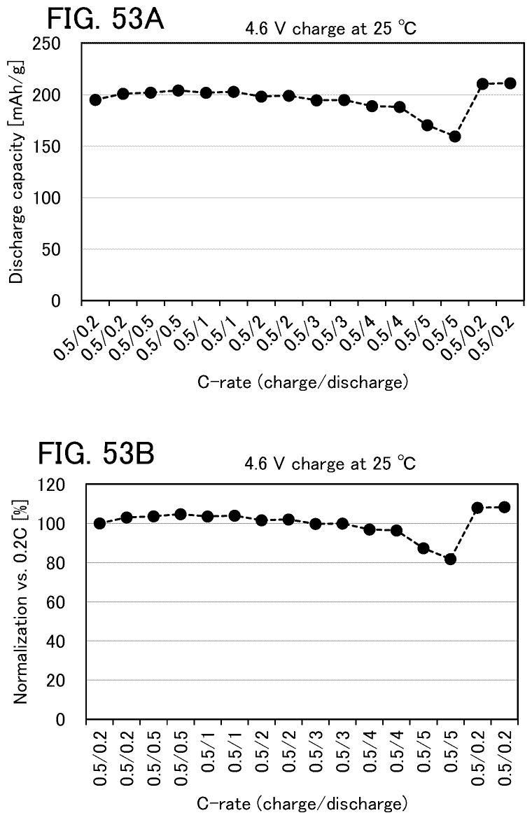

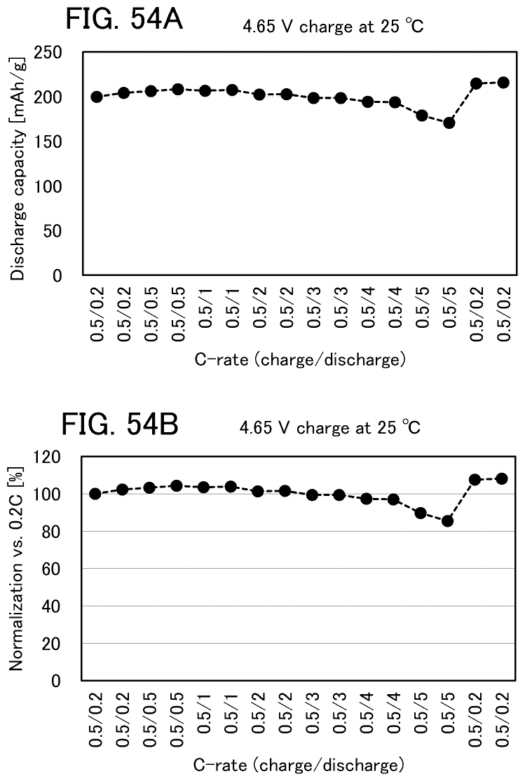

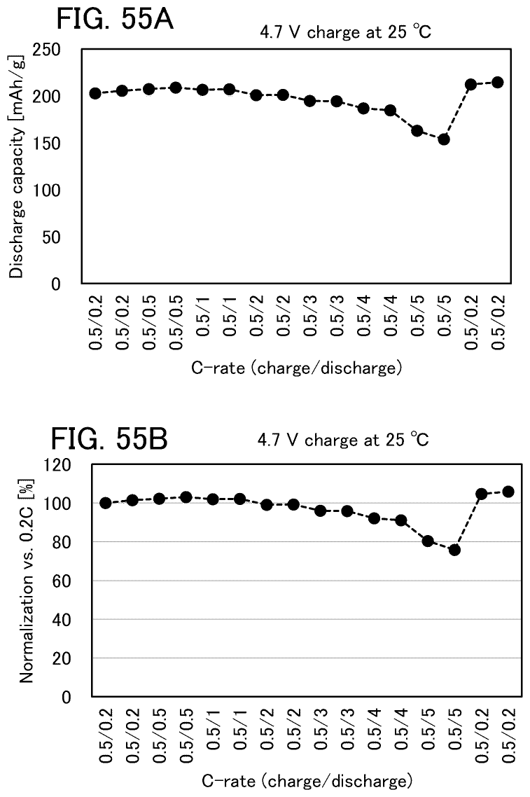

FIG. 53A to FIG. 55B show the results of the above measurements. In FIG. 53A, FIG. 54A, and FIG. 55A, the horizontal axis represents C-rate as the charge rate/discharge rate and the vertical axis represents discharge capacity (mAh/g). FIG. 53B, FIG. 54B, and FIG. 55B show the graphs of the results normalized with the discharge capacity at the time of the rate condition (C-rate: 0.5/0.2) used in the initial cycle.

The results in FIG. 53A, FIG. 54A, and FIG. 55A are listed in Table 7. The results in FIG. 53B, FIG. 54B, and FIG. 55B are listed in Table 8. According to FIG. 53A to FIG. 55B, Table 7, and Table 8, the rate performance of Sample 1-1 is good at any charge voltage. By comparison at equal C rates, the discharge capacity is higher at an initial C rate of 0.5/0.2 than at a last C rate of 0.5/0.2.

TABLE 7

| C-rate | | Discharge capacity (mAh/g) | | |
|---|---|---|---|---|
| Charge | Discharge | 4.6 V charge | 4.65 V charge | 4.7 V charge |
| 0.5 | 0.2 | 195.0 | 199.8 | 202.9 |
| 0.5 | 0.2 | 200.9 | 204.3 | 205.8 |
| 0.5 | 0.5 | 202.0 | 206.2 | 207.4 |
| 0.5 | 0.5 | 204.1 | 208.3 | 209.1 |
| 0.5 | 1 | 201.9 | 206.7 | 206.8 |
| 0.5 | 1 | 202.8 | 207.5 | 207.3 |
| 0.5 | 2 | 198.1 | 202.3 | 201.0 |
| 0.5 | 2 | 198.9 | 202.8 | 201.4 |
| 0.5 | 3 | 194.5 | 198.5 | 194.8 |
| 0.5 | 3 | 194.8 | 198.5 | 194.6 |
| 0.5 | 4 | 188.9 | 194.3 | 186.9 |
| 0.5 | 4 | 188.0 | 193.7 | 184.7 |
| 0.5 | 5 | 170.3 | 179.0 | 163.1 |
| 0.5 | 5 | 159.5 | 170.7 | 153.9 |
| 0.5 | 0.2 | 210.5 | 214.8 | 212.4 |
| 0.5 | 0.2 | 211.1 | 215.9 | 214.8 |

TABLE 8

| C-rate | | Normalization at 0.2 C (%) | | |
|---|---|---|---|---|
| Charge | Discharge | 4.6 V charge | 4.65 V charge | 4.7 V charge |
| 0.5 | 0.2 | 100.0 | 100.0 | 100.0 |
| 0.5 | 0.2 | 103.1 | 102.3 | 101.4 |
| 0.5 | 0.5 | 103.6 | 103.2 | 102.3 |
| 0.5 | 0.5 | 104.7 | 104.3 | 103.1 |
| 0.5 | 1 | 103.5 | 103.5 | 102.0 |
| 0.5 | 1 | 104.0 | 103.9 | 102.2 |
| 0.5 | 2 | 101.6 | 101.3 | 99.1 |
| 0.5 | 2 | 102.0 | 101.5 | 99.3 |
| 0.5 | 3 | 99.8 | 99.4 | 96.0 |
| 0.5 | 3 | 99.9 | 99.4 | 95.9 |
| 0.5 | 4 | 96.9 | 97.3 | 92.1 |
| 0.5 | 4 | 96.4 | 96.9 | 91.1 |
| 0.5 | 5 | 87.4 | 89.6 | 80.4 |
| 0.5 | 5 | 81.8 | 85.5 | 75.9 |
| 0.5 | 0.2 | 108.0 | 107.5 | 104.7 |
| 0.5 | 0.2 | 108.3 | 108.1 | 105.9 |

### <Temperature and Charge Voltage Dependence>

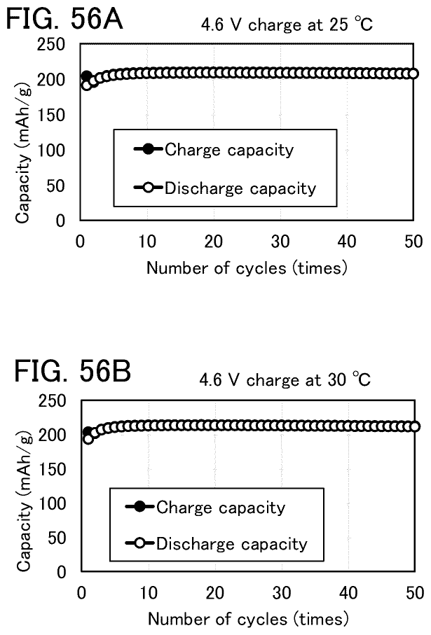

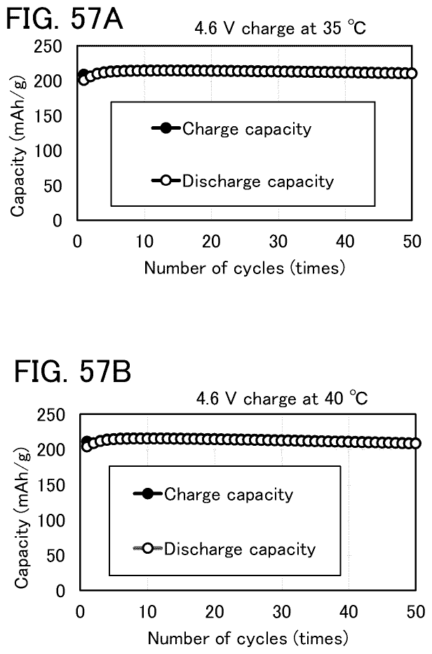

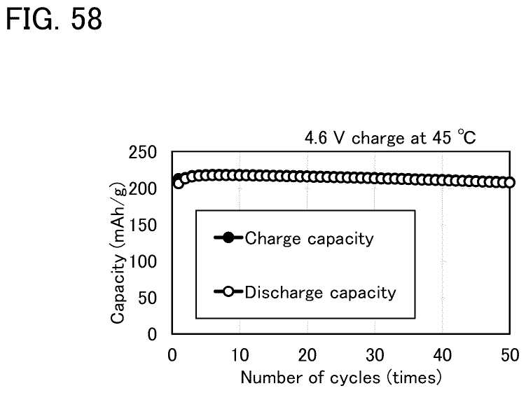

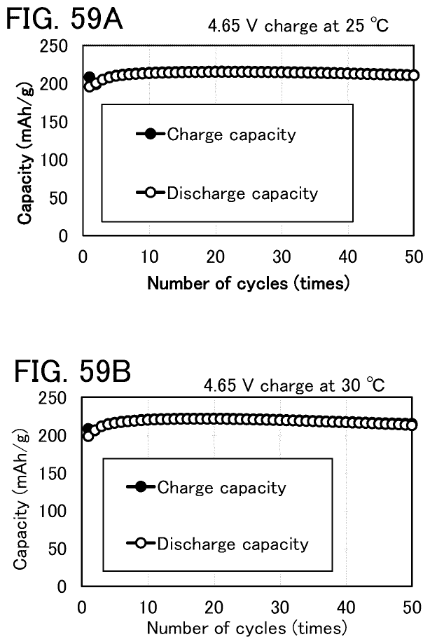

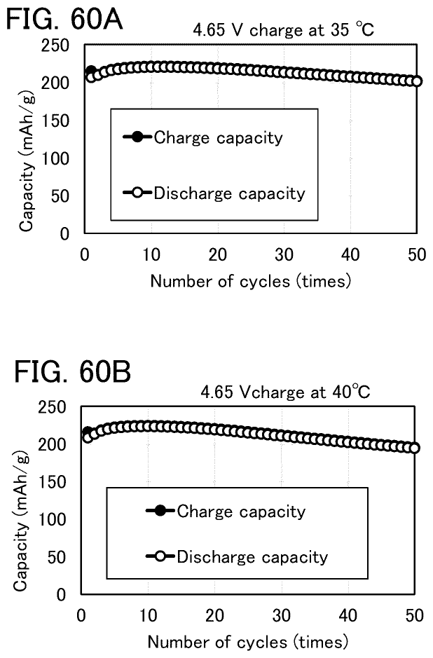

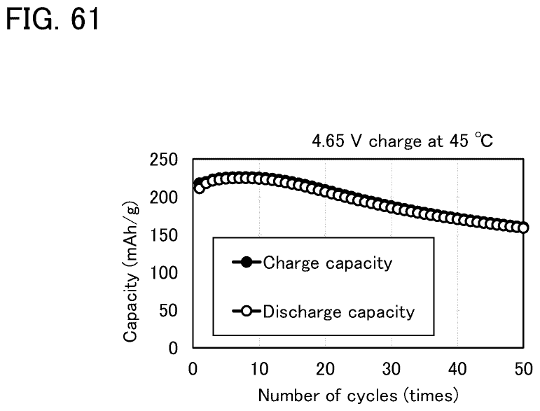

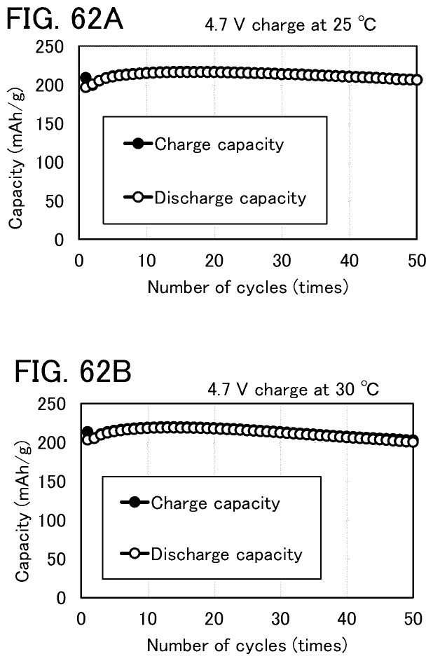

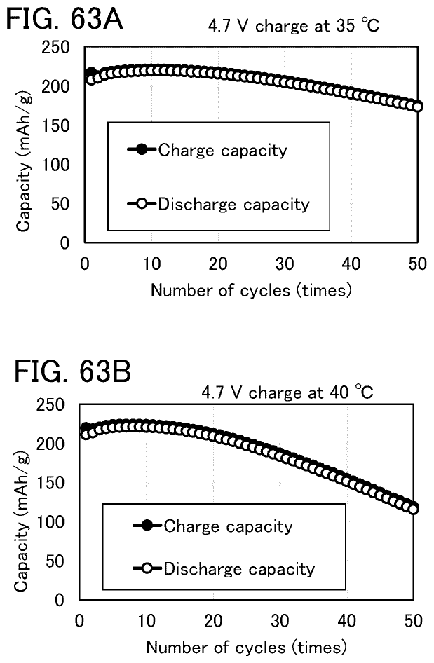

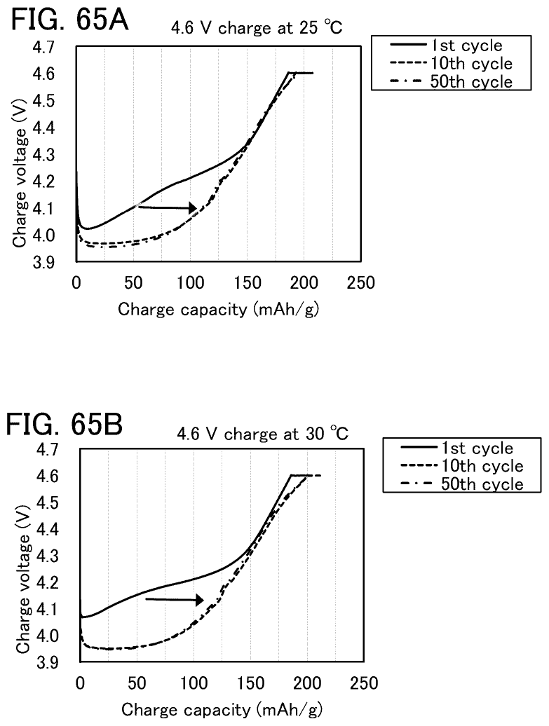

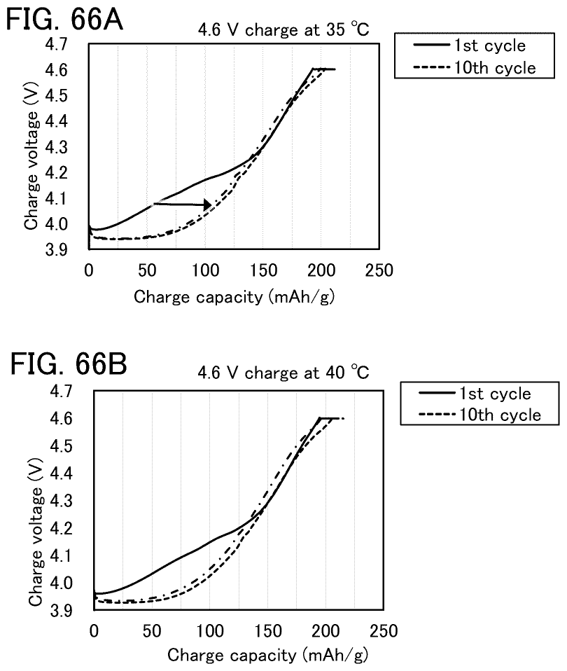

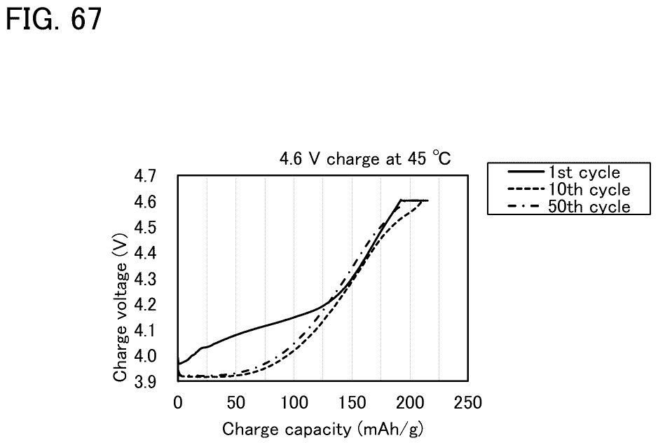

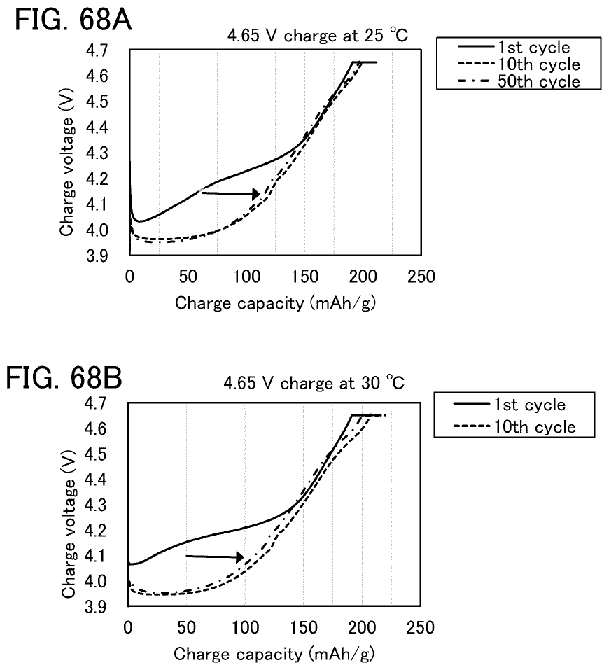

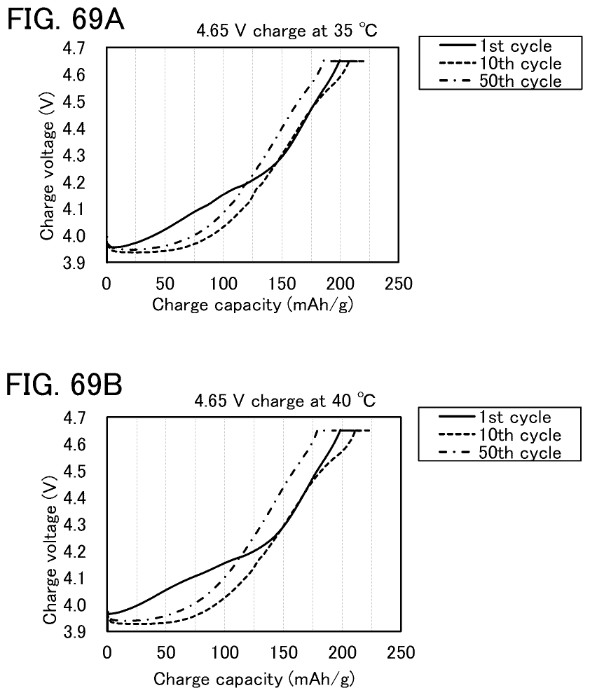

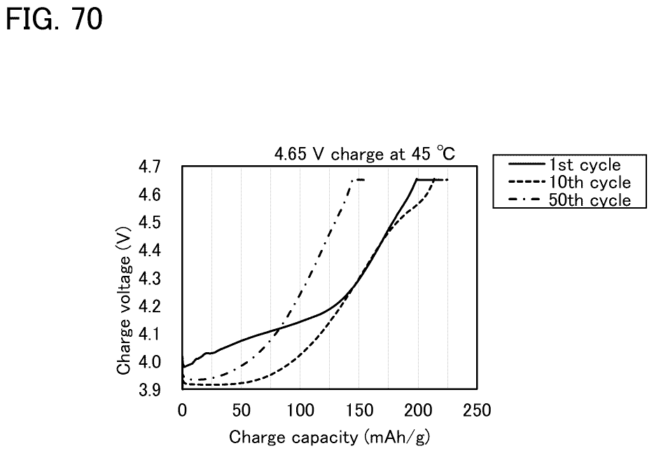

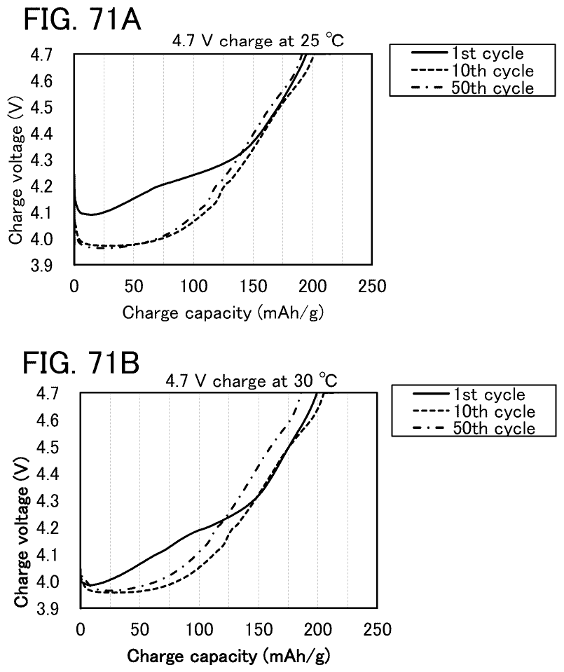

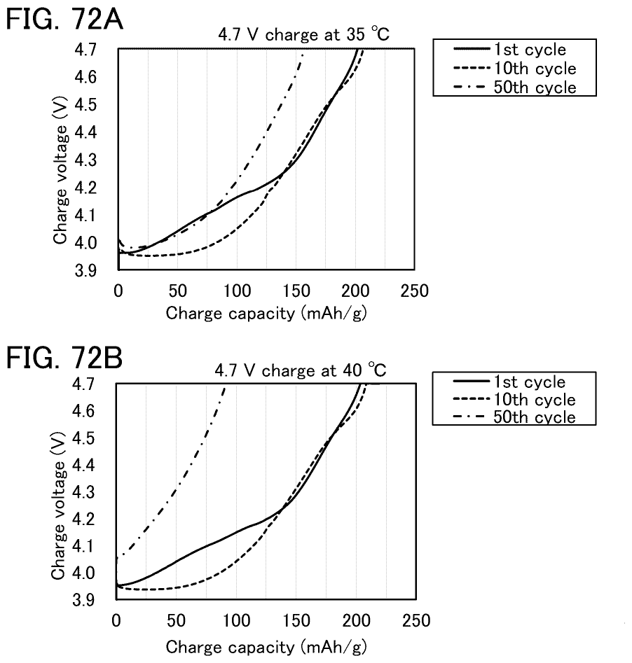

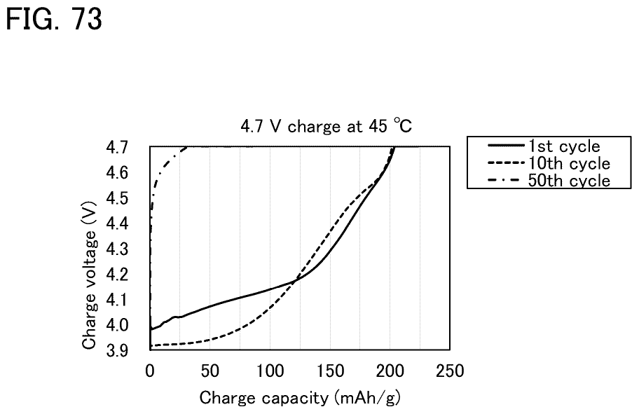

Next, Sample 1-1 was subjected to additional charge and discharge cycle tests in 30° C., 35° C., and 40° ° C. environments. Examination is performed together with the charge and discharge cycle tests previously performed in the 25° C. and 45° C. environments. The charge and discharge rate was set to 0.5 C in any case. The measurement results are shown in FIG. 56A to FIG. 64. In FIG. 56A to FIG. 64, the horizontal axis represents the number of cycles (times) and the vertical axis represents capacity (mAh/g). FIG. 65A to FIG. 73 show charge curves that were measured under the same conditions. FIG. 65A to FIG. 73 are graphs showing superimposed charge and discharge curves in the 1st cycle, the 10th cycle, and the 50th cycle which are based on the obtained charge and discharge curves in a range from the 1st cycle to the 50th cycle inclusive.

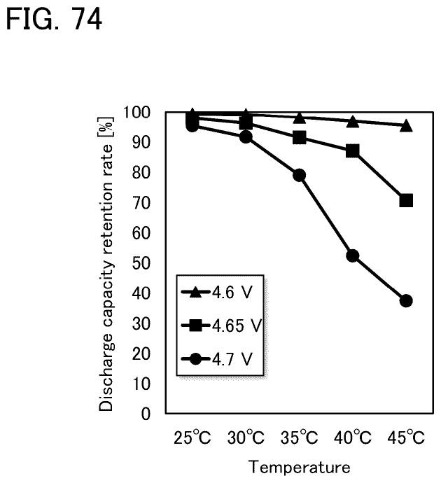

FIG. 74 and Table 9 show the discharge capacity retention rates (%) after the 50 cycles obtained from the results of the charge and discharge cycle tests at each temperature in FIG. 56A to FIG. 64. In Table 9, a region of relatively low discharge capacity retention rates is surrounded by a thick solid line.

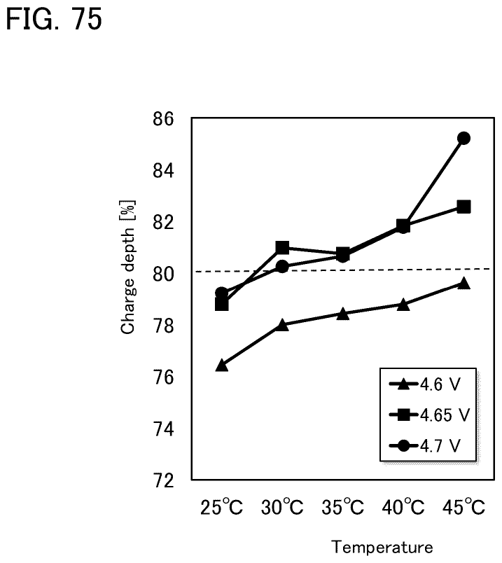

FIG. 75 and Table 10 show the charge depth obtained from the results of the charge and discharge cycle tests at each temperature in FIG. 65A to FIG. 73. Note that the charge depth can be obtained from the maximum charge capacity/theoretical capacity×100, and the theoretical capacity of LCO was set to 274 mAh/g. In FIG. 75, a dashed line is drawn to represent a 80% charge depth, which corresponds to 220 mAh/g charge capacity.

FIG. 56A to FIG. 75, Table 9, and Table 10 reveal that, when the charge depth is lower than 80%, the charge capacity and the discharge capacity retention rate are high and the battery characteristics are good in any temperature environment.

### <Analysis of Positive Electrode in Charge and Discharge Cycle of Half Cell>

In charge and discharge cycle tests of Sample 1-1, the relationship between change in Sample 1-1 and the number of charge and discharge cycles was examined for conditions at a charge voltage of 4.7 V and 25° ° C. and 45° C. environments.

In contrast with Sample 1-1 not subjected to the charge and discharge cycle tests, Sample 1-1 (25-1 C) and Sample 1-1 (45-1 C) denote the samples after one cycle, Sample 1-1 (25-5 C) and Sample 1-1 (45-5 C) denote the samples after 5 cycles, Sample 1-1 (25-15 C) and Sample 1-1 (45-15 C) denote the samples after 15 cycles, Sample 1-1 (25-30 C) and Sample 1-1 (45-30 C) denote the samples after 30 cycles, and Sample 1-1 (25-50 C) and Sample 1-1 (45-50 C) denote the samples after 50 cycles. Charge and discharge cycle conditions for Sample 1-1 (25-1 C) to Sample 1-1 (45-50 C) are shown in Table 11 and Table 12.

TABLE 11

| | Charge and discharge | | State of analysis sample | |
|---|---|---|---|---|
| | conditions | | | Cross-sectional STEM |
| | Measurement | Number | | analysis/cross- |
| Sample name | temperature | of cycles | XRD analysis | sectional SEM analysis |
| Sample 1-1 (25-1 C) | 25° C. | 1 | Charged state | Unanalyzed/unanalyzed |
| Sample 1-1 (25-5 C) | | 5 | Charged state | Unanalyzed/unanalyzed |
| Sample 1-1 (25-15 C) | | 15 | Charged state | Unanalyzed/unanalyzed |
| Sample 1-1 (25-30 C) | | 30 | Charged state | Unanalyzed/unanalyzed |
| Sample 1-1 (25-50 C) | | 50 | Charged state | Discharged state/ |
| | | | | discharged state |

TABLE 12

| | Charge and discharge | | State of analysis sample | |
|---|---|---|---|---|
| | conditions | | | Cross-sectional STEM |
| | Measurement | Number | | analysis/cross- |
| Sample name | temperature | of cycles | XRD analysis | sectional SEM analysis |
| Sample 1-1 (45-1 C) | 45° C. | 1 | Charged state | Discharged state/ |
| | | | | discharged state |
| Sample 1-1 (45-5 C) | | 5 | Charged state | Discharged state/ |
| | | | | discharged state |
| Sample 1-1 (45-15 C) | | 15 | Charged state | Discharged state/ |
| | | | | discharged state |
| Sample 1-1 (45-30 C) | | 30 | Charged state | Discharged state/ |
| | | | | discharged state |
| Sample 1-1 (45-50 C) | | 50 | Charged state | Discharged state/ |
| | | | | discharged state |

The various conditions not included in Table 11 and Table 12 are similar to the formation conditions of the positive electrodes, the formation conditions of the coin-type half cells, and the conditions of the charge and discharge cycle tests for the evaluation results shown in FIG. 56A to FIG. 73.

Two samples, a sample for an XRD analysis and a sample for a cross-sectional STEM analysis and a cross-sectional SEM analysis, were formed for each of Sample 1-1 (25-1 C) to Sample 1-1 (45-50 C). As shown in Table 11 and Table 12, each of Sample 1-1 (25-1 C) to Sample 1-1 (45-50 C) was brought into a charged state in the XRD analysis. To cause the charged state, constant current charge at 0.05 C (termination voltage: 4.7 V) was employed only for the charge in the last cycle.

For the XRD analysis, Sample 1-1 (25-1 C) to Sample 1-1 (45-50 C) were analyzed by XRD measurement and Rietveld method. The XRD measurement was performed with D8 ADVANCE manufactured by Bruker Corporation under the conditions described in <<XRD>> in Embodiment 2. On the obtained XRD measurement data, background removal and CuKα2 radiation component removal were performed using analysis software EVA manufactured by Bruker Corporation, and then analysis by the Rietveld method was performed. For the analysis by the Rietveld method, an analysis program RIETAN-FP (see F. Izumi and K. Momma, Solid State Phenom., 130, 15-20 (2007)) was used.

In the analysis by the Rietveld method, multiphase analysis was conducted to determine the abundance of the O3 structure, the O3′ structure, the H1-3 structure, and the O1 structure in each sample. Here, the abundance of an amorphous portion in Sample 1-1 not subjected to the charge and discharge cycle was assumed to be zero. The abundance of the amorphous portion in each of Sample 1-1 (25-1 C) to Sample 1-1 (45-50 C) was assumed to be the remainder of subtraction of the total abundance of the O3 structure, the O3′ structure, the H1-3 structure, and the O₁ structure in each of Sample 1-1 (25-1 C) to Sample 1-1 (45-50 C) from the total abundance of the O3 structure, the O3′ structure, the H1-3 structure, and the O1 structure in Sample 1-1. Here, the abundance of the amorphous portion in each of Sample 1-1 (25-1 C) to Sample 1-1 (45-50 C) can be regarded as the abundance of an amorphous portion generated or increased by the charge and discharge cycle.

In the analysis by the Rietveld method, a value output by RIETAN-FP was used as the scale factor. The abundance ratio of each of the O3 structure, the O3′ structure, the H1-3 structure, and the O₁ structure was calculated in molar fraction from the number of the multiplicity factors of the crystal structure and the number of the chemical formula units in a unit cell for the crystal structure. In the analysis of Sample 1-1 to Sample 1-1 (45-50 C) by the Rietveld method, each sample was standardized with white noise in the range including no significant signals in this XRD measurement (2θ=greater than or equal to 23° and less than or equal to 27°), and each abundance is not an absolute value but a relative value. Table 13 and Table 14 list the abundance ratios of the O3 structure, the O3′ structure, the H1-3 structure, the O1 structure, and the amorphous portion in Sample 1-1 to Sample 1-1 (45-50 C) in percentage terms.

As the cross-sectional STEM analysis of Sample 1-1 to Sample 1-1 (45-50 C), the area of a freely selected range and the area of a closed split existing in the freely selected range (the total area of closed splits when there were a plurality of closed splits) in a cross-sectional STEM image of an active material particle included in the positive electrode were calculated, and the proportion of the closed split in the freely selected range of a cross section of the particle (the proportion of the closed split) were calculated in percentage terms. Table 13 and Table 14 show the proportion of the closed split in Sample 1-1 to Sample 1-1 (45-50 C).

As the cross-sectional SEM analysis of Sample 1-1 to Sample 1-1 (45-50 C), whether a pit was generated on a surface of the active material particle existing in a predetermined range in a positive electrode cross section was analyzed in a cross-sectional SEM image of each positive electrode. In the case where pits were generated, the number of the pits were measured. The active material particle existing in an area of approximately 26 μm×approximately 19 μm was subjected to the cross-sectional SEM analysis in this example.

TABLE 13

| | XRD analysis | | Cross-sectional | |
|---|---|---|---|---|
| | | Abundance | STEM analysis | Cross-sectional |
| | | ratio | (Proportion of | SEM analysis |
| Sample name | Cyrstal structure | (%) | closed split) | (Number of pits) |
| Sample 1-1 (neither | O3 structure | 100 | Not observed | Not observed |
| charged nor discharged) | | | | |
| Sample 1-1 (25-1 C) | O3 structure | 44 | Unanalyzed | Unanalyzed |
| | O3′ structure | 34 | | |
| | Amorphous portion | 22 | | |
| Sample 1-1 (25-5 C) | O3 structure | 32 | Unanalyzed | Unanalyzed |
| | O3′ structure | 51 | | |
| | Amorphous portion | 17 | | |
| Sample 1-1 (25-15 C) | Unmeasured | | Unanalyzed | Unanalyzed |
| Sample 1-1 (25-30 C) | Unmeasured | | Unanalyzed | Unanalyzed |
| Sample 1-1 (25-50 C) | O3 structure | 6 | Not observed | 1 |
| | O3′ structure | 42 | | |
| | H1-3 structure | 10 | | |
| | Amorphous portion | 42 | | |

TABLE 14

| | XRD analysis | | Cross-sectional | |
|---|---|---|---|---|
| | | Abundance | STEM analysis | Cross-sectional |
| | | ratio | (Proportion of | SEM analysis |
| Sample name | Cyrstal structure | (%) | closed split) | (Number of pits) |
| Sample 1-1 (neither | O3 structure | 100 | Not observed | Not observed |
| charged nor discharged) | | | | |
| Sample 1-1 (45-1 C) | O3 structure | 56 | Not observed | Not observed |
| | O3′ structure | 32 | | |
| | Amorphous portion | 12 | | |
| Sample 1-1 (45-5 C) | O3 structure | 11 | Not observed | Not observed |
| | O3′ structure | 15 | | |
| | H1-3 structure | 23 | | |
| | O1 structure | 12 | | |
| | Amorphous portion | 39 | | |
| Sample 1-1 (45-15 C) | O3 structure | 3 | 0.08 | 3 |
| | O3′ structure | 42 | | |
| | H1-3 structure | 9 | | |
| | Amorphous portion | 46 | | |
| Sample 1-1 (45-30 C) | Unmeasured | | 0.37 | 13 |
| Sample 1-1 (45-50 C) | O3 structure | 40 | 0.35 | 34 |
| | H1-3 structure | 2 | | |
| | Amorphous portion | 58 | | |

In the XRD analysis results shown in Table 13, the abundance ratio of the amorphous portion increases as the number of charge and discharge cycles of the sample is larger.

According to the cross-sectional STEM analysis results and cross-sectional SEM analysis results shown in Table 13, any closed split inside the particle was not observed by the cross-sectional STEM analysis even after 50 cycles in the charge and discharge cycle test in the 25° C. environment.

In the XRD analysis results shown in Table 14, the charge and discharge cycle test in the 45° C. environment follows a similar trend in which the abundance ratio of the amorphous portion increases as the number of charge and discharge cycles is larger. However, in the charge and discharge cycle test in the 45° C. environment, the H1-3 structure and the O1 structure exist in Sample 1-1 (45-5 C). Furthermore, the abundance ratio of the amorphous portion tends to be higher in the samples in the 25° C. environment than in the samples in the 45° C. environment. In particular, the abundance ratio of the amorphous portion in Sample 1-1 (45-50 C) is 58%, which indicates a significant reduction in crystallinity.

According to the cross-sectional STEM analysis results and the cross-sectional SEM analysis results shown in Table 14, generation of closed splits inside the particles of Sample 1-1 (45-15 C) to Sample 1-1 (45-50 C) after 15 or more cycles are observed in the cross-sectional STEM analysis results. Generation of pits are also observed in the samples after 15 or more cycles also in the cross-sectional SEM analysis results, which indicates that more pits tend to be generated in the sample subjected to a larger number of charge and discharge cycles.

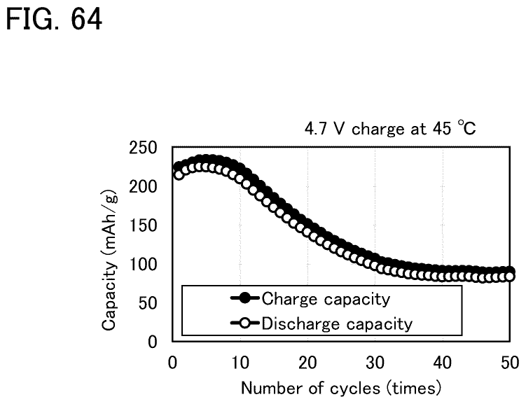

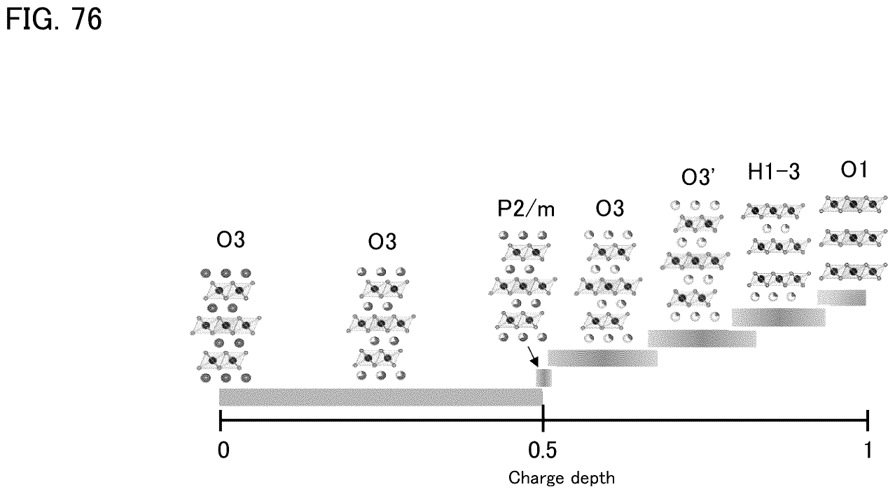

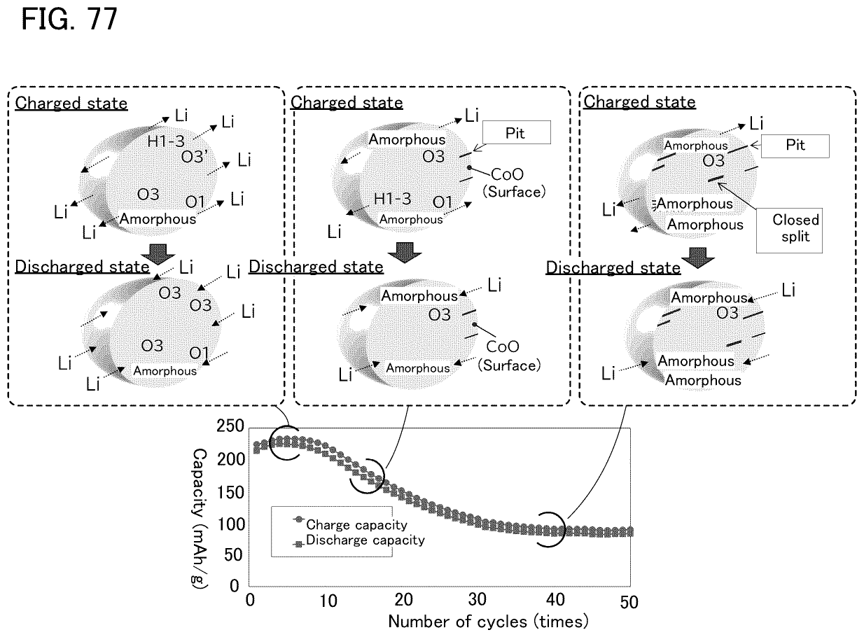

FIG. 76 and FIG. 77 are respectively a conceptual diagram showing the relationship between the charge depth and the crystal structure and a conceptual diagram showing the change in crystal structure inside the active material particle with repetition of the charge and discharge cycle, which are based on the XRD analysis results shown in Table 14. The graph shown in the lower part of FIG. 77 corresponds to the graph shown in FIG. 64. As illustrated in FIG. 76 and FIG. 77, as the charge and discharge cycles progress, not only the structures up to the O3′ structure but also the H1-3 structure and the O1 structure come to be formed and the proportion of the amorphous portion becomes higher. Hence, under the conditions at a charge voltage of 4.7 V and 45° C., degradation is presumably attributed to the charge and discharge cycles to a large degree.

### <Charge and Discharge Cycle Performance of Full Cell>

Next, a full cell was fabricated and its cycle performance was evaluated. Through the evaluation of the cycle performance of the full cell, the performance of a secondary battery can be clarified.

First, the full cell was assembled using Sample 1-1 as the positive electrode active material. The conditions of the full cell were similar to the conditions of the half cells described above except that graphite was used for the negative electrode and no additive agent was added. In the negative electrode, VGCF (registered trademark), carboxymethyl cellulose (CMC), and styrene butadiene rubber (SBR) were added besides graphite. CMC was added to increase viscosity, and SBR was added as a binder. Note that mixing was performed so that graphite:VGCF:CMC:SBR=96:1:1:2 (weight ratio).

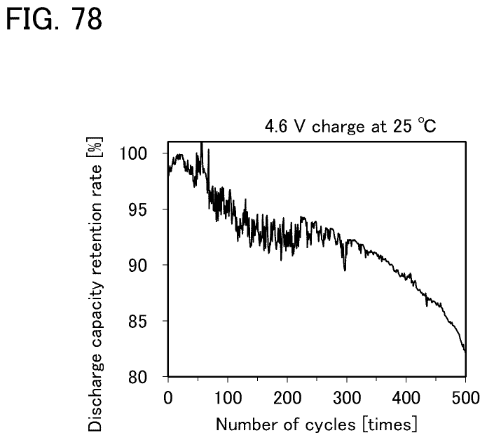

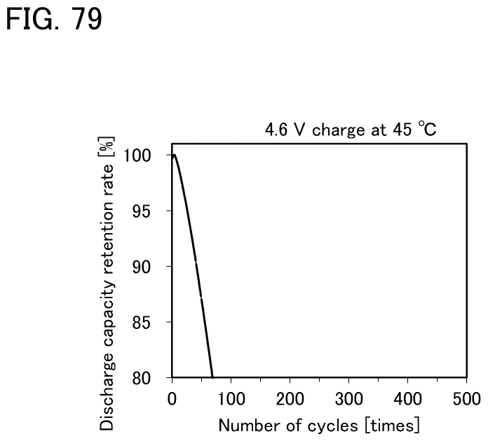

FIG. 78 is a diagram show in results of the cycle performance and the discharge capacity retention rate at a charge and discharge voltage of 4.6 V in a 25° C. environment when charge and discharge were performed at a charge rate and discharge rate of 0.2 C (1 C=200 mA/g). In the evaluation of the cycle performance of the full cell, the discharge termination voltage was set to 3 V. As the cycle performance shown in FIG. 78, it is found that the maximum discharge capacity is 205.1 mAh/g and the discharge capacity retention rate in the 500th cycle is 82.3%, i.e., higher than or equal to 80%. These are favorable battery characteristics. FIG. 79 shows results of the discharge capacity retention rate in a 45° C. environment, which are obtained when the other conditions similar to those of FIG. 78. As the cycle performance shown in FIG. 79, the maximum discharge capacity is 194 mAh/g.

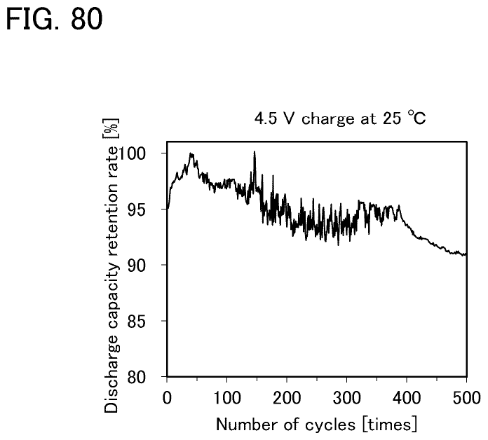

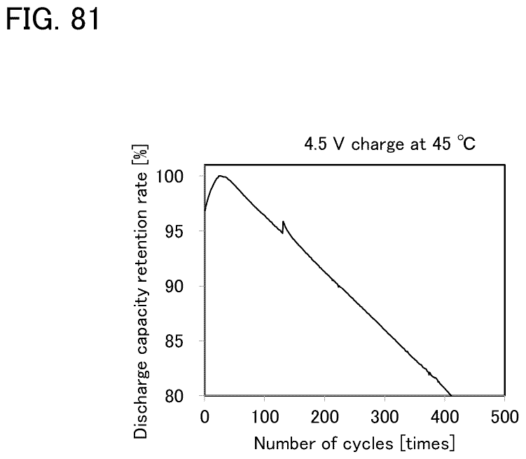

FIG. 80 is a diagram show in results of the cycle performance and the discharge capacity retention rate at a charge and discharge voltage of 4.5 V in a 25° C. environment when charge and discharge were performed at a charge rate and discharge rate of 0.2 C (1 C=200 mA/g). In the evaluation of the cycle performance of the full cell, the discharge termination voltage was set to 3 V. As the cycle performance shown in FIG. 80, it is found that the maximum discharge capacity is 196.6 mAh/g and the discharge capacity retention rate in the 500th cycle is 91.0%, i.e., higher than or equal to 90%. These are favorable battery characteristics. FIG. 81 shows results of the discharge capacity retention rate in a 45° C. environment, which are obtained when the other conditions similar to those of FIG. 80. As the cycle performance shown in FIG. 81, the maximum discharge capacity is 198.5 mAh/g.

For the cycle performance of the full cell, since graphite was used as the negative electrode, the charge and discharge voltage was lower than that in the case of the half cell including the lithium counter electrode, by approximately 0.1 V. That is, a charge voltage of 4.5 V in the full cell is equivalent to a charge voltage of 4.6 V in the half cell.

### Example 2

This example shows the temperature characteristics and rate performance of a secondary battery using a positive electrode formed under the conditions similar to those in Example 1.

As the positive electrode, a positive electrode formed under the conditions similar to those of Sample 1-1 described in Example 1 was used. Note that in addition to a positive electrode in which the loading level of the positive electrode active material per unit area was approximately 7 mg/cm², a positive electrode under the condition of approximately 5 mg/cm² and a positive electrode with approximately 20 mg/cm² were also formed.

A test half cell was assembled. A lithium metal was prepared as a negative electrode, i.e., a counter electrode. A separator was interposed between the positive electrode and the negative electrode, and contained together with an electrolyte solution in an exterior material.

For the electrolyte solutions, two conditions were employed. Under the first condition, a mixture solution of ethylene carbonate (EC) and diethyl carbonate (DEC) at EC:DEC=3:7 (volume ratio) to which vinylene carbonate (VC) was added as an additive agent at 2 wt % was used as the solvent of the electrolyte solution. As an electrolyte contained in the electrolyte solution, 1 mol/L lithium hexafluorophosphate (LiPF₆) was used.

Under the second condition, EMI-FSA (1-ethyl-3-methylimidazolium bis(fluorosulfonyl)amide) was used as the solvent of the electrolyte solution. As an electrolyte contained in the electrolyte solution, 2.15 mol/L of LiFSA (lithium bis(fluorosulfonyl)amide) was used and the concentration of the electrolyte in the electrolyte solution was 2.15 mol/L.

As the separators, porous polypropylene was used for the half cell using the electrolyte solution of the first condition and porous polyimide was used for the half cell using the electrolyte solution of the second condition.

### <Temperature Characteristics>

Temperature characteristics were measured. Evaluation was performed for the positive electrode in which the loading level of the positive electrode active material per unit area was approximately 5 mg/cm².

The measurement conditions are described.

As aging, charge and discharge were performed three times. The aging was performed in a thermostatic oven with a temperature (referred to as an environment temperature) of 25° C. As first charge, constant current charge was performed at 0.1 C up to the upper limit voltage and constant voltage charge was further performed with the lower limit set to 0.01 C. As first discharge after the first charge, constant current discharge was performed at 0.1 C with the lower limit voltage set to 2.5 V. As second charge, constant current charge was performed at 0.5° C. up to the upper limit voltage and constant voltage charge was further performed with the lower limit set to 0.05 C. As second discharge after the second charge, constant current discharge was performed at 0.5 C with the lower limit voltage set to 2.5 V. As third charge, constant current charge was performed at 0.5 C up to the upper limit voltage and constant voltage charge was further performed with the lower limit set to 0.05 C. As third discharge after the third charge, constant current discharge was performed at 0.1 C with the lower limit voltage set to 2.5 V. Note that the upper limit voltage of charge was adjusted to the upper limit voltage in acquisition of temperature characteristics.

After the aging, the temperature characteristics were evaluated. As for charge, after constant current charge at 0.5 C, constant voltage charge was performed with the lower limit set to 0.05 C. Different conditions were employed for the half cells having, respectively, the upper limit charge voltages of 4.6 V and 4.7 V. Discharge was performed at 0.1 C. 1 C was set to 200 mA/g. Here, the weight used for rate calculation was the weight of the positive electrode active material.

Charge was performed at an environment temperature of 25° C. and discharge was performed at environment temperatures of 25° C., 15° C., 0° C., −20° C., −40° C., 45° C., 60° C., 80° C., and 100° ° C. for the evaluation of the temperature characteristics.

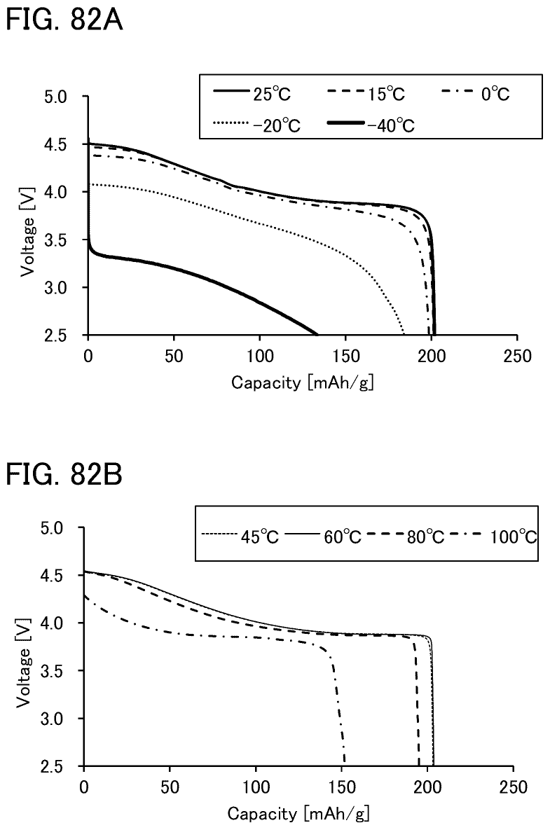

FIG. 82A to FIG. 84 show results of the half cells using a first electrolyte solution as the electrolyte solution.

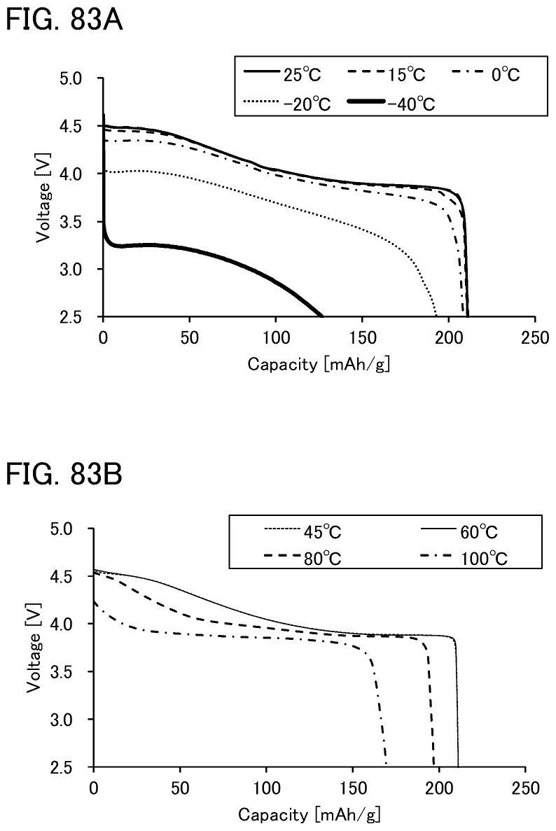

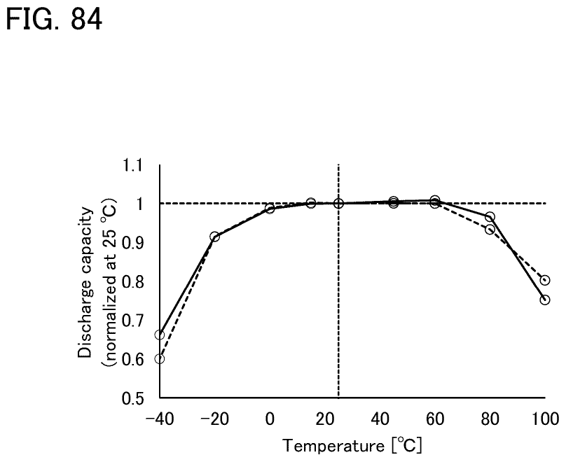

FIG. 82A and FIG. 82B show discharge curves when the upper limit voltage of charge is set to 4.6 V. FIG. 83A and FIG. 83B show discharge curves when the upper limit voltage of charge is set to 4.7 V. In FIG. 82A to FIG. 83B, the horizontal axis represents the discharge capacity per weight of the positive electrode active material, and the vertical axis represents discharge voltage. The discharge capacity at each temperature, in the case where the discharge capacity normalized at an environment temperature of 25° C. is regarded as 1, is shown in FIG. 84. The solid line denotes data with an upper limit voltage of 4.6 V and the dashed line denotes data with an upper voltage of 4.7 V.

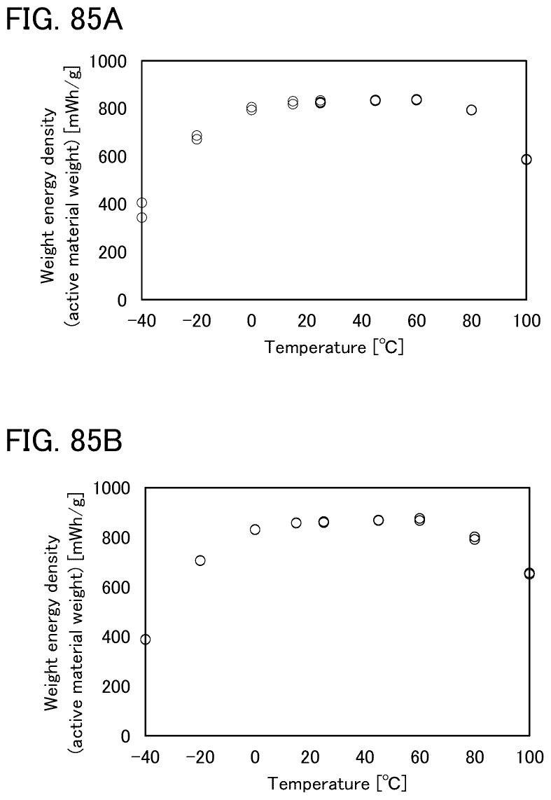

FIG. 85A and FIG. 85B show the weight energy density per weight of the positive electrode active material at each temperature. FIG. 85A shows data with an upper voltage of 4.6 V and FIG. 85B shows data with an upper voltage of 4.7 V.

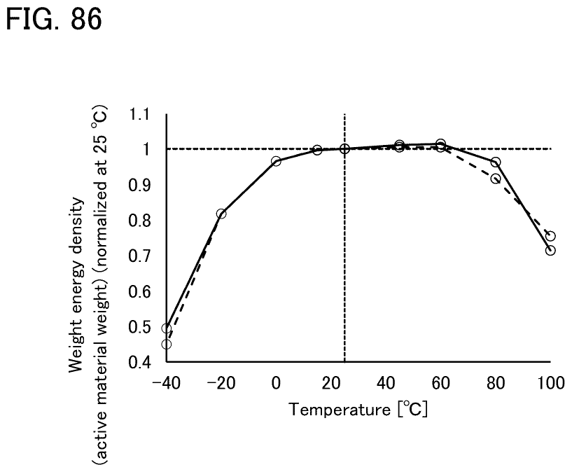

FIG. 86 shows the weight energy density at each temperature, which is normalized with the weight energy density at an environment temperature of 25° C. regarded as 1. The solid line denotes data with an upper voltage of 4.6 V and the dashed line denotes data with an upper voltage of 4.7 V.

Excellent discharge capacity was obtained at environment temperatures of −40° C. to 100° C.

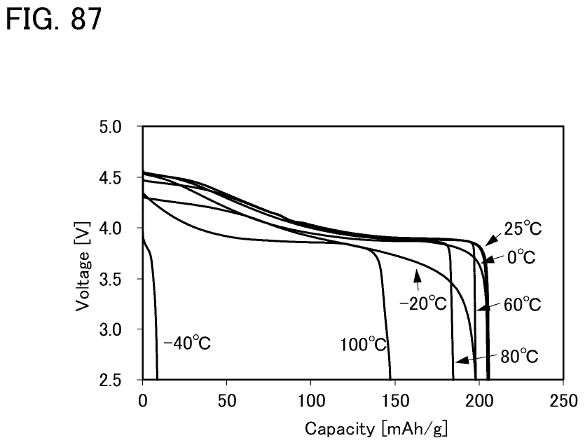

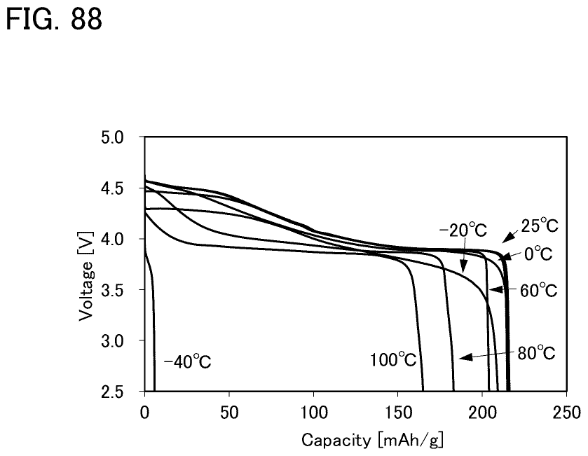

FIG. 87 and FIG. 88 show results of the half cells using a second electrolyte solution as the electrolyte solution.

FIG. 87 shows discharge curves when the upper limit voltage of charge is set to 4.6 V. FIG. 88 shows discharge curves when the upper limit voltage of charge is set to 4.7 V.

Excellent discharge capacity was obtained at environment temperatures of −20° C. to 100° C. Furthermore, at an environment temperature of −40° C., the discharge capacity was approximately 10 mAh/g.

Table 15 and Table 16 show, respectively, the discharge capacity per weight of the positive electrode active material (mAh/g) and the weight energy density per weight of the positive electrode active material (mWh/g) at each temperature. Note that the results of the measurement of each of two cells formed as the half cells employing the first condition are shown.

TABLE 15

| | Electrolyte | | | | Electrolyte | |
|---|---|---|---|---|---|---|
| | first condition | | | | second condition | |
| | 4.6 V | 4.7 V | 4.6 V | 4.7 V | 4.6 V | 4.7 V |
| 100° C. | 152.0 | 169.5 | 151.5 | 171.0 | 147.1 | 164.9 |
| 80° C. | 195.1 | 196.9 | 195.2 | 199.3 | 184.5 | 183.0 |
| 60° C. | 203.8 | 211.0 | 204.2 | 213.2 | 197.9 | 204.0 |
| 45° C. | 203.2 | 211.1 | 203.8 | 211.7 | 201.1 | 205.2 |
| 25° C. | 202.1 | 211.0 | 202.5 | 210.6 | 204.9 | 216.0 |
| 25° C. | 201.4 | 210.8 | 204.4 | 210.0 | 205.8 | 214.8 |
| 15° C. | 201.3 | 211.3 | 204.4 | 210.5 | 205.8 | 215.9 |
| 0° C. | 198.6 | 208.4 | 201.7 | 207.7 | 205.5 | 216.1 |
| −20° C. | 184.1 | 193.0 | 187.5 | 193.2 | 197.9 | 209.2 |
| −40° C. | 133.4 | 126.6 | 109.6 | 126.0 | 8.6 | 5.8 |

TABLE 16

| | Electrolyte | | | | Electrolyte | |
|---|---|---|---|---|---|---|
| | first condition | | | | second condition | |
| | 4.6 V | 4.7 V | 4.6 V | 4.7 V | 4.6 V | 4.7 V |
| 100° C. | 587.4 | 651.4 | 585.7 | 656.2 | 573.4 | 639.0 |
| 80° C. | 792.3 | 791.1 | 793.0 | 801.4 | 748.9 | 728.9 |
| 60° C. | 834.1 | 867.3 | 836.5 | 876.2 | 810.4 | 836.8 |
| 45° C. | 831.5 | 867.6 | 834.3 | 869.5 | 824.7 | 845.9 |
| 25° C. | 822.8 | 863.6 | 825.0 | 860.0 | 840.6 | 892.6 |
| 25° C. | 820.7 | 862.1 | 832.6 | 858.4 | 844.2 | 887.1 |
| 15° C. | 817.0 | 859.7 | 829.1 | 856.3 | 843.0 | 890.9 |
| 0° C. | 792.3 | 831.9 | 804.6 | 829.8 | 835.3 | 886.1 |
| −20° C. | 670.7 | 704.7 | 686.3 | 707.2 | 772.4 | 830.0 |
| −40° C. | 405.7 | 387.2 | 343.6 | 389.5 | 31.1 | 21.3 |

### <Rate Characteristics>

As aging, charge and discharge were performed twice. The aging was performed at an environment temperature of 25° C. As first charge, constant current charge was performed at 0.1 C up to the upper limit voltage and constant voltage charge was further performed with the lower limit set to 0.01 C. As first discharge after the first charge, constant current discharge was performed at 0.1 C with the lower limit voltage set to 2.5 V. As second charge, constant current charge was performed at 0.5 C up to the upper limit voltage and constant voltage charge was further performed with the lower limit set to 0.05 C. As second discharge after the second charge, constant current discharge was performed at 0.5 C with the lower limit voltage set to 2.5 V. Note that the upper limit voltage of charge was adjusted to the upper limit voltage in acquisition of temperature characteristics.

After the aging, the rate characteristics were evaluated. The environment temperature was set to 25° C. As for charge, after constant current charge at 0.5 C, constant voltage charge was performed with the upper limit set to 0.05 C. Different conditions were employed for the half cells having, respectively, the upper limit charge voltages of 4.6 V and 4.7 V. 1 C was set to 200 mA/g. Here, the weight used for rate calculation was the weight of the positive electrode active material.

Discharge was performed with the rates changed per cycle in the order of 0.1 C, 0.2 C, 0.5 C, 1 C, 2 C, 3 C, 4 C, 5 C, 10 C, 20 C, and 0.1 C, and two cycles of discharge were performed at each rate.

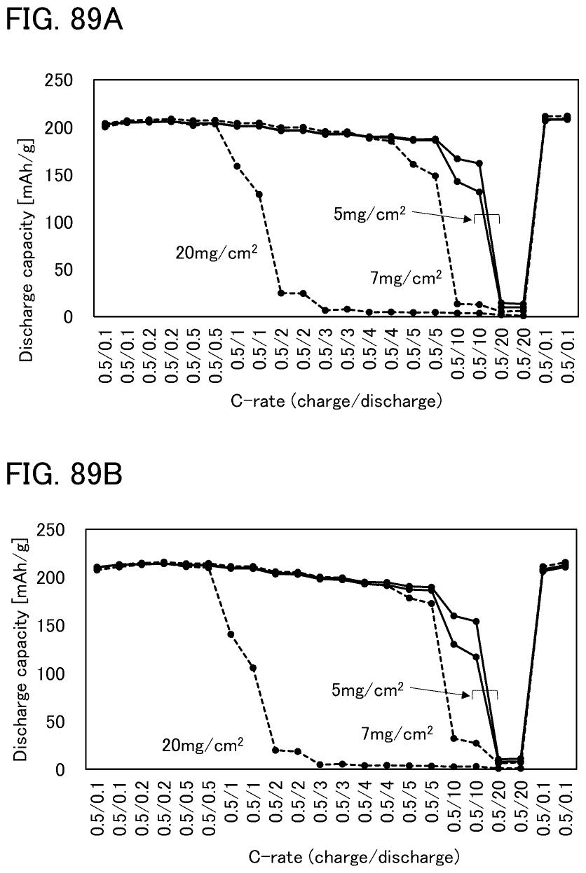

FIG. 89A and FIG. 89B show the results of the half cells employing the first condition for the electrolyte solution. FIG. 89A and FIG. 89B show the discharge capacity with the upper limit charge voltage of 4.6 V and 4.7 V, respectively. The discharge capacity shown in FIG. 89A and FIG. 89B is the discharge capacity per weight of the positive electrode active material. The results of the loading levels of the positive electrode active material weight, which are approximately 5 mg/cm², approximately 7 mg/cm², and approximately 20 mg/cm², are shown.

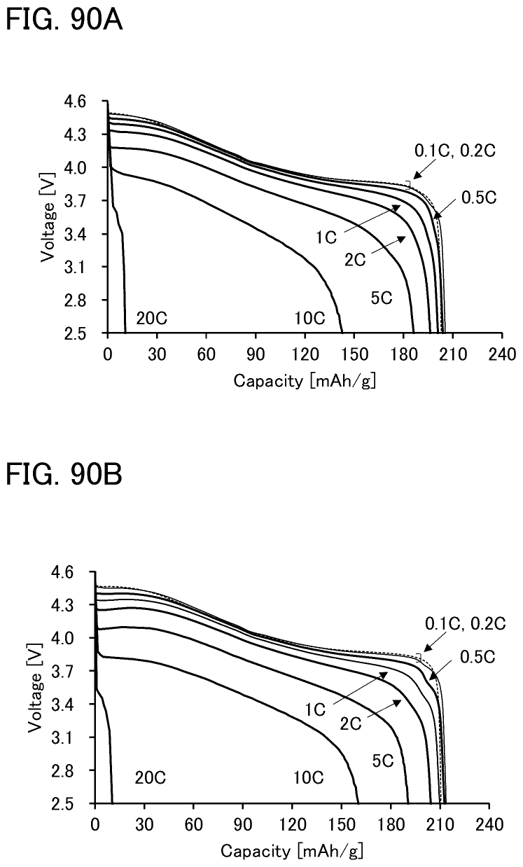

FIG. 90A and FIG. 90B show discharge curves employing the first condition for the electrolyte solution under the condition where the loading level of the positive electrode active material per unit area was approximately 5 mg/cm². In FIG. 90A and FIG. 90B, the horizontal axis represents the discharge capacity per weight of the positive electrode active material, and the vertical axis represents discharge voltage. The dashed line denotes a result at 0.1 C and the solid lines denote the other results. Note that data at 3 C and 4 C are not shown for easy viewing of the drawing. The results corresponding to only one cycle of the two cycles of discharge at each rate are shown. The result of only the cycle performed first is shown for the characteristics at 0.1 C. FIG. 90A and FIG. 90B show the results with the upper limit charge voltage of 4.6 V and 4.7 V, respectively.

High discharge capacity is obtained even at a discharge rate of 10 C. Note that the discharge capacity of approximately 10 mAh/g is obtained at 2θ C.

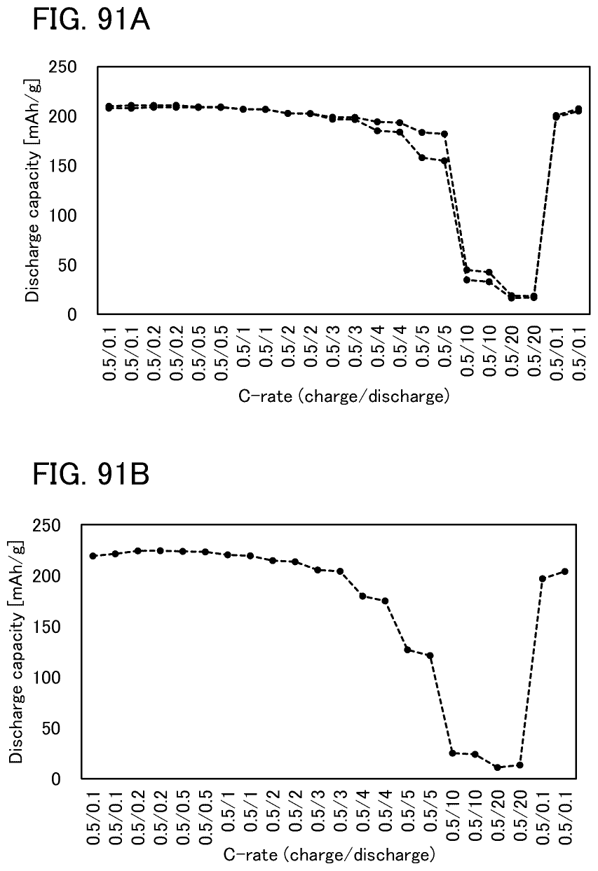

FIG. 91A and FIG. 91B show discharge curves employing the second condition for the electrolyte solution under the condition where the loading level of the positive electrode active material per unit area was approximately 5 mg/cm².

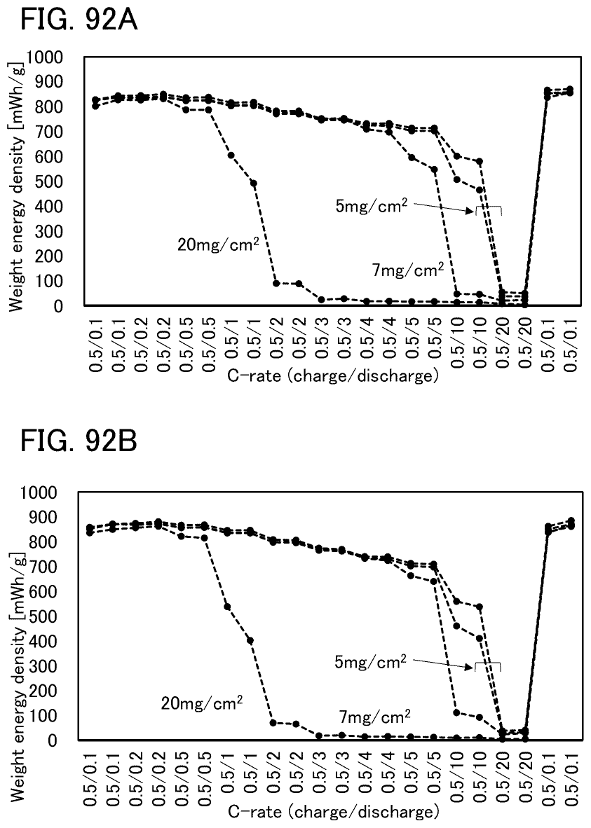

FIG. 92A and FIG. 92B show the weight energy density per weight of the positive electrode active material at each rate, for which the first condition is used for the electrolyte solution and the loading levels of the positive electrode active material per unit area are approximately 5 mg/cm², approximately 7 mg/cm², and approximately 20 mg/cm². FIG. 92A shows data on the results under the condition where the upper limit voltage is 4.6 V and FIG. 92B shows the data on the results under the condition where the upper limit voltage is 4.7 V.

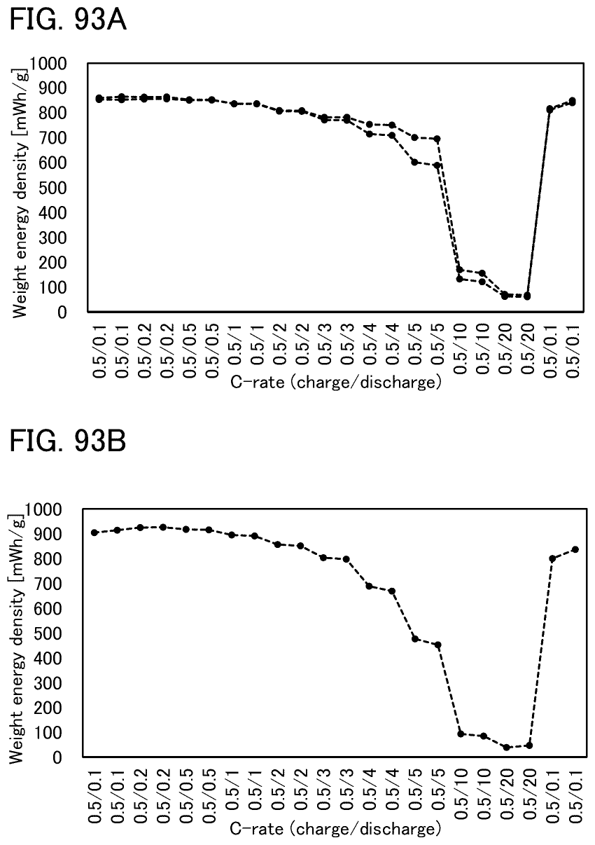

FIG. 93A and FIG. 93B show the weight energy density per weight of the positive electrode active material at each rate, for which the second condition is used for the electrolyte solution and the loading level of the positive electrode active material per unit area is approximately 5 mg/cm². FIG. 93A shows data on the results under the condition where the upper limit voltage is 4.6 V and FIG. 93B shows the data on the results under the condition where the upper limit voltage is 4.7 V.

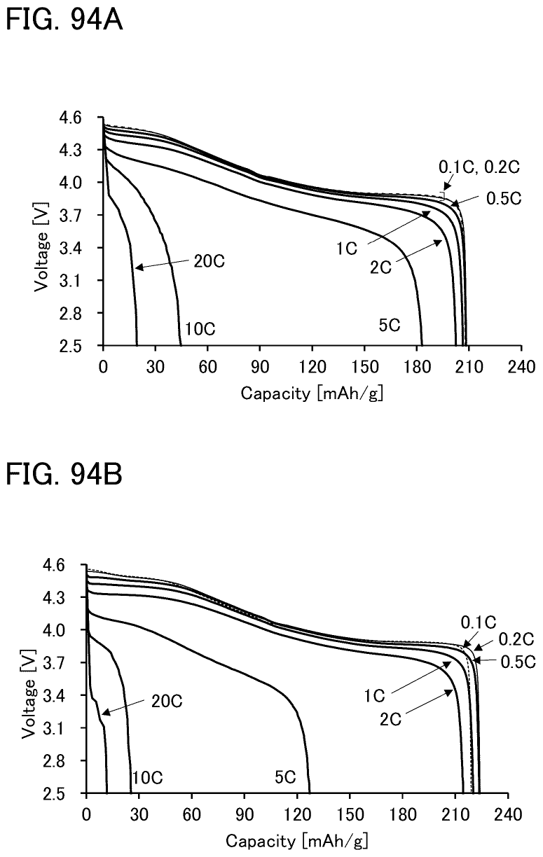

FIG. 94A and FIG. 94B show discharge curves employing the second condition for the electrolyte solution under the condition where the loading level of the positive electrode active material per unit area is approximately 5 mg/cm². In FIG. 94A and FIG. 94B, the horizontal axis represents the discharge capacity per weight of the positive electrode active material, and the vertical axis represents discharge voltage. FIG. 94A and FIG. 94B show the results with the upper limit charge voltage of 4.6 V and 4.7 V, respectively. The dashed line denotes a result at 0.1 C and the solid lines denote the other results. Note that data at 3 C and 4 C are not shown for easy viewing of the drawing. The results corresponding to only one cycle of the two cycles of discharge at each rate are shown. The result of only the cycle performed first is shown for the characteristics at 0.1 C.

High discharge capacity is obtained even at a discharge rate of 5 C. Note that discharge capacity higher than or equal to 20 mAh/g is obtained at 10 C and discharge capacity higher than or equal to 10 mAh/g is obtained at 2θ C.

### Example 3

In this example, characteristics of a secondary battery using the positive electrode formed under the conditions similar to those in Example 1 and an electrolyte solution different from that in Example 2 are described.

As the positive electrode, a positive electrode formed under the conditions similar to those of Sample 1-1 described in Example 1 was used. As the electrolyte solution, an electrolyte solution of a third condition different from the electrolyte solution of the first condition and the electrolyte solution of the second condition, which are described in Example 2, was used. A lithium metal was used as the negative electrode.

As the electrolyte solution of the third condition, a solution in which ethylene carbonate (EC), ethylmethyl carbonate (EMC), and dimethyl carbonate (DMC) were mixed at a volume ratio of 3:3.5:3.5 was used. As an electrolyte contained in the electrolyte solution, 1 mol/L lithium hexafluorophosphate (LiPF₆) was used.

A separator was interposed between the positive electrode and the negative electrode, and contained together with the electrolyte solution of the third condition in an exterior material, whereby a test half cell was formed. This battery is referred to as a coin-type half cell in some cases because the state of being contained in the exterior material is like a coin.

The coin-type half cells were formed in this manner, and subjected to charge and discharge tests in which measurement was performed with a charge-discharge measuring system (TOSCAT-3100) produced by TOYO SYSTEM Co., LTD, as a charge-discharge measuring instrument.

The measurement conditions are described. Three measurement conditions were employed, and the upper limit voltages of charge were 4.3 V, 4.6 V, and 4.7 V.

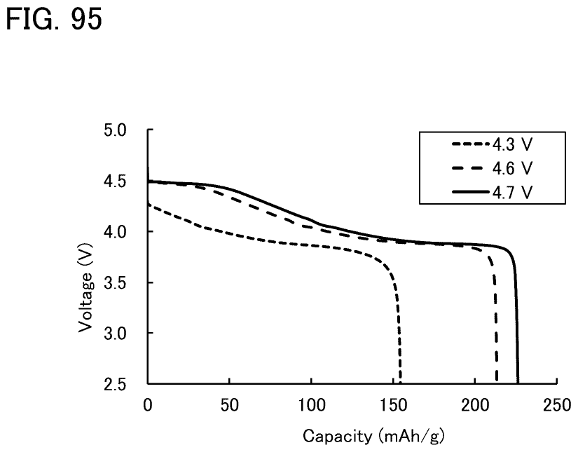

As the measurement under three conditions where the upper voltages in charge were 4.3 V, 4.6 V, and 4.7 V, measurements of three cycles of charge and discharge were performed using different half cells. The measurements were performed at an environment temperature of 25° C. As first charge, constant current charge was performed at 0.1 C up to the upper limit voltage and constant voltage charge was further performed with the lower limit set to 0.01 C. As first discharge after the first charge, constant current discharge was performed at 0.1 C with the lower limit voltage set to 2.5 V. As the charge and discharge in the second cycle and the third cycle, charge and discharge were performed under the same conditions as the 1st cycle. Table 17 and FIG. 95 show the results of the discharge in the third cycle. Here, 1 C was set to 200 mA/g. The weight used for rate calculation was the weight of the positive electrode active material.

Table 17 lists the average discharge voltage, discharge capacity, and discharge energy density under the conditions where the upper voltages in charge are 4.3 V, 4.6 V, and 4.7 V. The discharge curves thereof are shown in FIG. 95. Note that the weight used for calculation of the discharge capacity and the discharge energy density is the weight of the positive electrode active material.

TABLE 17

| Charge | Average discharge | Discharge | Discharge |
|---|---|---|---|
| voltage | voltage | capacity | energy density |
| [V] | [V] | [mAh/g] | [Wh/kg] |
| 4.3 V | 3.91 | 154.5 | 604.4 |
| 4.6 V | 4.08 | 213.4 | 871.7 |
| 4.7 V | 4.11 | 226.2 | 930.2 |

Table 17 and FIG. 95 reveal that, as the upper voltage in charge is increased to 4.3 V, 4.6 V, and 4.7 V, the average discharge voltage and discharge capacity become high and the discharge energy density significantly improves.

### REFERENCE NUMERALS

100: positive electrode active material, 100a: surface portion, 100b: inner portion, 101: crystal grain boundary, 103: projection, 104: coating film, 200: active material layer, 201: graphene compound, 300: secondary battery, 301: positive electrode can, 302: negative electrode can, 303: gasket, 304: positive electrode, 305: positive electrode current collector, 306: positive electrode active material layer, 307: negative electrode, 308: negative electrode current collector, 309: negative electrode active material layer, 310: separator

1. (canceled)

2. A battery comprising:
a positive electrode; and
a negative electrode,
wherein the positive electrode is used as a positive electrode of a test battery comprising a lithium metal counter electrode, and
wherein, when a test of 50 repetitions of a cycle of charge and discharge in which, after constant current charge is performed at 200 mA/g until a voltage of 4.6 V is reached, constant voltage charge is performed at a voltage of 4.6 V until a charge current of 20 mA/g is reached, and constant current discharge is then performed at 200 mA/g until a voltage of 2.5 V is reached is performed in a 25° C. environment or a 45° C. environment and discharge capacity is measured in each cycle, a discharge capacity value measured in a 50th cycle accounts for higher than or equal to 90% and lower than 100% of a maximum discharge capacity value in all 50 cycles.

3. (canceled)

4. A battery comprising:
a positive electrode; and
a negative electrode,
wherein the positive electrode is used as a positive electrode of a test battery comprising a lithium metal counter electrode, and
wherein, when a test of 50 repetitions of a cycle of charge and discharge in which, after constant current charge is performed at 100 mA/g until a voltage of 4.6 V is reached, constant voltage charge is performed at a voltage of 4.6 V until a charge current of 10 mA/g is reached, and constant current discharge is then performed at 100 mA/g until a voltage of 2.5 V is reached is performed in a 25° C. environment or a 45° C. environment and discharge capacity is measured in each cycle, a discharge capacity value measured in a 50th cycle accounts for higher than or equal to 90% and lower than 100% of a maximum discharge capacity value in all 50 cycles.

5. (canceled)

6. The battery according to claim 2,
wherein the positive electrode is used as a positive electrode of a test battery comprising a lithium metal counter electrode, and
wherein, when a test of 50 repetitions of a cycle of charge and discharge in which, after constant current charge is performed at 200 mA/g until a voltage of 4.65 V is reached, constant voltage charge is performed at a voltage of 4.65 V until a charge current of 20 mA/g is reached, and constant current discharge is then performed at 200 mA/g until a voltage of 2.5 V is reached is performed in a 25° C. environment and discharge capacity is measured in each cycle, a discharge capacity value measured in a 50th cycle accounts for higher than or equal to 90% and lower than 100% of a maximum discharge capacity value in all 50 cycles.

7. (canceled)

8. The battery according to claim 4,
wherein the positive electrode is used as a positive electrode of a test battery comprising a lithium metal counter electrode, and
wherein, when a test of 50 repetitions of a cycle of charge and discharge in which, after constant current charge is performed at 100 mA/g until a voltage of 4.65 V is reached, constant voltage charge is performed at a voltage of 4.65 V until a charge current of 10 mA/g is reached, and constant current discharge is then performed at 100 mA/g until a voltage of 2.5 V is reached is performed in a 25° C. environment and discharge capacity is measured in each cycle, a discharge capacity value measured in a 50th cycle accounts for higher than or equal to 90% and lower than 100% of a maximum discharge capacity value in all 50 cycles.

9. (canceled)

10. The battery according to claim 2,
wherein the positive electrode is used as a positive electrode of a test battery comprising a lithium metal counter electrode, and
wherein, when a test of 50 repetitions of a cycle of charge and discharge in which, after constant current charge is performed at 200 mA/g until a voltage of 4.7 V is reached, constant voltage charge is performed at a voltage of 4.7 V until a charge current of 20 mA/g is reached, and constant current discharge is then performed at 200 mA/g until a voltage of 2.5 V is reached is performed in a 25° C. environment and discharge capacity is measured in each cycle, a discharge capacity value measured in a 50th cycle accounts for higher than or equal to 90% and lower than 100% of a maximum discharge capacity value in all 50 cycles.

11. (canceled)

12. The battery according to claim 4,
wherein the positive electrode is used as a positive electrode of a test battery comprising a lithium metal counter electrode, and
wherein, when a test of 50 repetitions of a cycle of charge and discharge in which, after constant current charge is performed at 100 mA/g until a voltage of 4.7 V is reached, constant voltage charge is performed at a voltage of 4.7 V until a charge current of 10 mA/g is reached, and constant current discharge is then performed at 100 mA/g until a voltage of 2.5 V is reached is performed in a 25° C. environment and discharge capacity is measured in each cycle, a discharge capacity value measured in a 50th cycle accounts for higher than or equal to 90% and lower than 100% of a maximum discharge capacity value in all 50 cycles.

13. The battery according to claim 2,
wherein, when the test battery is in the 25° C. environment and the 45° C. environment, the discharge capacity value measured in the 50th cycle accounts for higher than or equal to 90% and lower than 100% of the maximum discharge capacity value in all the 50 cycles.

14. The battery according to claim 2,
wherein the discharge capacity value measured in the 50th cycle accounts for higher than or equal to 95% of the maximum discharge capacity value in all the 50 cycles.

15. The battery according to claim 2,
wherein the test battery is a coin-type half cell.

16. The battery according to claim 2,
wherein the test battery comprises an electrolyte solution, and the electrolyte solution comprises a solvent comprising ethylene carbonate and diethyl carbonate, an additive agent comprising vinylene carbonate, and a lithium salt comprising lithium hexafluorophosphate.

17. The battery according to claim 2,
wherein the positive electrode comprises a layered rock-salt positive electrode active material.

18. The battery according to claim 17,
wherein the positive electrode active material comprises lithium cobalt oxide.

19. An electronic device comprising the battery according to claim 2.

20. A vehicle comprising the battery according to claim 2.

21. The battery according to claim 2, wherein 200 mA/g is defined as 1 C.

22. The battery according to claim 4,
wherein, when the test battery is in the 25° C. environment and the 45° C. environment, the discharge capacity value measured in the 50th cycle accounts for higher than or equal to 90% and lower than 100% of the maximum discharge capacity value in all the 50 cycles.

23. The battery according to claim 4,
wherein the discharge capacity value measured in the 50th cycle accounts for higher than or equal to 95% of the maximum discharge capacity value in all the 50 cycles.

24. The battery according to claim 4,
wherein the test battery is a coin-type half cell.

25. The battery according to claim 4,
wherein the test battery comprises an electrolyte solution, and the electrolyte solution comprises a solvent comprising ethylene carbonate and diethyl carbonate, an additive agent comprising vinylene carbonate, and a lithium salt comprising lithium hexafluorophosphate.

26. The battery according to claim 4,
wherein the positive electrode comprises a layered rock-salt positive electrode active material.

27. The battery according to claim 26,
wherein the positive electrode active material comprises lithium cobalt oxide.

28. An electronic device comprising the battery according to claim 4.

29. A vehicle comprising the battery according to claim 4.

30. The battery according to claim 4, wherein 200 mA/g is defined as 1 C.
